(19) United States
(12) Patent Application Publication
(10) Pub. No.: US 2018/0298754 A1
(43) Pub. Date: Oct. 18, 2018

(54) DEVICE FOR LIFTING AND RECOVERING SEABED RESOURCE

(71) Applicant: KODAIRA ASSOCIATES INC., Tokyo (JP)

(72) Inventors: Takatoshi KODAIRA, Tokyo (JP); Takamoto KODAIRA, Tokyo (JP)

(21) Appl. No.: 15/775,230

(22) PCT Filed: Nov. 11, 2016
(86) PCT No.: PCT/JP2016/083616

§ 371 Date: May 10, 2018

(30) Foreign Application Priority Data
Nov. 13, 2015 (JP) 2015-222542

(51) Int. Cl. E21C 50/00; E02F 5/00; E02F 7/00; B63B 27/30; B63B 27/10; B63B 35/00; B63B 22/24; B63B 22/20; B63C 11/52; B63H 11/02; B63H 5/07; C25B 1/10; B01J 8/06; G01S 15/74; G01S 11/12

(52) U.S. Cl. CPC E21C 50/00; B01J 2208/065; E02F 7/005; B63B 27/30; B63B 27/10; B63B 35/003; B63B 22/24; B63B 22/20; B63C 11/52; B63H 11/02; B63H 5/07; C25B 1/10; B01J 8/067; G01S 15/74; G01S 11/12; E02F 5/006

(57) ABSTRACT

The present invention relates to a system for collecting, lifting, and recovering seabed mineral resources, specifically, a device wherein hydrogen gas is evolved on the seabed, resources are lifted by the buoyancy of the gas to the sea surface, and the hydrogen gas which has become an excess buoyancy source during the lifting and recovering is absorbed into an organic substance including toluene, thereby yielding hydrogenated compounds including cyclomethylhexane to recover the energy required for hydrogen gas production.

### CROSS-REFERENCE TO RELATED APPLICATION

This application is a U.S. continuation application filed under 35USC111(a) claiming benefit under 35USC120 and 365(c) of PCT application JP2016/083616, filed on Nov. 11, 2016, which claims priority to Japanese Patent Application No. 2015-222542, filed on Nov. 13, 2015, the entire contents of which are incorporated herein by reference.

### BACKGROUND OF THE INVENTION

### 1. Field of the Invention

The present invention relates to an apparatus for lifting objects from the seafloor. In particular, a system for collecting and raising mineral resources on the seabed uses hydrogen gas as the source of buoyancy from the bottom of the seafloor and then absorb hydrogen gas into an organic substance including toluene to recover hydrogen gas producing energy.

### 2. Description of the Related Art

The human being has traditionally tried to collect objects from the seafloor in the field of salvage, dredging, and underwater oil drilling. But they have not established any method to recover submarine resources from 2000 m to 5000 m, and the trial to restore submarine resources from more than 1000 m has just started, and there are no economic prospects.

The present invention relates to an apparatus for economically carrying out seafloor resource recovery more than a depth of 1000 m and up to a level of 5000 m. The inventor has newly devised by combining state-of-the-art technologies, such as electrochemical, organic chemistry, hydrogen engineering, control engineering, space engineering, and information engineering, which are not conventionally used in marine development, to achieve using the present hardware technology without a mechanical challenge under high-pressure conditions.

The followings are prior arts. The collection of seafloor minerals has been discussed conventionally as an extension of salvage technology, dredging technology, and offshore oil drilling technology. The Non-Patent Document 1 outlines the salvaging technology which uses “turning system” and uses buoyancy “balloon system,” and directly lift “grasping system.” The “turning system” is a metal or rubber balloon with compressed air, but is subject to the horizontal movement because of gas expansion due to depth change. The depth is less than 100 m. “grasping system” is a method of extending the arm directly to the seafloor. There is the only record in which the U.S. CIA raised a sunk Soviet strategic nuclear submarine from 5000 m in the “grasping system” for its profits from the seafloor to collect strategic nuclear information.

According to public report, it is believed to be an extension of submarine oil drilling technology. Because of the direct mechanical involvement of watercraft on water, the serene sea level is indispensable, and it is not suitable for collecting mineral resources from the deep sea.

Mineral collection from the bottom of the sea is not economically viable, and it is best to collect samples from deep-sea search boats, unmanned robots, and bowling. Exceptionally, as oil fields and gas fields erupt out by the internal pressure through an open hole. It is proposed to pump up the hot water in which mineral resources have been dissolved more than the marine thermal water, as an extension of the submarine oil drilling technology (Patent Document 1).

This method can also be obtained by pouring particular solvents into deposits, as well as shale gas extraction, and separating dissolved minerals from solutions after vacuuming them onto the water.

As a method for recovering mineral resources from seafloor layers extending dredging technology, they experimentally develop an elemental technology for drilling underwater hydrothermal deposits (Chimney, etc.) at depths of 1000 m to send them to sea surface by water pumps (Patent Document 2). The mining technology realizes drilling and dredging function under high pressure of the seafloor. It has been successful to collect 25 kg of sulfide ore, but there is a report that heavy duty is a problem. And the realization of abrasion resistance is essential, and future problem is the transportation of the slurry. (Chimney, etc.) The excavation of submarine minerals is at last stage of the test development of the elemental technology in the submarine hydrothermal deposit of 1000 m depth. Although there are cobalt chrysanthemum, manganese nodules, and rare earth deposits distributed on deep-sea surfaces deeper than 1000 m, resource recovery is in a step of the resource survey, and it has not started including methodology. (Non-Patent Document 3)

### BRIEF SUMMARY OF THE INVENTION

The inventor understands the development of submarine mineral resources at depths of more than 1000 m could not be solved by the extension of conventional salvage technology, dredging technology, and seafloor oil drilling technology, from the following viewpoint, it was fundamentally examined.

(1) The cobalt-rich crust, manganese nodules, and rare earth deposits deposited on the seafloor surface (FIG. 5) could be collected by bulldozers if they were on the ground. The primary cause that the drilling trial of hydrothermal deposits precedes is that hydrothermal deposits are relatively shallow at around 1000 meters in depth, and if there were a method to override the depth of seafloor, it could be easier to collect cobalt-rich crust, manganese nodules, and rare earth deposits.

(2) Although the 5000 m deep is only 5 km at a distance, it can be transmitted and received linearly with an electromagnetic wave of 300000 km per second in the air, whereas in water, it is at the speed of 1500 m per second, 200000 times slower. Also, there is no strait transmission of sound waves in water, and the amount of communication is overwhelmingly small. Also, the pressure is a difference of 1 atmospheric pressure between the space and on the ground, but at 5000 m in the sea bottom, the difference is 500 atm. The 5 km to the seafloor suggests the need to think in the world far away than expected

(3) On the other hand, sperm whales do not use a particular pressure resistance technique as the living body, but they dive up to 3000 m and come back to the sea surface preying upon giant squids (FIG. 3). Considering why it happens, the present invention has come out. There are reasons why sperm whales can smoothly go to the seafloor depth and back to the sea surface. Firstly the internal pressure of the liquid and solid material in the living body can be equal to the outer water pressure. And it can avoid the structural problem in the high-pressure environment. Secondly, they can move independently to objects on the seafloor and the sea surface, and there is no fundamental restriction as they are autonomous as the structure and moving body. Thirdly, sperm whales lift up and descend by using a change in specific gravity depending on the temperature of spermaceti oil, indicating that lifting and lowering using buoyancy is the most energy efficient as a vertical moving means in the liquid such as underwater.

Table of Contents

| I | Concept and feasibility | |
|---|---|---|
| | 1. | Policy of invention |
| | 2. | Consideration of alternatives |
| | 3. | Basic concept |
| | 4. | Feasibility |
| II | Operational Plan | |
| III | System configuration | |
| | 1. | Designing philosophy |
| | 2. | Deepsea Crane |
| | 3. | Seafloor Station |
| | 4. | Surface ship |

| | |
|---|---|
| 4.1 | Surface mothership |
| 4.2 | Carrier |

| IV | Principle of lifting | |
|---|---|---|
| | 1. | Principle |

| | |
|---|---|
| 1.1 | Hydride reaction |
| 1.2 | Response to water pressure changes |
| 1.3 | Structure and dynamics of the lifting control system |

| V | Deepsea Crane | |
|---|---|---|
| | 1. | Control system |

| | |
|---|---|
| 1.1 | Objectives and Functions |
| 1.2 | Dynamics and control systems |

| | |
|---|---|
| (a) | Position and velocity control |
| (b) | Attitude control |
| (c) | Integration of control variables |
| (d) | Configuration of the control system |

| | |
|---|---|
| 2. | Navigation system |

| | |
|---|---|
| 2.1 | Configuration |
| 2.2 | Inertial Navigation |
| 2.3 | Sound Navigation |
| 2.4 | Optical Navigation |

| | 3. | Docking control |
|---|---|---|
| | 4. | Operation mode control |
| | 5. | Fluid configuration control |
| VI | Seafloor Station | |
| | 1. | Control system |

| | |
|---|---|
| 1.1 | Objectives and Functions |
| 1.2 | Dynamics and control systems |

| | |
|---|---|
| (a) | Position and velocity control |
| (b) | Attitude control |
| (c) | Integration of control variables |
| (d) | Configuration of the control system |

| | |
|---|---|
| 2. | Navigation system |

| | |
|---|---|
| 2.1 | Configuration |
| 2.2 | Inertial Navigation |
| 2.3 | Acoustic Navigation |

| | 3. | Operation mode control |
|---|---|---|
| | 4. | Fluid configuration control |
| VII | Hydrogen gas generator | |
| VIII | Power generator | |
| | 1. | Current and Wave Conditions |
| | 2. | Power Supply Requirements |
| | 3. | Surface solar power generator |
| IX | Supervising and control system | |
| | 1. | System configuration |
| | 2. | Integrated supervisory and control system |
| | 3. | Deepsea Crane control system |
| | 4. | Seafloor Station control system |
| X | Operation method | |
| | 1. | Requirements for continuous operation |

| | |
|---|---|
| 1.1. | Definitions of abbreviations and variables |
| 1.2. | Physical properties of components |
| 1.3. | Reaction in the lifting, descending and moving |
| | processes |

| | |
|---|---|
| 2. | Configuration of continuous operation |

| | |
|---|---|
| 2.1. | Deepsea Crane |
| 2.2. | Seafloor Station |

| | |
|---|---|
| 3. | Improving efficiency of continuous operation |

I Concept and Feasibility

1. Policy of Invention

Firstly, the system fundamentally avoids the obstacles caused by the high-pressure environment.

Secondly, it is to avoid pumping, suction and avoiding energy waste to lift from the deep sea.

Thirdly, it is to ensure that all undersea equipment can be mobilized autonomously to the sea surface, eliminating reduced access to the deep sea, and preventing maintenance problems.

Fourthly, it actively utilizes the high-pressure environment of the deep sea.

Fifthly, structural standardization is applied to reduce development issues and risks.

The inventor invented the new equipment to solve this problem combining the results of electrochemical, organic chemistry, hydrogen engineering, control engineering, space engineering, and information engineering, that the marine development has not used. First, it makes the internal pressure and the external pressure of the equipment equal to fundamentally eliminate the requirements to withstand the high-pressure environment, avoiding its withstanding material.

The pressure of the hydrogen gas used as the buoyancy source was set at approximately equal to the ambient water pressure for any sea depth so that there was no mechanism of high stress. Thus it is released from the strength constraints, resulting in the ease of scaling up the equipment.

Second, lifting up from and descending to the seafloor was carried out by the buoyancy of hydrogen gas, and it avoids the waste of energy needed by the high-pressure mineral pumping from the seabed.

It is unnecessary for the buoyancy method to employ high elevation pump to raise the mineral resources in the sea to the sea surface,

It eliminates a movable mechanism under high pressure, high-pressure piping, the friction mechanism, and pressure withstanding arrangement with a massive pressure difference, and there is no problem of abrasion and sealing of transport pipe due to slurry transport.

Further, since the method of the present invention lifts up objects collected from the seafloor are lifted as they are, there is no restriction of dimensional shape and physical properties for its recovery. As there is little information on submarine resources and reduced visibility on the seafloor, it eliminates mineral processing such as slurrying ore there, so that the advantage of mining ore as the original stone is large.

Third, the reduction of the water weight of the equipment makes all of them could float on the sea surface by itself for maintenance as part of the steady operation to improve the inferior access to the seafloor and the underwater. Maintenance and inspection of all equipment can be easily carried out at the sea level. This feature facilitates its movement at the seabed, so the mobility suitable for collecting thinly and widely spread minerals over there became feasible.

Fourthly it actively utilizes the high-pressure environment. Electrolysis generates hydrogen gas on the seafloor to get the buoyancy, but electrolysis in the high-pressure environment compresses the bubbles to decrease the inhibition factor of electrolysis which is caused by the decrease of conductivity by generated bubbles. As a result, the energy efficiency improves.

Some of the electrolysis equipment of water actively utilize this property. Furthermore, as the hydrogenation of toluene (organic hydride reaction) for hydrogen gas recovery is an equilibrium reaction, the equilibrium point becomes the hydrogen gas adsorption side at high pressure (about 200° C.), and the adsorption reaction promotes.

2. Consideration of Alternatives

A primary alternative to the method of using buoyancy is lifting by wire applying salvage technology. There have been no methods proposed as the deep-sea mineral resource collection method, but the cause is assumed as follows.

When we lift up a basket loaded with minerals collected at the seafloor by a wire fixed to the basket, the high strength nylon rope will be the best, as it is less rigid, its water weight is lighter. It needs about 120 φ of its diameter to raise 250 tons. However, the inventor of the present invention cannot find an appropriate control method to guide wire to a basket located in a predetermined recovery place pulling it into the sea, then at a seafloor installation to make an empty one grasp the rope to lift it to the sea surface,

Furthermore, the inventor of the present invention cannot find an appropriate control method even though there may be a method to load the minerals collected at the seafloor into the basket and let the surface ship to lift it. (Observability of the distributed variable system is not guaranteed.)

The second alternative to using buoyancy is an extension of dredging technology by improving the performance of the slurrying and the high lift water pump, which is researched to lift the minerals from submarine hydrothermal deposits in the 1000 m class seafloor, to lift up the resources from the more in-depth sea. As it is structured to install the lift pipe to the deep sea and to set a high lift water pump at the tip, even though it is technically feasible, the feasibility including reliability and maintainability is not apparent. As the collected minerals go through a flexible hose in the lower part of the water pump, its maintenance is difficult.

3. Basic Concept

In the present invention, water is electrolyzed in the seafloor to generate hydrogen gas, and it utilizes buoyancy. This scheme has the following advantages:

(1) Its vast floating power is available. Hydrogen has a small molecular weight of 2 and enjoys sufficient buoyancy at the bottom of the 5000 m class. Since the 5000 m class seafloor is 500 atm (atmosphere pressure), the hydrogen gas at 500 atm is 45 g per liter, whereas the air is 28.642 g per liter. The buoyancy obtained by 1 liter of air is 338 g for the 5000 m seafloor and 955 g for the hydrogen gas.

(2) Toluene can absorb the excessive hydrogen gas in the process of lift up, and it becomes methylcyclohexane (MCH), the absorbed hydrogen gas is available as fuel for hydrogen gas station. Methylcyclohexane is easy to transport as liquid bearing hydrogen at ambient temperature and pressure and can be a means of hydrogen transport to a hydrogen gas station for automobiles. The generation of hydrogen gas at the seafloor of 5000 m for levitation, it requires ten times as much energy as the position energy to lift 5000 m. It is necessary to erase 499/500 hydrogen gas in the lifting process to keep the buoyancy at a predetermined value while maintaining the same external pressure as the inside pressure of the underwater lifting device. When released into the sea, almost all of the energy injected into the electrolysis of water disappear in the ocean, but hydrogenation of toluene can recover the input energy during the flotation process.

(3) Power transmission to the seafloor can be by high voltage alternate currency, and thinned aluminum wires are available. Thus the water weight and resistance and mechanical effect reduce.

(4) Although it requires considerable electric power for electrolysis, if the marine support ship can generate electricity by a floating solar cell, then it is recovered absorbing by toluene, it creates clean energy at sea as a by-product without waste.

(5) The method of lift up and descending using buoyancy means that there is no mechanical connection between the surface ship and the other body, and there is no constraint on the underwater structure. If there is a connection between sea surface and sea seafloor, such as lifting pipes and salvage wires, due to the stress exerted by the waves of sea vessels, and it is weak in the rough weather. For this reason, the salvage practice uses wires capable of withstanding four to six times the load of salvage, only when the sea is quiet.

4. Feasibility

4.1 Weight Reduction

It is necessary to set the specific gravity of the equipment to near 1.0 to utilize buoyancy, so it is essential to reduce its weight as a whole. Therefore it uses the carbon fiber resin with a strength of about 1.8 of specific gravity as a structural material. In particular, in the realization of an underwater lifting device that collects seafloor minerals, it is crucial for the economy to be able to fill the inside of the equipment with liquid, and that the specific gravity can be around 1.0 in the absence of gas. In other words, the specific gravity of 1.0 means that it is possible to land softly on the seafloor by self-weight, and there is no need for specific devices for the soft landing.

Also, it is necessary to generate additional gas to keep its volume to maintain its buoyancy if its specific gravity is around 1.0 with gas at the start of descending (this means the excessive weight does not turn around 1.0 without the buoyancy of gas). It needs an additional gas generator. It is necessary to hold the gas in the pressure-resistant shell costing the increase of weight if intending the gas volume and buoyancy against water pressure increase while keeping the gas pressure. (any human-powered submarine has this constraint and is different from a sperm whale that reciprocates the deep sea and sea surface) The increase in weight results in the decrease in the ability to float the seafloor minerals and the degradation of the economic efficiency.

Weight reduction is an essential requirement for realization and is its vital factor discussed below.

(a) Case of Floating Up

FIG. 1 shows an example of a typical underwater lifting device (hereafter it is referred as Deepsea Crane, the unit in FIG. 1 is mm) that collects about 200 tons of mineral resources from the seafloor at a level of 5000 meters.

The number of moles to fill with 500 atm (atmospheric pressure) (equivalent to 5000 m depth) 250 m3 of hydrogen gas tank as a buoyant source is;

250×10³/22.4×500=5.58×10⁶ moles

11.16×10⁶ g(11.16 tons) gives a buoyancy of 238.8 tons

One molecule of toluene adsorbs 3 molecules of hydrogen gas to form methylcyclohexane (MCH).

C₇H₈+3H₂→C₇H₁₄

As the molecular weight of toluene is 92, the amount of toluene needed to adsorb the balance of hydrogen gas left 1 atm of gas is;

The moles of toluene needed is;

5.58/3×10⁶ moles×499/500=1.856×10⁶ moles

The weight of toluene is;

1.856×10⁶ moles×92=170.8×10⁶ g

The volume of toluene is;

170.8×10⁶ g/0.8678=196.8 10⁶ cm³

This is as shown in FIG. 2(a).

In the process of lift up, as shown in FIG. 2(b) toluene adsorbs hydrogen gas and changes to MCH, and at the completion of lift up the state having adsorbed hydrogen gas is as shown in FIG. 2(c);

As the molecular weight of MCH is 98, the density of MCH is 0.769 g/cm3;

The moles of MCH generated is;

1.856×10⁶ moles

The weight of MCH is;

1.856×10⁶ moles×98=181.9×10⁶ g

The volume of MCH is;

181.9×10⁶ g/0.769=236.5×10⁶ cm³

The capacity of the buoyancy tank is 357.1 m3, and the capacity of the liquid tank is 240.0 m3.

When the weight of the outer wall 008 and the partition wall 002 of the Deepsea Crane 001 is 10 mm thick of carbon fiber resin, the volume of the partition wall 002 is 6.4×106 cm3, and the water weight is 5.1 ton. The maximum shear stress on the outer wall is in the vertical direction in the cylindrical portion while obtaining the buoyancy of 238.8 tons.

The cross-sectional area of the outer wall is 1885 cm2 with a thickness of 10 mm, and the average shear stress of the carbon fiber resin is 150 kg/mm2 and can withstand up to 28,275 tons. Since the withstanding value is 100 times more than the load, the outer wall is thin in the range that does not interfere with the self-shape holding. If its thickness is 5 mm, the water weight is 2.6 tons.

The hydrogen gas absorption reactor 005 is described in OTHER PUBLICATIONS 6 as an already commercialized system. The following is a ½ scale of the system;

| Type | | | Multi-tube fixed bed catalyst reactor |
|---|---|---|---|
| Catalyst | | | Pt/Al2O3 (3 mm pellet in diameter) |
| Fluid | | | C7H8, 3H2, C7H14 |
| Operating temperature | | | 200 deg. In Celsius |
| Flow | In | H2 | 50,000 Nm3/h |
| | | C7H8 | 6.9 ton/h |
| | Out | C7H8 | 0.05 ton/h |
| | | C7H14 | 7.3 ton/h |

| | |
|---|---|
| Main material | SUS304 |
| Equilibrium reaction rate | 99.2% |
| Schematic dimension (body part) | |
| Outer diameter | 2.0 m in diameter |
| | 2.0 mm in thickness |
| Inner tube | |
| Outer diameter | 40 mm |
| | Length 10 m Thickness 0.3 mm |
| | Number 500 |
| Total catalyst | 4.5 m3 |

The density of SUS304 is 7.93 g/cm3, the one of Al2O3 is 4.1 g/cm3, and the catalyst is a sphere in shape then its filling rate is 74%. Therefore the reactor can be as follows;

| Reactor weight Inner tube | 1.5 | tons |
|---|---|---|
| Body part | 0.6 | tons |
| Catalyst | 13.3 ton totally 15.4 tons | |
| Heat exchanger | 2 | tons |
| Cooler | 2 | tons |
| Auxiliaries & piping | 4 | tons |

Thus the total weight comes to be 26 tons. The total weight is 26 tons. Since the reaction rate of C7H8 is 6.9 tons/h, according to the design example of the OTHER PUBLICATIONS 6, it is necessary 24.6 hours to absorb all of the hydrogen gas by 170 tons of toluene leaving 1 atm of hydrogen gas. This time is required to reach the sea surface from the seafloor of 5000 m depth. The required time could decrease by the improvement of catalyst and reaction control. When the seafloor depth is 1/m, the required hydrogen gas amount is 1/m.

(b) The Case of Descending Down

When descending, the liquid tank is filled with 196.8 m3 of toluene, and the remaining 43.2 m3 are filled with pure water for hydrogen gas generation by electrolysis. The buoyancy tank 003 is filled with pure water, and the Cargo unit 007 is empty. Thus 196.8×(1−0.8678)=26.0 tons of buoyancy is obtained by toluene, as the weight of the Deepsea Crane is 26.0 then the total specific gravity comes to be 1.0. By adding a little, it turns to be 1.0+alpha then it can gradually drop to the seafloor allowing the Deepsea Crane soft landing to the seafloor (FIG. 2(d)).

II Operational Plan

Since the system of the present invention intends the one for continuously collecting mineral resources on the seafloor, its design should materially realize its operation.

FIG. 4 shows the operational form according to this purpose.

The Deepsea Crane 001 −1 to 3 collect submarine resources from the sea bottom 022 using the buoyancy of hydrogen gas. Therefore it is necessary to collect the submarine resources in the sea bottom and to load them to the Deepsea Cranes and to generate hydrogen gas for lift up. For this purpose, the Seafloor Station 018 settles on the seafloor. The submarine resources exist from 1000 m to 5000 m depth of the seafloor as shown in FIG. 5 (a). Manganese nodules distribute on it (FIG. 5 (b)). The cobalt-rich crust is also deposited thinly on the seafloor as pillow lava (FIG. 5 (c-1)(c-2)).

Manganese nodules or cobalt clutch crust could be collected on the ground, but in the seafloor; there are no means to load them into the Deepsea Crane 001 which is a lifting means so the Seafloor Station 018 loads it. The lower hemisphere of the Deepsea Crane 001 can separate from the Deepsea Crane 001 as the Cargo-unit 007, and the Deepsea Crane 001, which separates the Cargo-unit 007, is referred to the Crane Engine 005.

FIG. 6. shows the design of the Seafloor Station 018 which can install Cargo-unit 007 on the Cargo-unit port 023 on it.

FIG. 7 (a) shows that the Deepsea Crane 001 descends to the Cargo-unit port 023a of the Seafloor Station 018, and it docks to the Cargo-unit port 023a (FIG. 7(b)). And it lifts up leaving the empty Cargo-unit 007 and moves to another Cargo-unit port 023b on the opposite side of the Seafloor Station 018 then is re-docked it, as shown in FIG. 7(c).

The re-docked Cargo-unit 007 loads collected ore 010 collected by an unmanned remote control electric bulldozer, the Seafloor bulldozer 019. And the Deepsea Crane 001 which loads hydrogen gas (FIG. 7 (d)) from the Seafloor Station 018 detaches from the Seafloor Station 018 and floats when it obtains the buoyancy (FIG. 7 (e)).

By this method, the seafloor resources are not subjected to slurrying and pumping in the deepsea environment, and it becomes possible to recover close to the condition as it is, therefore many technical problems can be avoided.

The Seafloor Station 018 carries out the accumulation of hydrogen gas in preparation for the arrival of the next Deepsea Crane 001 and loading of the collected ore 010 to the empty Cargo-unit 007 in the Cargo-unit port a 023a.

FIG. 4 shows the Deepsea Crane 001-3 detaches from the Seafloor Station 018, rises toward the Surface mothership 016 and arrives at the Deepsea Crane port 100. The Surface mother ship 016 unload the collected ore 010 and methylcyclohexane (MCH) which has adsorbed hydrogen gas in the Deepsea Crane 001-3. After its unloading, for the next mission of the Deepsea Crane 001-3, the buoyancy tank 003 loads pure water 014 and the liquid tank 004 loads the Toluene 012 and sea water 015 for filling to drop into the seafloor (FIG. 2 (d)).

A carrier 017 carries the toluene to absorb hydrogen gas and pure water for hydrogen gas generation from a starting port and supplies them to the Surface mothership 016, and collects the collected ore 010 and methylcyclohexane (MCH) from the Surface mothership 016 and returns to the port to repeat this round trip.

The Surface mothership 016 is a base ship to collect mineral resources from the seafloor, which occupies the sea surface over the collecting seabed, directs the collection of mineral resources, maintenance of equipment, and supply of power. A plurality of Deepsea Cranes 001, a Seafloor Station 018, a Seafloor bulldozer 019, and a solar cell are mounted to the mineral collection point to deploy a plurality of Deepsea Cranes 001, a Seafloor Station 018, a Seafloor bulldozer 019, and a solar cell strip 401 to the undersea and sea surface. The Surface mothership 016 also includes toluene and pure water for initial operation. The Surface mothership 016 controls the operation of all related equipment and the system for its purpose including the staying carrier 017 which carries collected ores.

The Surface mothership 016 can change its position depending on the resource state of the seafloor. The Deepsea Crane 001 and the Seafloor Station 018 can set to a specific gravity 1.0, so if a long distance of movement is needed, it is possible to raise them to the sea surface, and then develop them at the new point. If it is a short distance, the Seafloor Station 018 can mount the Seafloor bulldozer 019 on it, and the Seafloor Station can lift up to about 10 m from the seafloor so that it can move horizontally by the propeller. Also, as the solar cell strips 401 employing a thin film type with micro-inverters for lift up and expansion, it is possible to move. The latter portion describes the concrete implementation method.

According to the present invention, since the lifting of the material is carried out by buoyancy from the seafloor, the mechanical effect due to the depth of the seafloor is small, and it can be applied widely from less than 1000 m to more than 5000 m. Further, since there is no part of the structure which is structurally constrained, it is easy to scale up. Energy efficiency is also high because of the use of buoyancy of hydrogen gas generated on the sea floor, and MCH can recover the majority energy to generate hydrogen gas.

### BRIEF EXPLANATION OF THE DRAWINGS

FIG. 1 is a diagram which shows an example of a configuration of the Deepsea Crane according to the present invention.

FIG. 2 is a diagram which illustrates an operation mode of a Deepsea Crane according to the present invention.

FIG. 3 is a diagram which shows the underwater precipitation and levitation of the sperm whale.

FIG. 4 is a diagram which shows an overall operational form of the Seafloor Station of the present invention.

FIG. 5 is a diagram which shows the situation of seafloor resources and photographs.

FIG. 6 is a diagram which shows an example of a configuration of the Seafloor Station of the present invention.

FIG. 7 is a diagram which shows the operation of the Deepsea Crane and the Seafloor Station according to the present invention.

FIG. 8 is a diagram which illustrates an external structure of the Deepsea Crane of the present invention.

FIG. 9 is a diagram which illustrates an internal structure of the Deepsea Crane of the present invention.

FIG. 10 illustrates the structure of a liquid tank of the Deepsea Crane of the present invention.

FIG. 11 is another diagram showing the structure of a liquid tank of the Deepsea Crane of the present invention.

FIG. 12 illustrates the structure of an organic hydride reactor of the Deepsea Crane of the present invention.

FIG. 13 is a piping system diagram of the Deepsea Crane of the present invention.

FIG. 14 illustrates a structure of the Seafloor Station of the present invention.

FIG. 15 is a diagram showing an operational sequence of the movement of the Seafloor Station of the present invention.

FIG. 16 is a diagram which shows the state of a Crane Engine during a moving operation sequence of the Seafloor Station of the present invention.

FIG. 17 is a diagram which shows a piping system of the Seafloor Station of the present invention.

FIG. 18 is a diagram which shows a piping system in connection with the Deepsea Crane and the Seafloor Station of the present invention.

FIG. 19 is a diagram which shows a concept of a surface mothership of the present invention.

FIG. 20 is a diagram which shows the characteristics of the lifting control of the present invention.

FIG. 21 is a diagram which illustrates a block diagram of the lifting control system of the present invention.

FIG. 22 is a flowchart which shows an operation of the lifting control system of the present invention.

FIG. 23 is flowcharts which show operations of the lifting control system of the present invention.

FIG. 24 is a diagram which illustrates a propulsion device for the Deepsea Crane of the present invention.

FIG. 25 is a diagram which shows the position and velocity dynamic characteristics of the Deepsea Crane of the present invention.

FIG. 26 is a diagram which shows the dynamic characteristics of Deepsea Crane attitude of the present invention.

FIG. 27 is a diagram which shows the dynamic characteristics of Deepsea Crane attitude of the present invention.

FIG. 28 is a diagram which illustrates a control vector of a propulsion device of Deepsea Crane of the present invention.

FIG. 29 is a diagram which illustrates a block diagram of the operation control system of Deepsea Crane of the present invention.

FIG. 30 is a diagram which shows a full view of the navigation control of Deepsea Crane of the present invention.

FIG. 31 is a diagram which shows the acoustic propagation characteristics of the sea.

FIG. 32 is a diagram which shows the overall control system configuration of Deepsea Crane of the present invention.

FIG. 33 is a flowchart which shows an operation of a navigation control system of Deepsea Crane of the present invention.

FIG. 34 is a flowchart which shows an operation of an inertial navigation system of Deepsea Crane of the present invention.

FIG. 35 is a diagram which illustrates the principle and implementation method of acoustic ranging from Deepsea Crane of the present invention.

FIG. 36 is a diagram which illustrates the principle and operation of acoustic ranging from Deepsea Crane of the present invention.

FIG. 37 is a flowchart which shows an operation of an acoustic navigation system of Deepsea Crane of the present invention.

FIG. 38 is a diagram shows the principle of acoustic ranging from Deepsea Crane of the present invention.

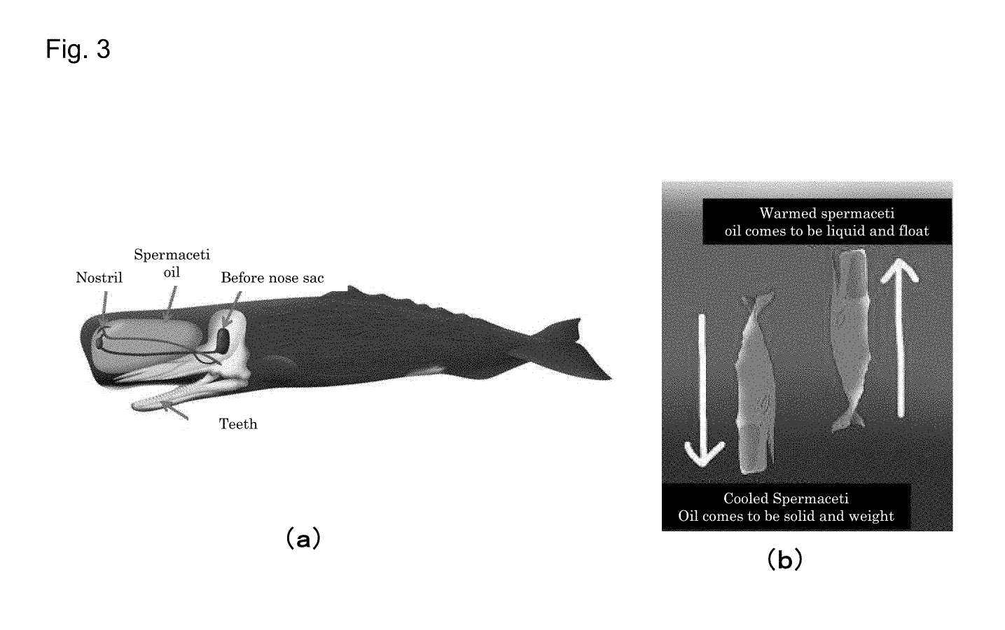

FIG. 3D is a diagram which shows the principle of optical ranging from Deepsea Crane of the present invention.

FIG. 40 is another diagram which shows the principle of optical ranging from Deepsea Crane of the present invention.

FIG. 41 is a flowchart which shows an operation of an optical navigation system of Deepsea Crane of the present invention.

FIG. 42 is a diagram which illustrates an identification scheme of a light emitting device of Deepsea Crane of the present invention.

FIG. 43 is a diagram which shows a structure of a docking device of the Deepsea Crane of the present invention.

FIG. 44 is a diagram which shows an operation of a gripping mechanism of a docking device of Deepsea Crane of the present invention.

FIG. 45 is a diagram which illustrates a structure of a gripping mechanism of a docking device of the Deepsea Crane of the present invention.

FIG. 46 is a flowchart which shows an operation of a docking navigation system of the Deepsea Crane of the present invention.

FIG. 47 is a diagram which shows the principle of the control values of a docking navigation system of the Deepsea Crane of the present invention.

FIG. 48 is a flowchart showing an operation of operation mode control of Deepsea Crane of the present invention.

FIG. 49 is a diagram which illustrates piping connection and operation at the time of levitation of the Deepsea Crane of the present invention.

FIG. 50 is a diagram which shows a piping connection and operation at the end of floating and hydrogen gas purge of the Deepsea Crane of the present invention.

FIG. 51 is a diagram which shows a piping connection and operation at the end of floating and MCH unloading of the Deepsea Crane of the present invention.

FIG. 52 is a diagram which illustrates a piping connection and operation during a downward preparation (toluene filling) of the Deepsea Crane of the present invention.

FIG. 53 is a diagram which illustrates a pipe connection and operation during a downward preparation (pure water filling) of the Deepsea Crane of the present invention.

FIG. 54 is a diagram which shows a pipe connection and operation during the descent of the Deepsea Crane of the present invention.

FIG. 55 is a diagram which shows a pipe connection and operation during replacement and transfer of a cargo-unit of the Deepsea Crane of the present invention.

FIG. 56 is a diagram which shows a pipe connection and operation during a descending process (Hydrogen gas filling, pure water transfer) of the Deepsea Crane of the present invention.

FIG. 57 is a diagram which shows a pipe connection and operation during a descending process (completion of hydrogen gas fill up and clear water transfer) of the Deepsea Crane of the present invention.

FIG. 58 is a diagram which shows a pipe connection and operation during a floating preparation (Adjustment of buoyancy injecting seawater) of the Deepsea Crane of the present invention.

FIG. 59 is a diagram which shows an attitude control propulsion mechanism of the Seafloor Station of the present invention.

FIG. 60 is a diagram which shows the dynamic characteristics of the attitude of the Seafloor Station of the present invention.

FIG. 61 is a diagram which shows the position and velocity dynamic characteristics of the Seafloor Station of the present invention.

FIG. 62 is a diagram which shows a control vector of a propulsion device of the Seafloor Station of the present invention.

FIG. 63 is a diagram which shows a full view of navigation control of the Seafloor Station of the present invention.

FIG. 64 is a diagram which shows the overall control system configuration of the Seafloor Station of the present invention.

FIG. 65 is a flowchart which shows an operation of a navigation control system of a submarine support device of the present invention.

FIG. 66 is a diagram which illustrates a block diagram of a control system of the Seafloor Station of the present invention.

FIG. 67 is a diagram which shows the characteristics of the buoyancy control at the time of descent of the Seafloor Station of the present invention.

FIG. 68 is a diagram which illustrates the principle and implementation method of acoustic navigation of the Seafloor Station of the present invention.

FIG. 69 is a flowchart which shows an operation of an inertial navigation system of the Seafloor Station of the present invention.

FIG. 70 is a flowchart which shows operation mode control of the Seafloor Station of the present invention.

FIG. 71 is a diagram which shows a pipe connection and operation during lift up of the Seafloor Station of the present invention.

FIG. 72 is a diagram which shows a pipe connection and operation of MCH unloading at the end of flotation of the Seafloor Station of the present invention.

FIG. 73 is a diagram which shows a pipe connection and operation of the Seafloor Station (toluene filling) of the present invention.

FIG. 74 is a diagram which shows a pipe connection and operation of the Seafloor Station (pure water filling) of the present invention.

FIG. 75 is a diagram which illustrates a pipe connection and operation during the descent of the Seafloor Station of the present invention.

FIG. 76 is a diagram which illustrates a pipe connection and operation of the Seafloor Station of the present invention.

FIG. 77 is a diagram which shows a pipe connection and operation of a buoyancy reduction process (hydrogen gas absorption) of the Seafloor Station of the present invention.

FIG. 78 is a diagram which shows a pipe connection and operation during a flotation preparation (increasing buoyancy) of the Seafloor Station of the present invention.

FIG. 79 is a diagram which illustrates a structure of a hydrogen generator of the Seafloor Station of the present invention.

FIG. 80 is a diagram which shows a structure of a water electrolysis laminated unit of a hydrogen generator of the Seafloor Station of the present invention.

FIG. 81 is a diagram which shows sea conditions in the area of a seafloor resources lifting and recovery equipment of the present invention.

FIG. 82 is a diagram which illustrates the structure of a solar cell strip of a seafloor resources lifting and recovery equipment of the present invention.

FIG. 83 is a diagram which illustrates a method of deploying and pulling out solar cell strips of seafloor resources lifting and recovery equipment of the present invention.

FIG. 84 is a diagram which illustrates a structure of a self-propelled solar cell deployment device of a solar cell strip of seafloor resources lifting and recovery equipment of the present invention.

FIG. 85 is a diagram which illustrates a structure of a self-propelled solar cell deployment device of a solar cell strip of seafloor resources lifting and recovery equipment of the present invention.

FIG. 86 is a diagram which illustrates the structure of a solar cell strip traction plate of seafloor resources lifting and recovery equipment of the present invention.

FIG. 87 is a diagram which illustrates a deployment control system of a self-propelled solar cell deployment device of seafloor resources lifting and recovery equipment of the present invention.

FIG. 88 is a flowchart which illustrates an operation of a self-propelled solar cell expansion device of a solar cell strip of seafloor resources lifting and recovery equipment of the present invention.

FIG. 89 is a flowchart which illustrates an operation of a self-propelled solar cell expansion device of seafloor resources lifting and recovery equipment of the present invention.

FIG. 90 is a diagram which shows a supervisory monitoring and control system configuration of seafloor resources lifting and recovery equipment of the present invention.

FIG. 91 is a diagram which shows a configuration of a power supply system of a seafloor resources lifting and recovery equipment of the present invention.

FIG. 92 is a diagram which shows a continuous operation with a position change at the same depth of a seafloor resources lifting and recovery equipment of the present invention.

FIG. 93 is a diagram which shows a continuous operation with a position change to a shallower depth of a seafloor resources lifting and recovery equipment of the present invention.

FIG. 94 is a diagram which shows a continuous operation with a position change to a more in-depth of seafloor resources lifting and recovery equipment of the present invention.

FIG. 95 is a diagram which shows parallel operation by a plurality of the Deepsea Cranes of seafloor resources lifting and recovery equipment of the present invention.

### DETAILED DESCRIPTION OF THE INVENTION

III System Configuration

After this, a description to implement the present invention will be given in detail referring the drawings. The present invention should not limit to the following description, and it is possible to perform various modifications in a range not departing from the gist.

1. Design Philosophy

Both the Deepsea Crane 001 and the Seafloor Station 018, which are the present invention, control buoyancy by hydrogen gas as the base technology.

The technology to control buoyancy by manipulating hydrogen gas and toluene, MCH, pure water, and seawater is common to the both. The Deepsea crane 001 is the combination of the Crane Engine 005 and the Cargo-unit 007. And the Seafloor Station is the combination of the four sets of the Crane Engines (in the case of the embodiment), the Seafloor Station platform 027, and the Hydrogen gas generator 024. Thus it can be possible to reduce the design and manufacturing cost by standardizing the Crane Engine 005.

In realizing the method to employ the homogenized hardware as much as possible, and to achieve functions by software.

As already discussed in the Feasibility studies, the present invention has become feasible for the first time by applying new technologies developed in fields other than submarine resource development. Individually, these are;

Large diameter carbon resin structure commercialized in the aircraft field;

Organic hydride technology used in the hydrogen fuel cycle;

Electrolysis equipment which has come to be compact and light weighted for fuel cell automobile (fuel cell and water electrolysis using the same technology);

The flexible organic photovoltaic cell in the solar cell;

Distributed micro-inverter, a docking control in the space engineering;

Robust precision control technique for the static process system.

2. Deepsea Crane

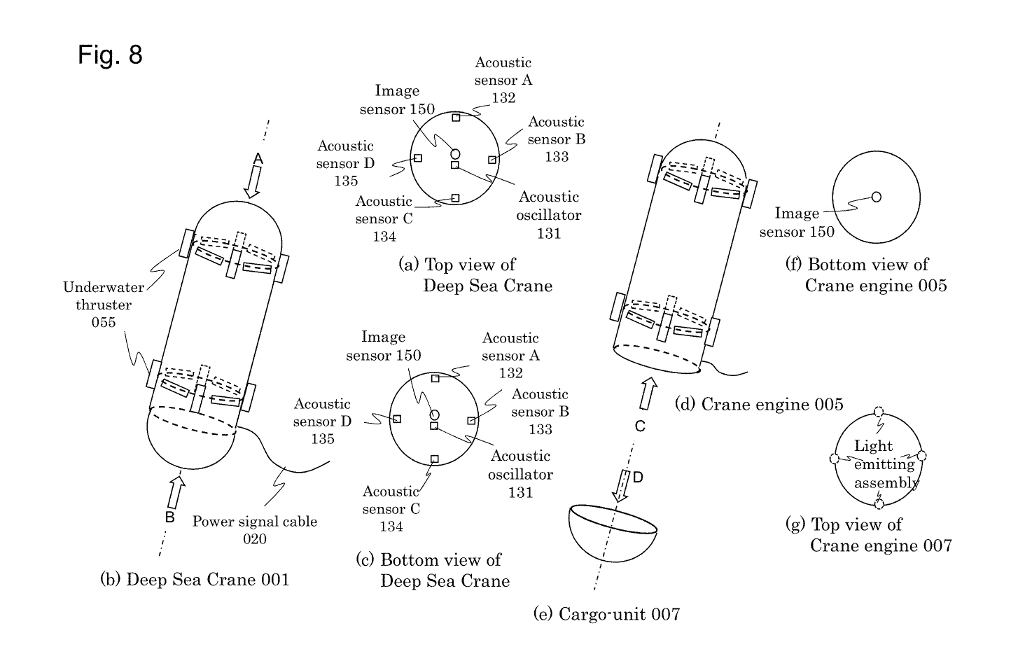

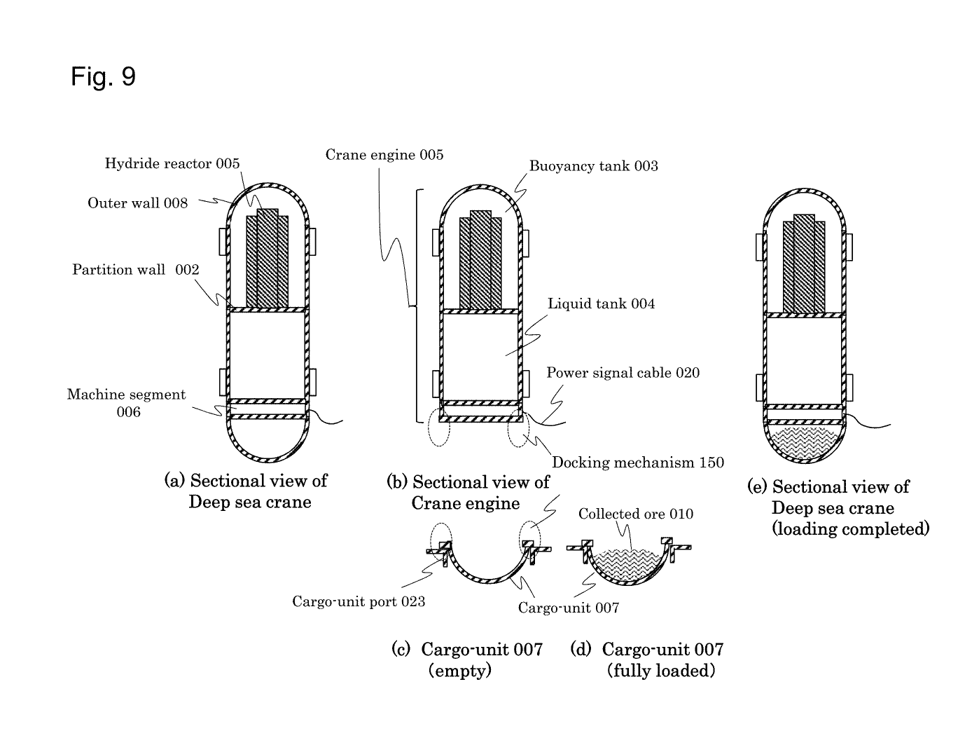

FIG. 8 shows an external structure diagram of the Deepsea Crane 001, and, FIG. 9 shows an internal structure diagram of the Deepsea Crane 001. The shape is composed of a rotating surface including a sphere and a cylinder and is constructed to have high strength, low resistance, and excellent controllability. It is not necessary to withstand the pressure because the internal pressure and the external pressure are almost equal regardless of the sea depth. This invention designs the outer wall 008 and the partition wall 002 with lightweight and carbon fiber resin with strength. The underwater lifting apparatus 001 comprises of four blocks of buoyancy tank 003, liquid tank 004, equipment room 006, and resource recovery unit 007. A hydrogen gas absorption reactor 005 is provided in the center portion of the buoyancy tank 003. The Cargo-unit 007 is detachable, and the docking mechanism 150 by the ratchet mechanism can be attached to and detached from the Crane Engine 005 consisting of a buoyancy tank 003, a liquid tank 004, and the Machine segment 006.

In the Deepsea Crane 001 in FIG. 8 (b), an Acoustic oscillator 131, Acoustic sensors A to D 132 to 135, and an image sensor 150 are installed in the upper surface of the Deepsea Crane 001 to guide it to the Surface mother ship 016 at the time of floating up. Also, in the Deepsea Crane 001 in FIG. 8(b), the Acoustic oscillator 131 and the Acoustic sensors A to D 132 to 135 and the image sensor 150 are installed in the lower surface of the Deepsea Crane 001 to guide to the Seafloor Station 018 at the time of descent.

In FIG. 8 (b) the Deepsea Crane 001 can divide into the Crane Engine 005 and the Cargo-unit 007 shown in FIG. 8 (e) for loading the collected ore 010. In FIG. 8 (d) to guide and control the Crane Engine independently, there is the image sensor 150 installed as shown in the lower side view of the Crane Engine 005, which is viewed from the direction C in FIG. 8 (d). In FIG. 8 (e) the Cargo-unit 007, which is a docking partner of the Crane Engine 005, installs four light emitting assemblies as shown in the upper view of the Cargo-unit 007 viewed from the direction D (FIG. 8(d)). The section “3. Navigation Control” describes these operational methods and examples.

FIG. 8 (b) shows an underwater thruster 055 of an electric propeller drive arranged in an axial symmetry above and below the Deepsea Crane 001. (In the case of the embodiment, each of the upper and lower are eight ones, the upper and lower portions in parallel to the AB axis are four ones, and the upper and lower parts in orthogonal to the AB axis are four ones.)

The rotational speed of the drive motor controls the strength and direction of the water flow for horizontal and vertical movement and attitude control. In FIG. 8 (b) the Deepsea Crane 001 has a specific gravity of 1.0, and the moving speed is less than 1 m/sec. Therefore, it becomes a static type control system such as a space probe. The “1. Buoyancy control, Attitude control” describes these operational methods and examples in detail.

The Power signal cable 020 penetrates into the Machine segment 006 in a sectional view of the Deepsea Crane in FIG. 9(b). In the Machine segment 006, the control equipment of a piping system pumps, valves, and propulsion thrusters 055, a heater of the hydride reactor 005 including the Deepsea Crane control system 430 are installed, and the Surface mother ship 016 supplies its control signals and power sources. The optical fiber and high pressure alternating current transmission are useful for weight reduction. Since the Machine segment 006 needs to be the same as the sea pressure, the motors, pumps, and valves must be entirely oil immersion or water immersion, and the electronic circuit also ensures the withstand pressure using a method including resin encapsulation.

FIG. 9 (a)-(e) show the internal structure and operation to transport the collected ore 010. The Deepsea Crane 001 can separate the Cargo-unit 007 as shown in FIG. 9 (b), (c). In the state in FIG. 9(a), when docking is carried out to the Cargo-unit port 023 of the Seafloor Station 018, the connection of the Cargo-unit 007 and the Crane Engine 005 is disengaged, and the Cargo-unit 007 and the Cargo-unit port 023 are connected (FIG. 9 (b) (c)). The Crane Engine 005 rises again and moves to another Cargo-unit port. The Cargo-unit 007 at the Cargo-unit port 023 of the destination is capable of stacking the collected ore 010 as shown in FIG. 9(d). When the Crane Engine 005 docks again in this state, the connection between the Cargo-unit 007 and the Cargo-unit port 023 disconnects, and the Cargo-unit 007 and the Crane Engine 005 connect each other to form a state in FIG. 9(e). This mechanism is the latter priority type docking device of the present invention, and the “V3 Docking Control” describes a detailed embodiment. In the state of FIG. 9(e), the buoyancy tank 003 can fill with hydrogen, and the Deepsea Crane can float.

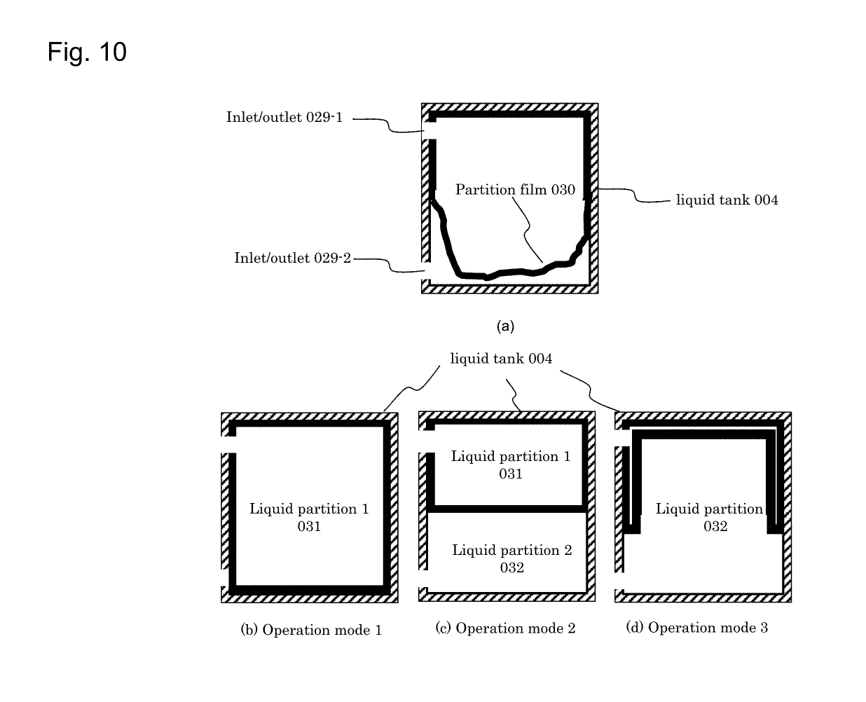

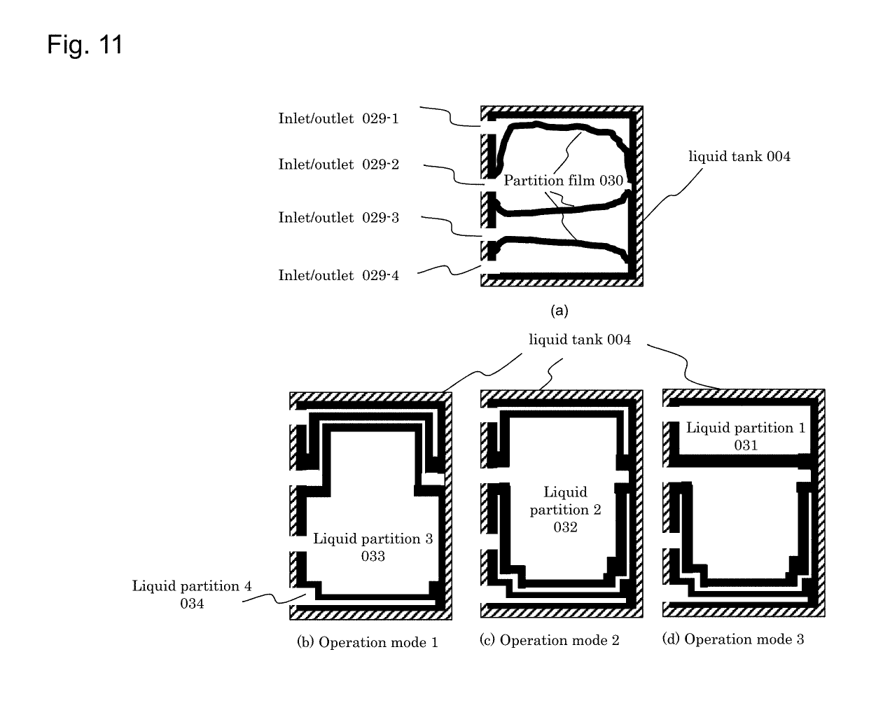

The Deepsea Crane 001 and the Seafloor Station 018 of the present invention control the distribution of hydrogen gas, toluene, MCH (methylcyclohexane), pure water and seawater in the Crane Engine 005 to float up and to descend. FIG. 10 and FIG. 11 show examples of the configuration of the liquid tank 004 for that purpose.

As the value of the specific gravity is in the order of “hydrogen gas<MCH<toluene<pure water” the liquid compartment and gas-liquid compartment of FIG. 10 and FIG. 11 fill with liquids and gases separated by Partition films to close the specific gravity to 1.0 and to stabilize the attitude of the Deepsea Crane 001 and to stabilize the boundary surface between different liquid and gas. MCH or toluene does not mix with pure water or seawater, but MCH and toluene, clean water and seawater are readily mixed. Hydrogen gas does not compound with MCH, clean water, or saltwater, but the compound with toluene at around 200° C.

The Partition film 030 in liquid tank 004 is essential to prevent mixing of toluene and MCH, pure water and seawater, and it is desirable to avoid direct contact with hydrogen gas and toluene.

The Partition film 030 may not be essential between other liquids or gases, but it is preferable to introduce the Partition film not to mix when the residual amount is low. The Partition film is preferably insoluble in toluene. For example, a fluorine-resin film that constitutes a partition in the upper or lower portion of the liquid tank 030 in the two-compartment configuration of FIG. 10.

And a closed space is formed so as not to adhere half of it along the wall, and each closed area has at least one inlet/outlet 029.

FIG. 11 is a four-segment type provided with inlet/outlet 029-1 to 4 and is employed in a Crane Engine 005 of the present invention.

The buoyancy tank 003 is provided with a hydride reactor 009 in the central portion without the Partition film 030. It operates with hydrogen gas and one type of liquid, and do not require the Partition film 030.

The description how to use the buoyancy tank 003 and the liquid tank 004 is as follows.

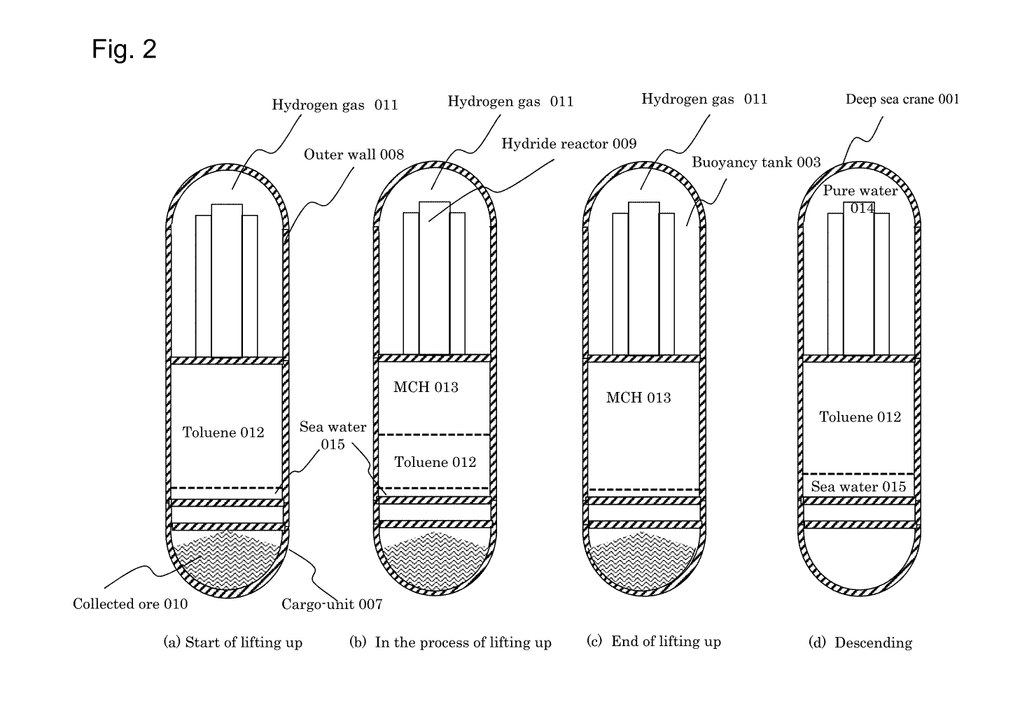

FIG. 2(a) shows the state when the Deepsea Crane 001 loads the collected ore 010 in the Cargo-unit 007 and starts lifting toward the Surface mother ship 016 from the Seafloor Station 018. The buoyancy tank 003 fills with hydrogen gas 011. The pressure of inside and outside of the wall 008 is equal, as it is 500 atm (atmospheric pressure) if the sea bottom is 5000 m. The buoyancy of the hydrogen gas 011 in the buoyancy tank 003 balances the weight of the collected ore 010 in the Cargo-unit 007 and the overall gravity of the Deepsea Crane 001 becomes slightly smaller than 1.0 to start floating

FIG. 2(b) shows a state in which the Deepsea Crane 001 is lifting up toward the Surface mother ship 016. As shown in “IV Principle of Lift up 1 Hydride reaction”, the water pressure outside the buoyancy tank 003 decreases as floats up. To keep the pressure by the hydrogen gas 011 of the buoyancy tank 003 constant, according to control scheme “IV 1.2 Response to water pressure changes” the hydrogen gas 011 is absorbed to toluene by the hydride reactor 009 and generates MCH 013.

FIG. 2(c) is a state when the Deepsea Crane 001 arrives at the Surface mother ship 016. The hydrogen gas 011 in the buoyancy tank 003 is absorbed by the toluene 012 except for 1 atm and becomes MCH. FIG. 2 (c) shows the seafloor resources raised, and the Surface mother ship 016 recovers the collected ore 010 in the Cargo-unit 007 and the MCH as a hydrogen gas source and transports to the destination along with the raised resources.

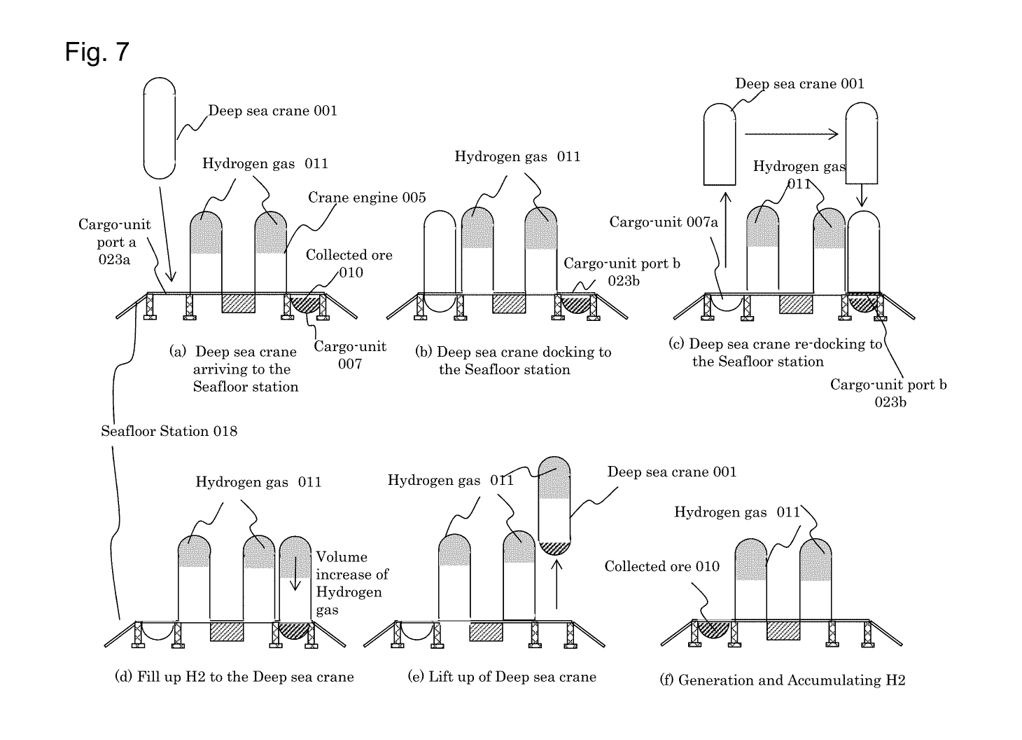

The Deepsea Crane 001, which transferred the collected ore 010 and the MCH to the Surface mother ship 016, is descended to the seafloor in FIG. 2 (d). The Cargo-unit 007 is empty, and the sea water enters and exits the Cargo-unit 007 freely, so the internal gravity of the Cargo-unit 007 becomes the specific gravity of the seawater. In the state shown in FIG. 2 (d), the specific gravity of the Deepsea Crane 001 is set to be slightly larger than 1.0; the Deepsea Crane fills with the liquid so that its specific gravity is same even when the ambient water pressure increases accompanying the descent. The buoyancy tank 003 with toluene mounted on the Surface mother ship 016. The pure water 014 is filled partially to adjust the overall buoyancy. Toluene and pure water do not mix, and the specific gravity of toluene is small, so pure water lowers. The liquid tank 004 fills with pure water 014 and seawater 015. Since a flexible Partition film 030 partitions the liquid tank 004 as described in FIG. 10 and FIG. 7, pure water 014 and saltwater 015 can mix. Pure water 014 is brought into the Seafloor Station 018 for hydrogen gas generation by electrolysis from the Surface mother ship 016.

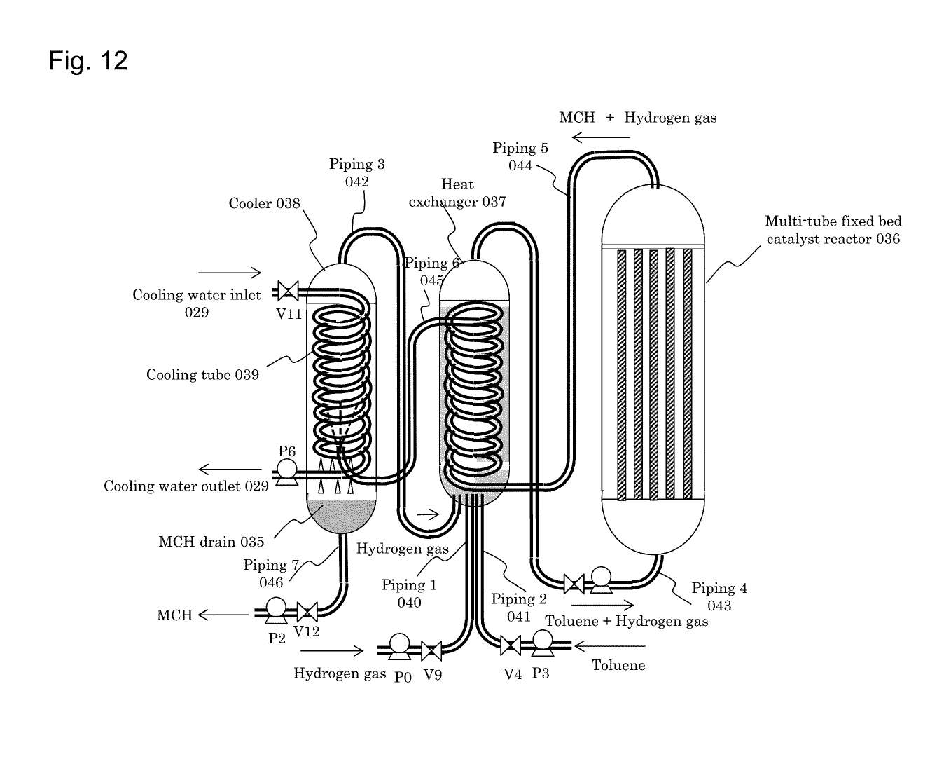

The hydride reactor 009 is a well-known technique, as OTHER PUBLICATIONS 6 shows the example of its configuration and FIG. 12 shows it. The novelty of the present invention is to absorb the gaseous hydrogen into toluene and use it for buoyancy control. The hydride reaction of toluene operates at around 200° C. Since the mixture of MCH and the hydrogen gas discharged from the multi-tube fixed bed catalyst reactor 035 is about 200° C., it is guided to the heat exchanger 036 via the pipe 5 044, and the toluene and hydrogen gas guided into the multi-tube fixed bed catalyst reactor 036 where the pipe 4 043 heats them. Toluene injected into the heat exchanger from pipe 2 041 is the liquid phase in the high-pressure environment. The thermally exchanged MCH and the unreacted hydrogen gas are guided to the cooler 038 via the pipe 6 045 through the piping 6 045, and the MCH is liquefied as a drain 035 to the bottom portion and transferred to the liquid tank 004. The unreacted hydrogen gas is injected into the heat exchanger 036 together with the high-pressure hydrogen gas in the buoyancy tank 003 via pipe 3 042 via pipe 3 042 and fed into a multi-tube fixed bed catalyst reactor 035.

The Machine segment 006 of the Deepsea Crane 001 contains; valves and pumps and connection pipes, power supply and devices to control the movement of liquid and gas; in the buoyancy tank 003, the liquid tank 004, the hydride reactor 005;

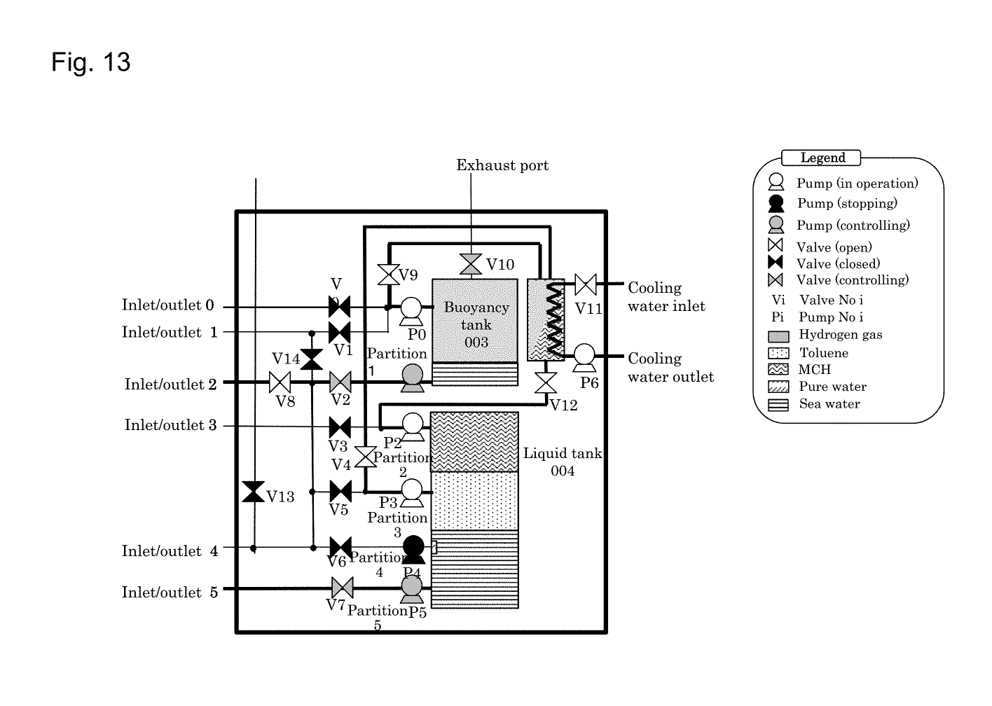

to/from the Seafloor Station 018 or the Surface mother ship 016 outside the Deepsea Crane 001. FIG. 13 is a diagram showing a piping system that controls valve 0 to valve 13 (V0 to V 13) and pumps 01 to 06 (P0-6) to move liquid and gas. FIG. 13 shows a floating state. For more details, the “V5 fluid configuration control” describes the operation of; the valve 0 to 13 (V0 to V 13); the pump 0 to 6 (P0-6); the fluid composition of the liquid tank 004; the transfer of gas and liquid between the Seafloor Station 018 and the Surface mother ship 016.

3. Seafloor Station

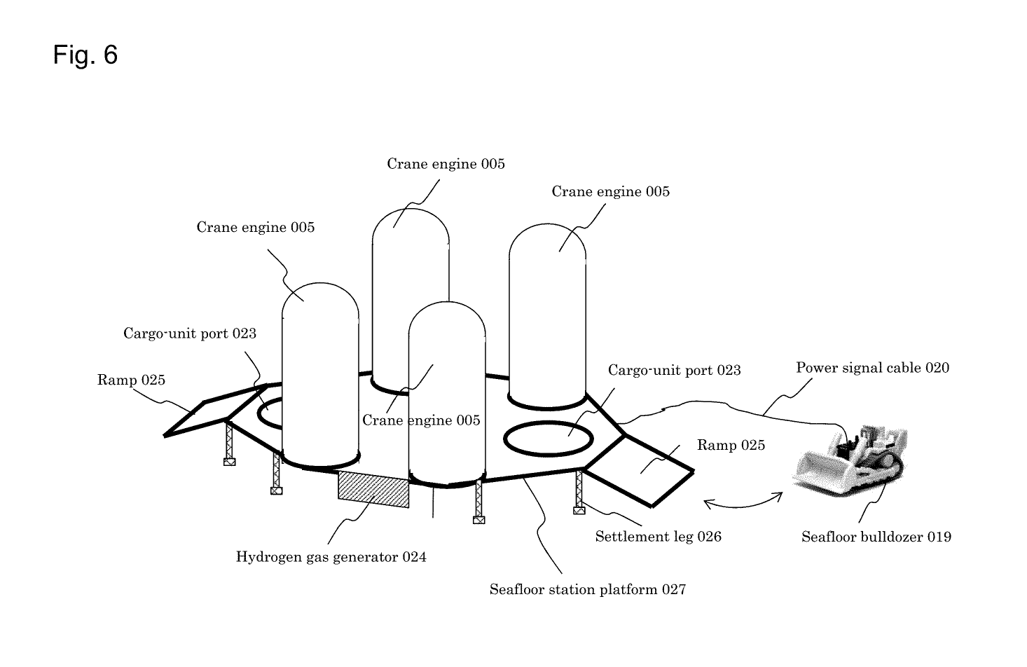

FIG. 6 shows the outer shape of the Seafloor Station 018. The role of the Seafloor Station 018 collects the submarine minerals from the Seafloor bulldozer 019 and inputs the collected ore 010 to the Cargo-unit 007 installed on the Cargo-unit port 023 via the ramp 025. In the case of FIG. 6, the Seafloor Station 018 has a base structure called the Seafloor Station platform 027 and has ramps 025 and two Cargo-unit ports 023 in the case of the example shown in FIG. 6. There is a plurality of Settlement legs 026 installed for Seafloor Station platform 027.

The Crane Engine 005 installed in the Seafloor Station 018 excludes the Cargo-unit 007 from the Deepsea Crane 001. The reason the Seafloor Station 018 uses the same structure of the Cargo-unit 007 is first to accumulate hydrogen gas generated by the hydrogen gas generator 024 in the buoyancy tank 003 and to supply the hydrogen gas to the Deepsea Crane 001.

Second, the liquid tank 004 accumulates and supplies toluene to lift up the Deepsea Crane 001. Third, The Crane Engine 005 can lift up the Cargo-unit 007 with the collected ore 010. Therefore within the range of this buoyancy, it is possible for the Seafloor Station to float the hydrogen gas generator 024, the Cargo-unit port 023, the ramp 025, the settlement legs 026, and the seafloor bulldozer loaded on the Seafloor Station.

Also, it is possible for the Seafloor Station to change the position on the seafloor and further up to the sea surface for maintenance.

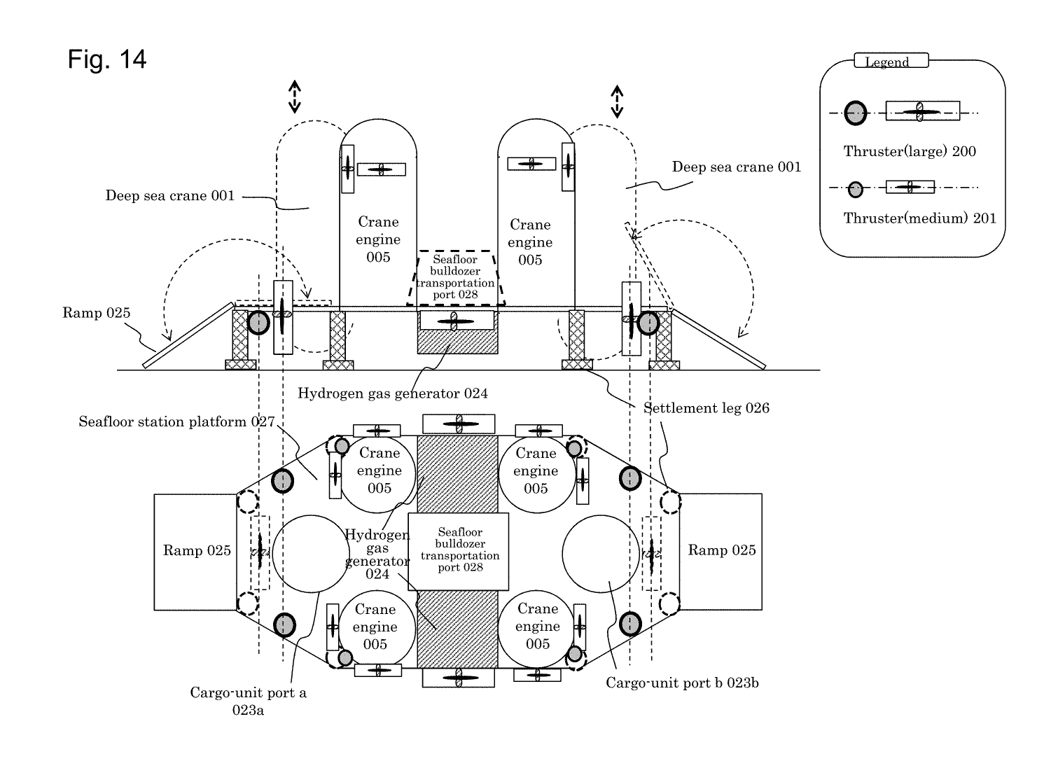

FIG. 14 shows a further detailed structure of the Seafloor Station 018. The hydrogen gas generator 024 is a water decomposition apparatus of solid polymer electrolyte membrane type with a laminated structure. The well-known fact is that the fuel cell of solid polymer electrolyte membrane type and the same type of water decomposition equipment can operate reversibly, and the output of 114 KW for automobiles is already mass-produced by 37-liter volume and 56 kg of weight as a fuel cell as of 2015. Since the electric power required in the electrolysis is 4.1 to 5.3 kWh/Nm3 (hereafter calculated as 5, 0 kWh/Nm3), the hydrogen gas to launch the four Deepsea Cranes 001 from the Seafloor Station 018 is 1000 m3 in 500 atm. The power required for this is 500×1000×5 kWh, and if it is equivalent to 114 kW fuel cell, 500×1000×5 kWh/114 kW=914×24 h, therefore 914 units can generate the required hydrogen gas. The weight is 914 times makes 51 tons. This number is sufficiently small compared to the buoyancy of 200 tons that the Crane Engine 005 generates per unit.

In FIG. 14, the Cargo-unit port 023a is a hole in which the Deepsea Crane 001 is docked to accommodate the empty Cargo-unit 007a. There are the two positions of the Cargo-unit port 023 installed in the Seafloor Station 018 in the configuration example of FIG. 6. The Deepsea Crane 001, which docks to the Cargo-unit port 023a in FIG. 7, separates the empty Cargo-unit 007a into the Cargo-unit port 023a and docks the Cargo-unit 007b that has already loaded the seafloor resources in the Cargo-unit 023b. This method applies the concept of information processing “alternating buffer,” and there is an advantage that the collection and loading of seafloor resources can be carried out only by the Seafloor bulldozer 019 without using particular loading mechanism. As the Cargo-unit 007b is loaded with seafloor resources by the Seafloor bulldozer 019, having docked to the Cargo-unit 007b the Deepsea Crane 001 is given buoyancy force by being injected hydrogen gas into its buoyancy tank 003 from the Crane Engine 005 of the Seafloor Station 018 for lift up to the sea surface.

In FIG. 6, the Seafloor bulldozer 019 is an electric bulldozer remotely controlled from the Surface mother ship 016, which is 30 to 50 tons of the same level as the above-ground equipment. The collected minerals are fed into the Cargo-unit 007 of the empty load installed in the Cargo-unit port 023 by the Seafloor bulldozer 019.

The Seafloor Station 018 has a moving function at the seafloor. It increases the hydrogen gas in the buoyancy tank 003 of the Crane Engine 005 in the Seafloor Station 018 to obtain the buoyancy and move it getting the horizontal propulsion force by the thruster (large) 200 of FIG. 14 and the thruster (medium) 201 on the Crane Engine 005. At this time, the Seafloor bulldozer 019 receives the power supply and the operation monitoring signal via the power signal cable 020 (FIG. 6), and is mounted and moved in the Seafloor bulldozer transportation port 028 of the Seafloor Station 018. At this time, as shown in FIG. 14, the ramp 025 jumps upward to prepare the underwater movement. FIG. 7 shows the operation of the Seafloor Station 018 relating the Deepsea Crane 001 and the process of the settling down, loading cargo, and lifting up to/from the seafloor, including hydrogen gas filling. FIG. 7 (a) is a phase where the Deepsea Crane 001 of the empty load arrives at the Cargo-unit port 023a. The Deepsea Crane 001 is all filled with liquid as shown in FIG. 2 (d) and is close to the specific gravity 1.0. The buoyancy tank of the Crane Engine 005 of the Seafloor Station 018 in FIG. 7(a) accumulates the hydrogen gas generated by the hydrogen gas generator. FIG. 7 (b) is a state in which the Deepsea Crane 001 is settled down and docked at the Seafloor station 018. FIG. 7 (c) shows an operation of the Cargo-unit 007a of the empty load leaving on the Cargo-unit port 023a and moving and docking the other side of the Cargo-unit port 023b. The Cargo-unit 007b in the Cargo-unit 023bA loads the collected ore 010. In the docked state, the buoyancy is insufficient to float the collected ore 010.

FIG. 7 (d) shows a state in which the hydrogen gas in the buoyancy tank 003 of the Seafloor Station 018 is transferred to the Deepsea Crane 001 to provide buoyancy. The operation at this time is described as a process to transition from FIG. 2 (d) to FIG. 2 (a). The hydrogen gas intrudes into the buoyancy tank 003 in FIG. 2 (d) from above extruding the pure water as shown in FIG. 2(d). Hydrogen gas is at low temperature (about 0° C.) and is not absorbed in pure water. The Deepsea Crane 001 floats toward the sea surface because it acquires buoyancy. FIG. 7 (f) accumulates hydrogen in the buoyancy tank 003 of the Crane Engine 005 in a state after the lift up the departure of the Deepsea Crane 001. The collected ore 010 is accumulated in the Cargo-unit 007a of the Cargo-unit port 023a to return to the state in FIG. 7(a).

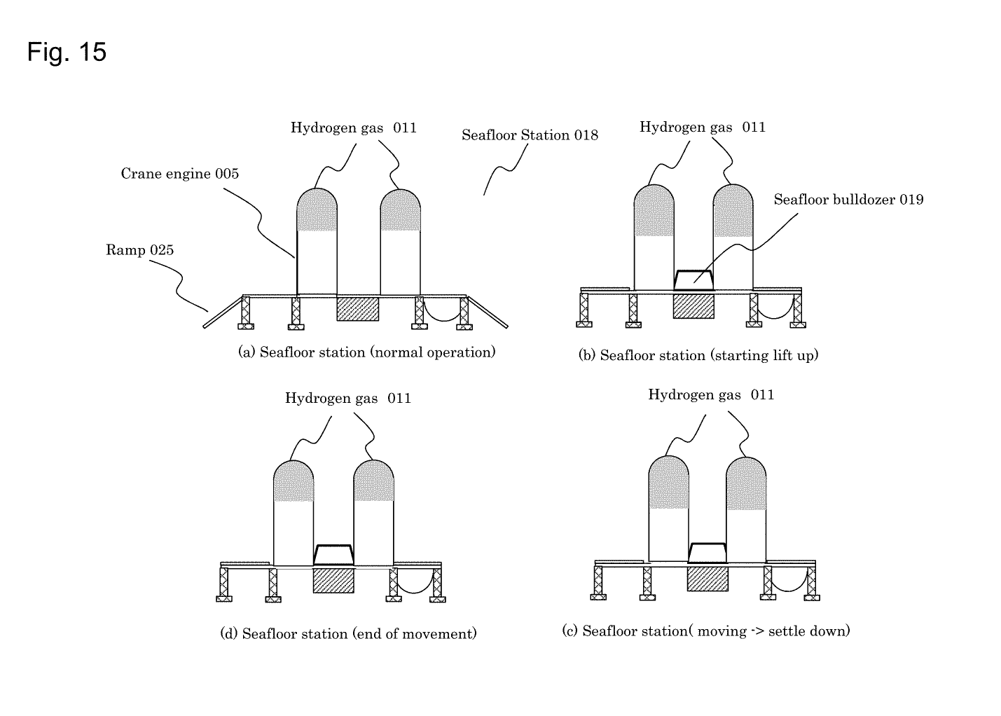

FIG. 15 shows the horizontal movement of the Seafloor Station 018 on the seafloor and the operation of floating to the sea surface. FIG. 15 (a) shows a steady process of the Seafloor Station 018. In this state, the Seafloor Station 018 needs to settle down on the seafloor, and the specific gravity needs to be higher than 1.0. In the example described above, since there are four Crane Engines 005 installed in the Seafloor Station 018, the buoyancy tank 003 of the Crane Engine 005 filled with hydrogen gas generates the total of 240×4=960 tons of buoyancy. In the example described above, it is relatively easy to reduce the water weight of the Seafloor Station 018 including the Seafloor Station platform 027 to 850 tons or less, as the Seafloor bulldozer 019 is 30 to 50 tons, and the electrolysis device is 51 tons. If this condition is satisfied, the Seafloor station 018 can detach from the seafloor, and its maintenance inspection can be carried out to the sea surface.

FIG. 15 (b) shows the state when the Seafloor Station 018 detaches from the seafloor. The Seafloor bulldozer 019 is mounted, and the hydrogen gas amount in the buoyancy tank 003 of the Crane Engine 005 increases until the specific gravity of the entire Seafloor Station 018 becomes 1.0 by operating the hydrogen gas generator 024. Then, the Thruster (large) 200 and the Thruster (medium) 201 shown in FIG. 14 work to move upward and horizontally and settling down at the destination. FIG. 15 (b) and FIG. 15 (c) are carried out by the thrust of the propulsion apparatus 055 in FIG. 8 in the state where the specific gravity is 1.0. After settling down on the seafloor, the specific gravity increases from 1.0. In FIG. 15 (d), the toluene absorbs hydrogen gas, and the volume reduces as MCH, and the buoyancy decreases to make the specific gravity more than 1.0. The state in FIG. 15 (b) is from moving to settle down. FIG. 15 (b) shows the state that the Thruster (large) 200 and the Thruster (medium) 201 gives the speed upward to be able to rise to the sea surface. “IV Principle of lifting” describes in detail the way to control the reaction of toluene as the water pressure decreases with lifting up, and it keeps the specific gravity of the Seafloor Station 018 at 1.0. Even in the Seafloor Station 018, the portion of the Crane Engine 005 is the same as that of the Deepsea Crane 001 so that the same operation as that of the Deepsea Crane 001 works. That is, in FIG. 2 (a) (b) (c), the load instead of the Cargo-unit 007 and the collected ore 010 is the Seafloor Station platform 027, a hydrogen gas generator 024, a Seafloor bulldozer 019, and the Seafloor Station platform 027. As shown in FIGS. 2 (a) (b) (c), the hydrogen gas is absorbed by the toluene as it rises to the sea surface, thereby making the MCH.

The Deepsea Crane 001 and the Seafloor Station 018, which lift up to the sea surface from the seafloor, and descend to, and the Seafloor Station 018 moves horizontally along the seafloor, keeping its specific gravity of 1.0. Since the moving speed is not more than 1 m per second, the small vertical movement in the range where the fluctuation of the horizontal move, attitude control, and hydraulic pressure are ignorable. As the control object, it is close to the static process system represented by the transfer function 1/s. The Thruster (large) 200 and the Thruster (medium) 201 shown in FIG. 14 control them.

4. Surface Ship

It is necessary to set up a base by surface ships at a sea area that is the core point to collect mineral resources on the sea floor. The function of the Surface mothership 016, which is a base, is below.

(1) From the mother port,

The surface ship carries equipment including a power generation facility including a plurality of the Deepsea Crane 001, the Seafloor Station 018, a Seafloor bulldozer 019, and a self-propelled solar cell expansion equipment 404 to the collection point. And it deploys and restores them between the sea surface and the seafloor.

(2) An unmanned underwater robot searches for a suitable place to install the Seafloor Station 018 and sets an acoustic marker to guide it.

(3) Since the measured value of ocean currents in the Pacific Ocean in the sea area where the seafloor resources exist is equal to or less than 5 knots, the self-position is kept accurately against the current up to ½ knots.

(4) According to the resource condition of the seafloor, it changes the position of the equipment, for a long distance move it once restores the submarine equipment and deploys them at a new area, for short range move the submarine equipment is moved horizontally along the seafloor.

(5) Restores equipment in the undersea and sea surface and maintains them.

(6) Supply power to the underwater and sea surface.

(7) The Deepsea Crane 001 and the Seafloor Station 018 fills with toluene and pure water to descend toward the seafloor and collects the mineral resources there and recovers MCH which absorbed hydrogen.

(8) Since the Deepsea Crane 001 frequently carries and reciprocates minerals between the sea bottom and the water vessels, the unloading of the cargo shall be operable without the influence of the sea conditions.

(9) The Surface mothership receives toluene and pure water from the carrier ship and the Surface mother ship temporarily stores on it MCH and mineral resources collected from the Deepsea Crane 001 and then transfer to the carrier ship.

(10) The system is equipped to control the operation of all equipment related to the collection of mineral resources, including carrier ships carrying collected minerals.

4.1 Surface Mothership

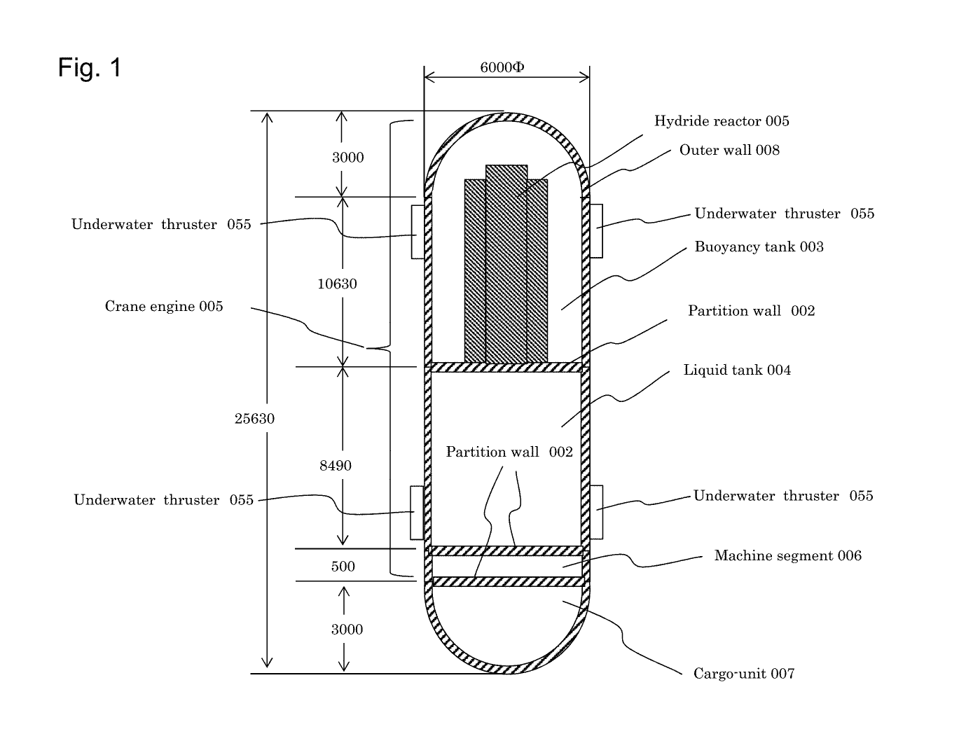

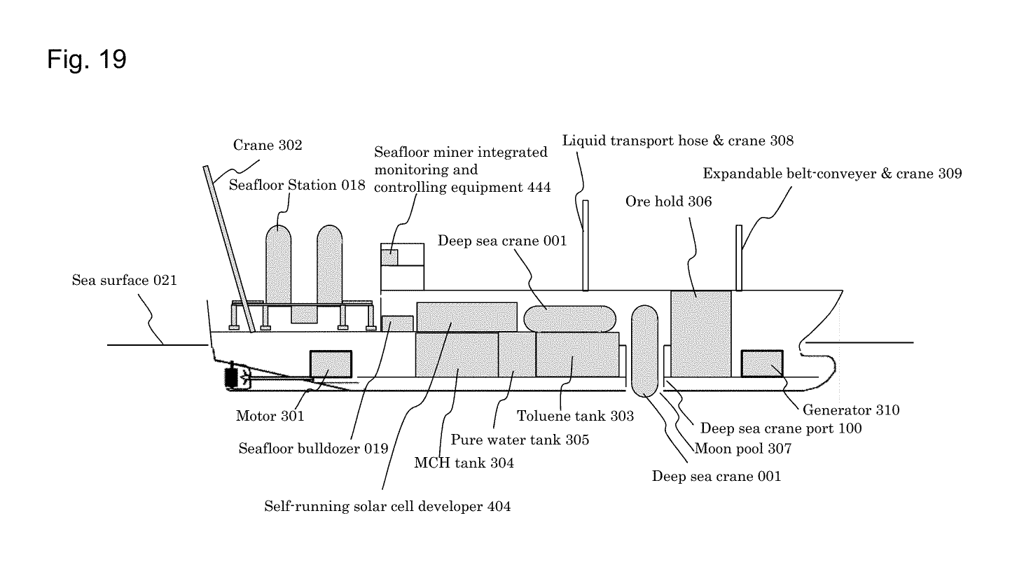

FIG. 19 shows a conceptual diagram. In this case, it estimates first a system to raise 250 tons from the bottom of the sea. In this case, the Deepsea Crane 001 becomes the scale of FIG. 1. If it is 5000 m below the seafloor, it will take a day.

When the Seafloor Station 018 operates by a time difference using four Deepsea Cranes 001, the daily yield is about 1000 tons, toluene requirement is 800 cubic meters, MCH yield is 1000 cubic meters, and water requirement is 400 tons. Because of the need for economies of scale, the ship will ship every 10th, and it will be a 15000-20000 ton class transport ship. The Seafloor Station 018 is 30 m in length, 20 m in width, 25 m in height and about 300 tons dry weight. Since the sea area in which the Surface mothership deploys has a current of 0.0 to 1.5 Knott, it is preferable to promote by electricity to maintain the position. The electric power required for the electrolysis of hydrogen gas generated in the ocean is assumed to be an onboard generator or an offshore solar cell, but it can work as a power source for electricity promotion. The solar cells in the offshore area “VIII power generator” are made up of a micro-inverter with a 10 m width, 4 km length of a ribbon-like flexible film solar cell, and mounted on the Surface mother ship 016 in a roll shape 4 m in diameter and 100 10 m in length. Since MCH and toluene are transportable at room temperature and atmospheric pressure as in petroleum, a conventional cargo ship is available, if it is transportable by hoses and transport by belt conveyors for mineral resources. For this purpose, there are a liquid transport hose and crane 208, an expansion belt conveyor and crane 209 at the Surface mother ship 016. The toluene tank 203 and the pure water tank 205 are for temporary storage for the Deepsea Crane 001 and the Seafloor Station 018, and the MCH tank 204 is temporary storage to transfer the MCH collected from the Deepsea Crane 001 to the carrier. The ore hold 206 is temporary storage of the ore 010 from the Deepsea Crane 001 to the carrier.

4.2 Carrier

MCH and toluene are transportable at room temperature and atmospheric pressure as well as oil so that a conventional cargo ship is available transporting by hoses and by a belt conveyor for mineral resources. For this purpose, there are a liquid transport hose and crane 208, an expansion belt conveyor and crane 209 provided at the command ship 016.

IV Principle of Lifting

1. Principle

1.1 Hydride Reaction

It is necessary to give the Deepsea Crane 001 buoyancy to overcome the weight of the collected ore 010 to lift it from the seafloor. Therefore, the buoyancy tank 003 fills with hydrogen gas in the high-pressure environment there. This buoyancy can leave the seabed, but as the hydrogen gas expands as lifts up, the buoyancy tank 003 breaks if it is sealed. If the expansion is allowed, the buoyancy goes up further and, it will accelerate. The excess hydrogen gas should be released into the sea to prevent this, but the cost required for electrolysis of water will be in vain. The organic hydride method can absorb hydrogen gas for recovery to avoid this, and the number of gaseous moles of hydrogen gas decreases with decreasing depth (rising). This process is a divergence system for control. The stabilization by the controller is indispensable, and furthermore, a safety device is essential to prevent the case when unintended insufficient buoyancy or excessive buoyancy occurs, and the control is not in time. As a control system, the stability increases if the rise speed is slow.

The control characteristics when the organic hydride reaction is available for buoyancy control is as follows.

Various variables are defined below, where the suffixes; T, M, H, W show materials; toluene, MCH, hydrogen, and water. (x) shows value at the depth x m from the sea surface.

| Name of Variables | Symbol | Unit |
|---|---|---|
| Water weight of the Deepsea Crane | W_{S} | [kg] |
| Water weight of the Collected ore | W_{L} | [kg] |
| Weight of Toluene | W_{T} | [kg] |
| Weight of MCH (liquid) | W_{M} | [kg] |
| Volume of H2 | V_{H} | [L] |
| Volume of Toluene (liquid) | V_{T} | [L] |
| Volume of MCH (liquid) | V_{M} | [L] |
| Volume of pure/sea water | V_{W} | [L] |
| Sea depth | X | [m] |
| Sea pressure | P(x) | [atm] |
| Density of Toluene | ρ_{T} | [g/cm³] |
| Density of MCH | ρ_{M} | [g/cm³] |
| Standard gas molar volume | m = 22.4 | [L] |

The following constants are used;

| | Molecular | Molecular | | Density | | Liquid volume (1 mol) | |
|---|---|---|---|---|---|---|---|
| Material | formula | weight | | [g/cm³] | | [cm³] | |
| Water | H₂O | μ_{W} | 18 | ρ_{W} | 1.0 | V_{W} = μ_{W}/ρ_{W} | 18 |
| Toluene | C₇H₈ | μ_{T} | 92 | ρ_{T} | 0.867 | V_{T} = μ_{T}/ρ_{T} | 127.44 |
| MCH | C₇H₁₄ | μ_{M} | 98 | ρ_{M} | 0.769 | V_{M} = μ_{M}/ρ_{M} | 106.01 |
| Hydrogen | H₂ | μ_{H} | 2 | ρ_{H} | | | |

The buoyancy by MCH is;

W_{M}(z)−V_{M}(z)×10³=μM(1/ρ_{M}−1)×(M_{H}−m_{H}(z))/3×10⁻³ [kg]

The buoyancy by toluene is;

W_{T}(z)−V_{T}(z)×10³=μ_{T}(1/ρ_{T}−1)×(M_{T}−(M_{H}−m_{H}(z))/3)×10⁻³ [kg]

Where at the time of departure from the seafloor all hydrogen is in a gas state, its amount is MH. As the Deepsea Crane floats up the hydrogen gas is absorbed to toluene, suppose the gas state hydrogen is m×(x) Mol. The toluene absorbs MH−mH(x) mol of hydrogen gas and it generates (MH−mH(x))/3 mol of MCH. Therefore the water weight F(z) of the Deepsea Crane 001 is;

$$F ( z ) = {W}_{S} + ( P ( {Z}_{B} ) \times {V}_{H} ( {Z}_{B} ) ) / m ) \times 2 \times {10}^{- 3} - {V}_{H} ( Z ) - {μ}_{T} ( 1 / {ρ}_{T} - 1 ) \times ( {M}_{T} - ( {M}_{H} - {m}_{H} ( z ) ) / 3 ) \times {10}^{- 3} - {μ}_{M} ( 1 / {ρ}_{M} - 1 ) \times ( {M}_{H} - {m}_{H} ( z ) ) / 3 \times {10}^{- 3}$$

Separating the terms depending the depth z and independent from the depth z;

$$F ( z ) = {W}_{S} + ( P ( {Z}_{B} ) \times {V}_{H} ( {Z}_{B} ) ) / m ) \times 2 \times {10}^{- 3} - {μ}_{T} ( 1 / {ρ}_{T} - 1 ) \times ( {M}_{T} - {M}_{H} / 3 ) \times {10}^{- 3} - {μ}_{M} ( 1 / {ρ}_{M} - 1 ) \times {M}_{H} / 3 \times {10}^{- 3} - {m}_{H} ( z ) \times m \times {10}^{- 2} / z - ( {μ}_{T} ( 1 / {ρ}_{T} - 1 ) - {μ}_{M} ( 1 / {ρ}_{M} - 1 ) ) \times {m}_{H} ( z ) \times {10}^{- 3}$$

One to three lines of the above formula show constant, and the fourth line means that the buoyancy increases in inverse proportion to the depth when the depth becomes shallow, and the fifth row shows the change in buoyancy in the liquid phase due to the difference in specific gravity of the toluene and MCH.

The depth z where the mole number of the hydrogen gas MH balances the buoyancy is;

F(z)=0 should be met, therefore;

z=m_{H}(z)×10m/(B−m_{H}(z)×((μ_{T}(1/ρ_{T}−1)−μ_{M}(1/ρ_{M}−1)))

Where B is the constant given by;

$$B = {W}_{S} \times {10}^{- 3} - ( P ( {Z}_{B} ) \times {V}_{H} ( {Z}_{B} ) ) / m ) \times 2 + {μ}_{T} ( 1 / {ρ}_{T} - 1 ) \times ( {M}_{T} - {M}_{H} / 3 ) + {μ}_{M} ( 1 / {ρ}_{M} - 1 ) \times {M}_{H} / 3$$

m_{H}(z) is the reduced mole number of the hydrogen gas by the hydride reaction, and when the Deepsea Crane 001 is at depth z its internal and external pressure is equal, and its buoyancy is 0.

1.2 Response to Water Pressure Changes

The ambient pressure decreases as the Deepsea Crane 001 rises from the seafloor. By synchronizing the decreasing the hydrogen gas pressure with the lowering of the ambient water pressure using hydride reaction, it is possible for the Deepsea Crane 001 to float to sea level without pressure stress. FIG. 13 is a piping system diagram of the Deepsea Crane 001 during the elevation shown in FIG. 2(b).

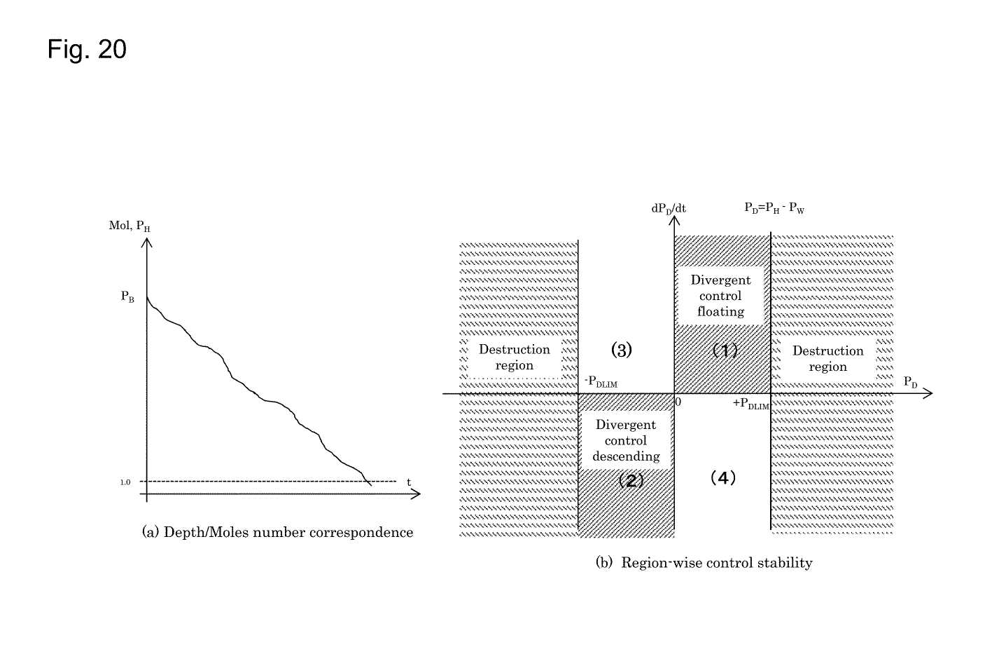

FIG. 20 (a) shows the relationship between the depth and the number of the hydrogen gas in the buoyancy tank. The buoyancy control of the present invention by “IV 1.1 Hydride reaction” is as follows;

the toluene absorbs the hydrogen gas in the buoyancy tank 003 to decrease its pressure, and

the Deepsea Crane 001 floats up keeping the specific gravity to 1.0 and keeping its internal and ambient pressure equal.

When the operating temperature of the reactor is about 200° C., the toluene absorbs almost 100% of the hydrogen gas.
If the volume of the hydrogen gas is constant, according to the Boyle Shaar law, as the internal pressure of the buoyancy tank PH is proportional to the hydrogen gas molar number (mols), the number of hydrogen gas moles (mols) which decreases linearly, as shown in FIG. 20(a), with the reactor operating time from seafloor pressure PB to 1 atm at the sea surface. The ambient water pressure PW is proportional to the sea depth z by PW (z)=z/10, except for the case when the internal pressure to the outer wall of the buoyancy tank PH is equal to the ambient water pressure PW, the outer wall breaks when it exceeds the limit. Therefore, it is necessary to float from the seafloor to the sea surface while maintaining the pressure of the buoyancy tank PH=ambient water pressure PW. If the specific gravity is 1.0 (the same as the specific gravity of seawater), the buoyancy balances with gravity, and if the propulsion device stops, there is no rise and down thrust (F=0), and it is stationary in the sea. If the pressure of the buoyancy tank (exactly same as the specific gravity of seawater) and the sea pressure (F=0) are equal, the external wall of the buoyancy tank does not get pressure. This state is called equilibrium state. If the hydride reactor stops, the equilibrium state continues. In the vicinity of the equilibrium state, it is descending at F>0, floating at F<0, and settling at F=0.

1. When the hydrogen gas volume of the buoyancy tank is kept constant by closing V2, V8, and V7,

(1) In equilibrium, when F is slightly +, the water pressure (P_{W}) increases. Since the buoyancy does not change, descending continues, the difference between the pressure (P_{W}) of the buoyancy tank and the sea pressure (P_{H}) increases, and the buoyancy tank breaks.

(2) In equilibrium, the F is slight − and the sea pressure (PW) decreases. Since the buoyancy does not change, the floating continues, and the difference between the pressure (PW) and the sea pressure (PH) of the buoyancy tank increases and the buoyancy tank breaks.

2. When V2, V8, and V7 are closed, the hydrogen gas pressure (PH) of the buoyancy tank is maintained equal to the sea pressure (PW).

(1) In equilibrium, when F is slightly +, the water pressure (PW) increases, and therefore the F is increased and, the buoyancy tank does not break, but accelerates descending.

(2) In equilibrium, when F is slight −, the water pressure (PW) decreases, resulting in a decrease in F, the buoyancy tank does not break but accelerates floating.

Since 1.(1) (2) and 2.(1) (2) are unstable systems around equilibrium points, a control system should stabilize the system and should prevent the loss of equipment in emergency situations.

1.3 Structure and Dynamics of the Lifting Control System

In the case of constructing a control system, it is essential to measure the state variables required for control with necessary accuracy. Since the equilibrium point is unstable as a control system, it is crucial to measure the state variables needed for maneuvering and their time changes. The capacity of the hydride reactor limits the lifting speed. In the design available at present as a hydride reactor, the average movement is 5.5 cm/sec, when it is collected from the seafloor of 5000 m to the sea surface in the design example. It would be 11 cm/sec even if the reaction capacity doubled. As a significant measurement, including time change, to detect a rate change of 1%, a precision requirement of 0.055 cm is required for the depth of 5000 m, and 1/10000000 accuracy is needed. Since the water pressure has a linear relationship with the depth, there is the same accuracy request for the pressure. This accuracy requirement is not feasible, and it is impossible to construct the control system using the absolute value of depth or water pressure. (if forcibly used, the control system diverges due to noise.)

Therefore, a PD which is the pressure difference between the buoyancy tank (PH) and the seawater (PW) turns to be a practical and significant measurement.

P_{D}=P_{H}−P_{W}

dP_{D}/dt=d(P_{H}−P_{W})/dt

In the case of PD, ±1 (atm) of full scale is sufficient, so it is feasible to get 1/10000 of accuracy. FIG. 20 (b) shows the stability of the control system using PD.

Here, the PDLIM is the failure limit pressure of the buoyancy tank.

P_{D}<−P_{DLIM}

P_{D}>P_{DLIM}

The above are destruction regions as shown in FIG. 20 (b) and it is needed to avoid this region.

In FIG. 20 (b), PD>0, dPD/dt>0 (Hatch Area (1)) indicates that the buoyancy tank pressure is higher than seawater and this tendency is increasing. Increasing the hydrogen gas volume to reduce the internal pressure difference in the buoyancy tank rises the buoyancy rate, increasing the ascending speed, and further increasing the internal pressure difference of the buoyancy tank, thereby increasing the divergence control. (in the case the specific gravity is kept to 1.0)

In FIG. 20 (b), PD<0, dPD/dt<0 (Hatch Area (2)) indicates that the buoyancy tank pressure is lower than seawater and this tendency decreases. When the hydrogen gas volume is reduced to reduce the internal pressure difference of the buoyancy tank, the buoyancy rate decreases and the descending speed increases, and the difference in the internal pressure of the buoyancy tank increases, and it comes to be the divergence control. (in the case the specific gravity is kept to 1.0)

In FIG. 20 (b), PD<0, dPD/dt>0 (Area (3)) indicates that the buoyancy tank pressure is lower than seawater and this tendency is decreasing. The internal pressure difference in the buoyancy tank decreases over time, and it becomes 0, which is a stable region. (in the case the specific gravity is kept to 1.0)

In FIG. 20 (b), PD>0, dPD/dt<0 (Area (4)) indicates that the buoyancy tank pressure is higher than seawater and this tendency is decreasing. The internal pressure difference in the buoyancy tank decreases over time, and it becomes 0, which is a stable region. (in the case the specific gravity is kept to 1.0) In the buoyancy control, the PD is controlled to avoid destruction (collapse) of the buoyancy tank 003.

Since the pressure of the buoyancy tank decreases with the MCH buildup, it automatically rises to the sea surface while it controls the pressure difference PD to 0 between the internal buoyancy tank and the surrounding seawater. Control is performed to reduce the internal pressure difference PD of the buoyancy tank by controlling the floating/descending speed by the Thruster device.

The characteristics of the control system are as follows.

(1) The rising speed is from 5.5 to 10 cm/sec and a minute speed from the performance constraint of hydride reactor.

(2) The Deepsea Crane 001 is very slow speed and has a small resistance and large mass. Since the specific gravity is 1.0, it can be a static process as a control system. Therefore, a permanent movement is an approximation of acceleration in the rising/descending direction by the Thruster device. (precisely speaking a long time constant dynamics)

The thruster accelerates in rising/descending direction to cancel the pressure drop of the buoyancy tank by caused by hydride reaction, then the depth of water pressure come to be equal to that of the buoyancy tank, and realizes the depth change rate. However, in the lifting process of the Deepsea Crane 001, toluene absorbs hydrogen gas and changes to MCH. The specific gravity of the entire Deepsea Crane 001 does not change, but the MCH increases because its specific gravity is lower than that of toluene. To reduce the hydrogen gas volume in the buoyancy tank 003 and to reduce the hydrogen gas volume of the buoyancy tank, water is injected into the buoyancy tank by the pump and valve control to reduce the amount of the hydrogen gas in the buoyancy tank 003.

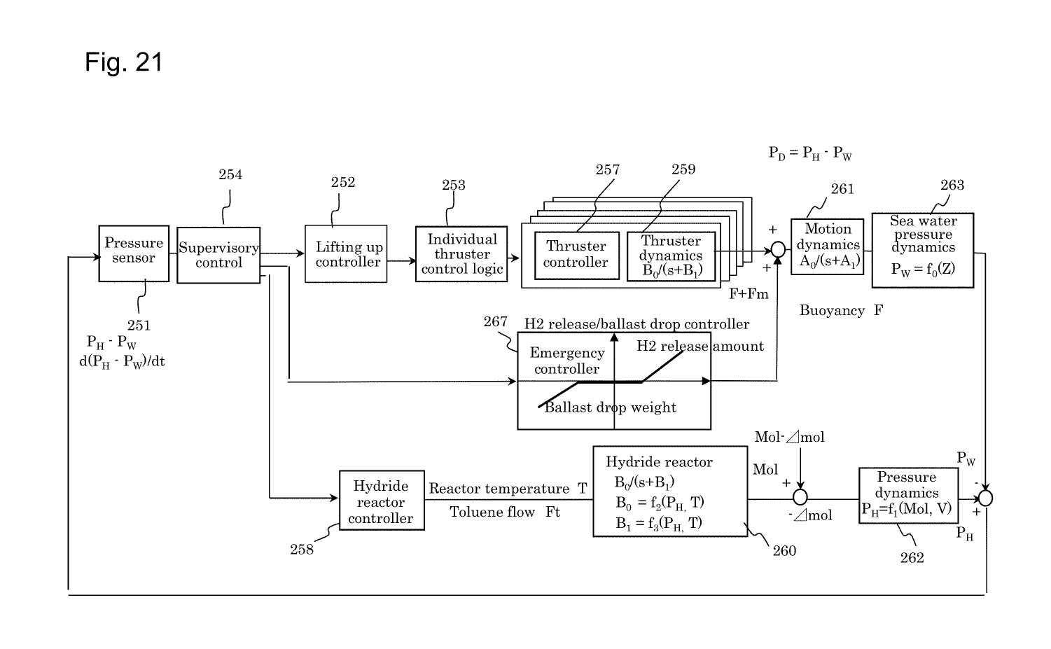

FIG. 21 shows the control algorithm described above in the block diagram. The measurement process of variables consists only of PD and dPD/dt which can be measured practically by;

P_{D}(t)=P_{H}(t)−P_{W}(t)

dP_{D}(t)/dt=d(P_{H}(t)−P_{W}(t))/dt

Although the two variables are continuous system notation for time, the control algorithm constitutes a discrete value control system as a sampled value.

In FIG. 21, the buoyancy control system comprises a hydride reactor controller 258, a Thruster controller 257, an emergency controller 267, and a control master 254 for controlling these. The hydride reactor controller 258 stationary continues the reaction which has been carried out publicly as an organic hydride reaction and controls the hydride reactor in FIG. 12. The hydrogen gas in the buoyancy tank 003 is fed into the heat exchanger 037 through the pipe 1 040. The heat exchanger 037 is supplied with toluene from the liquid tank 004 through the pipe 2 041, and the unreacted hydrogen gas recovered by the cooler 038 is fed through the pipe 3 042.

These exchange heat with the mixed gas of the high-temperature MCH and hydrogen discharged from the multi-tube fixed bed catalyst reactor 036, and they are fed into the multi-tube fixed bed catalyst reactor 036 via the piping 4 043,

and hydrogen gas is adsorbed to toluene by hydrogen gas organic hydride reaction. The organic hydride reaction of hydrogen gas is an equilibrium reaction, which is known to change to MCH under 400° C. and above ten atmospheric pressure, and the process of lifting from the deep seafloor is a preferable environment.

In each reaction tube of the multi-tube fixed bed type catalyst reactor 036 fills with Pt/Al2O3 (Φ3 mm Pellet). And the toluene and hydrogen gas fed from piping 4 043 change to the mixture of MCH and the hydrogen gas are exhausted from the piping 5 044 and led to the heat exchanger 037. They exchange heat with the mixture gas of the toluene and the hydrogen gas which flow to the multi-tube fixed bed catalyst reactor 036. The mixture of MCH and toluene flows to cooler 038, and being sprayed and cooled by cooling tube 039, then collects at the bottom of the cooler 038 as the drain, then through pipe 7 047 to the MCH compartment of liquid tank 004 FIG. 13 Partition 2). The hydride reactor 260 controls the toluene flow rate and reactor temperature in FIG. 12 to maintain a stable reaction.

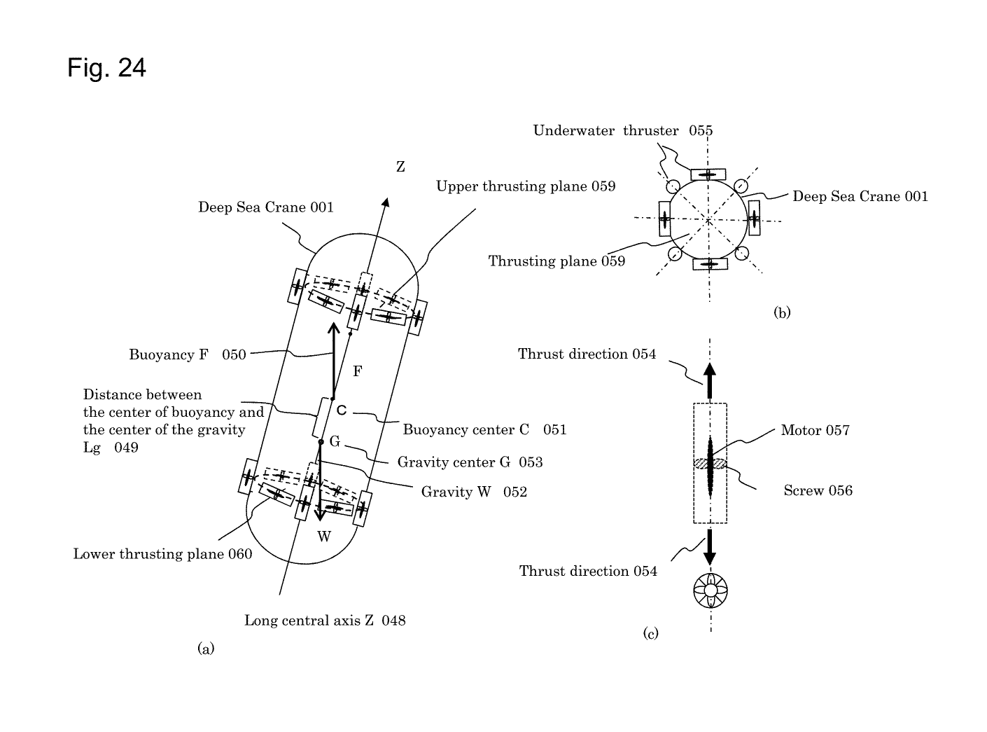

The reaction of the multi-tube fixed bed type catalyst reactor 036 is continuously performed, and as shown in FIG. 20 (a) Depth/moles number correspondence diagram, the molar number of hydrogen gas decreases with time. To maintain a constant volume corresponding to the number of moles decreasing and to maintain the pressure in the buoyancy tank 003 equal to the water pressure, the Deepsea Crane 001 is floated to make the water depth of the water pressure equal to the pressure in the buoyancy tank 003. Since the water depth change corresponding to the organic hydride reaction of the hydrogen gas is a slow speed of 5 to 10 cm/sec, the propulsion device 055 obtains the propulsion force by Thruster control system 253 and controls dPD/dt, to be PD=0. FIG. 24 (a) shows that the thruster 055 is placed at the upper and lower portions and concentrically of the Deepsea Crane 001 as shown in FIG. 24 (b). Each Thruster 055 is provided with a motor 057 driven screw 056 in a cylindrical nozzle to generate a jet stream by the rotational direction and rotational speed. The thruster dynamics 259 has the first order delay well known in the motor control, and the motion dynamics 261 is close to the static process system having a transfer function of 1/s as the Deepsea Crane is at slow speed, very low in weight and resistance to water, and the specific gravity is 1.0.

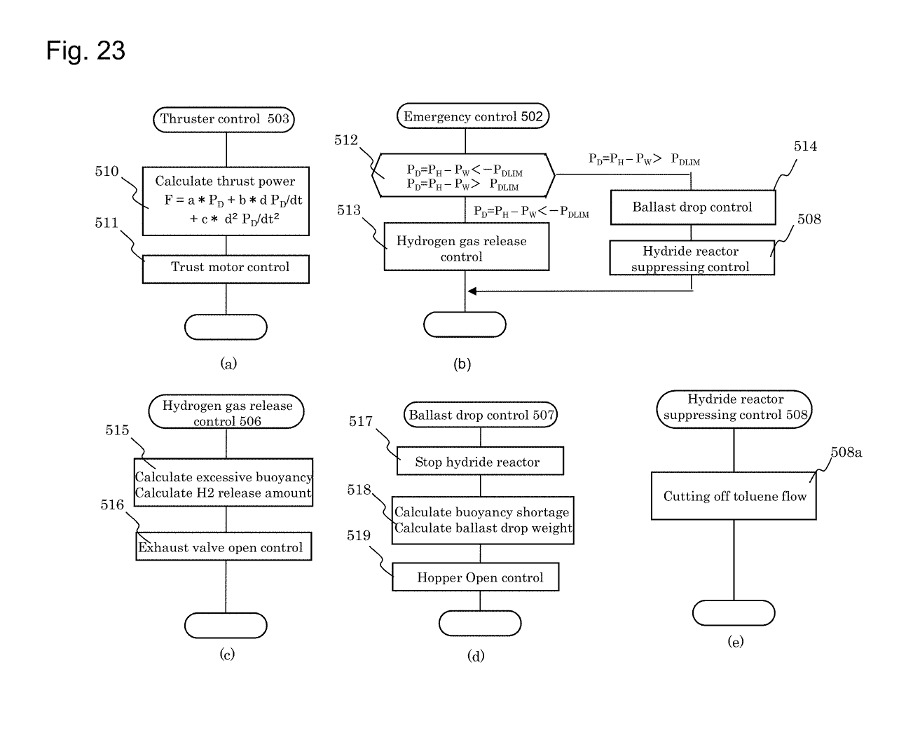

Such control is well known for attitude control in space. With the motion dynamics 261, the depth of the Deepsea Crane 001 changes, then the ambient water pressure PW is determined by the hydraulic dynamics 263. Each thruster control logic 253 controls the Thruster to eliminate the difference between the buoyancy tank pressure PH corresponding to the number of moles reduced by the hydride reactor 260. The Thruster controller 257 uses a well-known PID control system as shown in FIG. 23 (a), or for a robust control system with time-variant parameters. With the progress of the organic hydride reaction changing from toluene to MCH, as the specific gravity of the MCH is lighter than that of toluene, the hydrogen gas volume decreases slightly even though the sealed weight of the Deepsea Crane 001 does not change.

However, since the sealed weight of the Deepsea Crane 001 does not change, the specific gravity does not change, and if the Deepsea Crane 001 controls to eliminate the pressure difference between PH of the buoyancy tank and PW of the sea, it reaches the sea surface.

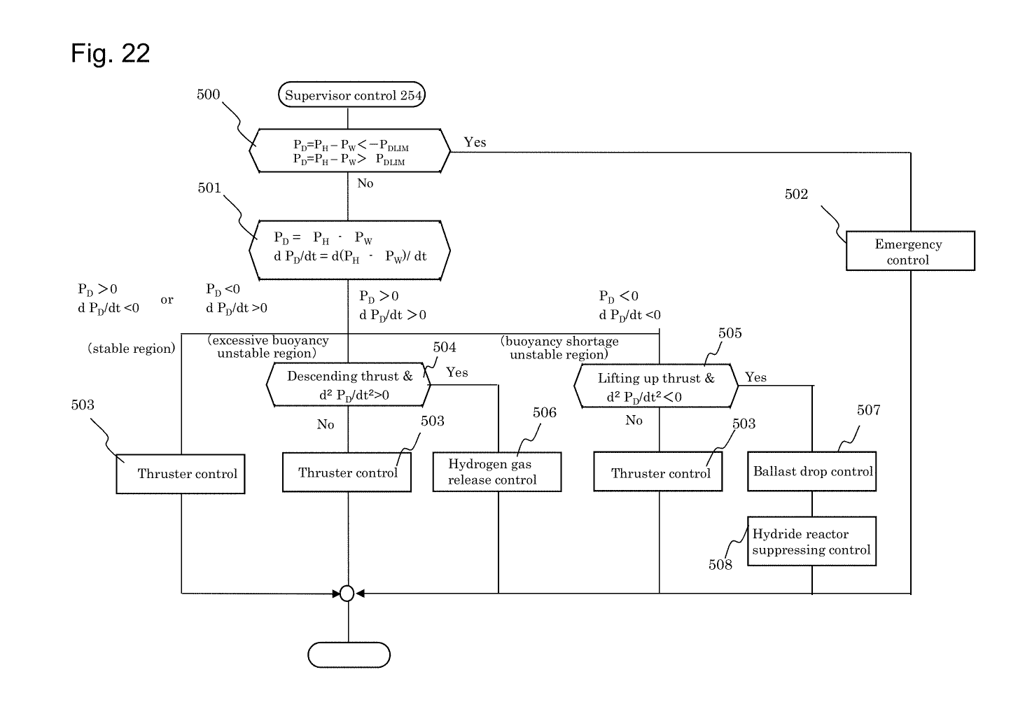

The control master 254 of FIG. 21 has a function of supervising the entire lifting control system and controls not to enter the divergence region and the destruction region of FIG. 20(b). FIG. 22 shows the function of the control master 254 and the emergency control 267 works when the internal and external pressure difference of the buoyancy tank 003 enters the fracture region at processing block 500.

FIGS. 23 (b) (d) (d) shows that the emergency control 267 releases hydrogen gas (Processing block 506) when the pressure of the buoyancy tank 003 exceeds the limits. And it drops the ballast (Processing block 507) and controls the hydride reaction (Processing block 528) when the pressure is too low.

The function of the control master 254 corresponds to FIG. 20 (b), and performs the processing of FIG. 22 corresponding to the PD and its change. In processing block 500, when it is in the fracture region of FIG. 20 (b), when the pressure is excessive due to the emergency control of the processing block 502, the hydrogen gas release control is performed in the processing block 503, then the pressure overload is eliminated. If the pressure is too low, it means that the increase in buoyancy is insufficient, then the ballast or cargo is partially dumped, and the hydride reaction control (Processing block 528) is carried out. Processing block 501 is a control corresponding to each region of (1) (2) (3) (3) (4) of FIG. 20(b).

The processing block 503 is controlled corresponding to the region (3) (4) in FIG. 20(b), and the deviation is reduced in the limit range even if there is a pressure deviation. In this case, the thrust control (Processing block 503) by execution of conventional PID control or so-called robust control. The region (1) of diverging floating diverges if there were not for floating suppression, but when the descending force works in the processing block 504 and the pressure overload is decreasing, it is judged to return to normal and the thruster control 503 continues. When pressure overload is increasing, then it is abnormal, and the hydrogen gas release is carried out. (Processing block 503) The divergent descending of the region (2) diverges unless descending is suppressed, but when the floating force works in processing block 505 and the pressure shortage is decreasing, it is judged to return to normal and the thruster control 503 continues. When the pressure shortage is increasing, as it is abnormal, then a part of the ballast or cargo is released, and the hydride reaction control is carried out. (Processing block 507,508)

FIG. 2 shows the state of the Deepsea Crane 001, at the start of the rise of (a), the hydrogen gas is filled to be the same pressure as the seafloor water pressure in the buoyancy tank 003, and the liquid tank 004 fills with toluene. The cargo-unit 007 loads the collected ore 010. The lower portion of the liquid tank 004 to balance fills with seawater separated by partition film 030. In this state, the specific gravity is adjusted to be 1.0. In FIG. 2(b) toluene absorbs the hydrogen gas of the buoyancy tank 003 and becomes MCH. Since MCH is lighter than toluene, it fills at the top of the liquid tank 004 separated by partition film 030. Since the toluene increases by the hydride reaction, the excess MCH may also flow to the lower portion of the buoyancy tank. The buoyancy tank has high-pressure hydrogen gas, but MCH does not react. In FIG. 20(c) at the end of lifting it reaches the sea level. The hydrogen gas in the buoyancy tank 003 became 1 atm, and the MCH has absorbed the rest.

V Deepsea Crane

1 Control System

(a) Objectives and Functions

The object to control is the Deepsea Crane 001 and the Seafloor Station 018, but the Seafloor Station 018 can be considered as a composite system of the Deepsea Cranes 001.

As the control system, it is necessary for the Seafloor Station 018 to control its position close to the Surface mothership 016 when lifting up to the sea surface, and to realize the descending speed not to damage the equipment when settling down to the seafloor.

However as it does not require the accuracy as the Deepsea Crane 001, the Deepsea Crane 001 is described in detail,

The chapter of “VI submarine support equipment” describes the Seafloor Station as an extension of the Deepsea Crane 001.

The Deepsea Crane 001 has three modes as the control for reciprocating between the Surface mothership 016 and the Seafloor Station 018.

(a) Position/Velocity Control

a.1 Depth Control

To satisfy the pressure requirements associated with hydride reaction at the time of lifting, as described in “IV Principle of lifting,” it is the highest priority to control the speed and depth along the Z axis (vertical).

At the time of descent, the hydride reaction stops, and there is no speed requirement for the Z axis (vertical).

If the Deepsea Crane 001 does not include gas at the departure from the sea surface, and if its specific gravity is 1.0, and the thruster 055 gives initial descending speed, it approaches to the seafloor at a constant velocity where the thrusting force balances to the seawater resistance.

Having approached the seafloor, the Deepsea Crane 001 docks to the Seafloor Station 018 by rendezvous control.

a.2 Movement Control

Since the settling position of the Seafloor Station 018 is not precisely under the Surface mother ship 016, it is necessary to change the horizontal position of the Deepsea Crane 018 when floating and descending. Therefore in addition to the depth control along the Z-axis, the horizontal (XY axis) velocity control is carried out based on the command of the navigation system.

As long as the Deepsea Crane 001 reaches the position of the Surface mothership at the sea surface, there is no restriction in the midcourse (terminal position control). There is no constraint on the velocity control of the XY axis except against the current.

(b) Attitude Control

Since the hydride reactor 009 is installed in the center portion of the Deepsea Crane 001 and filled with fluid different in specific gravity in the axial direction, the stable operation of the hydride reaction cannot work, if the Z-axis direction deviates from the vertical direction for more than a particular angle. Therefore, the attitude control is carried out not to generate the deviation between the Z axis and perpendicular direction more than a specific value (for example, 5°).

Since the hydride reaction does not work when descending, the constraint on posture is small. The rotation around the Z axis is limited to once not to generate cable intertwining.

(c) Rendezvous Control

At the time of settling to the seafloor, it is necessary to dock at a designated location of the Seafloor Station 018. Therefore it is required to perform the precision control of the zero terminal positional error and zero terminal attitude error at the accuracy of less than 1 cm in position, and less than a few cm/s in speed.

The rendezvous control is carried out in descending to the seafloor with the vacant cargo, and as the hydride reaction does not work, there is no restriction on the vertical velocity and depth.

At the time of floating, it is necessary to dock at the designated location (Moon pool 307 of the Surface mother ship 016). Therefore it is performed the precision control of the zero terminal positional error and zero terminal attitude error.

At the time of arrival to the sea surface, there is no control constraint on the velocity and depth in the vertical direction because the internal pressure and ambient sea pressure of the Deepsea Crane 001 are close to atmospheric pressure and the hydride reaction is not carried out.

In the rendezvous control, constraints on the vertical velocity and depth can be removed, and it is possible to carry out precision control for the position and velocity.

(2) Dynamics and Propulsion Equipment

Due to the hydrogenation rate of toluene, the lift up speed to the sea surface does not exceed 10 cm/sec, and the horizontal velocity is about 100 cm/sec to be able to counter the current of up to 2 knots.

As the propulsion mechanism, the underwater thruster 055 of the Deepsea Crane as shown in the FIG. 24, is a variable speed screw-driven water flow generator which is in use in the marine diving device.

To reduce the fluid resistance, weight reduction, ensuring maintenance, and ease of production, the Deepsea Crane 001 is rotationally symmetric on the Z-axis and is vertically symmetric. Therefore, the center of the fluid resistance is the midpoint C in the axial direction in FIG. 24. The center of gravity G is by Lg from the midpoint C.

FIG. 24(a) and FIG. 24 (b) show that the underwater thruster 055 is disposed at equal intervals on the upper circumference and the lower circumference of the Deepsea Crane 001 and can generate a thrust vector by variable speed control of the motor 057.

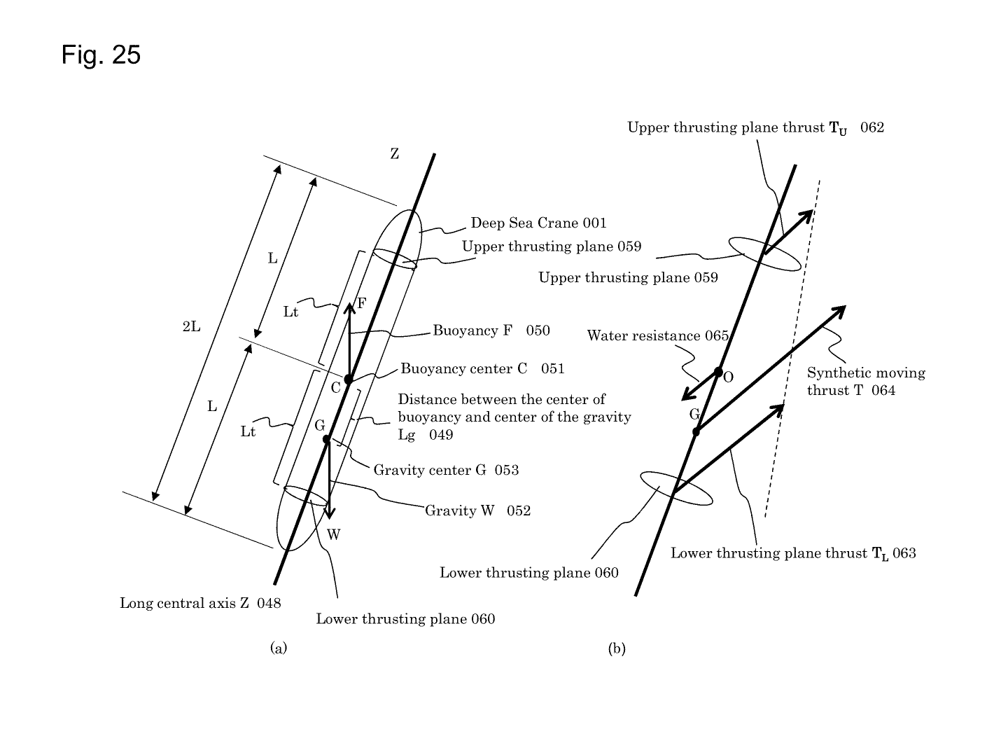

FIG. 25 to FIG. 27 are diagrams for explaining the dynamics of the Deepsea Crane 001. FIG. 25 (a) shows a symbol system for describing the dynamics of the Deepsea Crane 001, and the buoyancy center C 051 is at the midpoint of the central axis Z 048 of the Deepsea Crane 001. The underwater thruster 055 exists at the upper propulsion surface 059 and the lower propulsion surface 060 at the distance of Lt from the midpoint of the central axis Z 048.

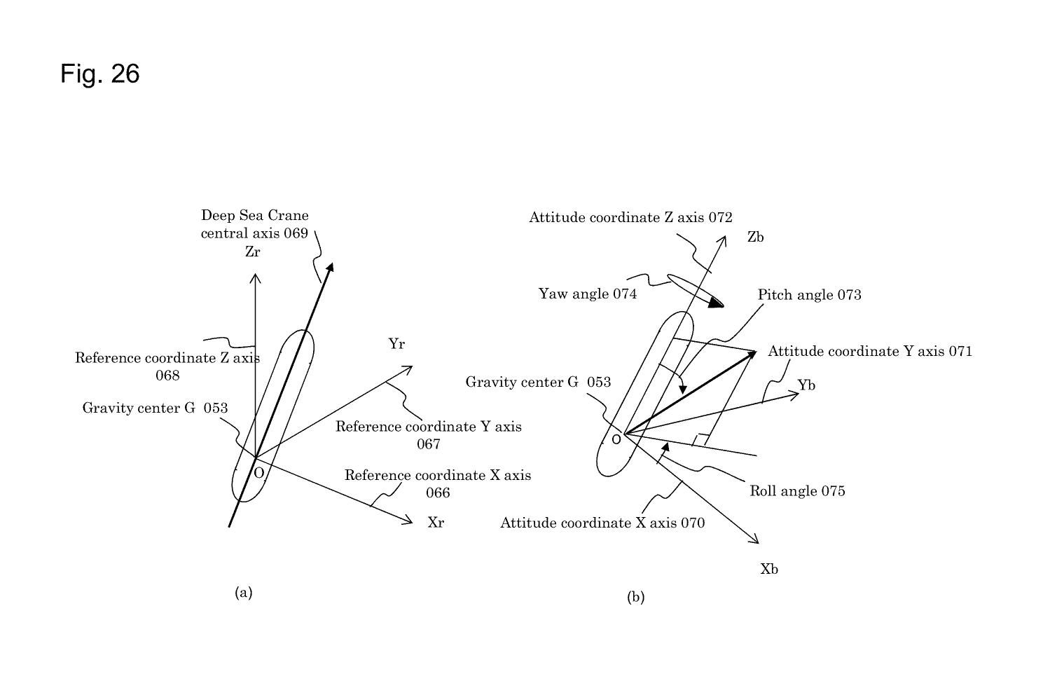

The control of the Deepsea Crane 001 performs position, velocity, and attitude control by shared underwater thrusters 055. FIG. 26 shows the dynamics expression of the Deepsea Crane 001 in reference coordinate system (a), and in attitude coordinate system (b).

The reference coordinate system uses the reference coordinate Zr axis 068 as a vertical line, and the reference coordinate Xr axis 066 is used as the north-south direction and the reference coordinate Yr axis 067 is used to control the position velocity.

FIG. 26 (b) defines the central axis 069 of the Deepsea Crane 001 to the attitude coordinate Z axis (Zb) 072,
FIG. 26 (b) sets the attitude coordinate Xb axis 070 and attitude coordinate Yb 071 as a coordinate which is specific to of the Deepsea Crane 001 and uses them for the attitude control.

The control system configures according to the following procedure.

a. Separating the Position Velocity Control System and the Attitude Control System

a. Separating the position velocity control system and the attitude control system

The movement of the centroid on the reference coordinate system shows the position and velocity, and the position velocity control system controls the position velocity of the center of gravity G053 and does not involve the change in the attitude.

The attitude control system controls the pitch angle 073, the yaw angle 074, and the roll angle 075 concerning the attitude coordinates 070 to 072 in FIG. 26 (b) setting the center of gravity G053 as the origin of the coordinate system. The attitude control has no movement of the center of gravity G053.

The separation of the position-velocity control system from the attitude control system is to realize different control goals for various operation phases of the Deepsea Crane 001 using individually changing the control parameters for each of the position velocity control system and the attitude control system.

b. Since the high precision control is essential for the attitude control during rendezvous control, it uses the quaternion which does not generate singularity, and it is applied the back-stepping method as a robust control for high control stability. (OTHER PUBLICATIONS 7)

c. The position-velocity and the attitude control systems share the underwater thruster 055 of which commands are from both systems.

The target value of the position-velocity control is given by the pressure control system for floating and by the navigation control system for target point arrival.

The target value of the attitude control is to keep the central axis Z 048 to vertical to stabilize hydride reaction, and during the docking control, it is to match the attitude to the docking target.

The position-velocity and the attitude control systems share the underwater thruster 055 of which commands are from both systems, and determined independently.

(a) Position, Velocity Control

FIG. 25 (b) shows the forces acting on the Deepsea Crane 001 in the position velocity control. The goal of the position-velocity control is to generate only the synthetic moving thrust T064 to the center of gravity G053, and not to generate any rotational torque. Each underwater thruster 055 exists on an upper thrust plane 059 which is perpendicular to the central axis Z 048 in FIG. 24 (a), and each underwater thruster 055 generates an upper thrusting plane 059 thrust TU 062 and a lower thrusting plane 060 thrust TL063 for the upper thrusting plane 059 and lower thrusting plane 060, respectively. For this reason, there is a relationship between (Number 001). The bold italics below represent vectors and matrices.

$$T = [ \begin{matrix}{T}_{x} \\ {T}_{y} \\ {T}_{z}\end{matrix} ] = {T}_{U} + {T}_{L} \\ where , \\ {T}_{U} = [ \begin{matrix}{T}_{Ux} \\ {T}_{Uy} \\ {T}_{Uz}\end{matrix} ] = {T}_{U} {I}_{b} \\ {T}_{L} = [ \begin{matrix}{T}_{Lx} \\ {T}_{Ly} \\ {T}_{Lz}\end{matrix} ] = {T}_{1} {I}_{b} \\ T = {TI}_{b} \qquad [ Equation 001 ]$$

Where, I_{b} is an unit vector directing T.

The thrust provided by each underwater thruster 055 for the upper thruster plane 059 and the lower thruster plane 060 must cancel the water resistance force 065. Since the water resistance force 065 acts on the buoyancy center C 051 which is the center of the shape of the Deepsea Crane 001, the rotational torque is not generated.

In FIG. 25 (b), suppose the actual thrust is T, and the propulsion force to cancel the water resistance force 065 is T′ T′ then (Equation 002) is met.

$${T}_{U} = {T}_{U}^{′} - \frac{R}{2} \\ {T}_{L} = {T}_{L}^{′} - \frac{R}{2} \\ T = {T}_{U} + {T}_{L} \\ {T}^{′} = {T}_{U}^{′} + {T}_{U}^{′} \\ R = a ( V ) T \qquad [ Equation 002 ]$$

where R is water resistance and a function of moving speed V.

Based on the conditions that do not cause rotation around the gravity center G for the upper thrusting plane 059 and to the lower thrusting plane 060 (Equation 003) are obtained.

$$( {L}_{t} + {L}_{g} ) {T}_{U} = ( {L}_{t} - {L}_{g} ) {T}_{L} \\ {T}_{L} = \frac{1}{2} ( 1 + \frac{{L}_{g}}{{L}_{t}} ) T \\ {T}_{U} = \frac{1}{2} ( 1 - \frac{{L}_{g}}{{L}_{t}} ) T \\ {T}_{L}^{′} = \frac{1}{2} ( 1 + \frac{{L}_{g}}{{L}_{t}} ) T + \frac{R}{2} \\ {T}_{U}^{′} = \frac{1}{2} ( 1 - \frac{{L}_{g}}{{L}_{t}} ) T + \frac{R}{2} \qquad [ Equation 003 ]$$

Where TL′ and TU′ are required driving force for upper thrusting plane 059 and lower thrusting plane 060 considering water resistance R.

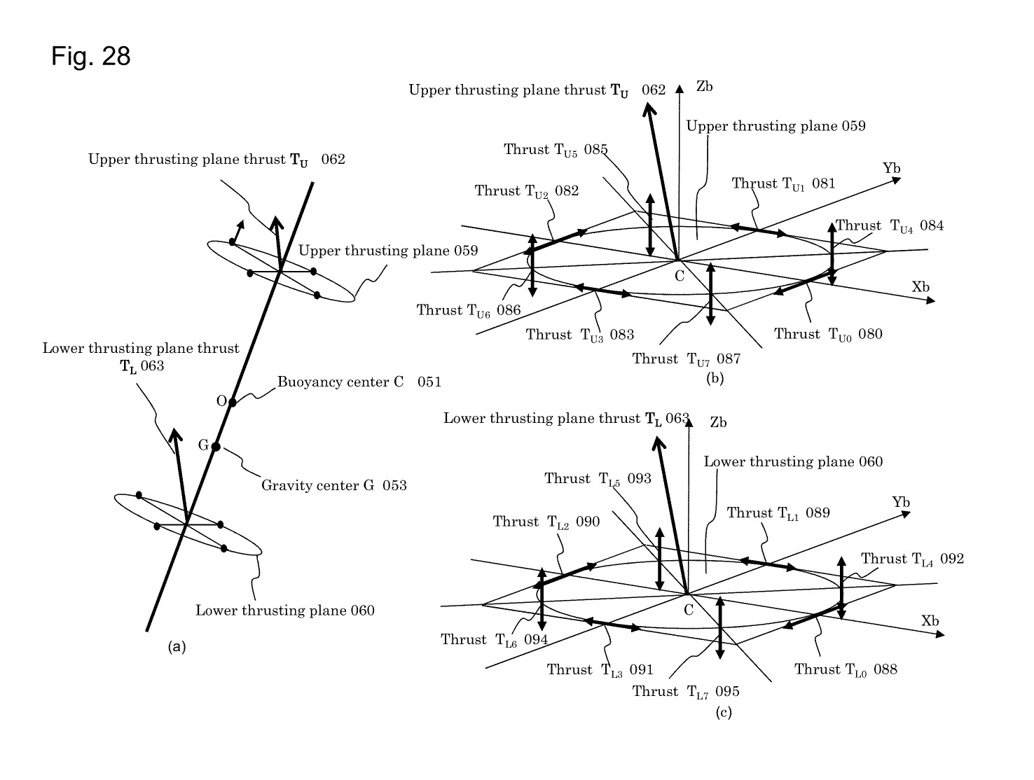

Then, in FIG. 28, a condition in which the thrust TL and TU do not generate rotational torque for the upper thrusting plane 059 and the lower thrusting plane 060 is determined.

FIG. 28 (b) (c) means as follows;

The upper thrusting plane thrust TL and the lower thrusting plane thrust TU are obtained as the synthetic force of the thrust TU0 080 to TU7 087, and the thrust TL0 088 to TL7 095, by underwater thrusters 055 which has thrusts in the tangential directions of the Deepsea Crane 001.

FIG. 28 (b) shows an airframe coordinate system, and as the roll angle can be freely changed, without loss of generality the generating points of the thrusts TU0 080 to TU3 083 and the generating points of the thrusts, TL0 088 to TL3 091 are on the Xb axis and the Yb axis.

$${T}_{Ul} = [ \begin{matrix}{T}_{Uix} \\ {T}_{Uiy} \\ {T}_{Uiz}\end{matrix} ] {T}_{Ll} = [ \begin{matrix}{T}_{Lix} \\ {T}_{Liy} \\ {T}_{Liz}\end{matrix} ] i = 0 , 7 \\ {T}_{U 0} = [ \begin{matrix}0 \\ {T}_{U 0} \\ 0\end{matrix} ] {T}_{U 1} = [ \begin{matrix}{T}_{U 1} \\ 0 \\ 0\end{matrix} ] {T}_{U 2} = [ \begin{matrix}0 \\ {T}_{U 2} \\ 0\end{matrix} ] \\ {T}_{U 3} = [ \begin{matrix}{T}_{U 3} \\ 0 \\ 0\end{matrix} ] {T}_{U 4} = [ \begin{matrix}0 \\ 0 \\ {T}_{U 4}\end{matrix} ] {T}_{U 5} = [ \begin{matrix}0 \\ 0 \\ {T}_{U 5}\end{matrix} ] \\ {T}_{U 6} = [ \begin{matrix}0 \\ 0 \\ {T}_{U 6}\end{matrix} ] {T}_{U 7} = [ \begin{matrix}0 \\ 0 \\ {T}_{U 7}\end{matrix} ] {T}_{L 0} = [ \begin{matrix}0 \\ {T}_{L 0} \\ 0\end{matrix} ] \\ {T}_{L 1} = [ \begin{matrix}{T}_{L 1} \\ 0 \\ 0\end{matrix} ] {T}_{L 2} = [ \begin{matrix}0 \\ {T}_{L 2} \\ 0\end{matrix} ] {T}_{L 3} = [ \begin{matrix}{T}_{L 3} \\ 0 \\ 0\end{matrix} ] \\ {T}_{L 4} = [ \begin{matrix}0 \\ 0 \\ {T}_{L 4}\end{matrix} ] {T}_{L 5} = [ \begin{matrix}0 \\ 0 \\ {T}_{L 5}\end{matrix} ] {T}_{L 6} = [ \begin{matrix}0 \\ 0 \\ {T}_{L 6}\end{matrix} ] \\ {T}_{L 7} = [ \begin{matrix}0 \\ 0 \\ {T}_{L 7}\end{matrix} ] \\ - {T}_{max} < {T}_{Ui} < {T}_{max} - {T}_{max} < {T}_{Li} < {T}_{max} \\ i = 0 , 7 \qquad [ Equation 004 ]$$

The conditions for not to generate rotational torque on the thrusting plane are (Equation 005) from FIG. 28 (b) (c).

$$\begin{matrix}{T}_{U 0} = {T}_{U 2} & {T}_{U 1} = {T}_{U 3} & {T}_{U 4} = {T}_{U 6} & {T}_{U 5} = {T}_{U 7} \\ {T}_{L 0} = {T}_{L 2} & {T}_{L 1} = {T}_{L 3} & {T}_{L 4} = {T}_{L 6} & {T}_{L 5} = {T}_{L 7}\end{matrix} \qquad [ Equation 005 ]$$

The upper thrusting plane thrust Tᵤ 062 is the sum of Tᵤᵢ, i=0.7

The lower thrusting plane thrust T_{L} 063 is the sum of T_{Li}, i=0.7

The next condition is obtained from the condition not to generate the rotation torque on the thrusting plane.

$${T}_{U} = [ \begin{matrix}{T}_{Ux} \\ {T}_{Uy} \\ {T}_{Uz}\end{matrix} ] = [ \begin{matrix}{T}_{U 1} + {T}_{U 3} \\ {T}_{U 0} + {T}_{U 2} \\ {T}_{U 4} + {T}_{U 5} + {T}_{U 6} + {T}_{U 7}\end{matrix} ] = 2 [ \begin{matrix}{T}_{U 1} \\ {T}_{U 0} \\ {T}_{U 4} + {T}_{U 5}\end{matrix} ] \\ {T}_{L} = [ \begin{matrix}{T}_{Lx} \\ {T}_{Ly} \\ {T}_{Lz}\end{matrix} ] = [ \begin{matrix}{T}_{L 1} + {T}_{L 3} \\ {T}_{L 0} + {T}_{L 2} \\ {T}_{L 4} + {T}_{L 5} + {T}_{L 6} + {T}_{L 7}\end{matrix} ] = 2 [ \begin{matrix}{T}_{L 1} \\ {T}_{L 0} \\ {T}_{L 4} + {T}_{L 5}\end{matrix} ] \qquad [ Equation 006 ]$$

The result of the (Equation 003) gives us the thrust (Equation 007) not generate the rotational torque for the center of gravity G053.

$${T}_{L}^{′} = \frac{1}{2} ( 1 + \frac{{L}_{g}}{{L}_{t}} ) T + \frac{R}{2} = \frac{1}{2} ( 1 + \frac{{L}_{g}}{{L}_{t}} + r ) [ \begin{matrix}{T}_{x} \\ {T}_{y} \\ {T}_{z}\end{matrix} ] = 2 [ \begin{matrix}{T}_{L 1} \\ {T}_{L 0} \\ {T}_{L 4} + {T}_{L 5}\end{matrix} ] \\ {T}_{U}^{′} = \frac{1}{2} ( 1 - \frac{{L}_{g}}{{L}_{t}} ) T + \frac{R}{2} = \frac{1}{2} ( 1 - \frac{{L}_{g}}{{L}_{t}} + r ) [ \begin{matrix}{T}_{x} \\ {T}_{y} \\ {T}_{z}\end{matrix} ] = 2 [ \begin{matrix}{T}_{U 1} \\ {T}_{U 0} \\ {T}_{U 4} + {T}_{U 5}\end{matrix} ] \qquad [ Equation 007 ]$$

The Deepsea Crane 001 and the Seafloor station 018 are keeping a specific gravity of near 1.0, and are at extremely slow speed in the range of 0.1 to 1.0 m/s.

The Equation 008 can express the motion as it is with a low resistance of symmetrical shape, is subjected to water resistance proportional to the speed of movement in the x, y, and z directions.

Where R represents the water resistance coefficient,

T(t)=M\ddot{X}(t)+R\dot{X}(t) [Equation 008]

Where M represents the mass of the Deepsea Crane 001, R is a resistance coefficient, and X (t) indicates a position in the reference coordinate system (FIG. 26 (a)) of the gravity center G 053. T (t) is the thrust in the reference coordinate system obtained from the navigation control system and the lifting control system for the Deepsea Crane 001.

The dynamics of (Equation 008) is a static process system, and unstable, the system structure is as an H ∞ control system with strong robustness for an error function (Equation 009). This scheme reflects the following features;

There are nonlinearity and uncertainty phenomena such as the fluctuation of the load in the cargo-unit 007.

There is the vibration of boundary surface among internal liquid in the Deepsea Crane 001, the change of gravity center caused by the progress of the hydride reaction, and the existence of sea current, and the error of water resistance by a linear function.

An example of the H ∞ control system for the static process system in three-dimensional space (OTHER PUBLICATIONS 7) is a more advanced example, and this is known to those skilled in the art.

$$The control strategy is to calculate T ( t ) to minimize \\ \int {( W ( t ) - {W}_{T} ( t ) )}^{T} A ( W ( t ) - {W}_{T} ( t ) ) dt \\ Where , W ( t ) = [ \begin{matrix}X ( t ) & {0}_{3 \times 3} \\ {0}_{3 \times 3} & \dot{X} ( t )\end{matrix} ] \\ {W}_{T} ( t ) = [ \begin{matrix}{X}_{T} ( t ) & {0}_{3 \times 3} \\ {0}_{3 \times 3} & \dot{{X}_{T} ( t )}\end{matrix} ] \qquad [ Equation 009 ]$$

A is a 6×6 constant matrix with the diagonal element aᵢᵢ>0 for i=1.5a

The right lower subscript in W_{T}(t) and X_{T}(t) in (Equation 009) indicates the target value and the right upper subscript indicates the transposition matrix.

(b) Attitude Control

The attitude control is performed by the reference coordinate system and the attitude coordinate system having the gravity center of G 053 in FIG. 26 (a) (b) as the origin.

Quaternion q, p are defined as follows;

$$[ Equation 010 ]$$

$$\begin{matrix}q = {q}_{0} + {q}_{1} i + {q}_{2} j + {q}_{3} k = {[ \begin{matrix}{q}_{0} & {q}_{1} & {q}_{2} & {q}_{3}\end{matrix} ]}^{T} & \\ p = {p}_{0} + {p}_{1} i + {p}_{2} j + {p}_{3} k = {[ \begin{matrix}{p}_{0} & {p}_{1} & {p}_{2} & {p}_{3}\end{matrix} ]}^{T} & \\ q + p = {[ \begin{matrix}{q}_{0} + {p}_{0} & {q}_{1} + {p}_{1} & {q}_{2} + {p}_{2} & {q}_{3} + {p}_{3}\end{matrix} ]}^{T} & addition \\ q - p = {[ \begin{matrix}{q}_{0} - {p}_{0} & {q}_{1} - {p}_{1} & {q}_{2} - {p}_{2} & {q}_{3} - {p}_{3}\end{matrix} ]}^{T} & substruction \\ q ⊗ p = D ( q ) p = [ \begin{matrix}{q}_{0} & - {q}_{1} & - {q}_{2} & - {q}_{3} \\ {q}_{1} & {q}_{0} & - {q}_{3} & {q}_{2} \\ {q}_{2} & {q}_{3} & {q}_{0} & - {q}_{1} \\ {q}_{3} & - {q}_{2} & {q}_{1} & {q}_{0}\end{matrix} ] [ \begin{matrix}{p}_{0} \\ {p}_{1} \\ {p}_{2} \\ {p}_{3}\end{matrix} ] & product \\ {q}^{*} = {q}_{0} - {q}_{1} i - {q}_{2} j - {q}_{3} k = {[ \begin{matrix}{q}_{0} & - {q}_{1} & - {q}_{2} & - {q}_{3}\end{matrix} ]}^{T} & conjugate \\ {q}^{*} = {q}^{- 1} & inverse\end{matrix}$$

In FIG. 26, when a quaternion showing an airframe attitude is set to qᵣ^{b} in the reference coordinate system, the time derivative becomes (Equation 011).

$${\dot{q}}_{r}^{b} = \frac{1}{2} D ( {q}_{r}^{b} ) [ \begin{matrix}0 \\ {ω}_{b}\end{matrix} ]$$

Where, ω_{b} is 3-axis angular velocity of the airframe coordinate.

$$Defining the inertia matrix J \\ J = [ \begin{matrix}{I}_{xx} & 0 & 0 \\ 0 & {I}_{yy} & 0 \\ 0 & 0 & {I}_{zz}\end{matrix} ] \qquad [ Equation 012 ]$$

The motion equation is defined as follows;

Jω_{b}=−S(ω_{b})Jω_{b}+T

Where, T is outer torque imposed to the airframe;

$$S ( {ω}_{b} ) = [ \begin{matrix}0 & - {ω}_{bz} & {ω}_{by} \\ {ω}_{bz} & 0 & - {ω}_{bx} \\ - {ω}_{by} & {ω}_{bx} & 0\end{matrix} ]$$

When quaternion error between the target attitude q_{d} and the current attitude is set to qₑ, the quaternion representing the target attitude is (Equation 013) related to the current attitude qᵣ^{b} and the solution is obtained (Equation 014).

q_{d}=qₑ⊗qᵣ^{b} [Equation 013]

qₑ=q_{d}⊗qᵣ^{b}^{^{−1}}=q_{d}⊗qᵣ^{b*} [Equation 014]

Where, it is used the fact that the inverse quaternion qᵣ^{b}^{^{−1}} is equal to the conjugate quaternion qᵣ^{b*};

It is equivalent that the quaternion representing the target attitude q_{d} is same as the present attitude qᵣ^{b}, and qₑ=[±1 0 0 0]^{T}, and complying the airframe attitude to target attitude.

Supposing the following vector x;

x=[1−qₑ₀qₑ₀qₑ₀qₑ₀]^{T}

The differential of x is obtained (Equation 015).

$$\begin{matrix}\dot{x} = [ \begin{matrix}- 1 & {0}_{1 \times 3} \\ {0}_{3 \times 1} & {I}_{3 \times 3}\end{matrix} ] \dot{{q}_{e}} = [ \begin{matrix}- 1 & {0}_{1 \times 3} \\ {0}_{3 \times 1} & {I}_{3 \times 3}\end{matrix} ] ( {q}_{d} ⊗ {{q}_{r}^{b}}^{*} ) \\ = [ \begin{matrix}- 1 & {0}_{1 \times 3} \\ {0}_{3 \times 1} & {I}_{3 \times 3}\end{matrix} ] \times \frac{1}{2} D ( {q}_{d} ) [ \begin{matrix}1 & {0}_{1 \times 3} \\ {0}_{3 \times 1} & - {I}_{3 \times 3}\end{matrix} ] D ( {q}_{r}^{b} ) [ \begin{matrix}0 \\ {ω}_{b}\end{matrix} ]\end{matrix} \qquad [ Equation 015 ]$$

Where, (Equation 016)

$${G}^{T} = [ \begin{matrix}- 1 & {0}_{1 \times 3} \\ {0}_{3 \times 1} & {I}_{3 \times 3}\end{matrix} ] \times \frac{1}{2} D ( {q}_{d} ) [ \begin{matrix}1 & {0}_{1 \times 3} \\ {0}_{3 \times 1} & - {I}_{3 \times 3}\end{matrix} ] [ \begin{matrix}- {q}_{r 1}^{b} & - {q}_{r 2}^{b} & - {q}_{r 3}^{b} \\ {q}_{r 0}^{b} & - {q}_{r 3}^{b} & {q}_{r 2}^{b} \\ {q}_{r 3}^{b} & {q}_{r 0}^{b} & - {q}_{r 1}^{b} \\ - {q}_{r 2}^{b} & {q}_{r 1}^{b} & {q}_{r 0}^{b}\end{matrix} ] \qquad [ Equation 016 ]$$

(Equation 015) can be expressed as (Equation 017).

\dot{x}=½G^{T}ω_{b} [Equation 017]

A candidate of the Lyapunov function for (Equation 017) is set to (Equation 018).

V₁(x)=x^{T}x

\dot{V}₁(x)=2x^{T}\dot{x}=x^{T}G^{T}ω_{b}

Here, given the stabilization feedback rule for x (Equation 019), the (Equation 020) is formed.

ω_{b}=α₁(x)=−K₁Gx [Equation 019]

\dot{V}₁(x)=−x^{T}G^{T}K₁Gx [Equation 020]

If, K₁>0 then \dot{V}₁(x)<0 and asymptotic stability around the origin of \dot{x}=½G^{T}ω_{b} is guaranteed.

To make ω_{b} follow α₁, using variable z₁ defined by z₁=ω−α₁,

Then Equation 017 and Equation 018 come to

\dot{x}=½G^{T}(α₁+z₁)=½G^{T}K₁Gx+½G^{T}z₁

\dot{V}₁(x)=−x^{T}G^{T}K₁Gx+X^{T}G^{T}z₁ [Equation 021]

Using Equation 012 of J\dot{ω}_{b}=−S(ω_{b})Jω_{b}+T, then, Equation 022 is met.

Jż₁=J\dot{ω}_{b}−J\dot{α}₁=−S(ω_{b})Jω_{b}+T−J\dot{α}₁ [Equation 022]

The candidate of the Lyapunov function V₂(x, z₁) and its time derivative comes to be Equation 023;

$$\begin{matrix} {V}_{2} ( x , {z}_{1} ) = {V}_{1} ( x ) + \frac{1}{2} {z}_{1}^{T} {Jz}_{1} \\ \begin{matrix}\dot{{V}_{2}} ( x , {z}_{1} ) = \dot{{V}_{1}} ( x ) + {z}_{1}^{T} \dot{{Jz}_{1}} \\ = - {x}^{T} {G}^{T} {K}_{1} Gx + {x}^{T} {G}^{T} {z}_{1} + {z}_{1}^{T} \{ - S ( {ω}_{b} ) J {ω}_{b} + T - J {\dot{α}}_{1} \}\end{matrix} & [ Equation 023 ] \\ {T}_{A} = S ( {ω}_{b} ) J {ω}_{b} \dot{J {α}_{1}} - Gx - {K}_{2} {z}_{1} & [ Equation 024 ] \\ \dot{{V}_{2}} ( x , {z}_{1} ) = - {x}^{T} {G}^{T} {K}_{1} Gx - {z}_{1}^{T} {K}_{2} {z}_{1} & [ Equation 025 ]\end{matrix}$$

Suppose K₁>0, K₂>0 then \dot{V}₂(x, z₁)<0 is met then the stability of V₂(x, z₁) around the origin is guaranteed and. it is guarantied that the airframe attitude follows the target attitude. Equation 024 shows the driving torque of the attitude control.

(c) Integration of Control Variables

(1) In the position velocity control, the thrust request to the gravity center G 053 in the reference coordinate system and (2) the rotational torque request for the gravity center G 053 in the attitude coordinate system are obtained, then the torque request value for each underwater thruster 055 is distributed and integrated.

As a thrust request for the gravity center G 053 in the reference coordinate system in the position velocity control;

As

$$T = [ \begin{matrix}{T}_{x} \\ {T}_{y} \\ {T}_{z}\end{matrix} ]$$

is obtained, it is changed to quaternion expression Q.

The airframe coordinate is expressed to the reference coordinate in quaternion as qᵣ^{b}

Then the quaternion expression Q in the reference coordinate is qᵣ^{b*}Qqᵣ^{b} in the airframe coordinate.

Suppose

$$B = [ \begin{matrix}{B}_{x} \\ {B}_{y} \\ {B}_{z}\end{matrix} ] = {{q}_{r}^{b}}^{*} {Qq}_{r}^{b}$$

Furthermore in Equation 008, since T_{L4}=T_{L5} and T_{U4}=T_{U5} can be met, Equation 026 is obtained from Equation 008,

Control orders to all of the underwater thrusters are defined by the position velocity controller.

$$[ \begin{matrix}{T}_{L 1} \\ {T}_{L 0} \\ {T}_{L 4}\end{matrix} ] = ( 1 + \frac{{L}_{g}}{{L}_{t}} + r ) [ \begin{matrix}{B}_{x} / 2 \\ {B}_{y} / 2 \\ {B}_{z} / 4\end{matrix} ] \\ {T}_{L 2} = {T}_{L 0} {T}_{L 3} = {T}_{L 1} {T}_{L 5} = {T}_{L 6} = {T}_{L 7} = {T}_{L 4} \\ [ \begin{matrix}{T}_{U 1} \\ {T}_{U 0} \\ {T}_{U 4}\end{matrix} ] = ( 1 - \frac{{L}_{g}}{{L}_{t}} + r ) [ \begin{matrix}{B}_{x} / 2 \\ {B}_{y} / 2 \\ {B}_{z} / 4\end{matrix} ] \\ {T}_{U 2} = {T}_{U 0} {T}_{U 3} = {T}_{U 1} {T}_{U 5} = {T}_{U 6} = {T}_{U 7} = {T}_{U 4} \qquad [ Equation 026 ]$$

Then, as the torque given to the airframe for the attitude control is given by Equation 024;

$${T}_{A} = [ \begin{matrix}{T}_{Ax} \\ {T}_{Ay} \\ {T}_{Az}\end{matrix} ]$$

where, T_{AX}: the torque around X_{b} axis,
   T_{Ay}: the torque around Y_{b} axis,
   T_{Az}: the torque around Z_{b} axis,

Then according to the coordinate system shown in FIG. 26, each component is defined; torque around the X_{b} axis can be independently generated by T_{A0L}, T_{A2L}, T_{A0U}, T_{A2U}, torque around the Y_{b} axis can be independently generated by T_{A1L}, T_{A3L}, T_{A1U}, T_{A3U}, These components are expressed as t_{ALi}, t_{AUi} i=0.7.

Torque around the Z_{b} axis can be generated by superimposing to T_{A0L}, T_{A2L},T_{A0U}, T_{A2U}, T_{A1L}, T_{A3L}, T_{A1U}, T_{A3U}. These components are expressed as S_{ALi}, S_{AUi} i=0.7 then it can be expressed as T_{ALi}=t_{ALi}+S_{ALi}, T_{AUi}=t_{AUi}+S_{AUi} i=0.7.

Based on the condition that the thrust T_{Li}, T_{Ui} do not generate movement other than the airframe rotation;

(t_{AL2}+t_{AL0})(Lₜ−L_{g})=−(t_{AU2}+t_{AU0})(Lₜ+L_{g})

(t_{AL3}+t_{AL1})(Lₜ−L_{g})=−(t_{AU3}+t_{AU1})(Lₜ+L_{g})

Furthermore, the torque around Z_{b} axis is divided in inverse proportion in distance from the gravity center.

(S_{AL0}−S_{AL1}−S_{AL2}+S_{AL3})(Lₜ−L_{g})=(s_{AU0}−s_{AU1}−S_{AU2}+s_{AU3})(Lₜ+L_{g})

The torque around each axis is as follows.

$${T}_{A} = [ \begin{matrix}{T}_{Ax} \\ {T}_{Ay} \\ {T}_{Az}\end{matrix} ] = [ \begin{matrix}( {t}_{AL 2} + {t}_{AL 0} ) ( {L}_{t} - {L}_{g} ) - ( {t}_{AU 2} + {t}_{AU 0} ) ( {L}_{t} + {L}_{g} ) \\ ( {t}_{AL 3} + {t}_{AL 1} ) ( {L}_{t} - {L}_{g} ) - ( {t}_{AU 3} + {t}_{AU 1} ) ( {L}_{t} + {L}_{g} ) \\ ( {s}_{AL 0} - {s}_{AL 1} - {s}_{AL 2} + {s}_{AL 3} ) r + ( {s}_{AU 0} - {s}_{AU 1} - {s}_{AU 2} + {s}_{AU 3} ) r\end{matrix} ]$$

Then, Equation 027 is obtained.

$${T}_{AL 0} = {T}_{AL 2} = {t}_{AL 0} + {s}_{AL 0} = \frac{{T}_{AX}}{4 ( {L}_{t} - {L}_{g} )} + \frac{( {L}_{t} + {L}_{g} )}{16 {L}_{t}} {T}_{AZ} \\ {T}_{AL 1} = {T}_{AL 3} = {t}_{AL 1} + {s}_{AL 3} = \frac{{T}_{Ay}}{4 ( {L}_{t} - {L}_{g} )} + \frac{( {L}_{t} + {L}_{g} )}{16 {L}_{t}} {T}_{AZ} \\ {T}_{AL 4} = {T}_{AL 5} = {T}_{AL 6} + {T}_{AL 7} = 0 \\ {T}_{AU 0} = {T}_{AU 2} = {t}_{AU 0} + {s}_{AU 0} = - \frac{{L}_{t} - {L}_{g}}{{L}_{t} + {L}_{g}} ( \frac{{T}_{AX}}{4 ( {L}_{t} - {L}_{g} )} + \frac{( {L}_{t} + {L}_{g} )}{16 {L}_{t}} {T}_{AZ} ) \\ {T}_{AU 1} = {T}_{AU 3} = {t}_{AU 1} + {s}_{AU 3} = - \frac{{L}_{t} - {L}_{g}}{{L}_{t} + {L}_{g}} ( \frac{{T}_{Ay}}{4 ( {L}_{t} - {L}_{g} )} + \frac{( {L}_{t} + {L}_{g} )}{16 {L}_{t}} {T}_{AZ} ) \\ {T}_{AU 4} = {T}_{AU 5} = {T}_{AU 6} = {T}_{AUL 7} = 0 \qquad [ Equation 027 ]$$

Adding (Equation 026) and (Equation 027) control orders for each underwater thruster are determined.

(d) Configuration of the Control System

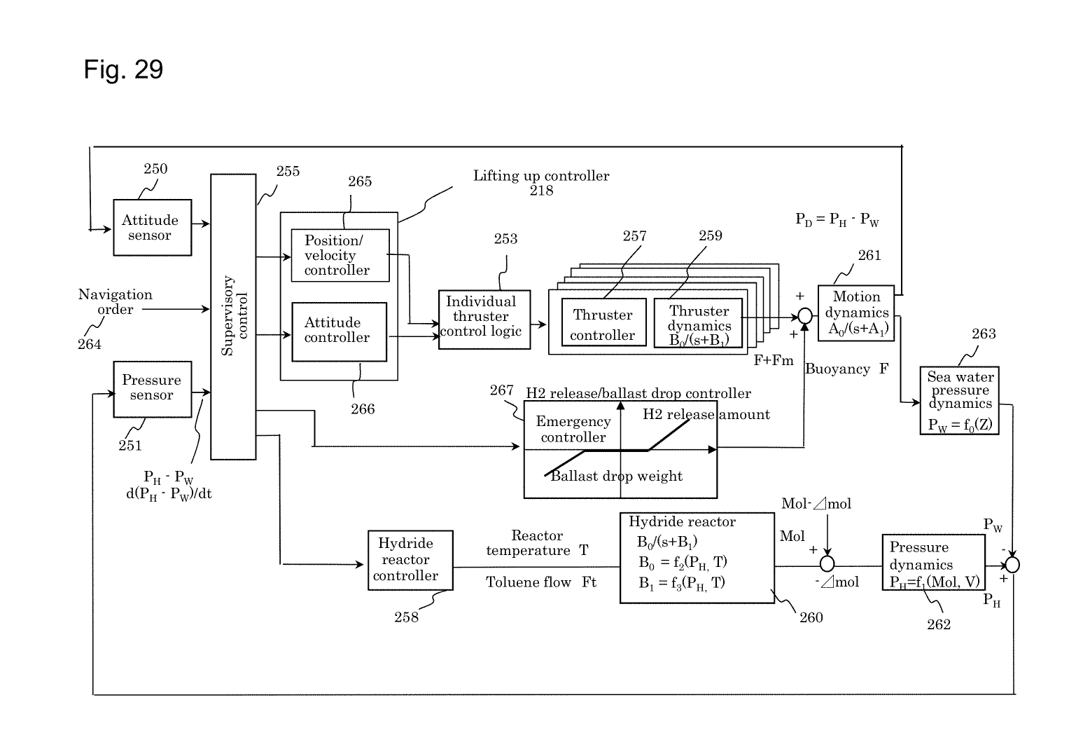

FIG. 29 shows a block diagram of control logic up to (Equation 027). In FIG. 21, the Z-axis direction control by the lift control 218 is extended to the xy axis and attitude control, and the position velocity control system 265 and the attitude control system 266 are shown in FIG. 29. The position velocity control system 265 outputs the control order by (Equation 027), and the attitude control system 266 outputs the control order by the (Equation 026), and the individual thruster control logic 253 outputs a command signal to the individual underwater thruster.

As the control of the Deepsea Crane 001 by maneuvering the individual thrusters, is common to all of its operational phase, the supervisory-control 255 realizes the request for each operation changing the diagonal elements, which correspond to the state variables, of the diagonal matrix A (Equation 009) in the position-velocity controller 265 and the attitude controller 266, which are the feedback coefficients (Equation 020).

3. Navigation Control

(1) Configuration

The navigation control system is positioned above the operation control system (FIG. 29) in the overall control system (FIG. 32) of the Deepsea Crane 001 and gives the navigation order 264 to the supervisory control 255 of the operation control system.

In the lifting up and descending using the buoyancy of the present invention, there is no need to create structures with dynamical couplings such as a rising pipe between the starting point and the arrival point (the Surface mothership and the Seafloor Station), and there is no mechanical constraint. On the other hand, it is necessary to autonomously guide a route between the starting point and the arrival point, and it is indispensable the docking function to the target at the arrival point. Since seawater is almost stationary at the seafloor, the disturbance against position and velocity is small, but the relative movement of the sea surface to support ships by the wave is necessary. To avoid sea surface waves and minimize this effect, arrival and departure port called moon pool 307 is provided in the central part of the hull of the surface mother ship 016, such as submarine research vessels.

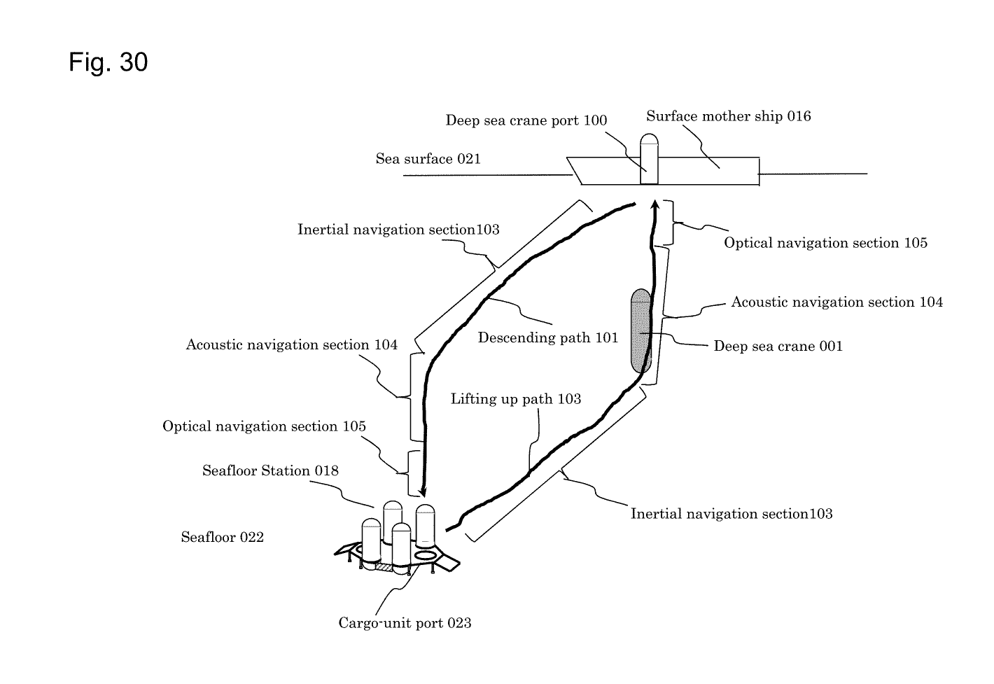

FIG. 30 shows a method of round trip of the Deepsea Crane 001 between the Seafloor Station 018 and the surface mother ship 016. When the Deepsea Crane 001 descends from the surface mothership 016 to the Seafloor Station 018, the downward path 101 is set beforehand. In the case of route guidance in water, it is impossible to use a straight radio wave, and transparency of light is not guaranteed, so the light cannot be used except in very close distance. Therefore, the optical fiber communication is applied. The available position sensors include (1) inertial position sensors, (2) depth meters, (3) acoustic sensors, (4) optical sensors, but as there are advantages and disadvantages in each one, these are in use in combination.

During inertial navigation interval 103, an inertial sensor and a depth meter are used to guide position, velocity, and attitude to minimize deviation from the descending path 101. The descending path 101 at its initial inertial navigation section 103 is set to occupy close above the target seafloor support station 018.

It is by decreasing the deviation from the vertically upper position from the target Seafloor Station 018 to eliminate the effect of bending of the sound line by the underwater temperature distribution for the subsequent acoustic navigation section.

In the closest region of the Seafloor Station 018, the optical navigation section 105 is prepared to dock to the cargo-unit port 023 by accurate position, velocity, and attitude control

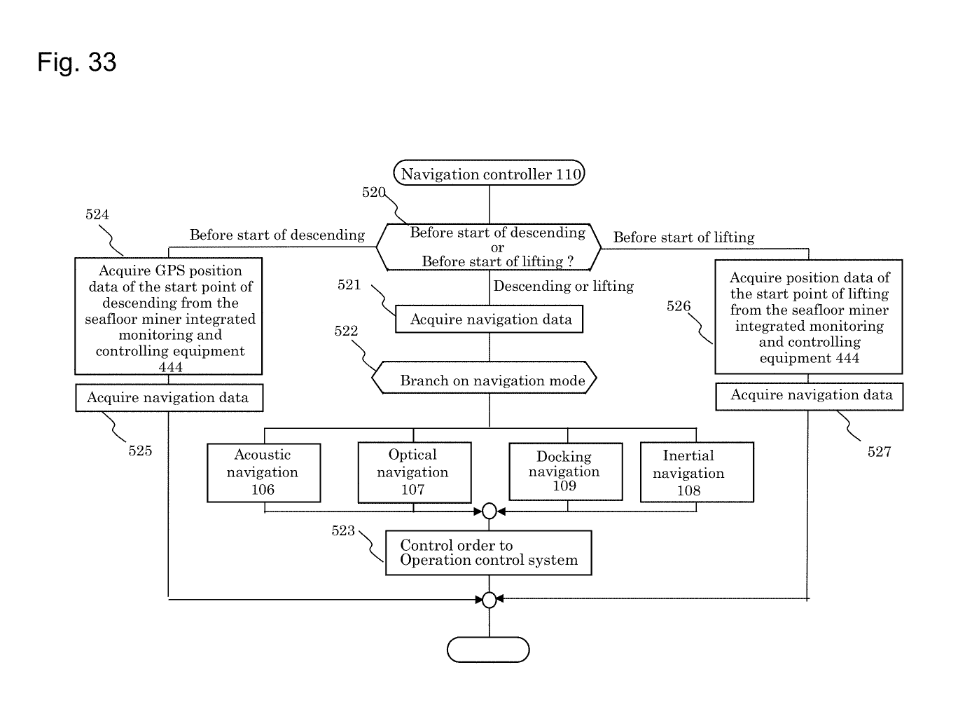

The navigation control system 110 of FIG. 32 operates according to the operation flowchart of the navigation control system shown in FIG. 33.

In processing block 520, it is judged whether the Deepsea Crane 001 is before the departure from the Seafloor Station 018 or the surface mothership 016.

And if before the departure and if descending the GPS positioning data of the integrated supervisory control equipment 444, which is on the surface mothership 016, is acquired as initialization data.

If before the floating up the Deepsea Crane 001 gets the position data kept at the Seafloor Station 018 as the initialization data. It is prepared a countermeasure against deterioration of accuracy over time by drift accumulation of inertial navigation system after the starting of floating up or descending. Processing block 521 acquires navigation data including inertial sensors, digital compasses, and depth meters. In processing block 522, it branches by navigation mode (inertial navigation, acoustic navigation, optical navigation, and docking navigation). The initial setting at the start of flotation or descent is by the inertial navigation.

(2) Inertial Navigation

Since GPS is not available in water, in the case of the inertial guidance the error of position accumulates by drift with time after initialization to the reference coordinates. Therefore, the inertial guidance is not available for terminal one in the sea.

However, there is an advantage to get position and velocity data within a constant error. Therefore, it is used in the initial stage while drift does not accumulate in both floating up and descending (inertial navigation section 103). And the Deepsea Crane approaches the target in the horizontal plane as close as possible to the vertically above or down position so that in the next stage of acoustic navigation the approach to the goal is from near vertical above or down.

It is possible to eliminate the effect of refraction of sound propagation by selecting sound wave path closer to vertical.

While the drift error of the inertial sensor is small at the initial stage of the route, it guides to directly above or below the target descending or lifting ay the same time to minimize the effect of the refraction of sound propagation due to the sea temperature distribution before switching to the acoustic guidance.

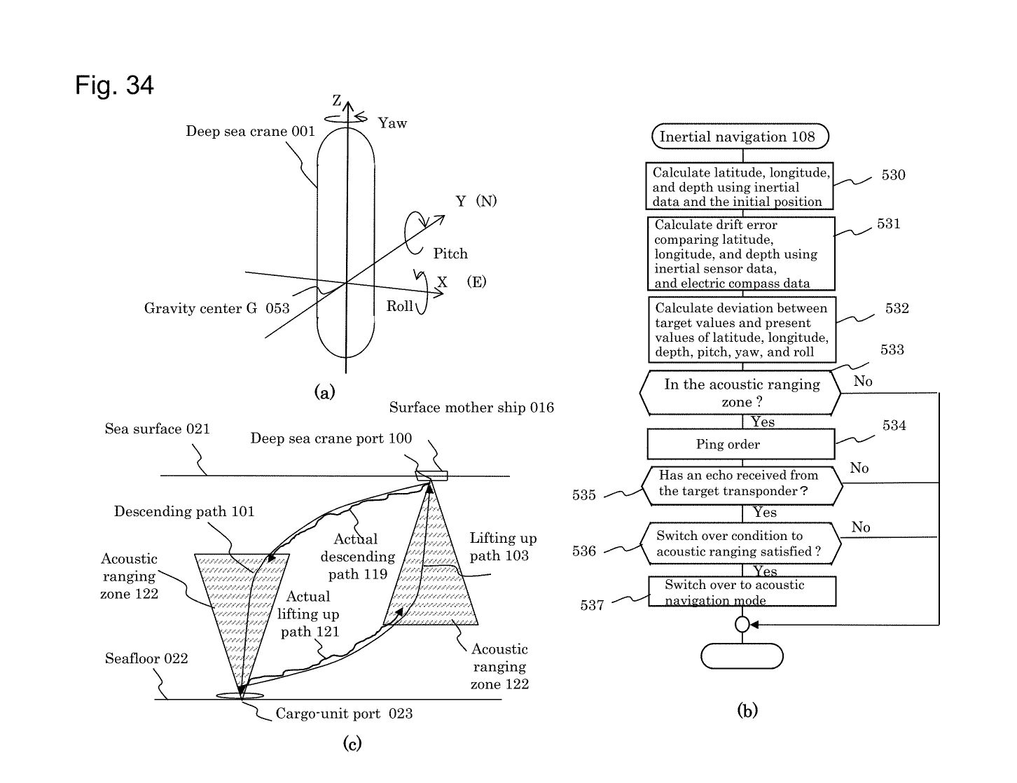

The processing of inertial navigation 108 follows the processing flow of the operation of the inertial navigation system of FIG. 34.

As GPS is not available, the initial position obtained in the processing block 524 or 526 in FIG. 33 adds the moving distance obtained in the inertial navigation system to the present location (Processing block 530).

The depth system data and the moving orientation obtained by the electronic compass in processing block 531 can estimate the drift of the inertial navigation sensor. The maximum likelihood latitude, longitude, depth, speed, attitude corrected by the drift estimate at processing block 532, and the deviation from the target path appears.

Taking into account the refraction of the sound propagation path (Processing block 530) the acoustic measuring range 122 is set to a conical zone above or below the final target (the cargo-unit port 023, the Deepsea Crane 100) with high linearity.

When the Deepsea Crane 001 is confirmed to have entered the acoustic measuring range 122 by the inertial navigation system in the processing block 533, the sound generation order is issued to the acoustic navigation system 108 by the processing block 534.

Having confirmed that the reception of the echo from the transponder installed at the target point in the processing block 535,

and that the signal level exceeds the threshold value in the processing block 536,

and that the distance is equal to or less than the threshold value,

then the switching to the acoustic navigation mode occurs in the processing block 536.

(3) Acoustic Navigation

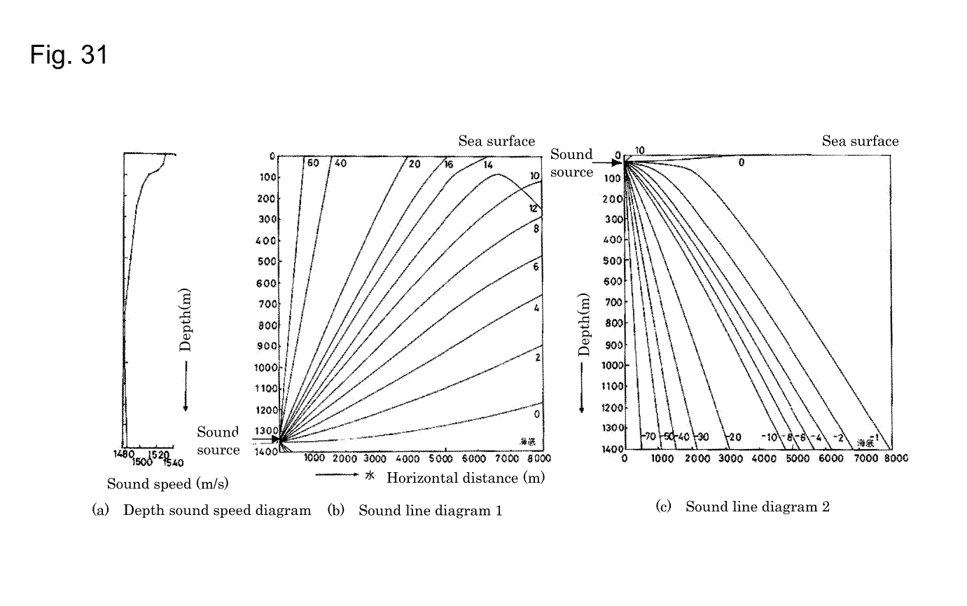

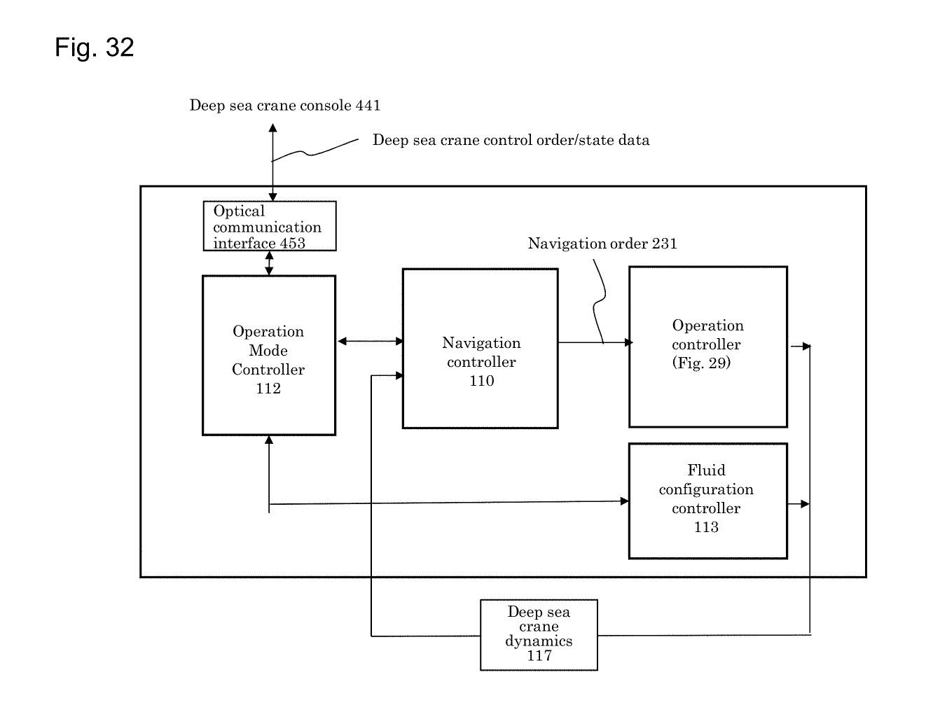

The acoustic navigation is used for float up and descent in section 104 following inertial navigation. This scheme is because the temperature distribution of seawater does not guarantee the straightness of the sound wave, but because it is suitable for use in the medium to short range in response to error characteristics, and the light does not reach except the nearest. The temperature distribution of seawater exists in the depth direction, but the horizontal direction is uniform. When positioning with a transponder is performed, the horizontal direction is available in a comparatively accurate manner, but an error in the vertical direction increases with departure from the vertical direction. As an example of the sound propagation path is shown in FIG. 31, it is sure for the sound path to reach the target if it departs more than 20° from directly above or below.

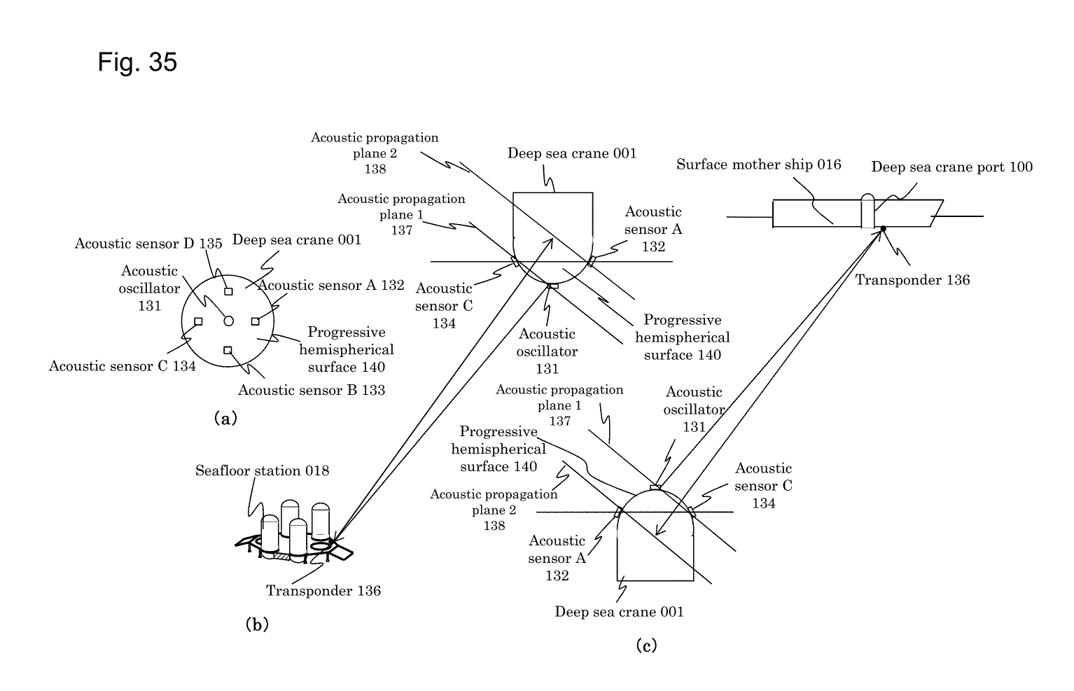

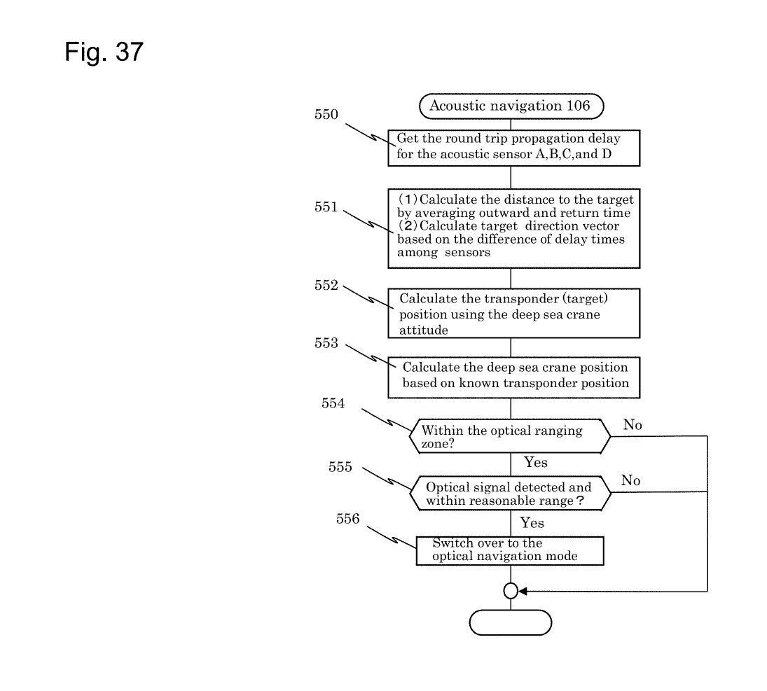

FIG. 35 shows the principle and implementation method of acoustic navigation 106. An acoustic sensor A 132, an acoustic sensor B 133, an acoustic sensor C 134, and an acoustic sensor D 135 reside in the traveling direction curved surface 140 of the Deepsea Crane 001. The acoustic oscillator 131 lies in these centers, and it periodically pings when it enters the sound navigation section 104. When the transponder installed in the cargo-unit port 023 returns the echo, a time lag occurs in the arrival of the echo signal for each acoustic element as shown in FIG. 35 (b). That is, in FIG. 35 (b), the echo from the transponder 136 reaches the acoustic sensor C 134 at the acoustic sensor C 137, enters the acoustic sensor A 138, and reaches the acoustic sensor A 132, and is caused to be shifted by time. FIG. 35 (d) shows the situation in three dimensions. It shows that the deviation of the arrival time of the echo signal from the four points of acoustic sensors A to D 132 to 135 surrounding the origin O on the XY plane can calculate the transponder azimuth vector 139. The difference between the ping time and the arrival time of the echo determines the distance to the transponder 136. When the sound source is a point source, the calculation is not straightforward, but if the sound source is far from a distance between the acoustic elements, the azimuth, and range of the sound source are relatively simple as described in the FIG. 37. The acoustic ranging uses the same principle as the active sonar.

But (1) it is not necessary to create a target image,

And (2) it is possible to install a transponder on the target,

(3) It is intended to guide own position directly above or below the target,

(4) The precise positioning of the target is by the optical navigation.

Due to these reasons, it can be simplified and low powered.

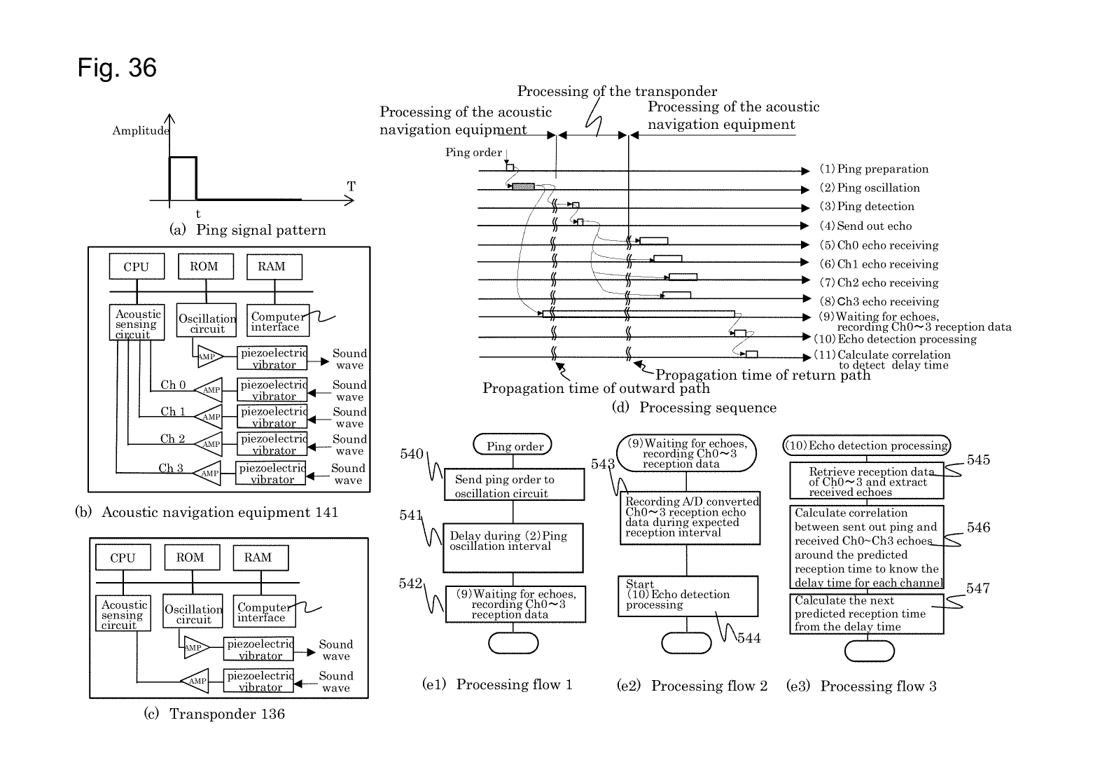

FIG. 36 shows the configuration and operation of the equipment used in acoustic navigation. The piezoelectric vibrator of the acoustic navigation equipment shown in the FIG. 36(b) is a piezoelectric ceramic widely used in the active sonar as the acoustic sensors A to D 132 to 135 and the acoustic oscillator 131 and applies a constant frequency voltage of the vibration signal pattern of FIG. 36 (a) to the piezoelectric vibrator to generate sound waves.

In FIGS. 36 (b) and 36 (c), acoustic sensing and acoustic oscillation are by another piezoelectric element but can be common.

FIG. 36 (b) shows the acoustic navigation equipment which resides in the Deepsea Crane 001 and the transponder in FIG. 36 (c) exists on the surface mothership 016 and the Seafloor Station 018. The operation of acoustic navigation is as described in the processing sequence (c), and the acoustic navigation equipment performs (2) signal oscillation by the ping command from the navigation control system. After the forward propagation time, the transponder detects (3) the ping and immediately (4) sends out an echo. After the return propagation time (5)-(8) Ch0 to Ch3 echo receptions are performed by the acoustic navigation equipment 141. The received signal is recorded immediately after the reception (9), then data of Ch. 0-3 is recorded. The correlation between the recorded response data and the transmitted ping signal is carried out in (10) (11), and the propagation delay time by the acoustic sensor is determined. (10)

FIG. 37 is a flowchart showing the operation of an acoustic navigation system using acoustic navigation equipment. The processing block 550 in FIG. 36 calculates the round trip sound propagation delay of each of the acoustic sensors A, B, C and D by the processing block 546, and the processing block 551 calculates the distance to the target by the average delay time between each sensor and the target.

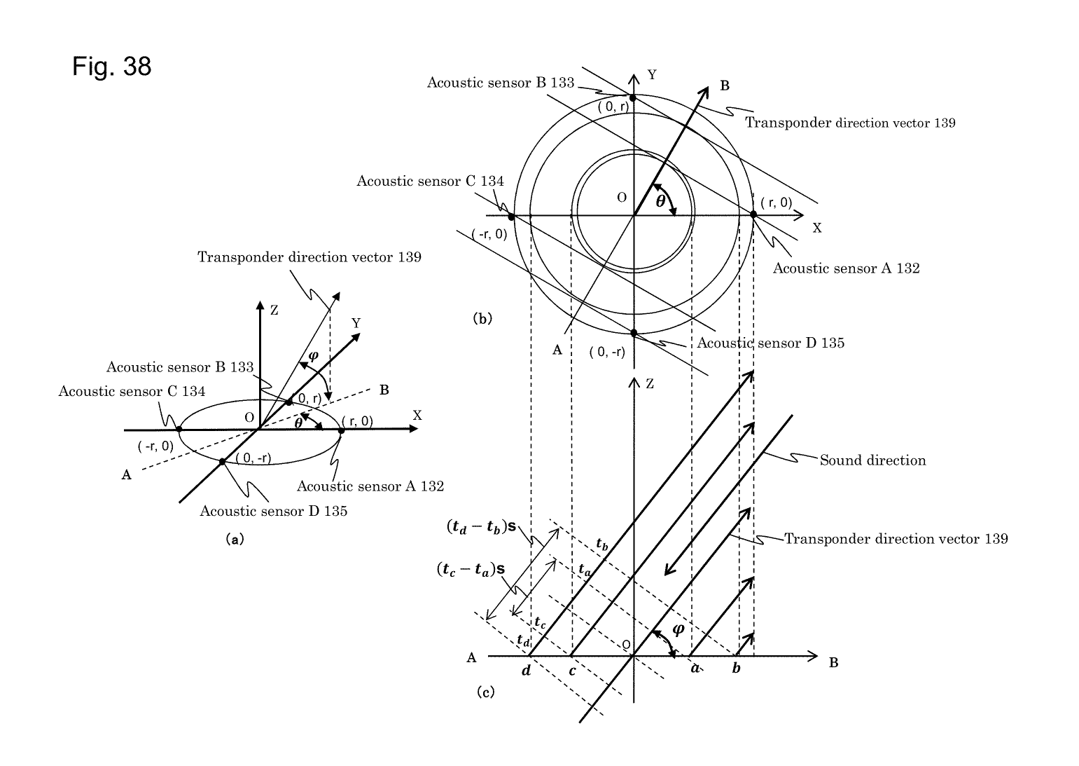

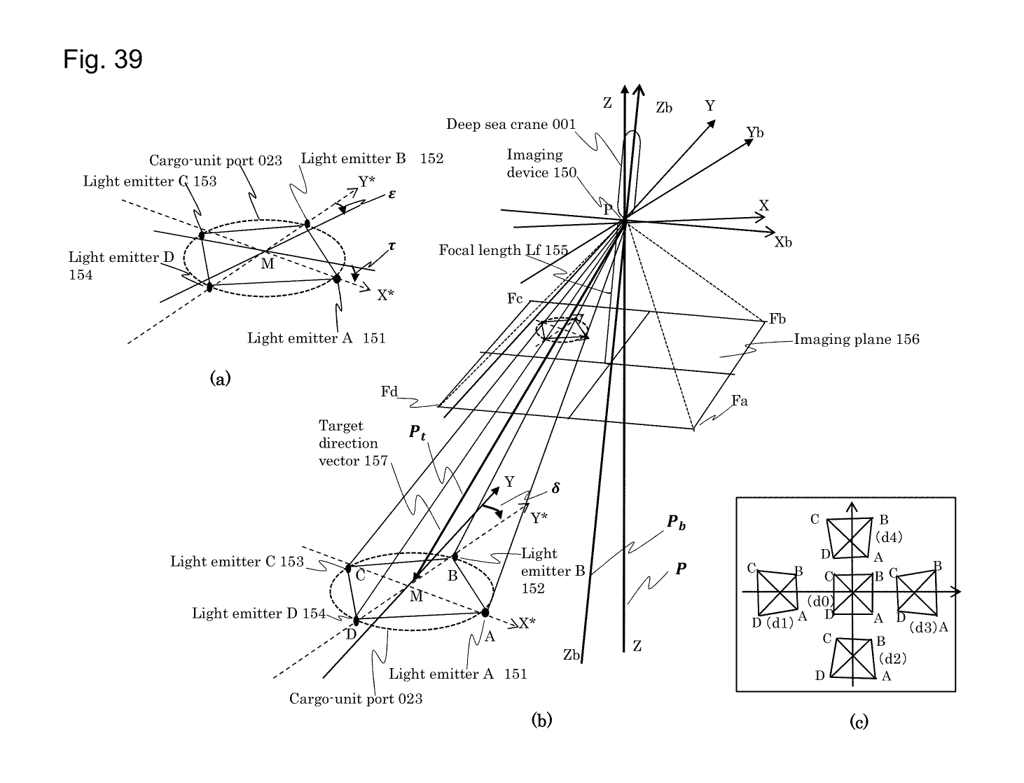

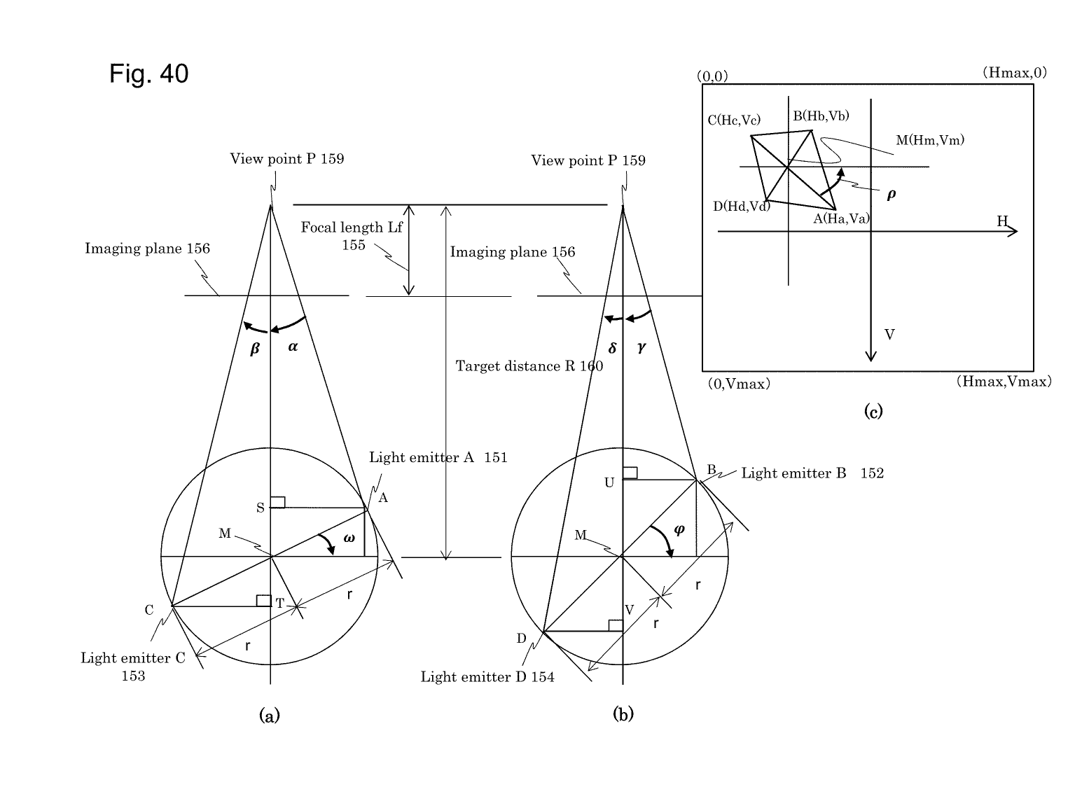

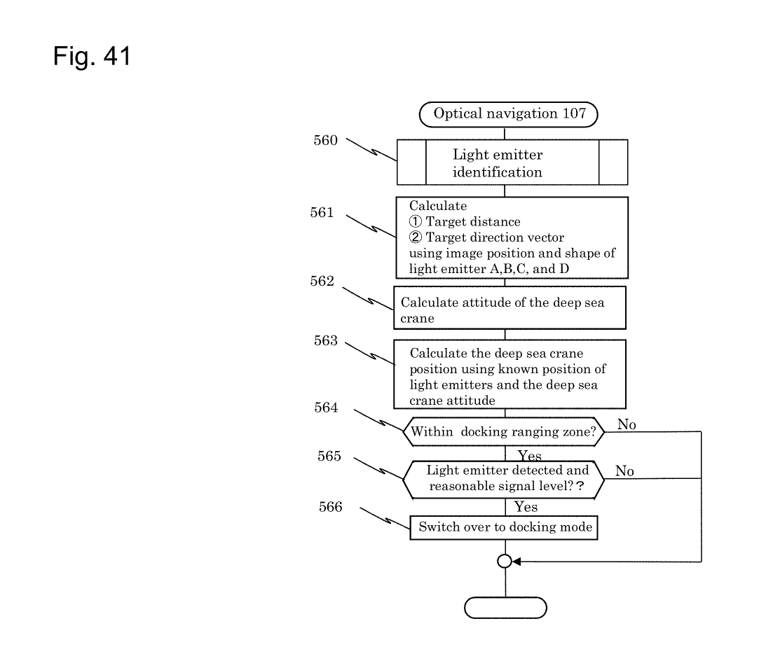

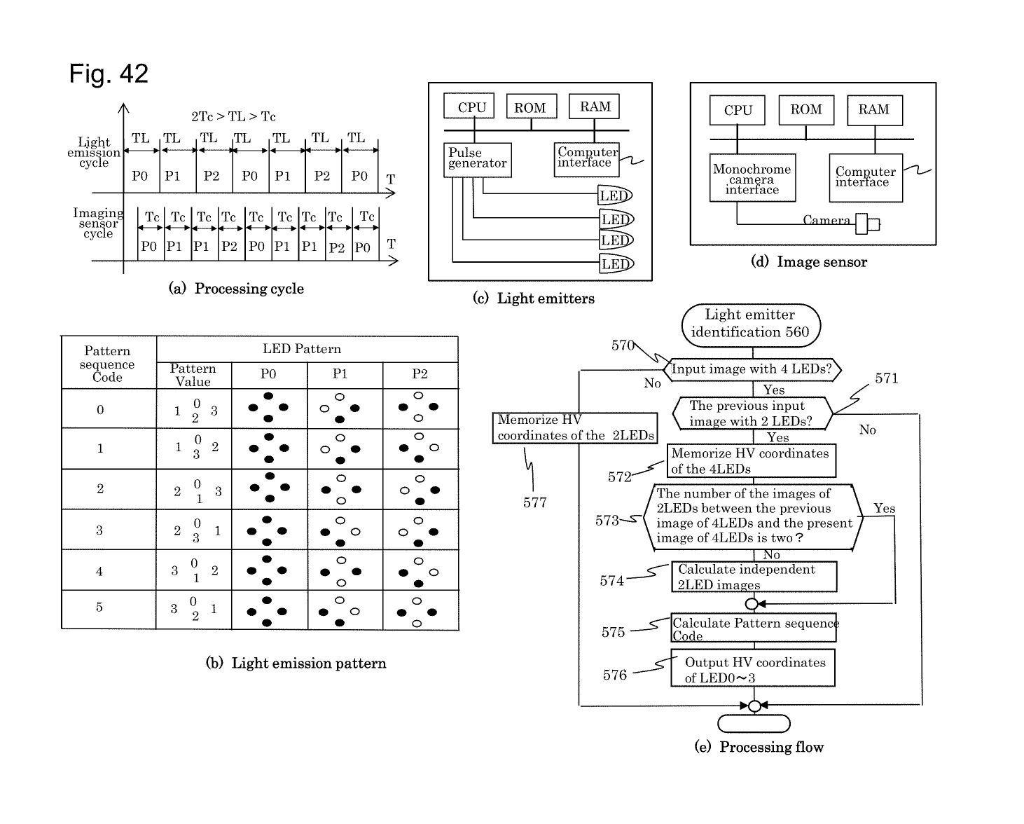

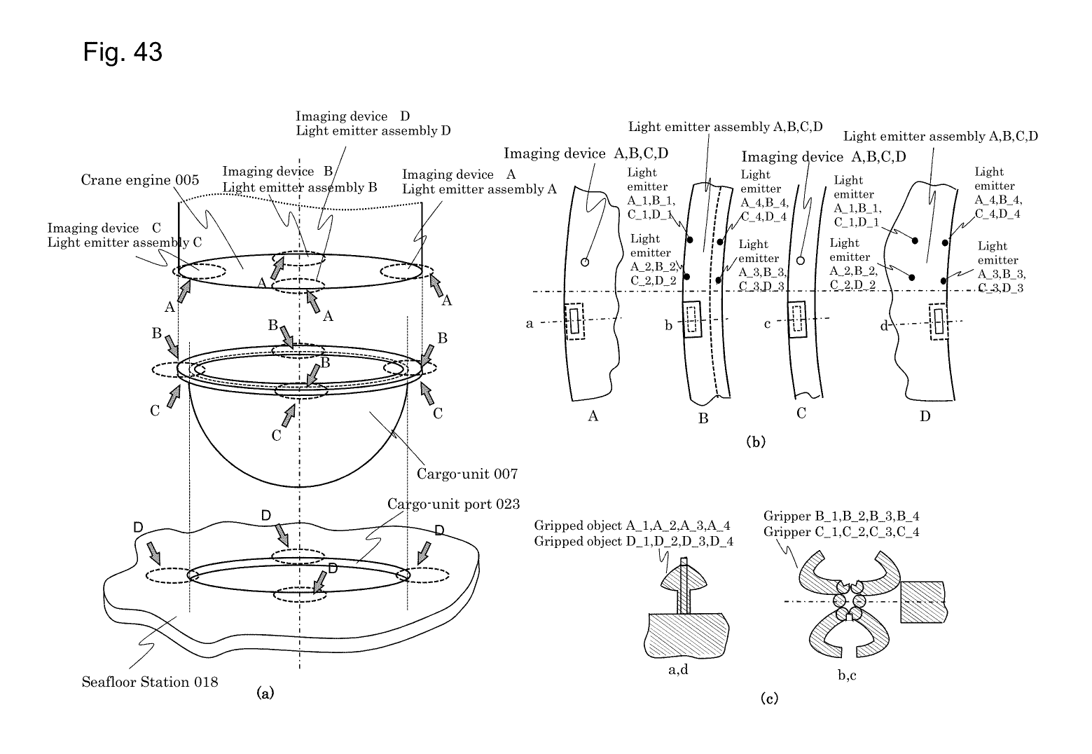

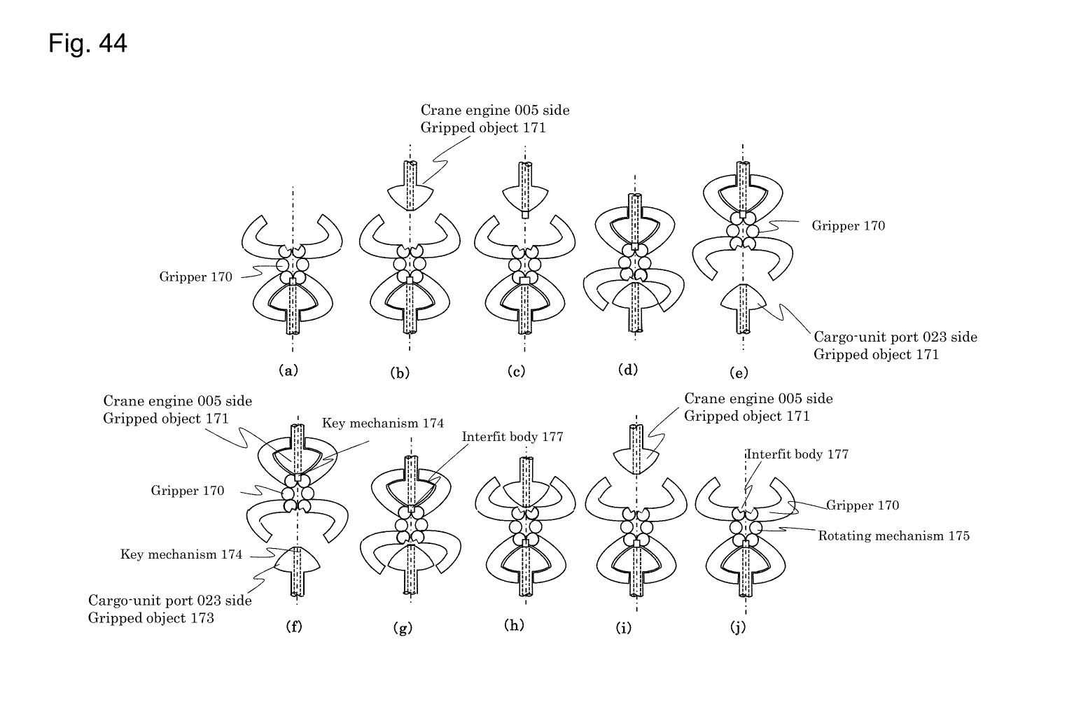

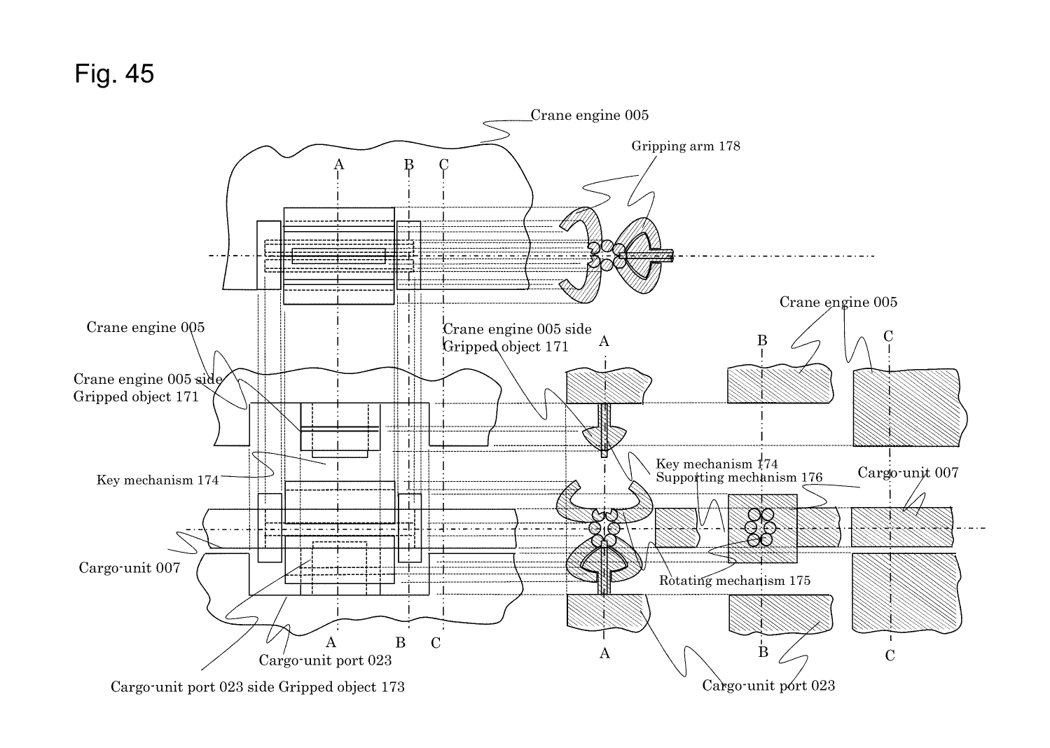

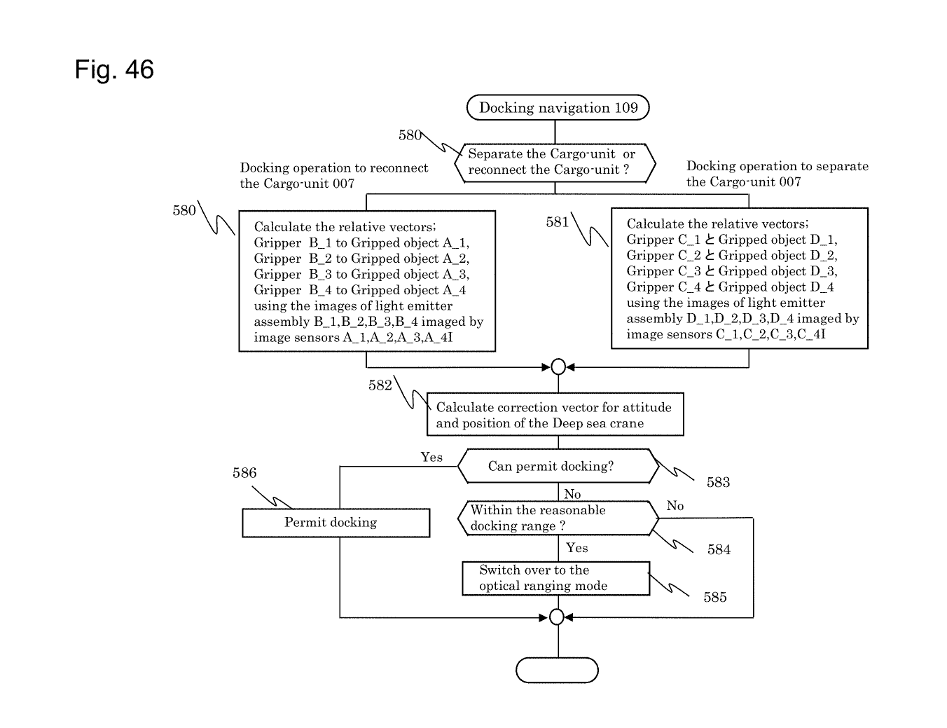

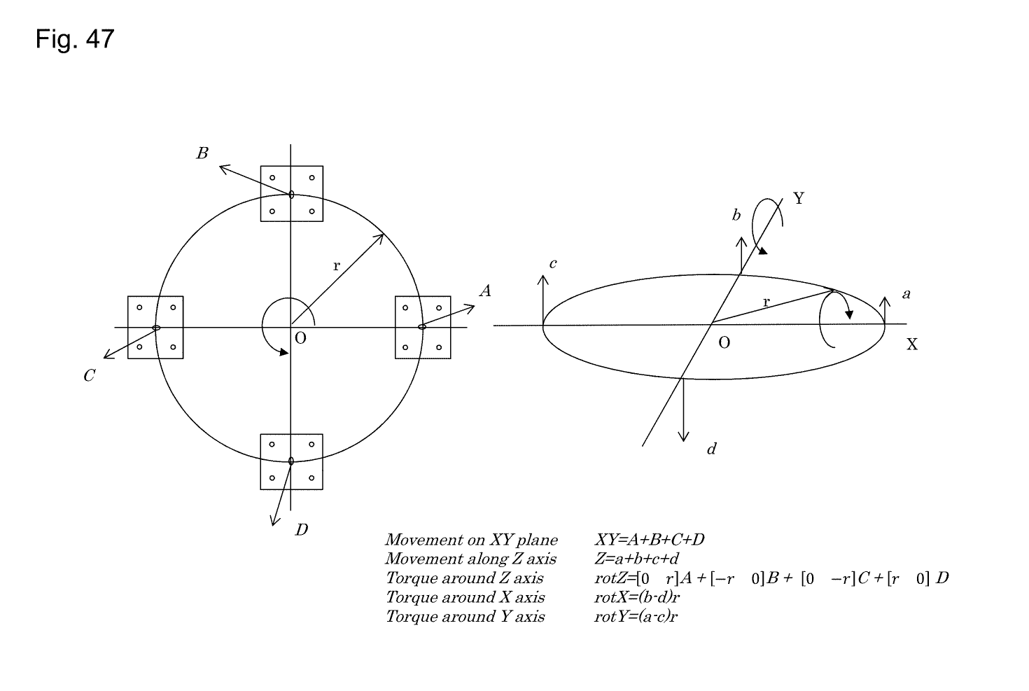

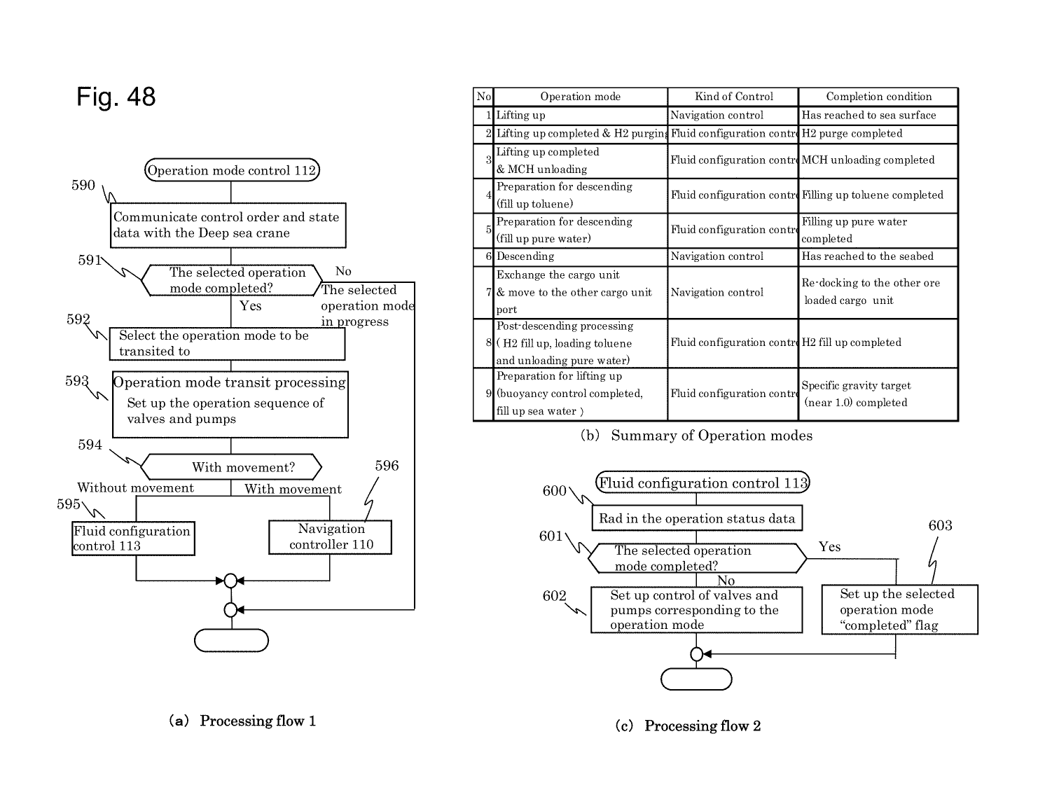

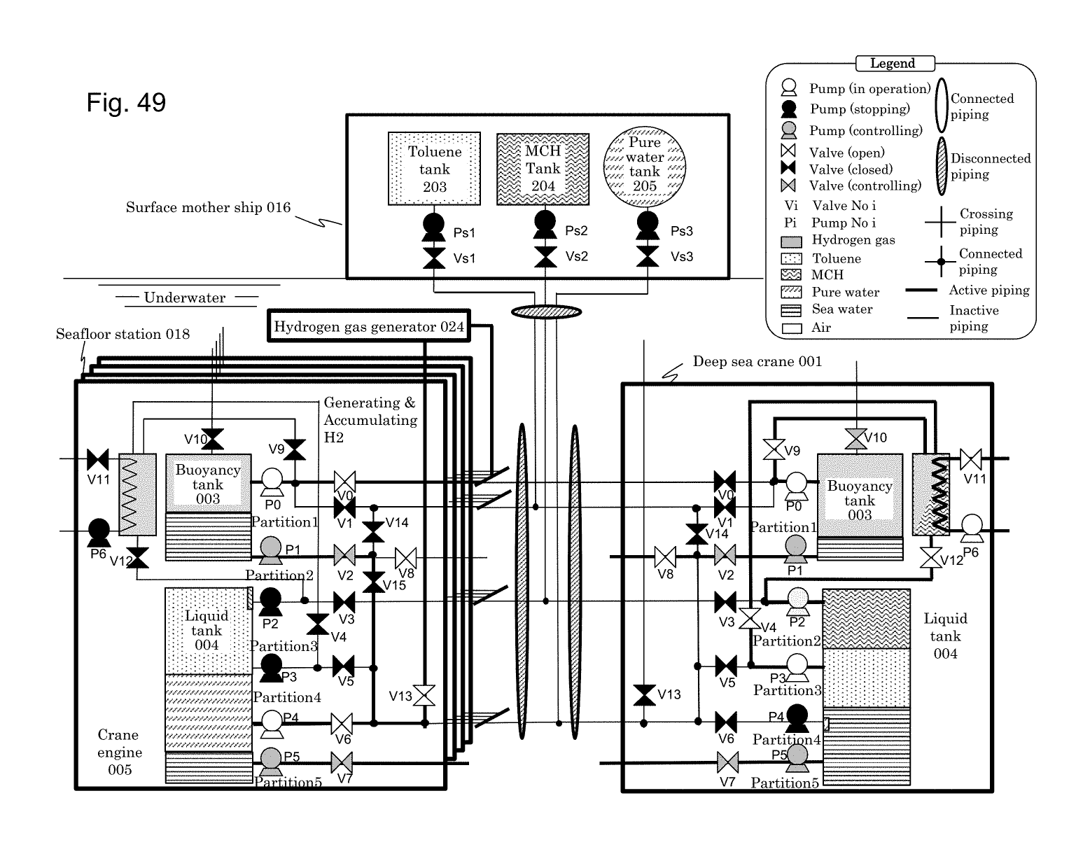

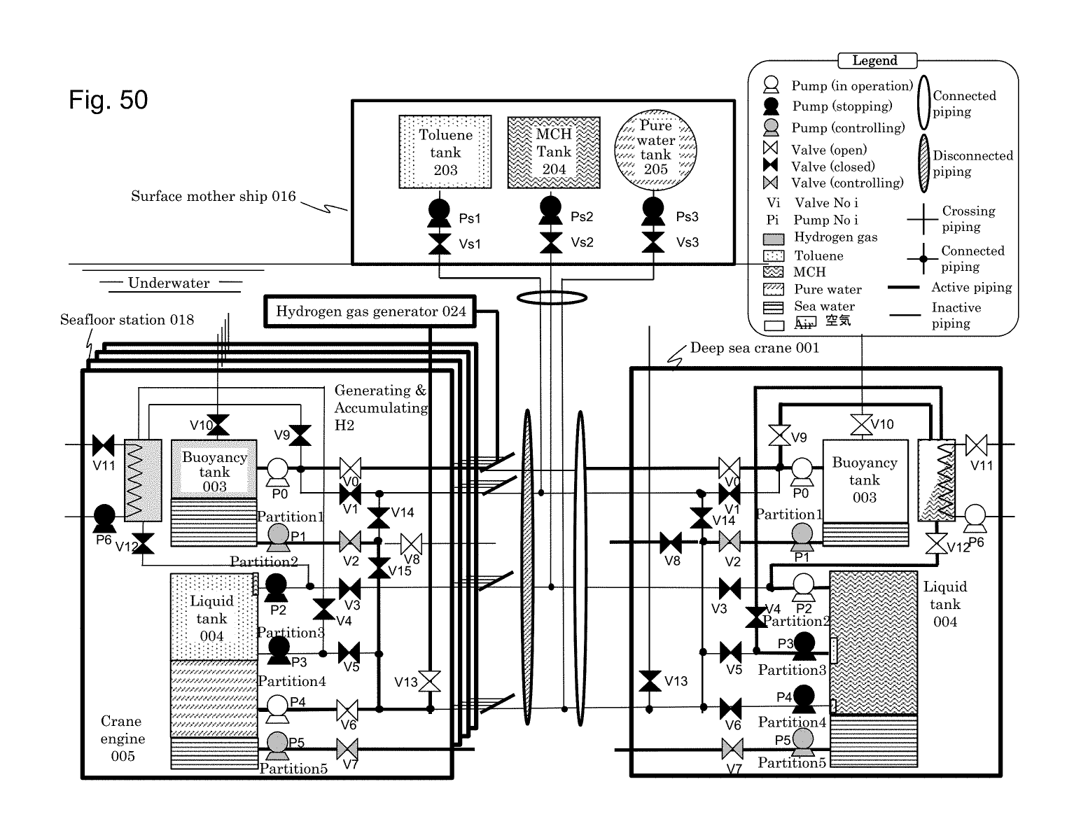

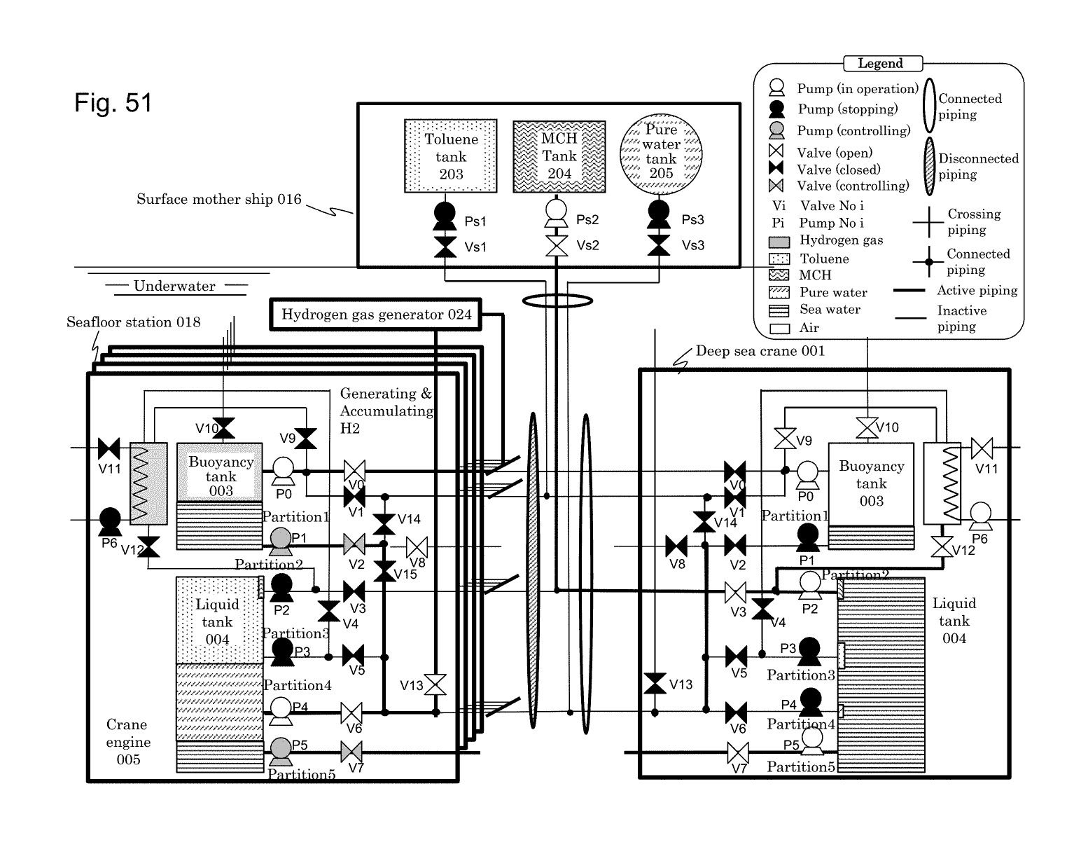

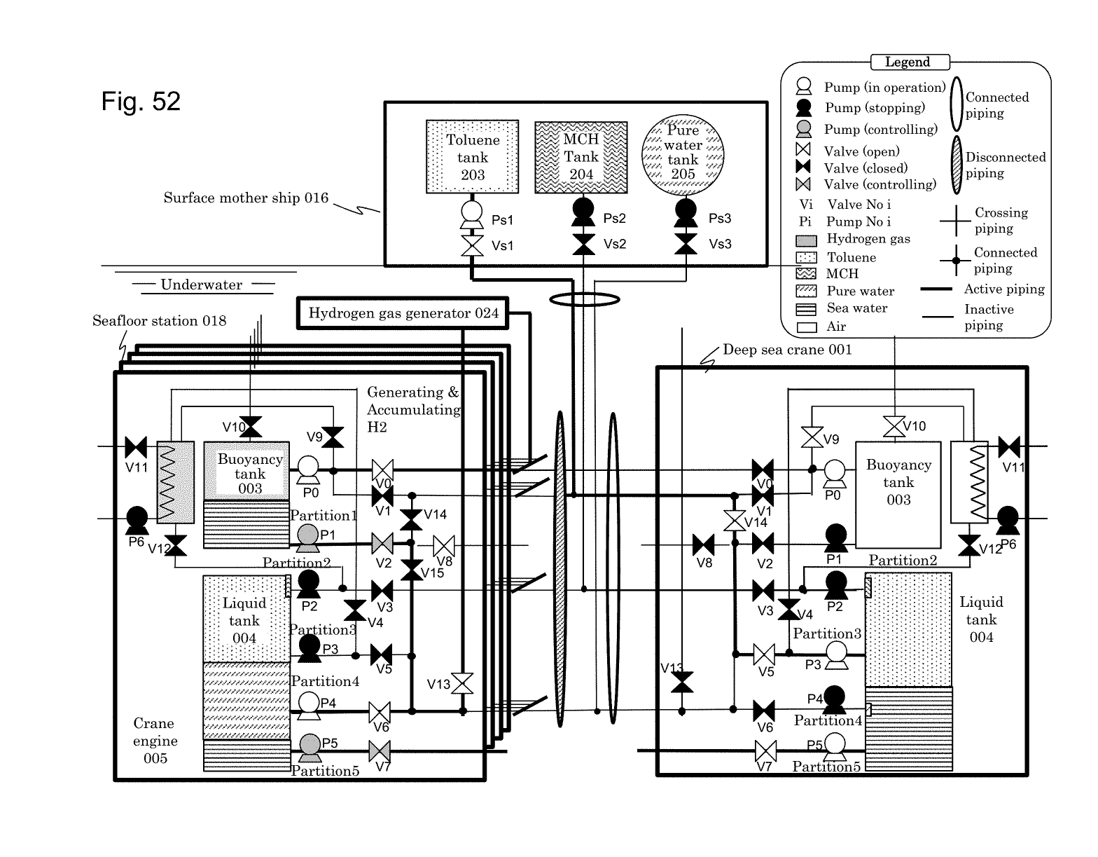

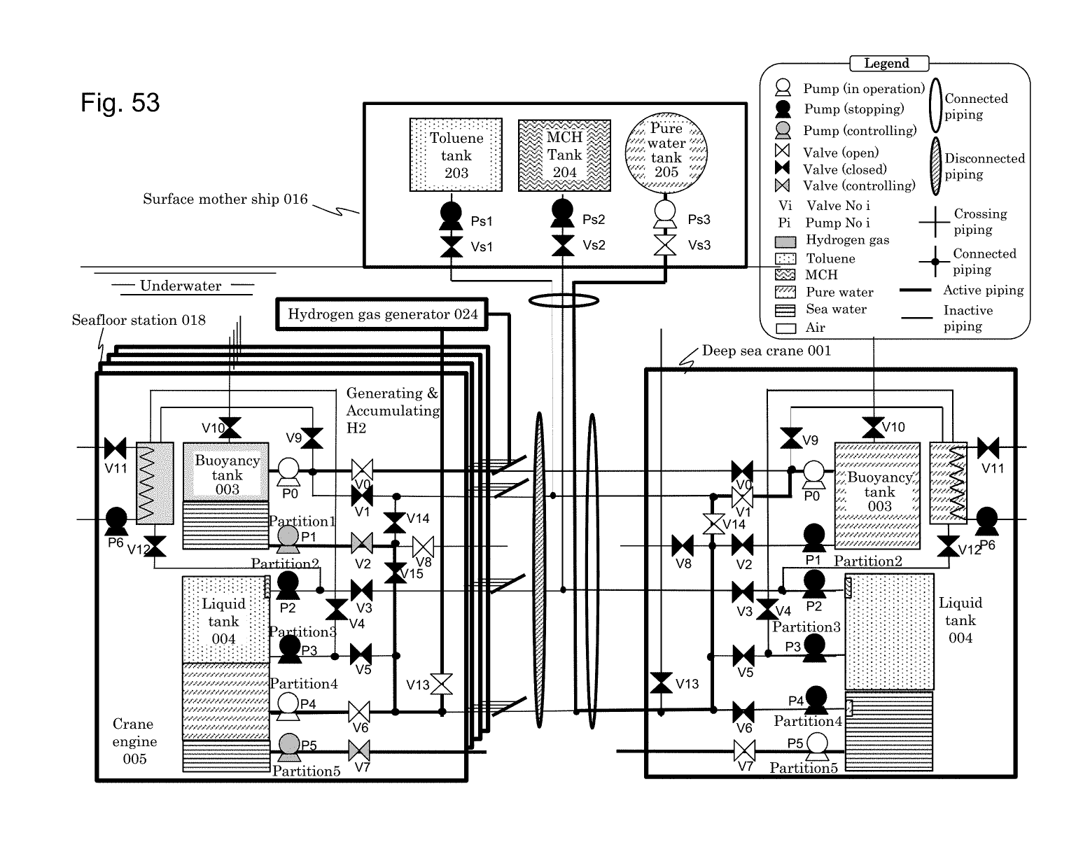

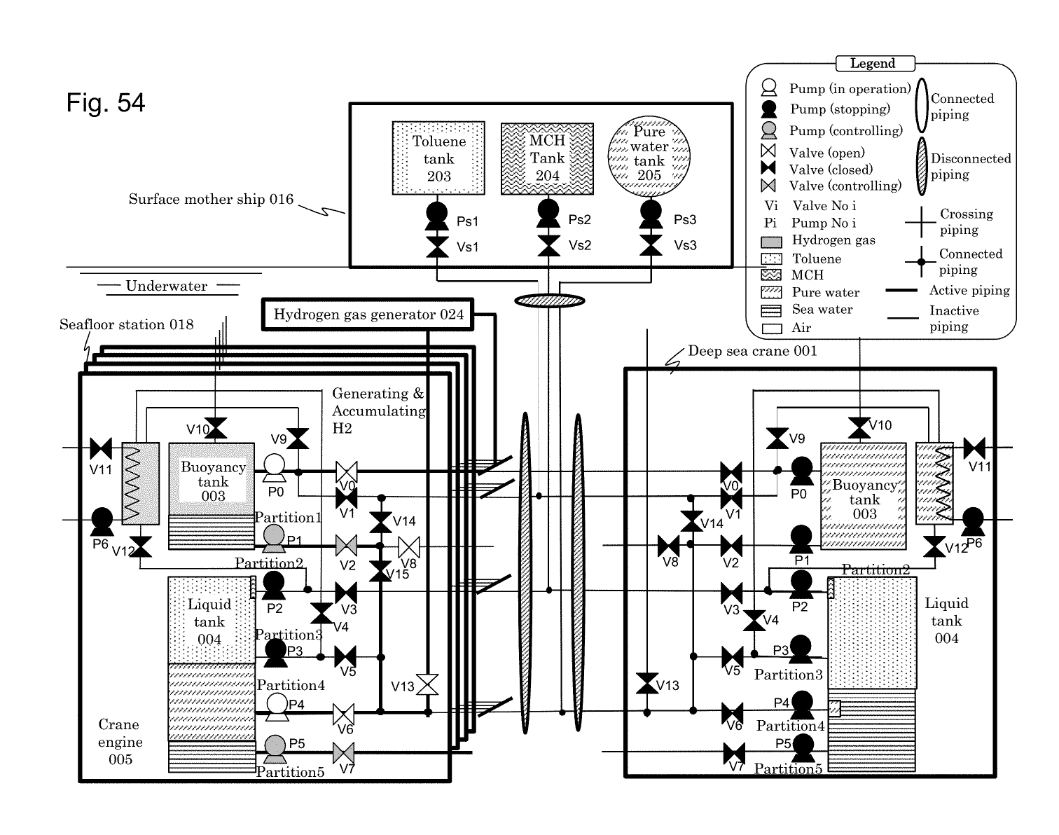

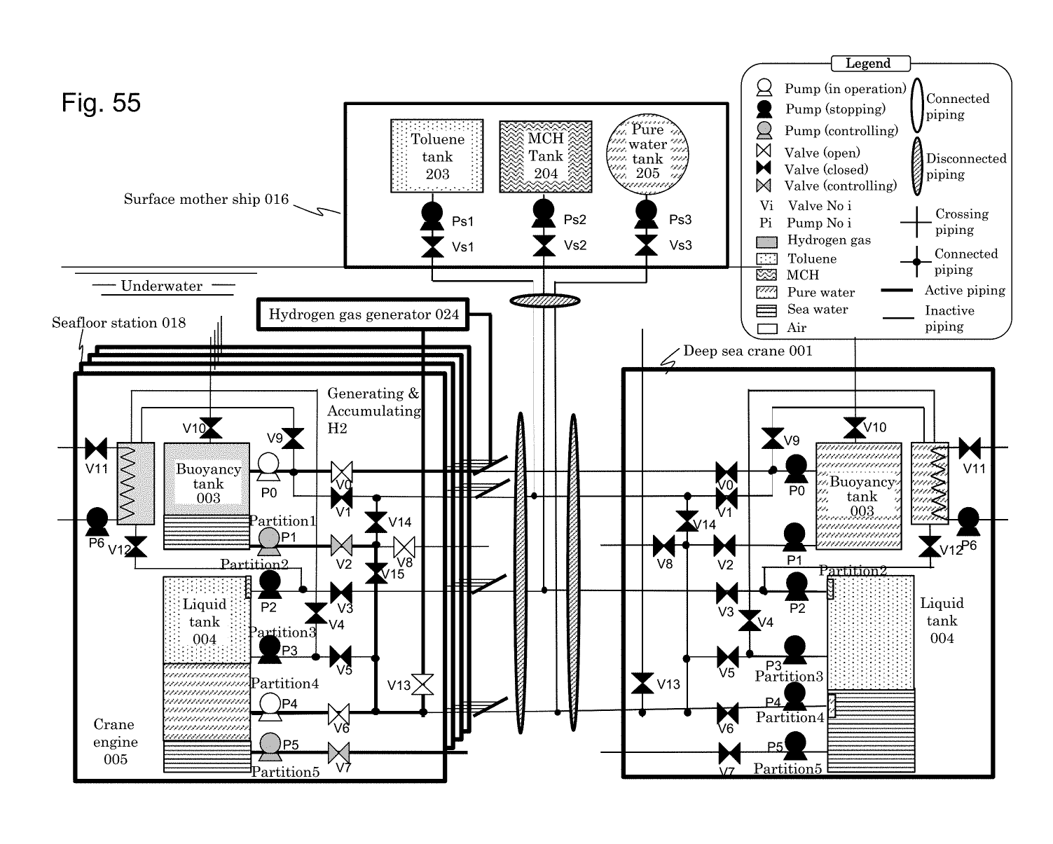

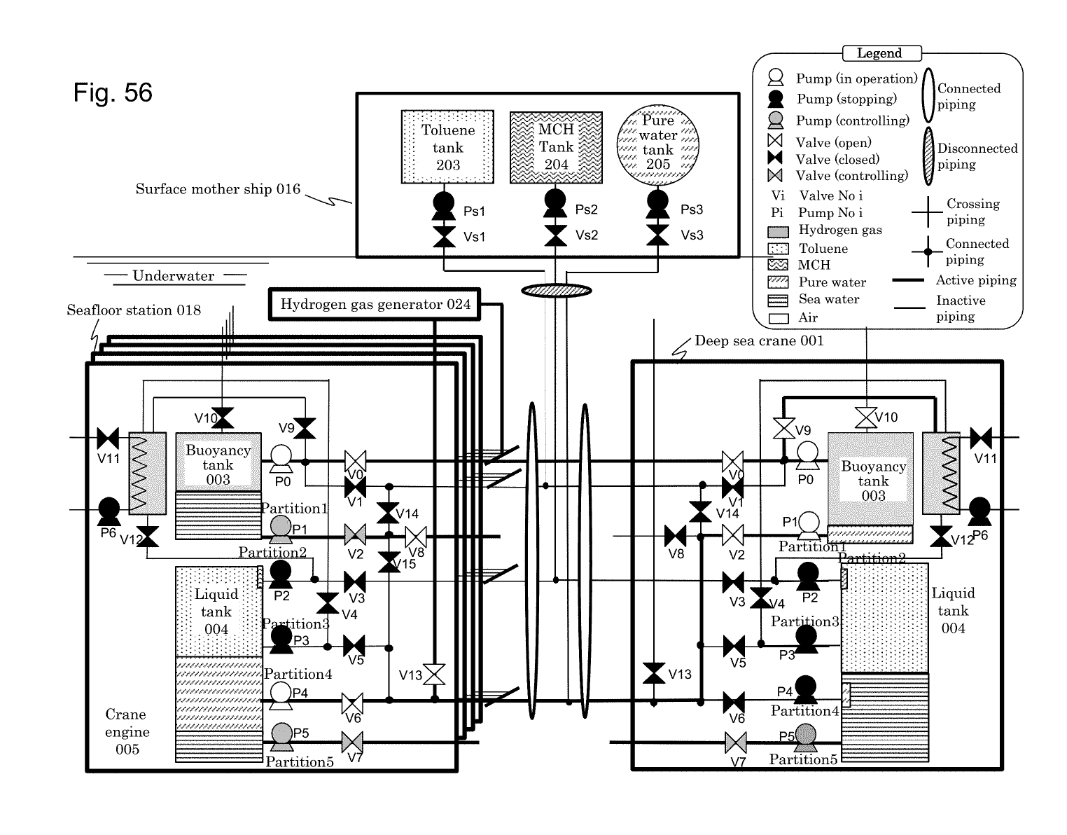

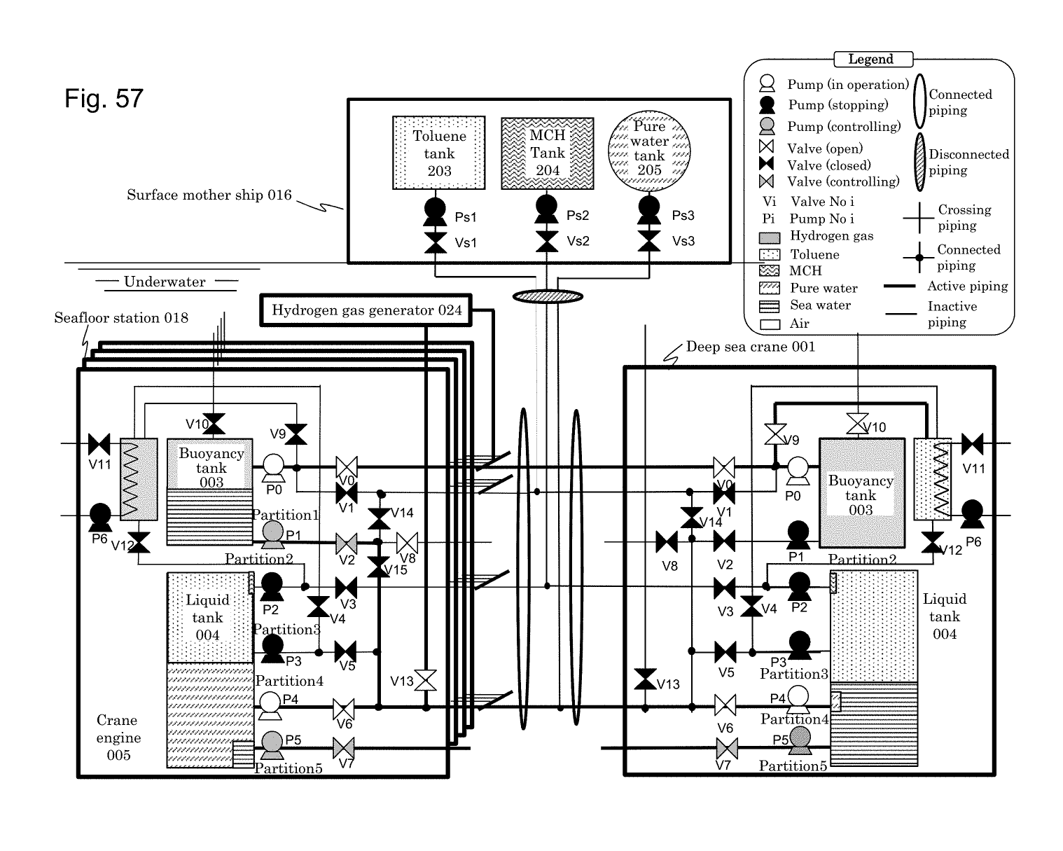

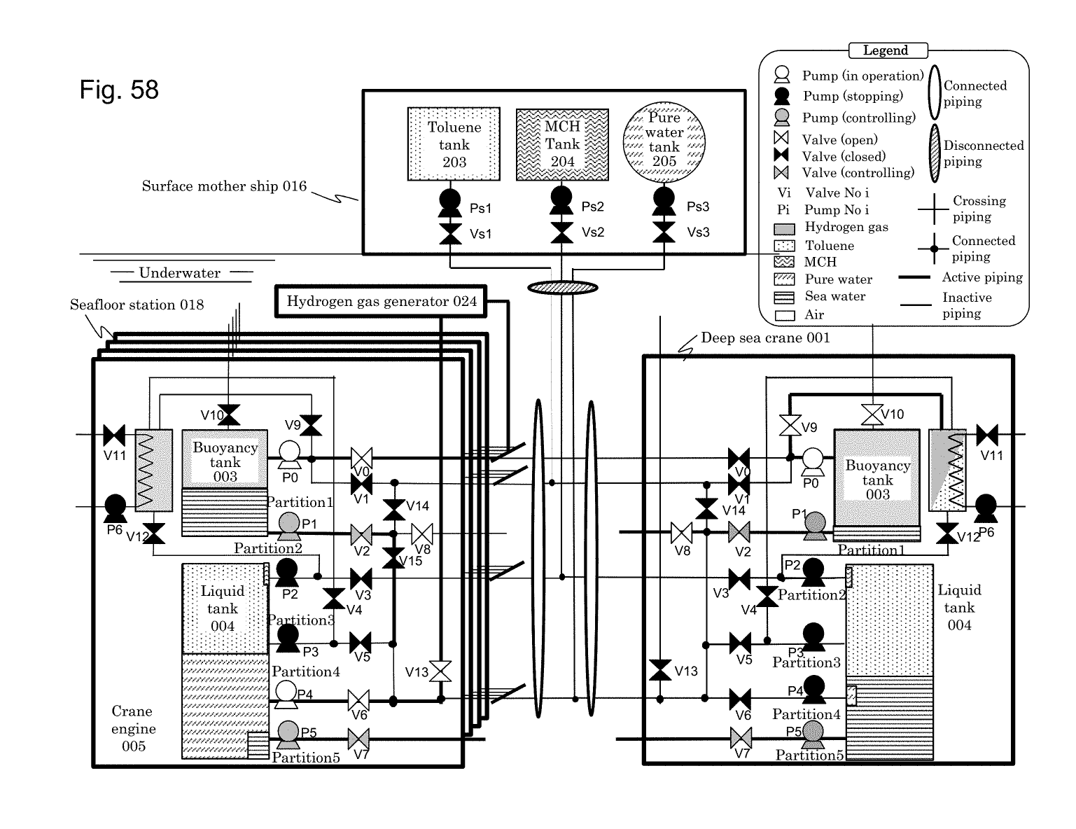

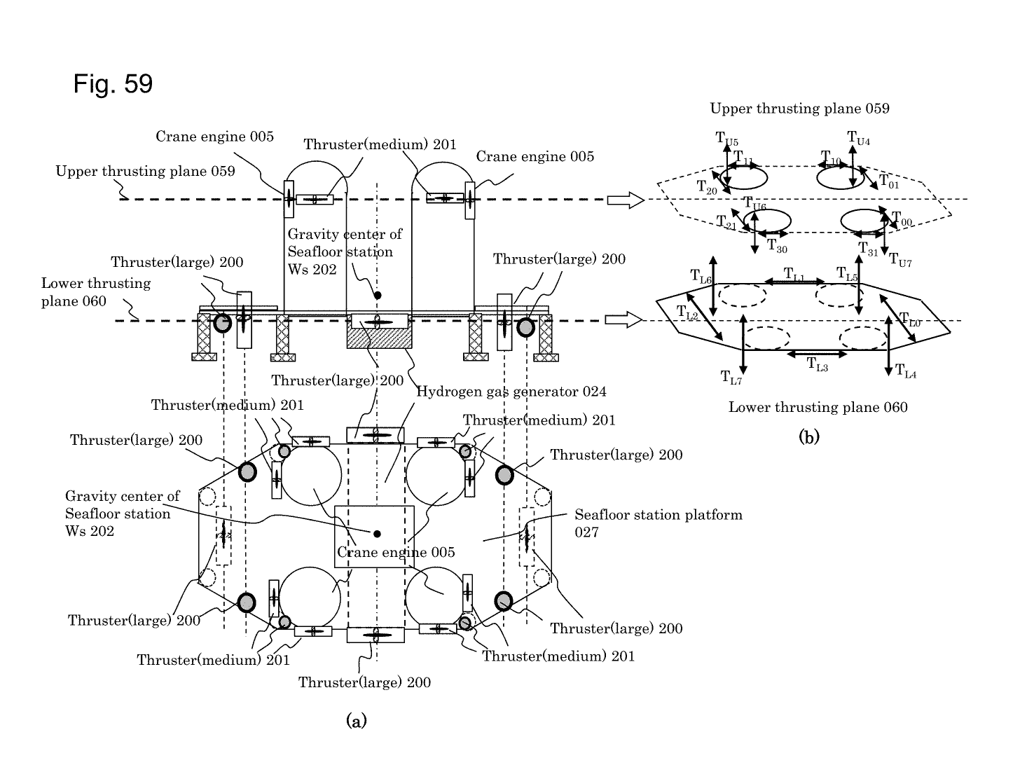

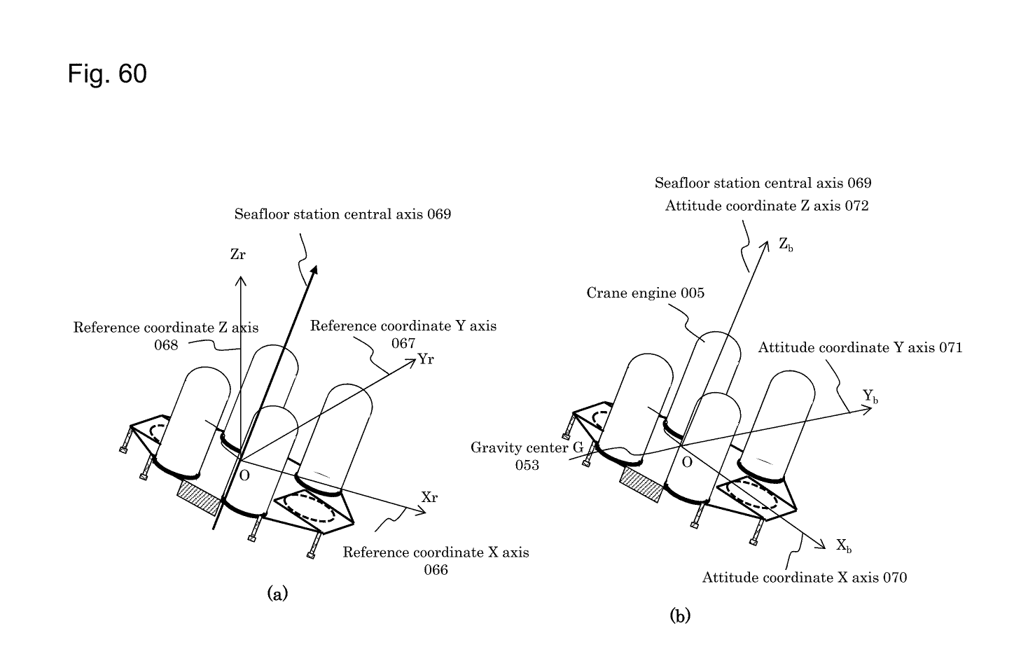

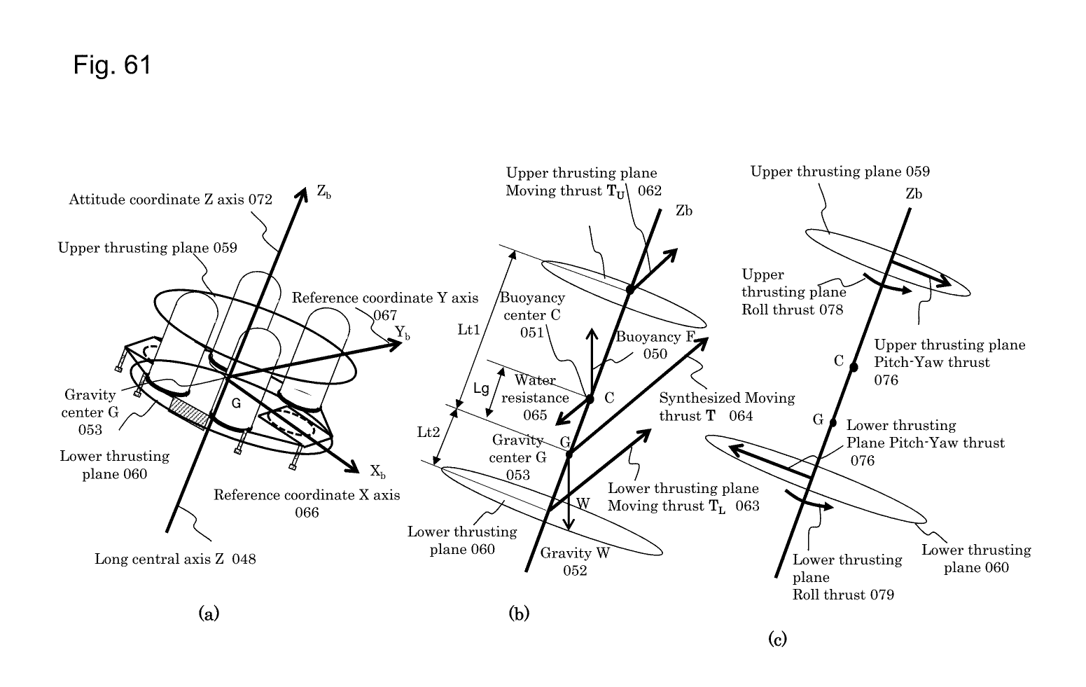

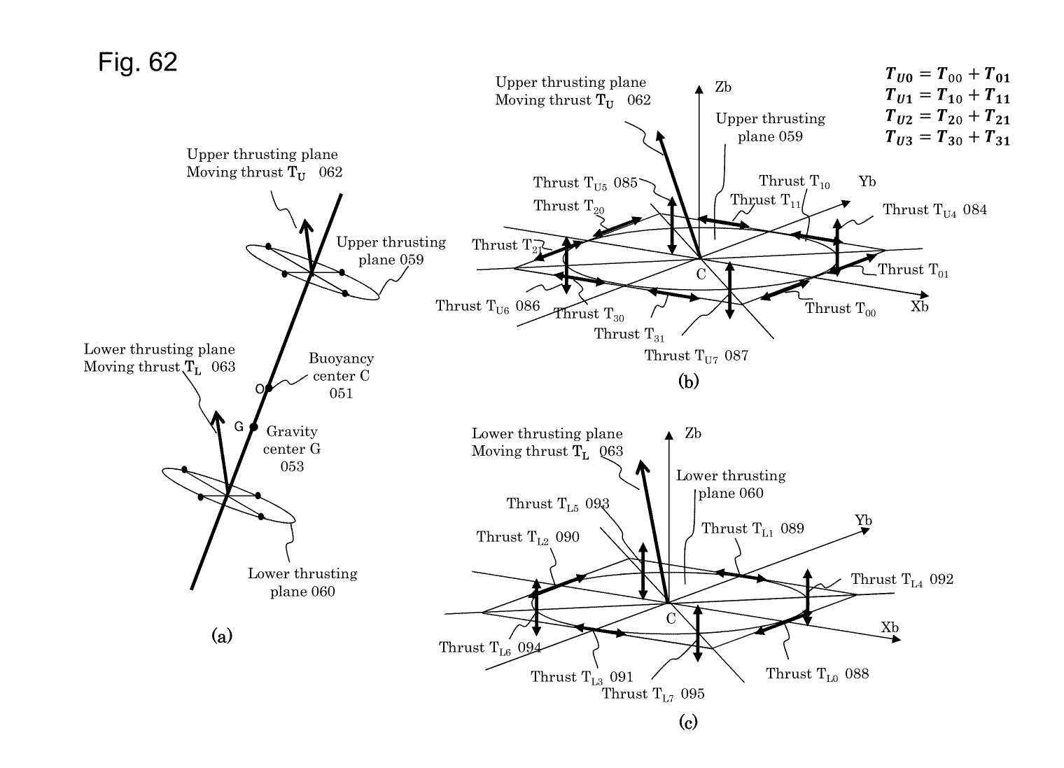

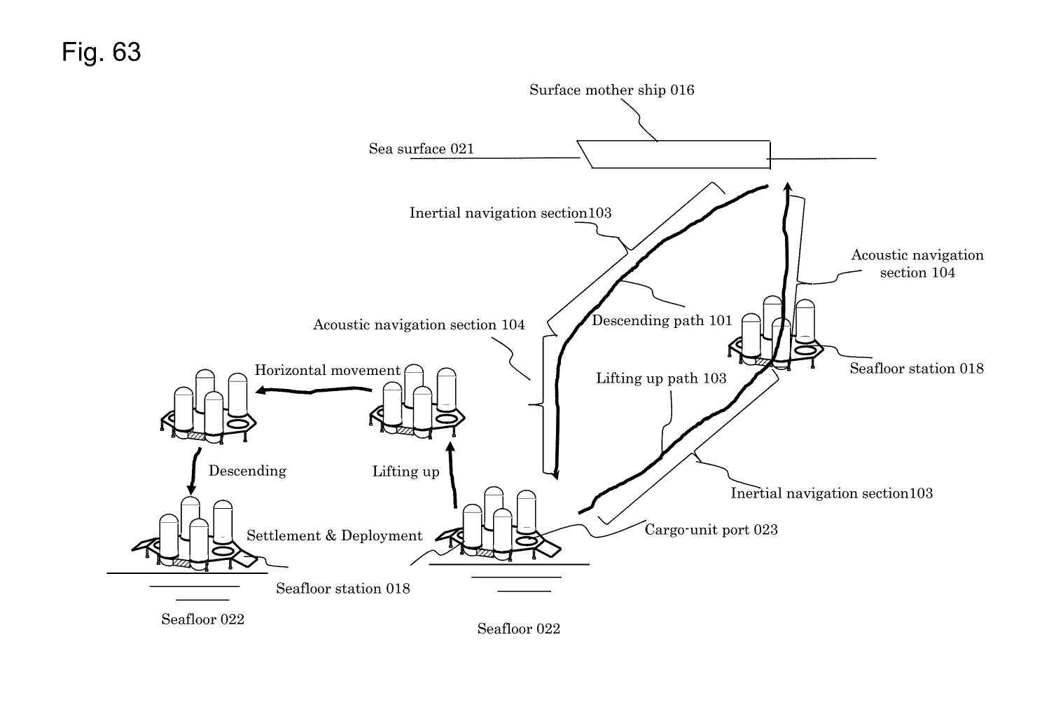

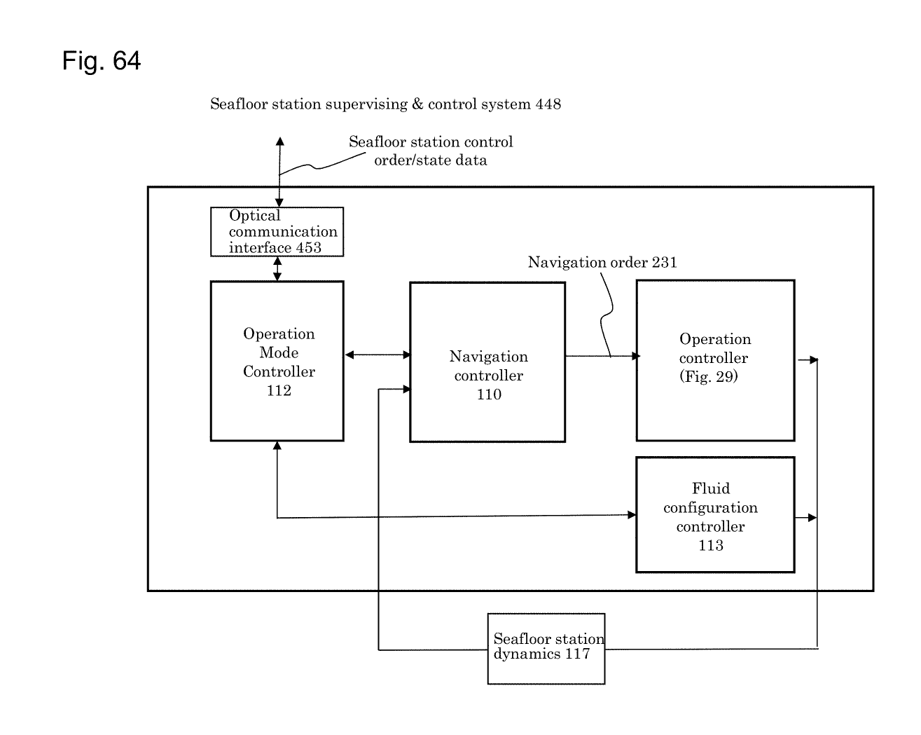

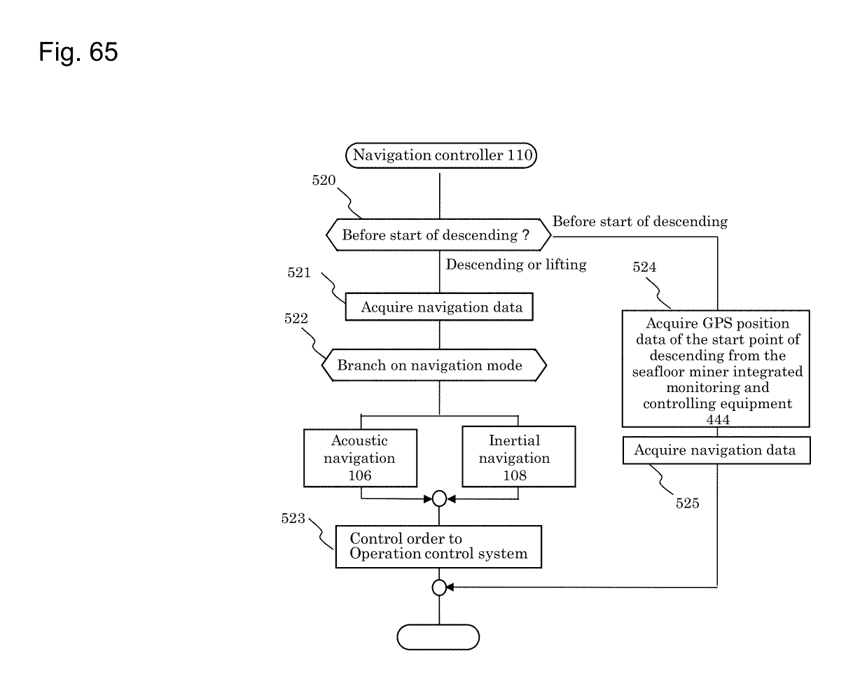

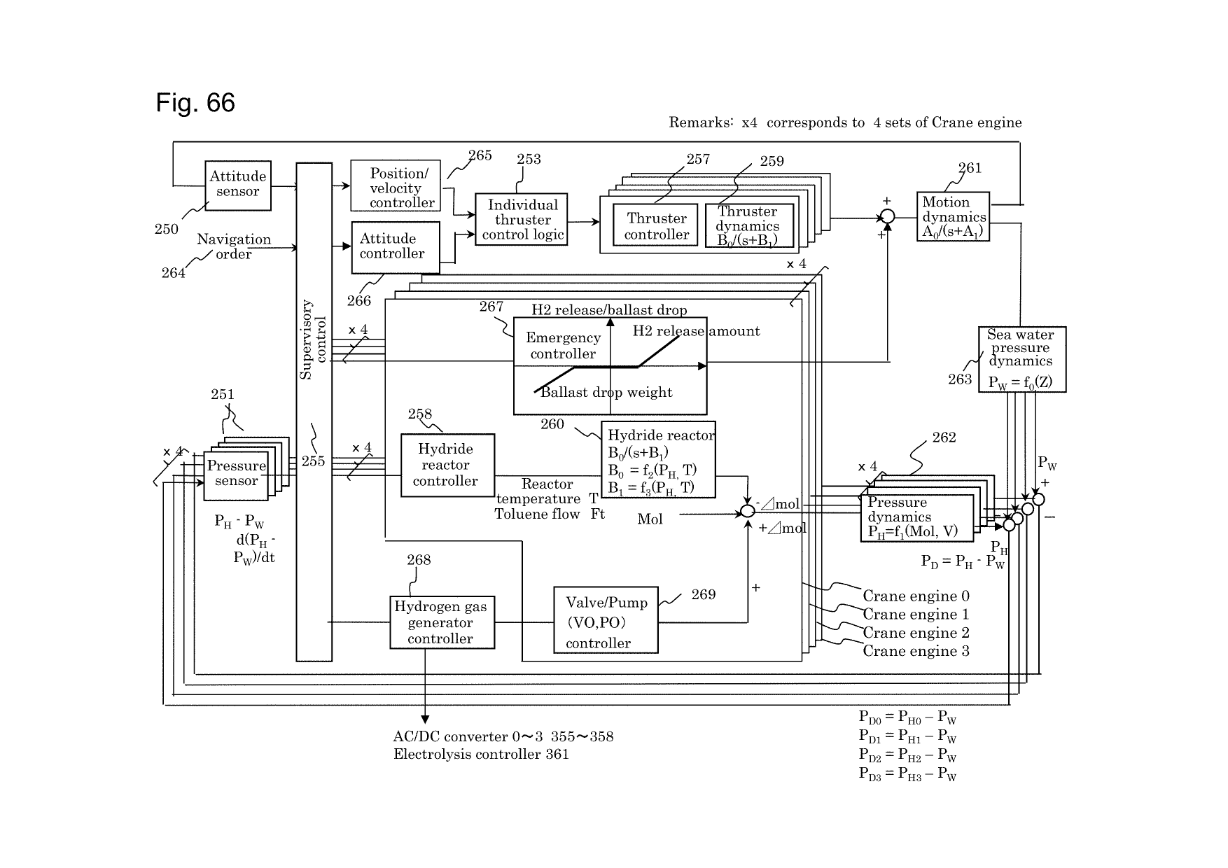

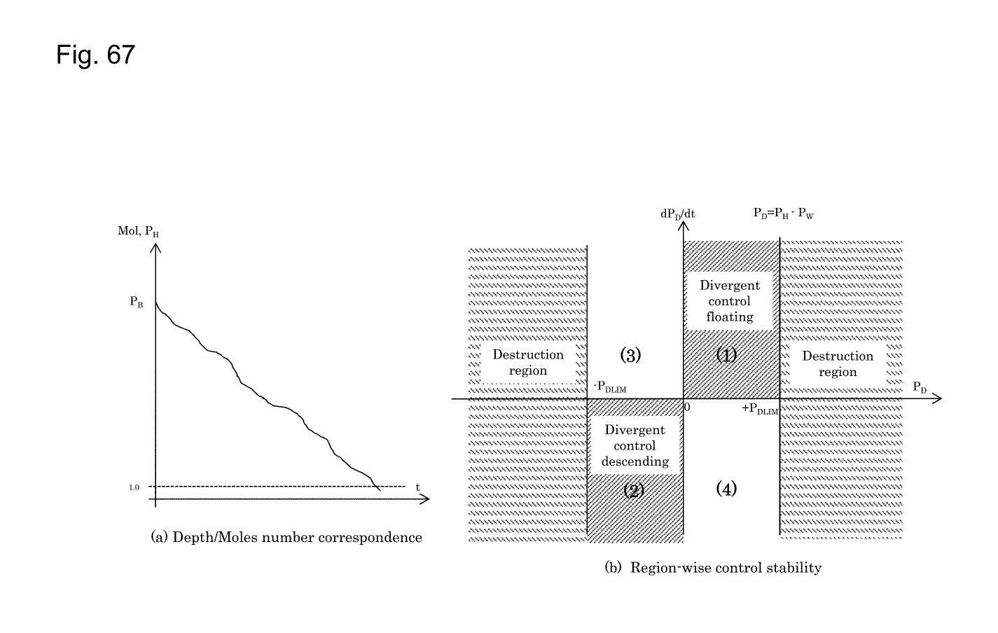

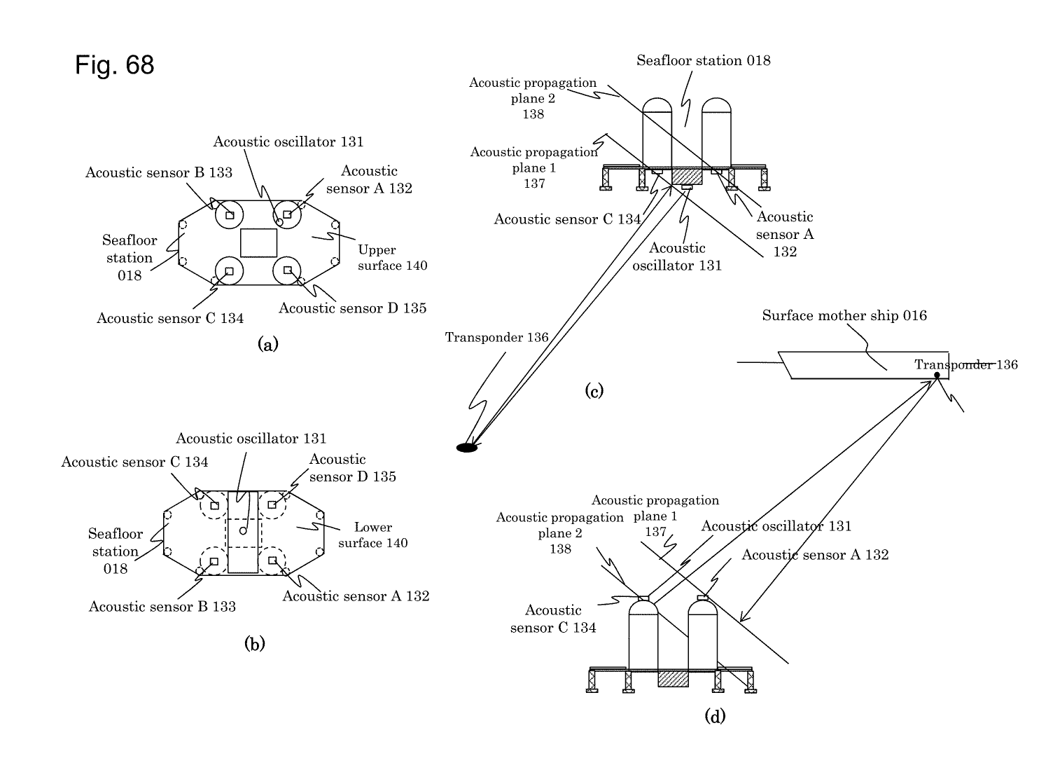

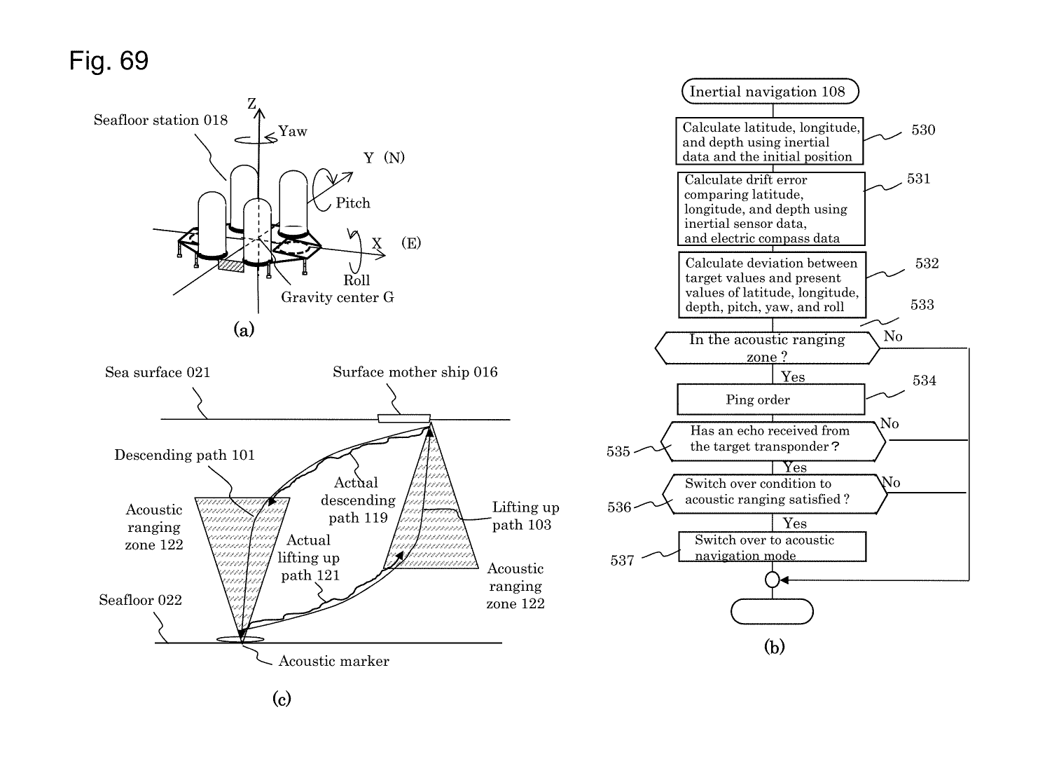

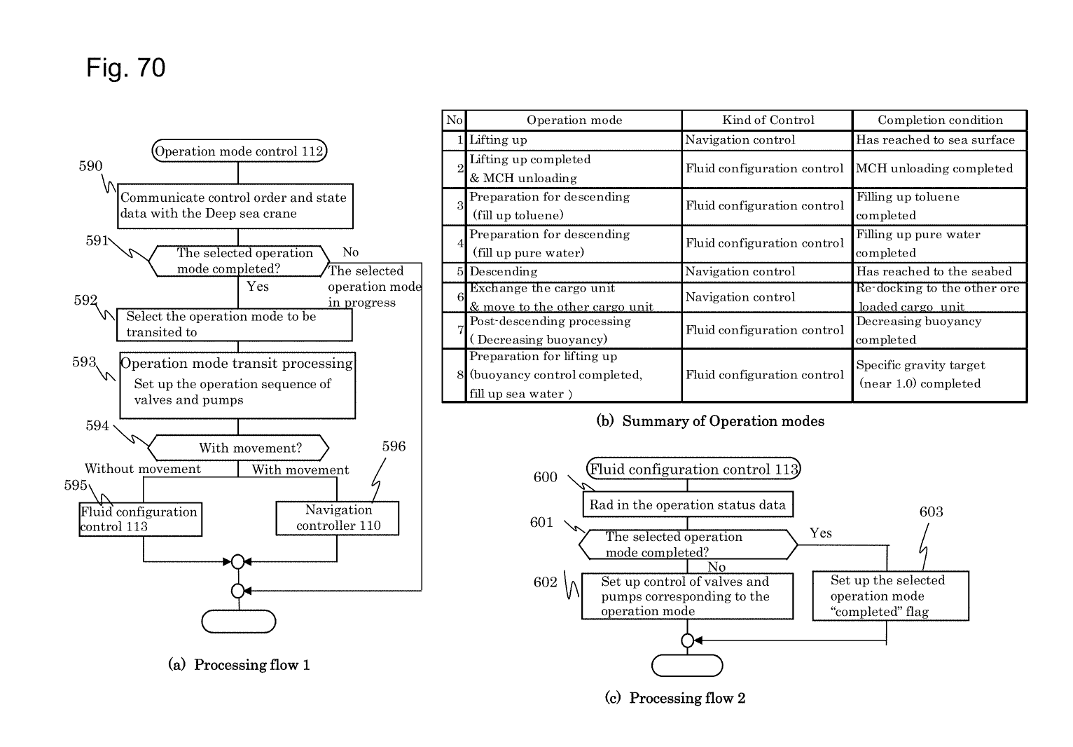

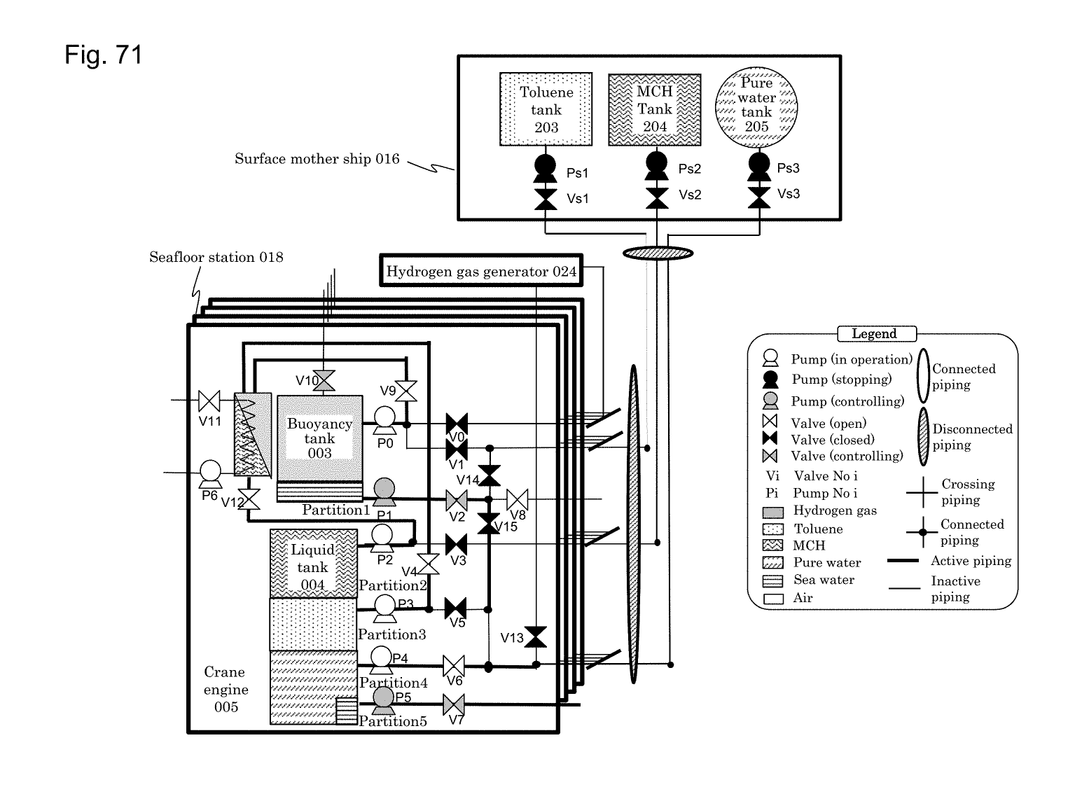

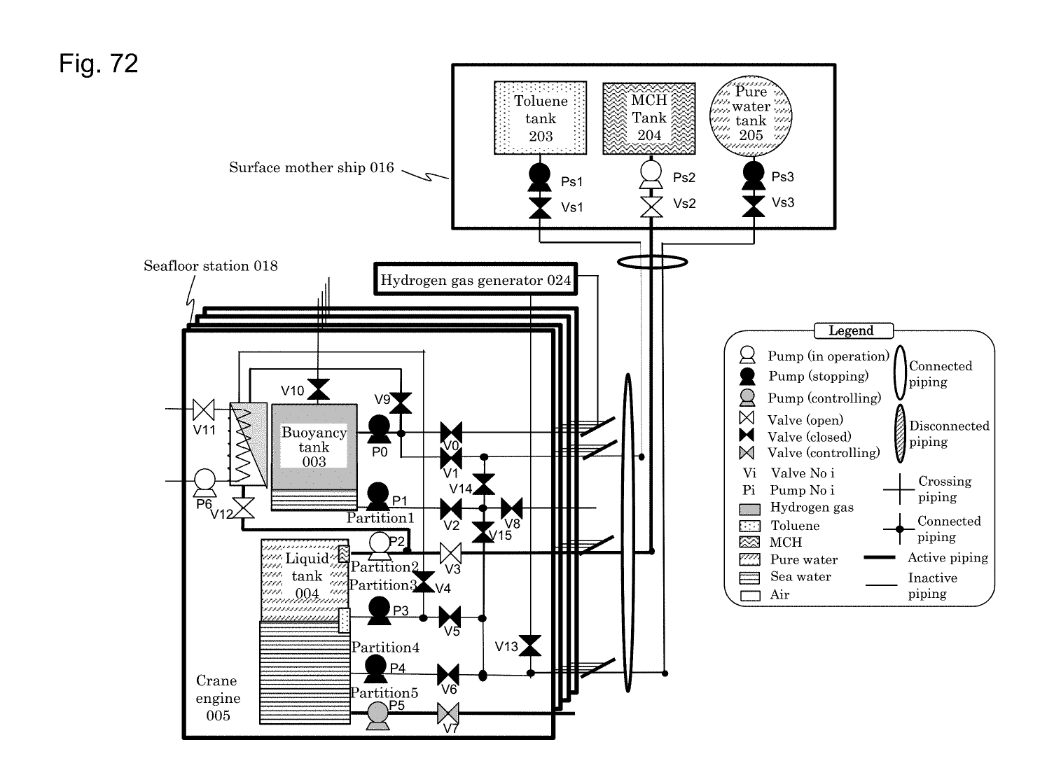

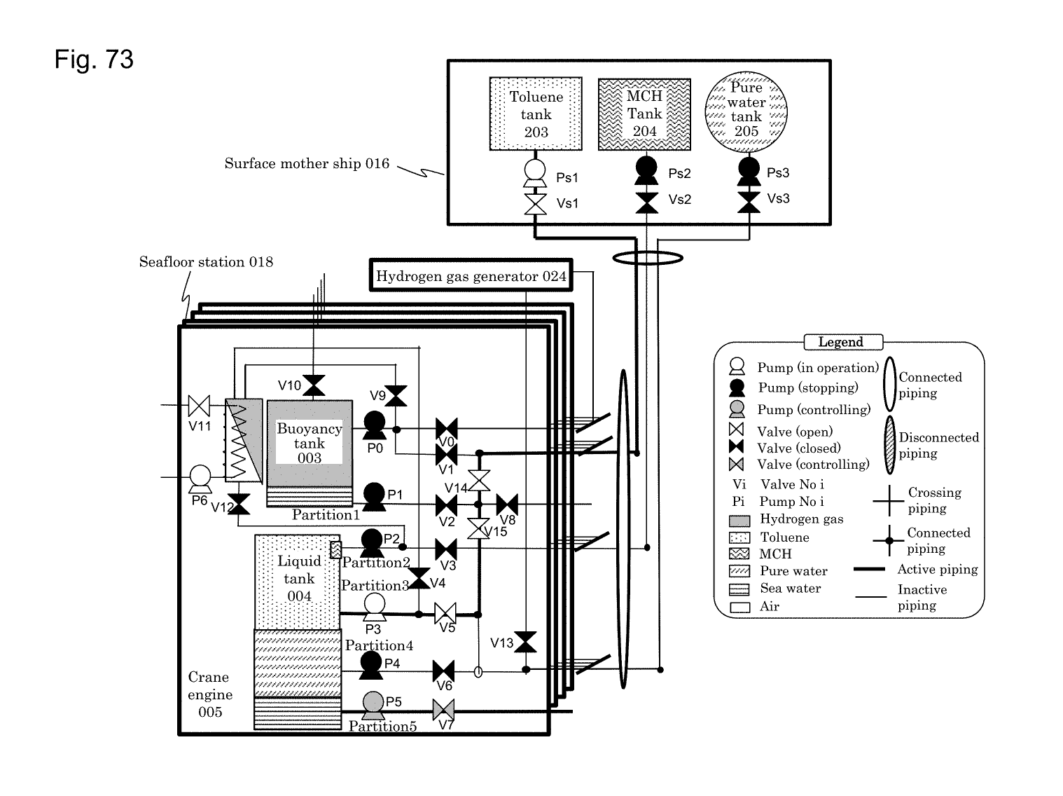

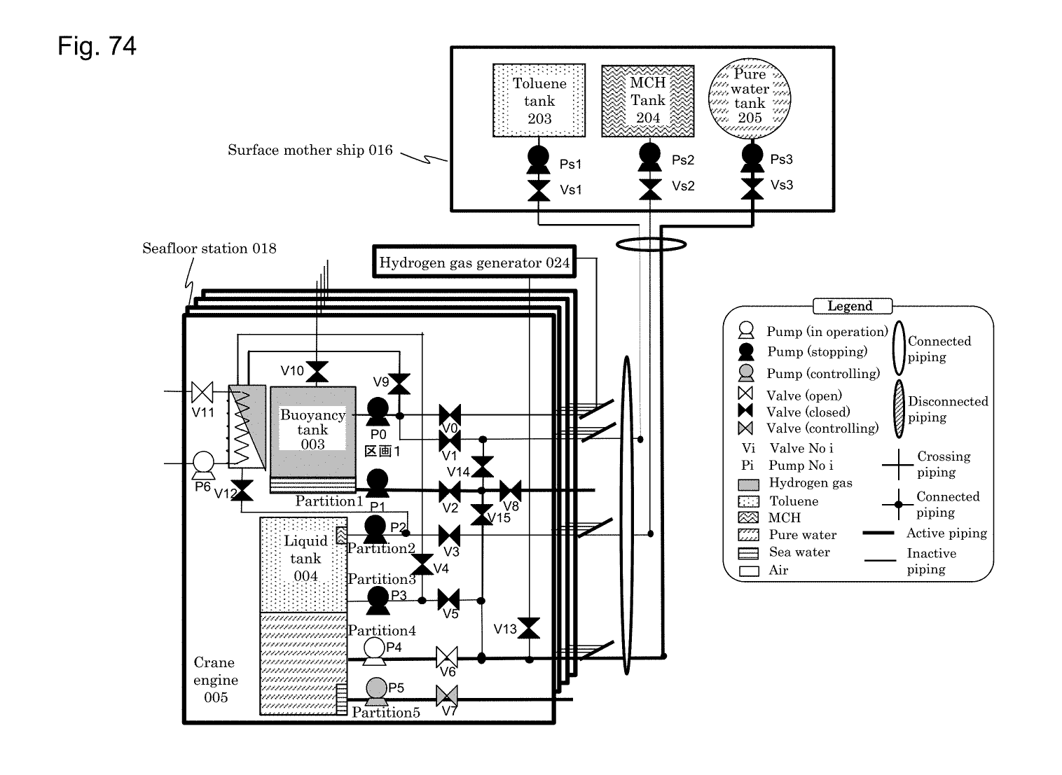

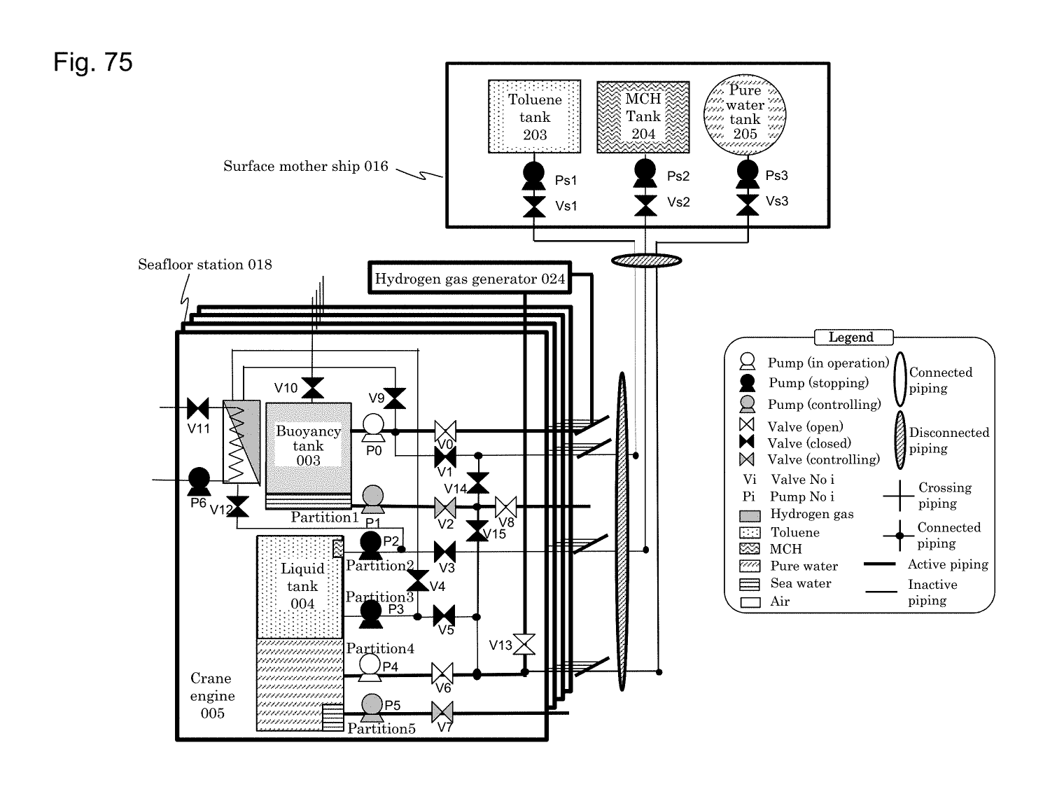

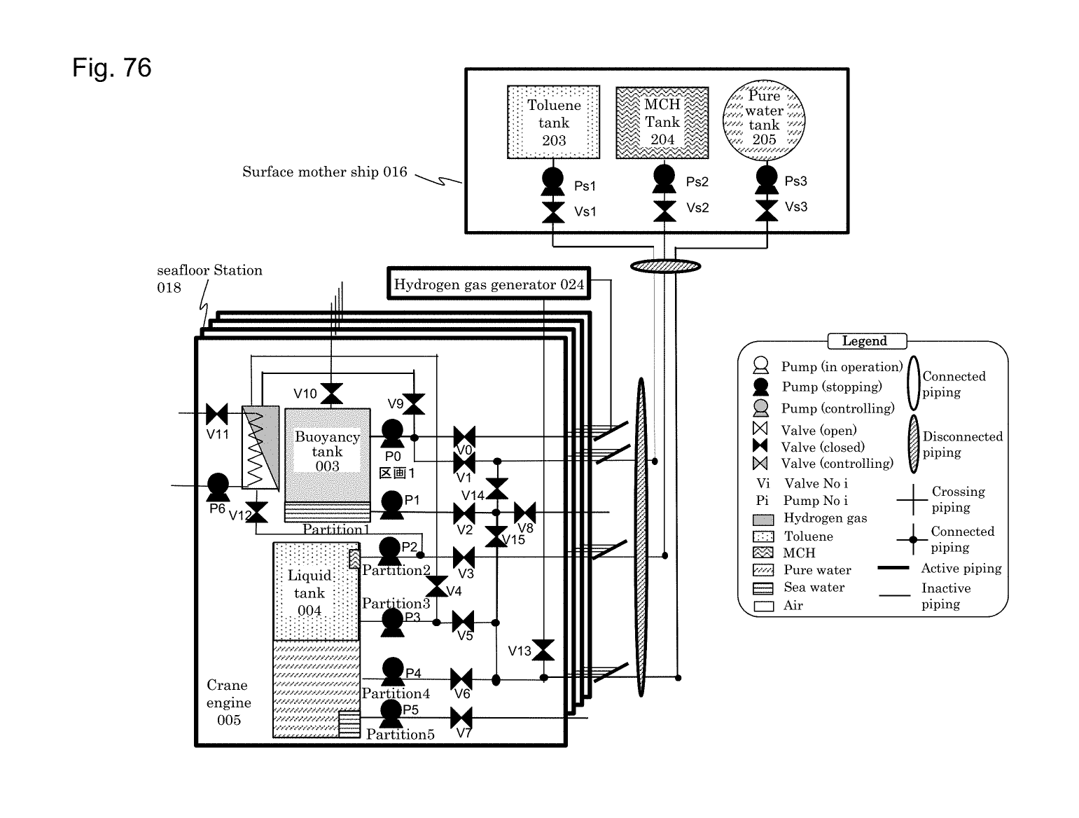

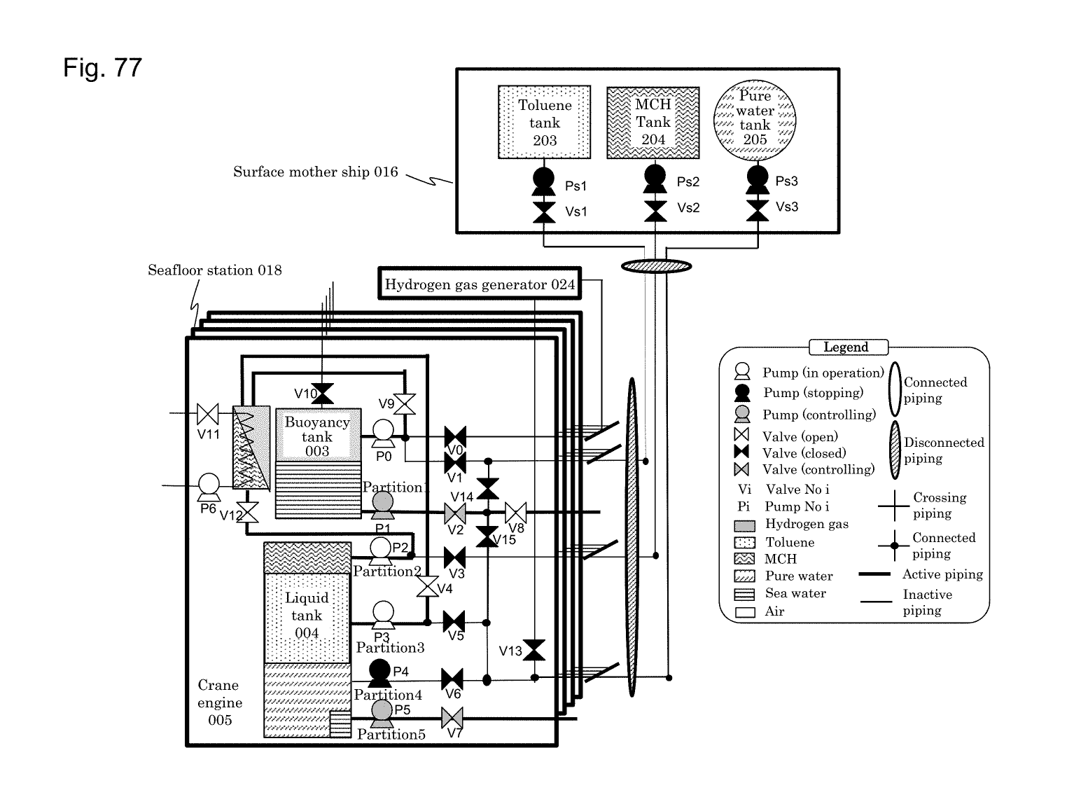

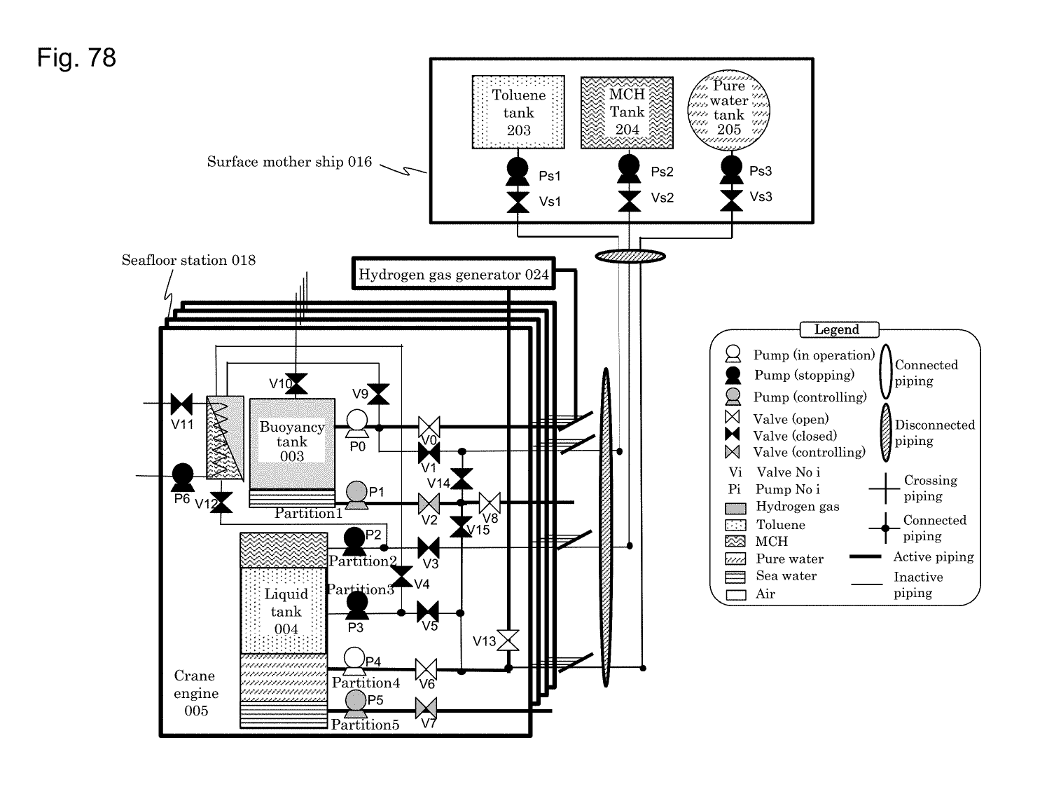

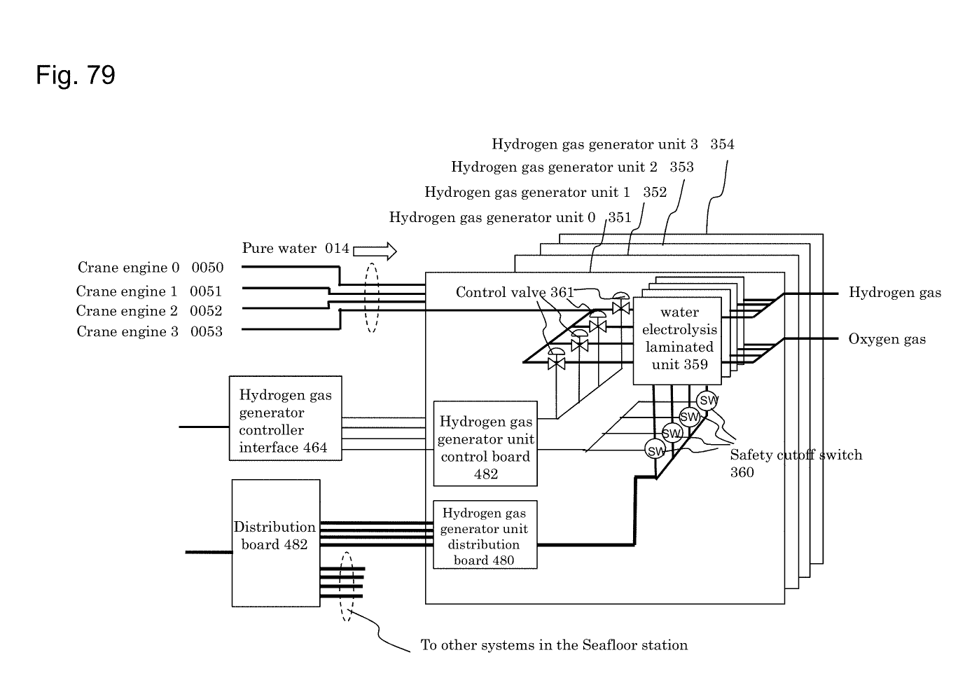

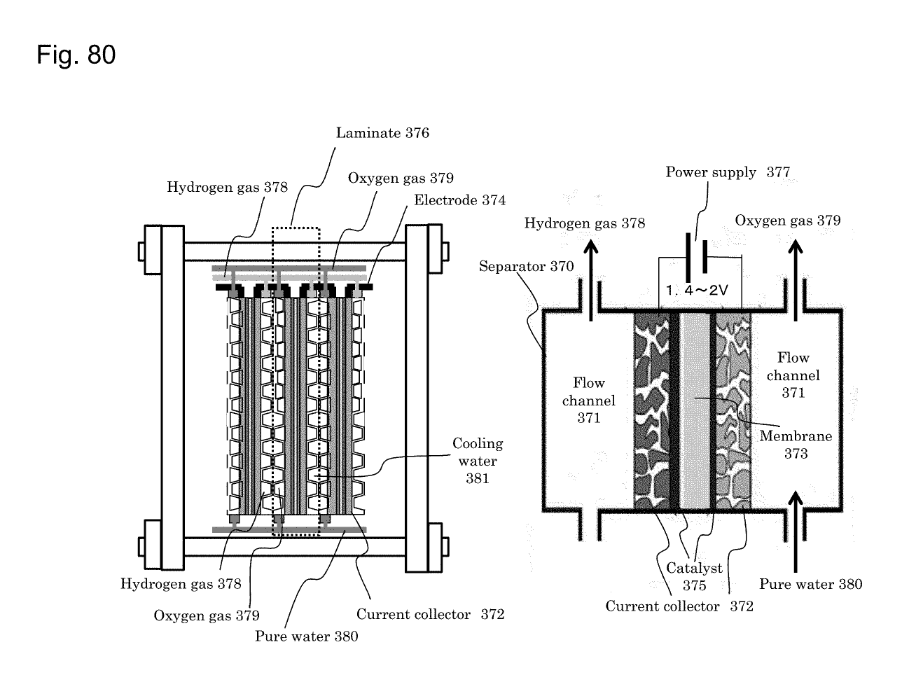

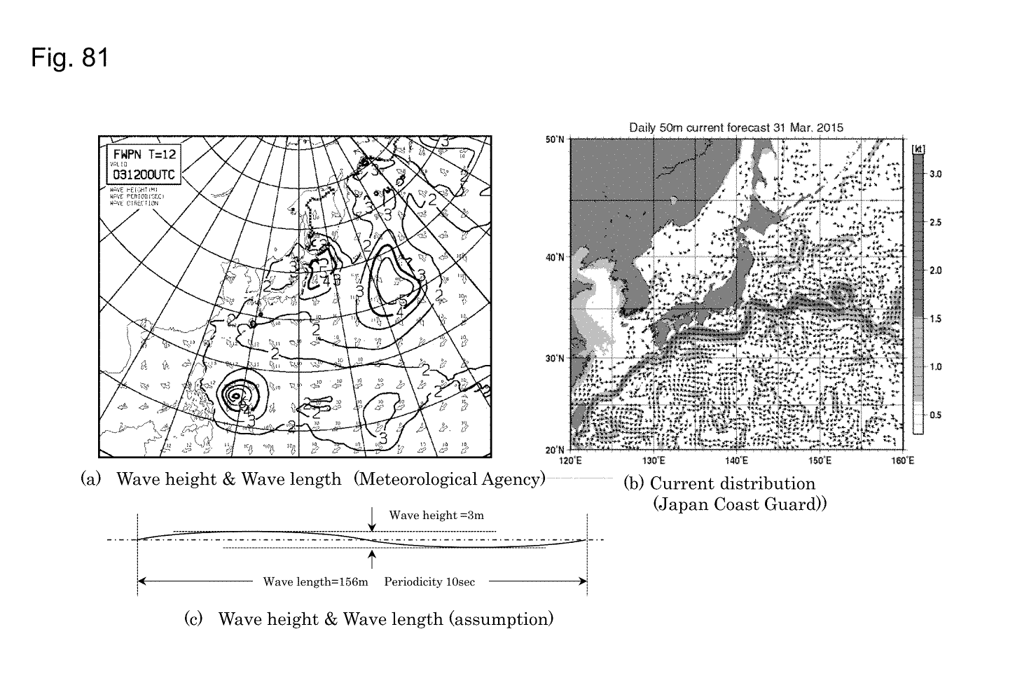

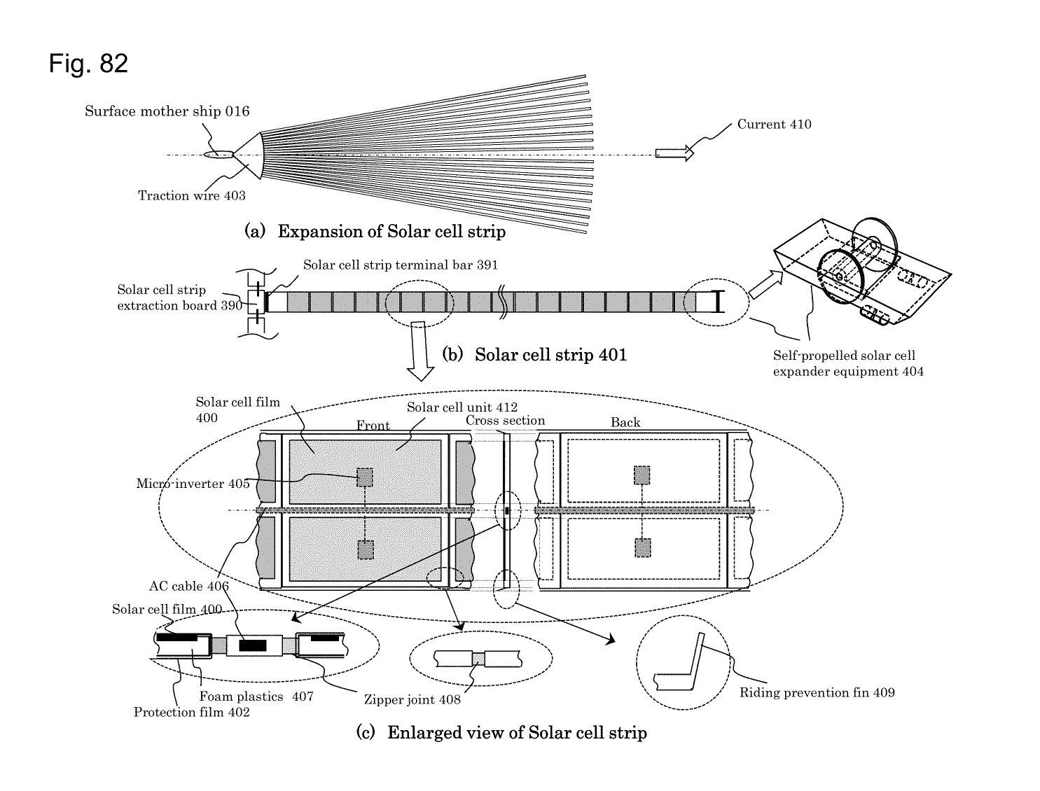

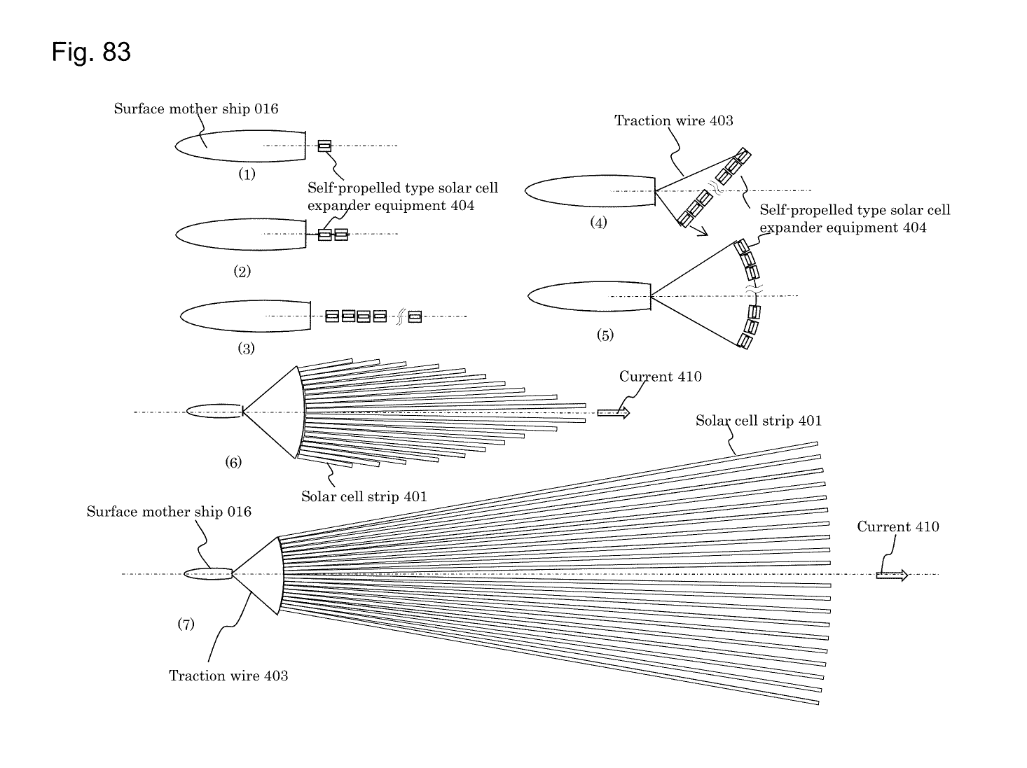

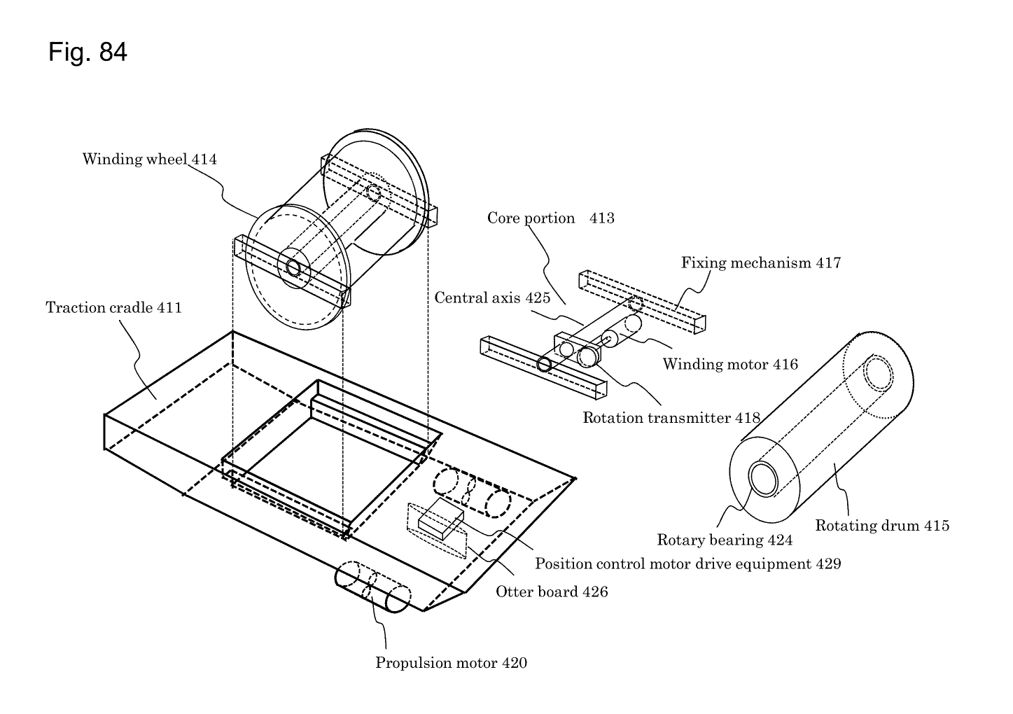

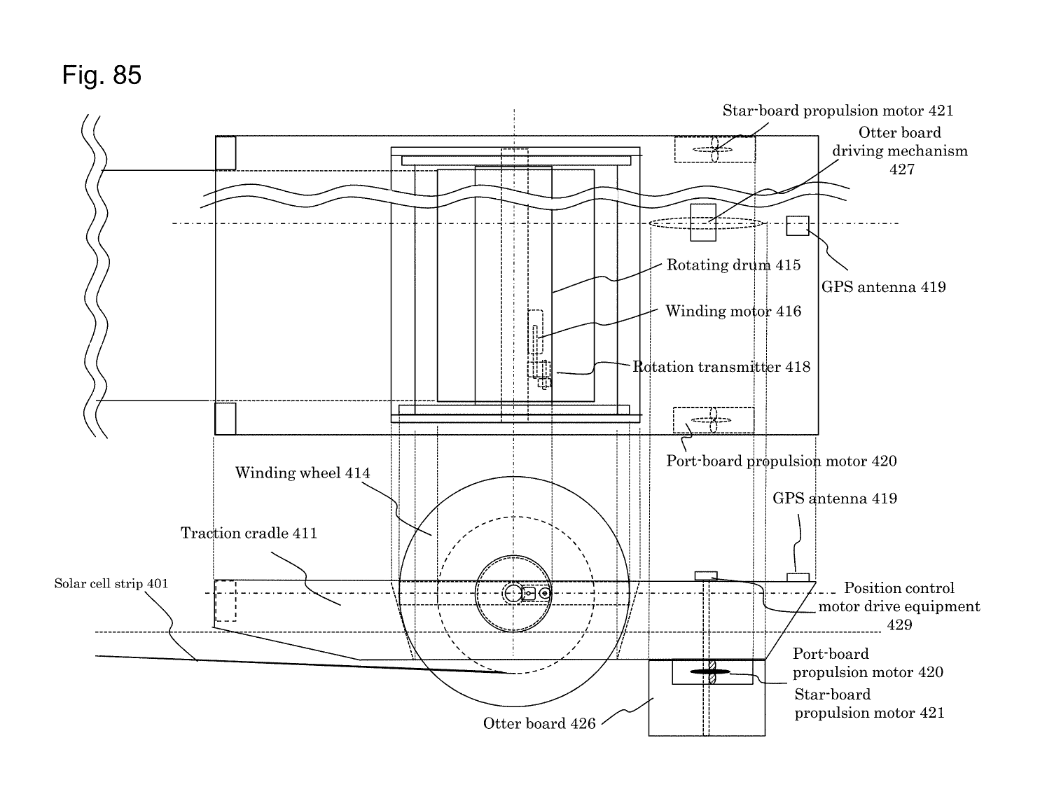

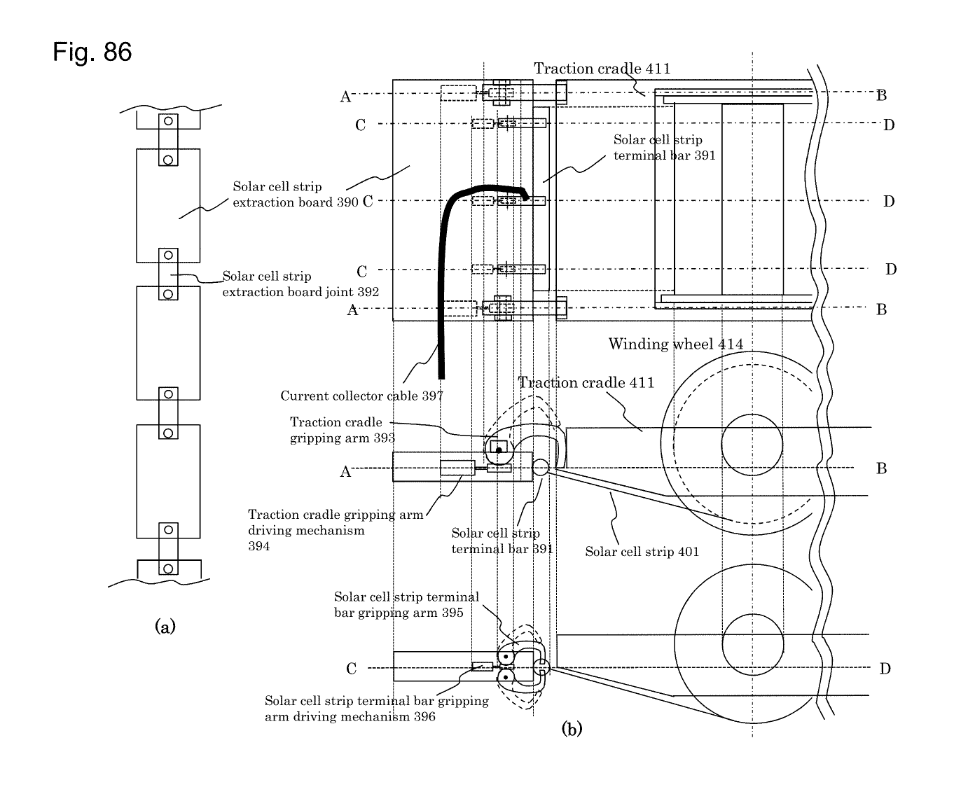

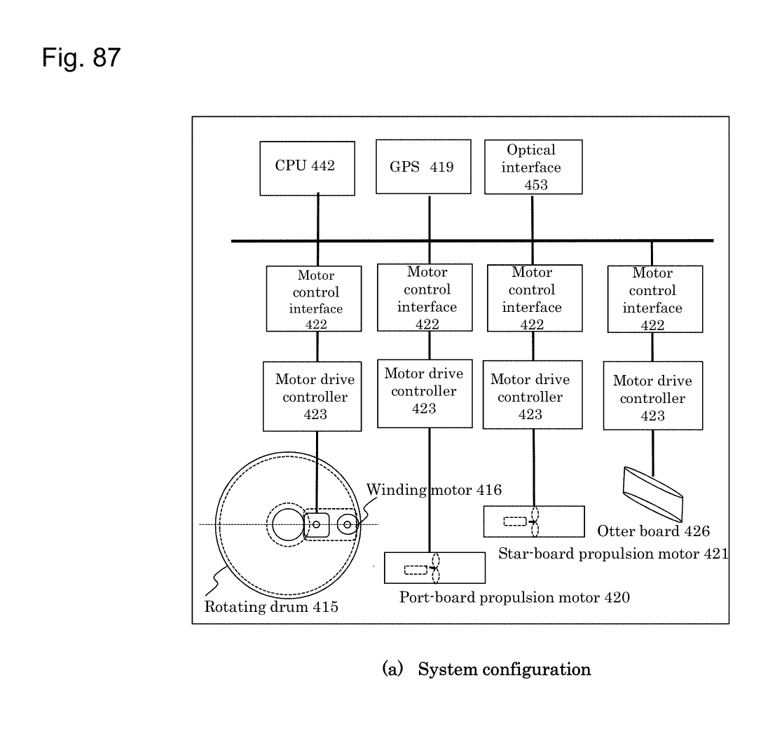

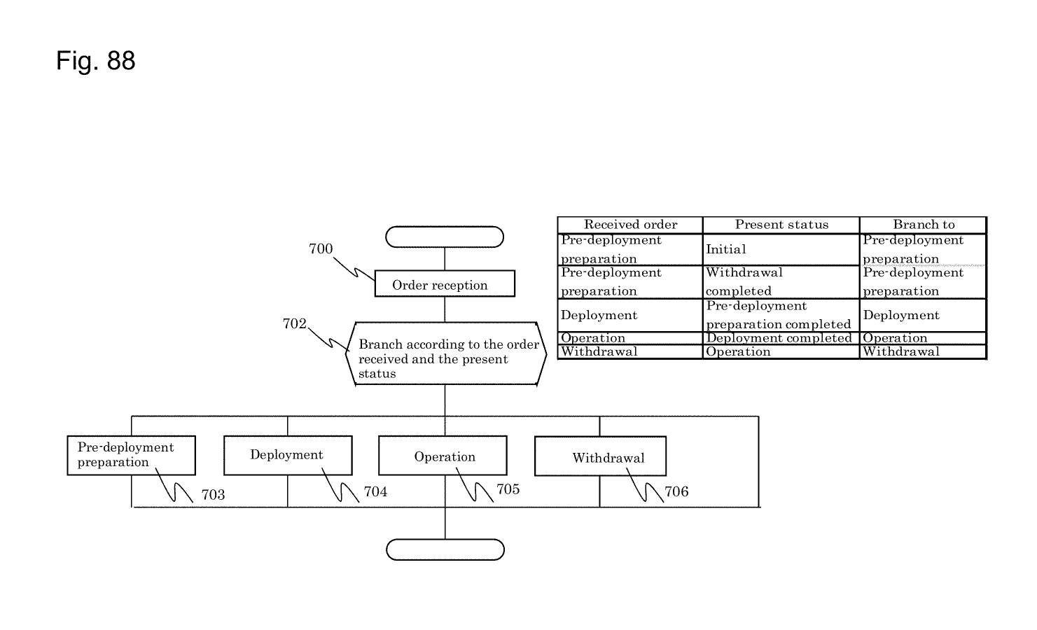

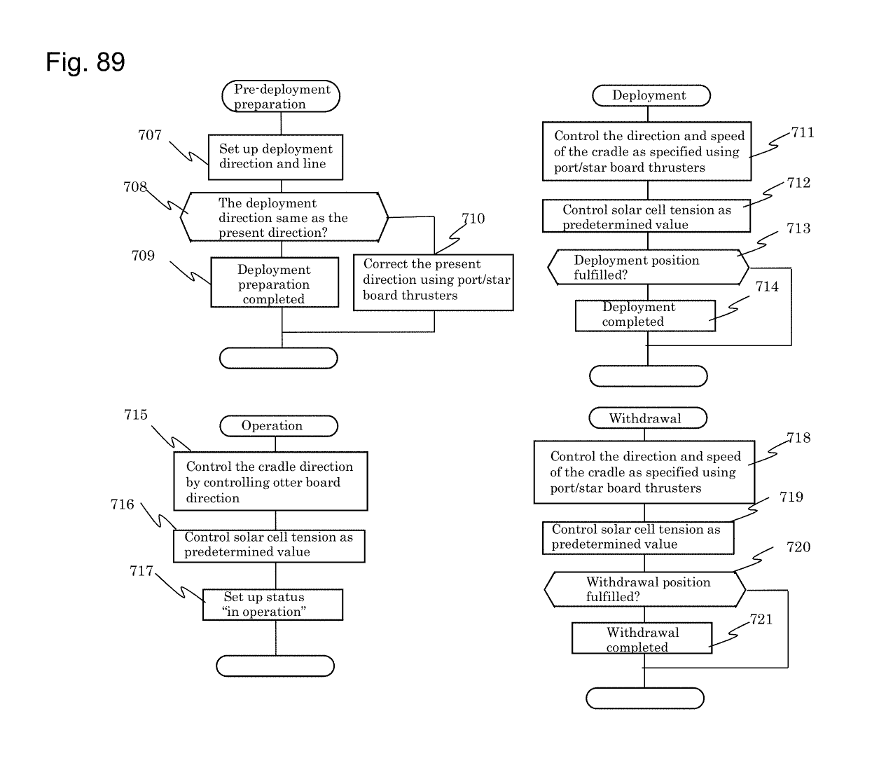

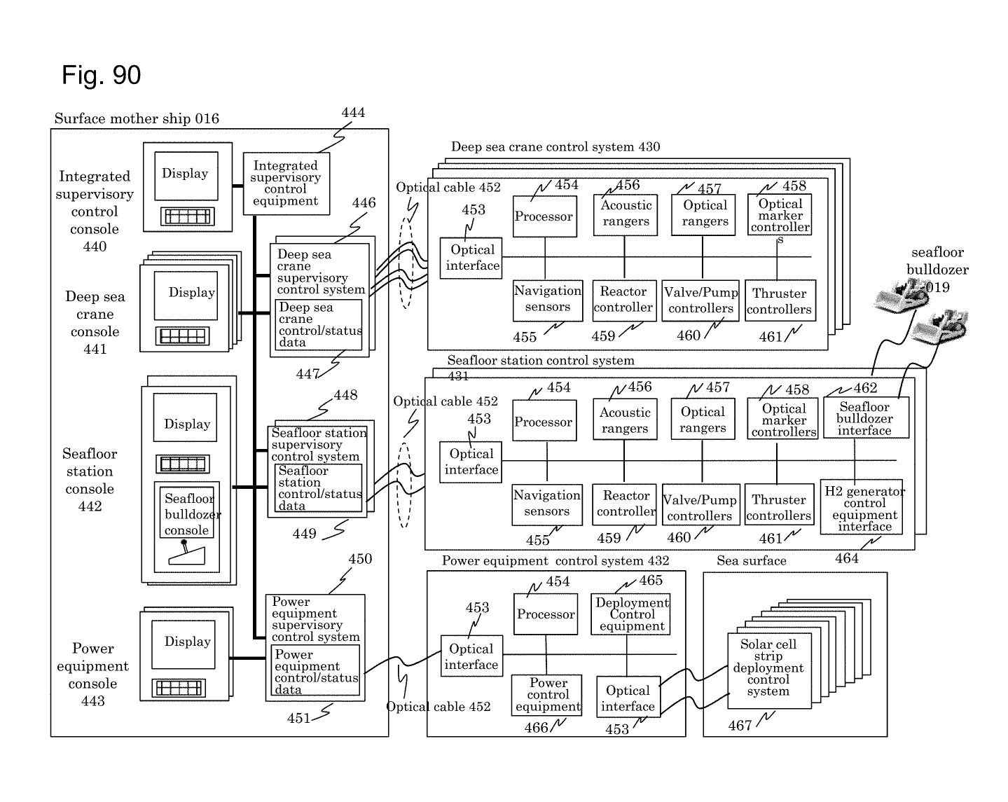

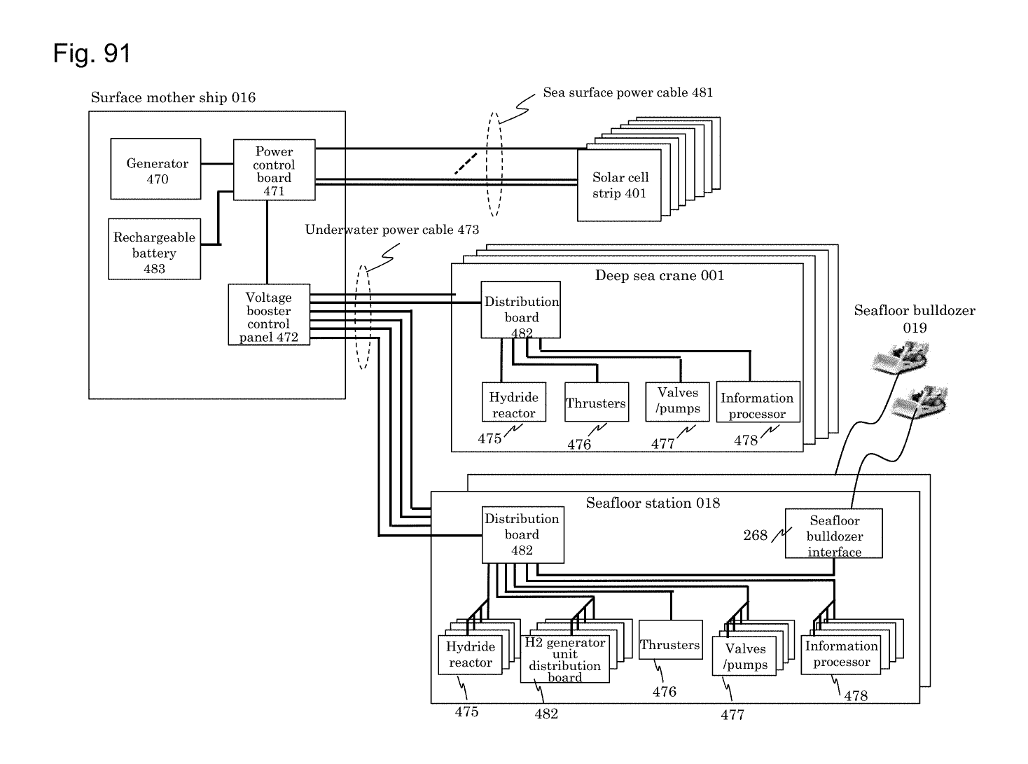

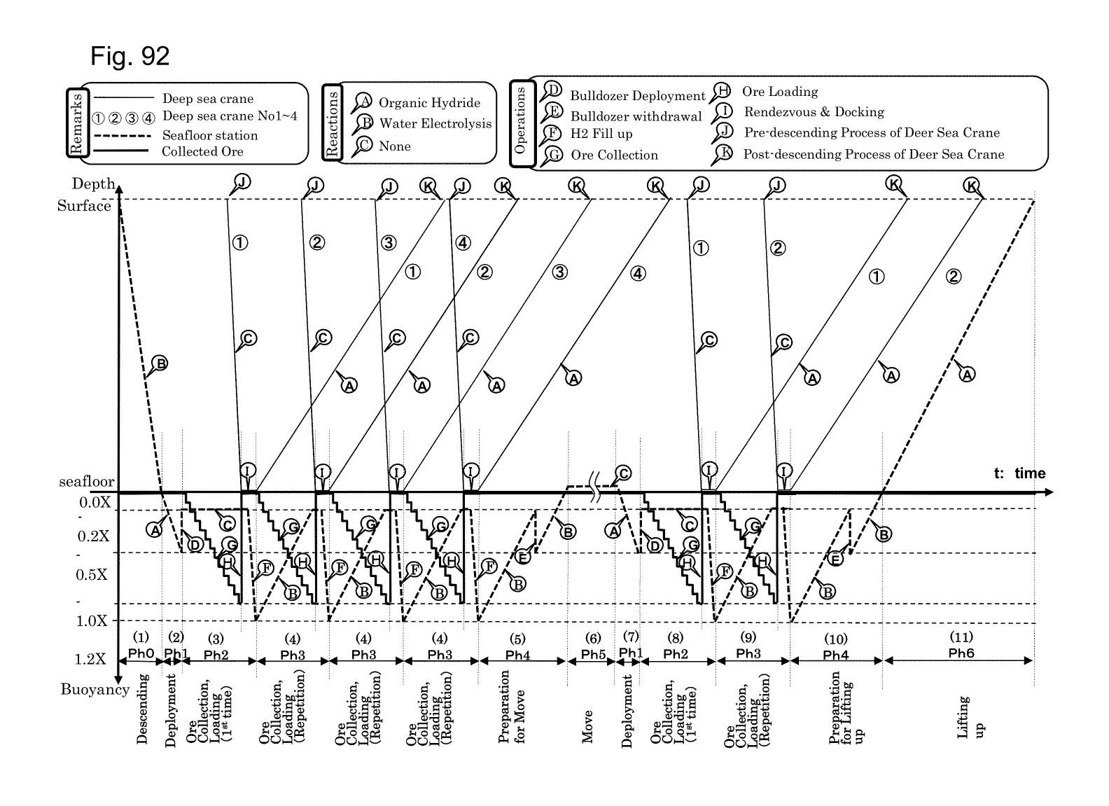

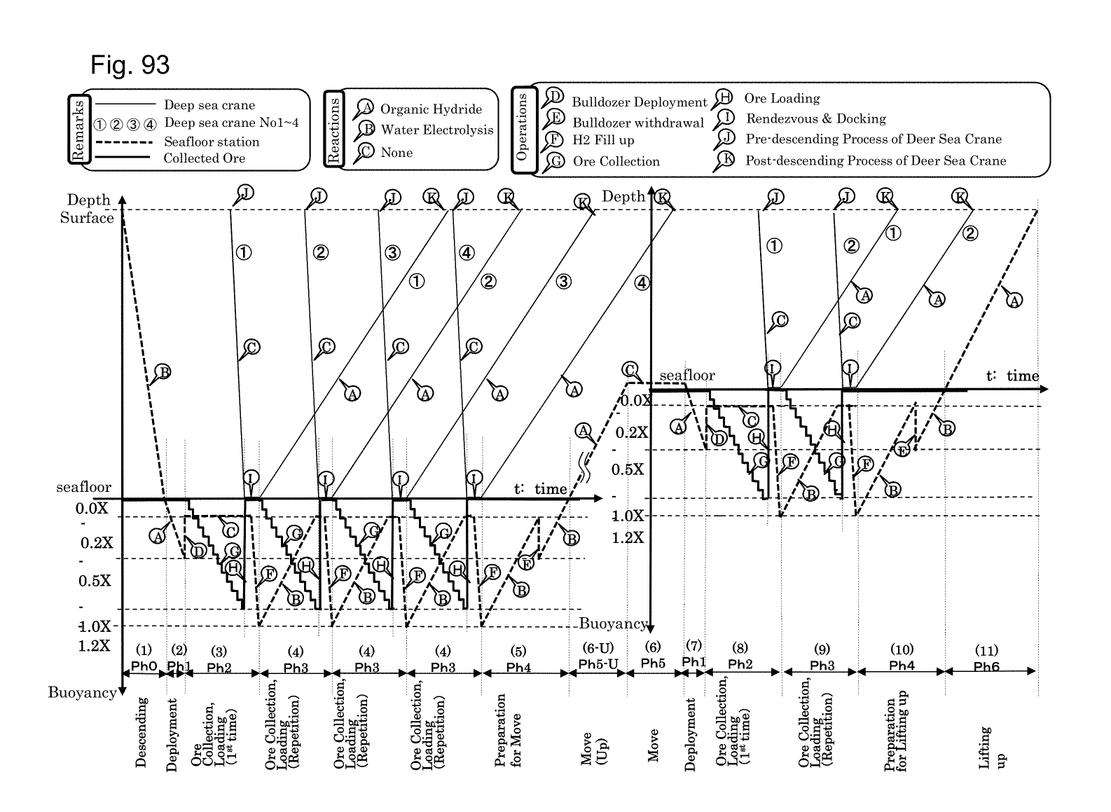

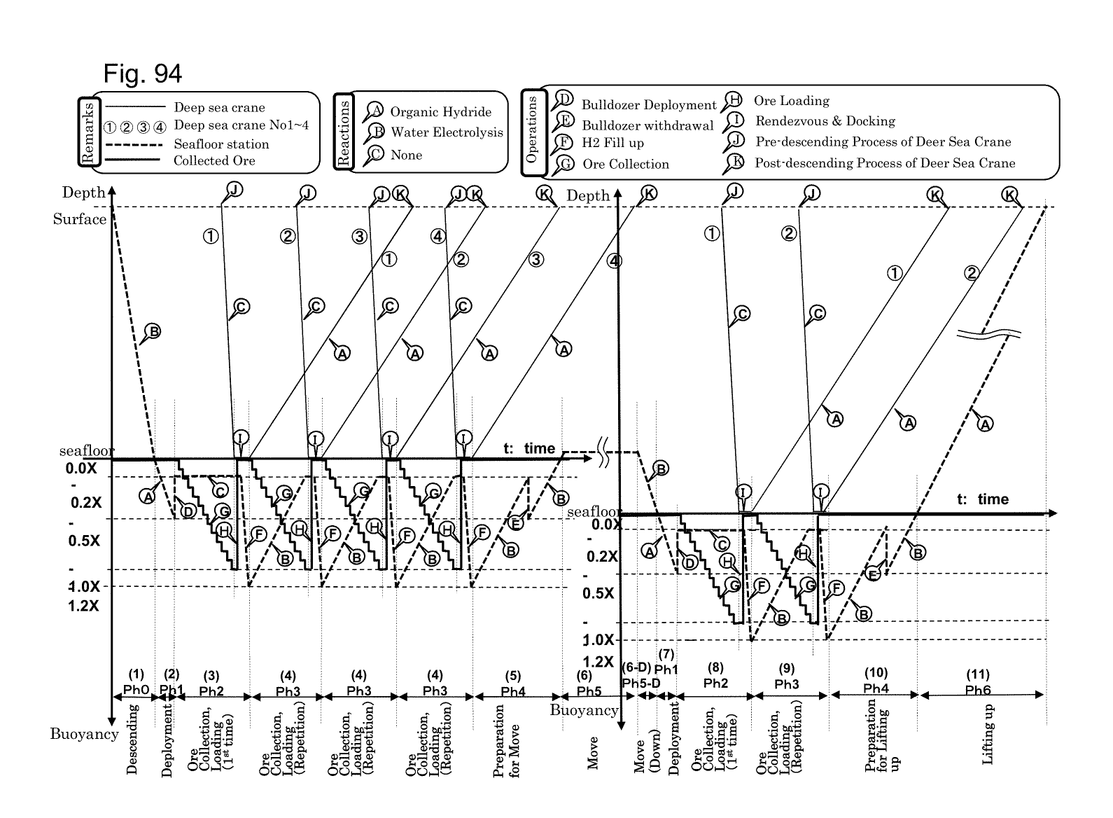

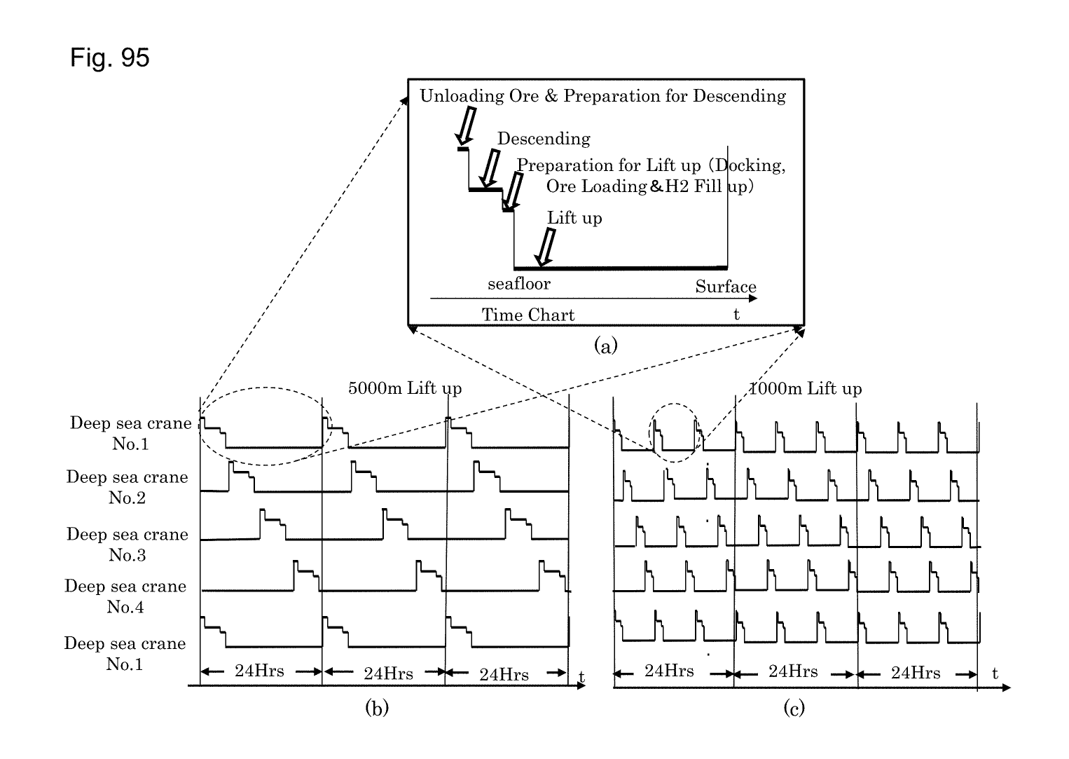

When a surface source is an approximation of the sound source, FIGS. 38 (a)-(c) show the description in detail.

In FIG. 38(a) the transponder direction vector 139 indicates an arrival direction of the sound wave, and the angle formed with the XY plane is φ, and the angle formed by the projection to the XY plane with the X axis is θ. AB is the direction of arrival of the sound wave, and FIG. 38 (b) is the view from the Z-axis.

FIG. 38(c) is a plane cut in FIG. 38(b) with a plane containing the sound arrival direction AB and Z axes and the relationship between the acoustic wave propagation path and the delay time for the acoustic sensors A to D 132 to 135 is shown. If the times of sound reception (seconds) of the acoustic sensors A to D 132 to 135 are ta, tb, tc, and td, and the underwater sound speed is s m/sec;

Based on the sound propagation distance between the acoustic sensor A and C and the distance calculated based on propagation time difference;

(t_{c}−tₐ)s=r cos φ cos θ

Based on the sound propagation distance between the acoustic sensor B and D and the distance calculated based on propagation time difference;

(t_{d}−t_{b})s=r cos φ cos θ

Then;

$$cos ϕ = \pm \frac{s}{2 r} \sqrt{{( {t}_{c} - {t}_{a} )}^{2} + {( {t}_{d} - {t}_{b} )}^{2}} \\ sin θ = \pm \frac{( {t}_{d} - {t}_{b} )}{\sqrt{{( {t}_{c} - {t}_{a} )}^{2} + {( {t}_{d} - {t}_{b} )}^{2}}} \qquad [ Equation 028 ]$$

Then, the processing block 551 is obtained. If there is no difference in propagation delay time for the acoustic sensors (Equation 028), cos φ=0, and sin θ is not obtained. cos φ=0 is a state in which the control object is complete because the transponder is directly above or below the sensor.

The transponder direction renews with the attitude data obtained from the inertial sensor in processing block 552, and the position of the Deepsea Crane determines from the transponder position known in processing block 553. If the distance between the transponder and the sensor is a few tens m and the vertical deviation is the optical measurement range (Field of view 20 to 30°), the process proceeds to the processing block 555, and if the target light emission is detected, the processing block 556 switches to the optical navigation mode in the processing block (Not false detection)

(4) Optical Navigation

In particular, in the seafloor, the distance of reaching the light is shortened due to the mud that rises, but it is possible to use the light-emitting element of LED in the final stage since accurate positioning is possible at a short distance of 10 to several meters.

The principle of optical navigation 107 will be described concerning FIGS. 39 (a) (b) (d). When the Deepsea Crane 001 senses light of light emitters A to D 151 to 154 located in the vicinity of the cargo-unit port 023 above the cargo-unit port 023, the image sensor 150 moves from the acoustic navigation section 104 to the optical navigation section 105.

Light emitters A to D 151 to 154 blink at different intervals to identify light emitting elements due to differences in periods. The image sensor 150 is installed at the distal end of the central axis of the Deepsea Crane 001 to capture the light-emitters A to D 151 to 154 in front.

If the central axis of the Deepsea Crane 001;

Shifts to the light emitting element AB side, the image of the (d1) in FIG. 39 (c) comes out.

Shifts to the light emitting element BC side, the image of the (d2) in FIG. 39 (c) comes out.

Shifts to the light emitting element CD side, the image of the (d3) in FIG. 39 (c) comes out.

Shifts to the light emitting element DA side, the image of the (d4) in FIG. 39 (c) comes out.

When there is no deviation from the center axis, the image of (d0) FIG. 39 (c) comes out.

FIG. 39 (b) shows the principle of optical navigation. The image sensor 150 installed at the tip of the Deepsea Crane 001 may be a conventional electronic camera having a viewing angle of about 24 to 35° with 1000×1000 to 4000×4000 pixels. The FaFbFcFd in FIG. 39 (b) is the imaging plane 156, and the image of the light-emitters A to D 151 to is imaged as shown in FIG. 40 (c).

In the optical navigation shown in FIG. 40, based on the following data;
(1) Pixel position of the image of the light emitters A to D, 151 to 154 on the image plane 156;
   light emitter A (Ha, Va), light-emitter B (Hb, Vb), light emitter C (Hc, Vc), light emitter D (Hd, Vd)
(2) Identification information of light emitters A-D, 151 to 154
(3) Focal length Lf 155 of image sensor 150
(4) The vertical image angle (α_{V}, α_{H}) and the number of vertical pixels of the image sensor 150 (Vmax, Hmax)
(5) The latitude, longitude (LatT, LonT) and depth (DpT) of center point of light emitters A to D, 151 to 154
(6) Angle β formed by the line AC connecting the light emitters A 151 and C 153 with the horizontal plane
(7) Angle γ formed by the line BD connecting the light emitters B 152 and D 154 with the horizontal plane
(8) Angle β formed by line BD and the North to the South direction (Y Axis)

the following data (A) (B) can be obtained from the following method.

The above (1) (2) are the measurement data of the image sensor 150, and (3) (4) are the inherent data to the image sensor 150, and (5) (6) (7) (8) are the actual measurement data at the Seafloor Station 018 or the surface mother ship 016, and these are all known.
(A) position of the Deepsea Crane 001 (latitude and longitude (LatT, LonT), depth (DpT))
(B) attitude of the Deepsea Crane 001 (pitch pb, yaw yb, roll rb)

The above (A) (B) is obtained using the quaternion.

The position of the Deepsea Crane 001 P in the reference coordinate system (XYZ, X Axis: East to West, Y Axis: North to South, Z Axis: Vertical) is defined, and a coordinate system (XbYbZb) P_{b} representing the attitude of the Deepsea Crane 001 is defined.

The cargo-unit port 023 in FIG. 39 (b) is assumed to be a field of view of the target direction vector 157 by the quaternion Q_{T} rotation to the reference coordinate P.

Pₜ=Q_{T}PQ_{T}* [Equation 029]

A cargo-unit port 023 in this coordinate system is projected onto the imaging plane 156 to obtain an image of FIG. 39 (c). Since the cargo-unit port 023 is located on a plane perpendicular to the Z axis of the reference coordinate P (seafloor), the surface formed by the target azimuth vector 157 and the cargo-unit port 023 is not perpendicular because it is located on a plane perpendicular to the Z axis of the reference coordinate P. FIG. 40 (a) (b) describes the PAC and PBD in FIG. 39 (b).

A is the point where the light emitter A 151 exists, and the B, C, and D are the same as the following. M is the intersection of AC and BD. The imaging coordinates of the imaging plane 156 of the A, B, C, and D are shown in FIG. 40 (c). The HV coordinate is in the upper left (0,0) and the lower right is (Hmax, Vmax). The coordinates of the intersection M of the line AC connecting the light emitters A and C and the light emitters B and D are given below.

$$[ \begin{matrix}{H}_{m} \\ {V}_{m}\end{matrix} ] = {[ \begin{matrix}{V}_{b} - {V}_{d} & - {H}_{b} + {H}_{d} \\ - {V}_{a} + {V}_{c} & {H}_{a} - {H}_{c}\end{matrix} ]}^{- 1} [ \begin{matrix}{H}_{d} {V}_{b} \\ {H}_{c} {V}_{c}\end{matrix} ] \qquad [ Equation 030 ]$$

In FIGS. 40 (a) and 40 (b), when the angle to see the line AM, and the line MC are α, β, the angle to see the line BM, and the line MD are γ, δ, these are given by Equation 031. Here, R is given by the distance between the viewpoint P and M which is the crossing point of the AC and BD, r is the distance between the light emitter and M, ω and φ are the angles between the orthogonal plane to the target direction vector PM and the line AC and the line BD (Equation 031).

$$tan α = \frac{r cos ω}{R - r sin ω} \\ tan β = \frac{r cos ω}{R + r sin ω} \\ tan γ = \frac{r cos ϕ}{R - r sin ϕ} \\ tan δ = \frac{r cos ϕ}{R + r sin ϕ} \\ R = \frac{r ( tan α + tan β )}{\sqrt{{( tan α - tan β )}^{2} + 4 {tan}^{2} {αtan}^{2} β}} or , \\ R = \frac{r ( tan γ + tan δ )}{\sqrt{{( tan γ - tan δ )}^{2} + 4 {tan}^{2} {γtan}^{2} δ}} \qquad [ Equation 031 ]$$

Calculating the average;

$$R = \frac{1}{2} ( \frac{r ( tan α + tan β )}{\sqrt{{( tan α - tan β )}^{2} + 4 {tan}^{2} {αtan}^{2} β}} + \frac{r ( tan γ + tan δ )}{\sqrt{{( tan γ - tan δ )}^{2} + 4 {tan}^{2} {γtan}^{2} δ}} )$$

$$sin ω = \frac{R}{r} \frac{tan α - tan β}{tan α + tan β}$$

$$sin ϕ = \frac{R}{r} \frac{tan γ - tan δ}{tan γ + tan δ}$$

On the other hand, since α, β, γ, and δ are determined from the coordinates of the image of the light emitter on the imaging plane 156, such as (Equation 032), the values R, ω, and φ of Equation 032 are determined.

$$α = \sqrt{{\{ \frac{( {H}_{a} - {H}_{m} ) {α}_{H}}{{H}_{max}} \}}^{2} + {\{ \frac{( {V}_{a} - {V}_{m} ) {α}_{v}}{{V}_{max}} \}}^{2}} \\ β = \sqrt{{\{ \frac{( {H}_{c} - {H}_{m} ) {α}_{H}}{{H}_{max}} \}}^{2} + {\{ \frac{( {V}_{c} - {V}_{m} ) {α}_{v}}{{V}_{max}} \}}^{2}} \\ γ = \sqrt{{\{ \frac{( {H}_{b} - {H}_{m} ) {α}_{H}}{{H}_{max}} \}}^{2} + {\{ \frac{( {V}_{b} - {V}_{m} ) {α}_{v}}{{V}_{max}} \}}^{2}} \\ δ = \sqrt{{\{ \frac{( {H}_{d} - {H}_{m} ) {α}_{H}}{{H}_{max}} \}}^{2} + {\{ \frac{( {V}_{d} - {V}_{m} ) {α}_{v}}{{V}_{max}} \}}^{2}} \\ tan ρ = \frac{{V}_{a} - {V}_{c}}{{H}_{a} - {H}_{c}} \qquad [ Equation 032 ]$$

Where, ρ indicates rotation relative to reference coordinates around the target direction vector PM. In (Equation 031), the cargo-unit port 023 is assumed to be horizontal, but generally, it is inclined with an attitude angle. As shown in FIG. 39 (a), when the X* axis is inclined by the angle α, and the Y* axis is inclined by the angle β relative to horizontal plane, r cos ε and r cos τ may be used for substitution of r.

From FIG. 40 (c), in the coordinate system (XbYbZb) the relationship between the attitude of the Deepsea Crane 001 P_{b} and the view coordinate Pₜ of the target azimuth vector 157 (Equation 034) can be obtained. The definitions of Pitch, Yaw, and Roll are as shown in FIG. 26.

$$Roll = \frac{{H}_{m} - \frac{{H}_{max}}{2}}{{H}_{max}} {α}_{H} \\ Pitch = - \frac{{V}_{m} - \frac{{V}_{max}}{2}}{{V}_{max}} {α}_{V} \\ Yaw = {tan}^{- 1} ( \frac{{V}_{a} - {V}_{c}}{{H}_{a} - {H}_{c}} ) \qquad [ Equation 033 ]$$

If the rotation of the Equation 033 in quaternion is Qₜ Equation 035 comes out.

Pₜ=QₜP_{b}Qₜ* [Equation 034]

Equation 036 is obtained from Equation 035 and Equation 030, then the attitude of the Deepsea Crane 001 for the reference coordinate P is obtained.

P_{b}=Qₜ⁻¹Q_{T}PQ_{T}*Qₜ^{*} [Equation 035]

The processing block 561 is obtained from Equation 031 and Equation 032, and the processing block 562 is obtained from Equation 035.

Since the center point latitude, longitude (LatT, LonT) and depth (DpT) of light emitters A-D 151 to 154 are known (Equation 030), the position P of the Deepsea Crane of the processing block 563 is obtained from Equation 036.

P=QT⁻¹PₜQ_{T}^{*-1} [Equation 036]

As a result of the optical navigation 107, the processing block 523 in FIG. 33 calculates the command order to the operation control system. And the Deepsea Crane 001 approaches to the Cargo-unit port 023 by the operation control system of FIG. 29. The processing block 564 assumes in a range of arrival of the docking LED shown in FIG. 43, and switches to the docking mode in processing block 566 when it is close to a few meters to 10 m. The processing block 565 does not switch to the docking mode when it does not satisfy the restriction such as the off-nadir angle <20° in which the imaging device 150 can see it.

The identification scheme of a light emitting device in FIG. 42 shows the details of FIG. 41 processing block 560. A method to identify an individual LED using the flashing pattern of four light emitters asynchronously at a shorter period than the blinking period of light emitters. FIG. 42 (c) Light emitters and FIG. 42 (d) Image sensor shows the configuration of the apparatus, and the light emission patterns P0, P1, and P2, are repeated in the periodic TL as shown in FIG. 42 (a). A plurality of light emission patterns are as shown in (b) Pattern sequence code of the light emission pattern, but the optical navigation may employ one of them. In the case of docking control, a plurality of light emitter sets and imaging devices are in use. In the CPU of the imaging sensor in FIG. 42 (d), the operation is performed according to (e) processing flow.

In the processing block 570, the recognition processing of the processing blocks 571 to 576 are skipped until the 4 LEDs light-on, and the processing block 577 records the image. The 4 LEDs light-on means the start of the LED pattern cycle. Processing blocks 572 to 576 may result in overlapping images of 2 LEDs light-on between the image of the image pickup device and the 4 LEDs light-on so that the pattern sequence Code of the light emitting pattern matching the processing block 575 is determined by eliminating this overlap. Since the identification of each LED is possible, the pixel coordinates in the imaging plane are transmitted, and output by the identification number of the LED in the processing block 576.

(4) Docking Navigation

In the optical navigation, after the target is closer to 1 to 2 m, precise attitude and position control are carried out by recognizing the detailed pattern of LED light emitters, and then the docking is carried out.

The Deepsea Crane 001 performs a precision position control in the final stage proximate to the Cargo-unit port 023. It separates the empty cargo unit 007 and places it on the Cargo-unit port 023, and floats up about 10 to 20 10 meters, and moves horizontally, and then docks with another cargo-unit 007 which fills with the cargo on the opposite side of the Seafloor Station 018. This operation is called the docking navigation. It is a two-choice docking device and position control and attitude control by image processing by a digital camera. FIGS. 43, 44, and 45 describe the structure of the docking device.

FIG. 43 (a) illustrates the relationship among the Crane Engine 005, the Cargo unit 007, and the Cargo-unit port 023 of the Seafloor Station 018. Now, the case where the Cargo unit 007 of the empty load exists on the Cargo-unit port 023 at the final stage of the descent is as follows.

The Cargo unit 007 and the Crane Engine 005 are detachable. And the Cargo unit 007 is connected to the Crane Engine 005 by the gripper (4 in this example) mounted on the circumferential portion of the Cargo unit 007, or the Cargo unit 007 is connected to the Cargo-unit port 023 in the second priority alternative selection mechanism.

FIG. 43 (b) C shows that the imaging devices A, B, C, and D exist at equal intervals at the lower edge portion of the Cargo unit 007. FIG. 43 (b) D shows that a light-emitter assembly consisting of four sets of LEDs exists in the peripheral portion of the Cargo-unit port 023 corresponding to the imaging devices.

The relationship between the LED and the imaging device is same as the relationship between the LED and the imaging device in the principle of the optical navigation principle (1) FIG. 39, and the position and attitude of the Deepsea Crane 001 is to the so that the imaging device is in the center of the light-emitting LED. In the circumferential portion of the Cargo unit 007, a gripper shown in FIG. 43 (c) b, c is installed at the position shown in FIG. 43 (b) Aa, Bb, Cc, and Dd. The operation of the gripped object and the gripper is as shown in FIG. 44. FIGS. 44 (f)-(j) show the action until the Crane Engine 005 separates the empty Cargo unit 007 and separates it from the Cargo-unit port 023 and then floats up again.

FIG. 44 (f) shows the status just before docking the Cargo unit 007 with the Crane Engine 005 to the Cargo-unit port 023, while the Crane Engine 005 side gripped object 171 connects with the gripper 170 of the Cargo unit 007.

The key-mechanism 174 is invaginated in the Crane Engine 005 side gripped object 171, and the inter-fit body 177 of the rotary mechanism 175 is pressed downward to prevent the gripper 170 from opening.

When the gripped object 171 at the Cargo-unit port 023 side penetrates the lower side of the gripper 170 in (g),

the key-mechanism 171 of the gripped object 174 at the Crane Engine 005 is pulled up to in (g) to (h) by pulling out the key-mechanism 174 of the Crane Engine 005 side gripped object 171,

and pulling up the key-mechanism 174 of the Cargo-unit-port 023 side gripped object 171 to the lower inter-fit body 177 of the gripper 170.

The lower side of the gripper 170 closes through the rotating mechanism 175, and the upper side opens. The Cargo unit 007 becomes connected to the Cargo-unit-port 023 side gripped object 171, and the Crane Engine 005 and the Cargo unit 007 are disconnected. The picture (i) shows the state in which the Cargo engine 005 is released and floating up.

The gripping mechanism shows an example.

As long as

(1) latter priority

(2) robust and durable

are met, there is no need to stick to an example.

The Crane Engine 005 which has separated the Cargo unit 007 is lifted up by 15 to 20 m and moved horizontally by 10 to 20 m to dock to the opposite side of the Cargo-unit port 023. Since the release and horizontal movement are carried out without a hydrogen gas absorption reaction in the state of seawater specific gravity, there is no constraint on depth and depth change rate, and the optical navigation 107 and the operation control system (FIG. 29) can be in use. In this docking, the Crane Engine 005 and the Cargo unit 007 on the Cargo-unit port 023 loaded with seafloor resources dock. In FIG. 43, the Crane Engine 005 lowers in a state in which the Cargo unit 007 is connected to the Cargo-unit port 023, and A and B in FIG. 43 (a) dock. FIG. 43 (b) A shows that the imaging devices A, B, C, and D exist in A on the lower surface of the Cargo engine 005, and the same docking control as the separation docking of the Cargo unit 007 is carried out by arranging the light emitting LEDs shown in FIG. 43 (b) B on the upper surface B of the Cargo unit 007.

FIGS. 44(a) to 44 (e) show the operation to connect the loaded Cargo unit 007, which links to the Cargo-unit port 023, to the Crane Engine 005, and then to disconnect from the Cargo-unit port 023, and then to float up again.

In (a), the gripper 170 of the Cargo unit 007 and the Cargo-unit-port 023 side gripped object 171 are connected.

In (b)-(d), the Crane Engine 005 sides gripped object 171 docks to the gripper 170, And in (c) and (d) the key-mechanism 174 of the Cargo-unit port 023 sides gripped object 171 is pulled out,

And the key-mechanism 174 of the Cargo-unit 023 sides gripped object 174 is pushed down to the upper inter-fit body 177 of the gripper 170. The top side of the gripper 170 closes through the rotating mechanism 175, and the lower-side opens.

The Crane Engine 005 side gripped object 171, and the gripper 170 of the Cargo unit 007 are connected. FIG. 45 shows the structure of the gripper and the gripped object in the third angle projection method drawing. The gripping arm 178 is held in the support mechanism 176 via six rod-shaped rotating-mechanism 175 and bears the load.

FIG. 46 describes the operation of the docking navigation system. In processing block 580, the Cargo unit separation (Processing block 581) or the Cargo unit reconnection docking (Processing block 580) is branched. The processing block 581 and the processing block 580 perform the same processing as the processing blocks 560 to 563 of the optical navigation in FIG. 41 without any difference other than the parameters, and obtain the relative positional relationship between the LED light emitter and the image sensor. The difference from the optical navigation in FIG. 41 is that there is a plurality of combinations of LED light emitters and image sensors (Processing block 581). Since there are four sets of combinations, it is necessary to determine the position error of the Crane Engine 005 or the Deepsea Crane 001 from the relative position of each one. And the processing block 582 integrates the XY plane movement vector, the Z-axis movement vector, the X-axis torque, the Y-axis torque, and the Z-axis torque. (FIG. 47)

4. Operation Mode Control

FIG. 32 shows the overall control system structure of the Deepsea Crane. Where in addition to the navigation control system 110 and the operation control system (FIG. 29) which works during the movement of the Deepsea Crane 001, there is an operation mode control 112 which changes the liquid composition with no move in preparation for the next action.

The operation mode control 112 is located at the top of the control system of the Deepsea Crane and receives a control command from the Deepsea Crane supervisory control system 446 of the Surface mother ship 016 via the optical communication interface 453 at processing block 590. There are ten types of operation modes of the Deepsea Crane 001 in the operation mode list shown in FIG. 48 (b). In the operation mode, there is the navigation control with the movement and the fluid configuration control for changing the liquid composition in the static state, and the operation mode list of FIG. 48 (b) describes the contents of each operation mode.

The processing block 591 checks the completion condition of FIG. 48 (b), and if the completion condition is not satisfied, the operation mode currently executing is continuously executed. When the completion condition is satisfactory, the operation mode to transfer is selected. In practice, the operation mode No. in the operation mode list FIG. 70(b) is made to step forward. For the operation mode transition, it is necessary to realize the piping state and liquid configuration of FIGS. 49 to 58 corresponding to the transition destination operation mode. In processing block 594, either fluid control (Processing block 595) or navigation control (Processing block 596) is selected corresponding to the destination operation mode to transfer

5. Fluid Configuration Control

This control changes the liquid composition inside the Crane Engine 005, which is a component of the Deepsea Crane 001, by controlling the piping state to realize an internal state corresponding to each operation mode.

The processing flow 2 in FIG. 48 (c) controls the transition of the operation modes shown in FIG. 49 to FIG. 58.

The processing block 601 checks the completion condition shown in the operation mode list (b), and the processing block 602 controls the following (1) to (10) corresponding to the operation mode.

(1) Floating Up (Operational Mode 1 in FIG. 49)

(a) Deepsea Crane 001

The operation described above “V Deepsea Crane 1 control system, two navigation system, three docking control” is carried out independently in the state where the Deepsea Crane 001 does not connect to the Seafloor Station 018 and the Surface Mothership 016 with the pipe connection. Toluene is sent from the liquid tank 004 section 3 of the Deepsea Crane 001 via V 14 to the hydride reactor 009 together with the hydrogen gas of the buoyancy tank 003 to generate the MCH. The generated MCH flows to the liquid tank 004 via V 12. For the change in volume of the liquid tank 004, the seawater in the Partition 5 of the liquid tank 004 is injected/drained by P5 via V7 to cancel this change.

(b) Seafloor Station 018

Hydrogen gas generation and accumulation are in operation when the Deepsea Crane 001 is separated.

The Crane Engine of the Seafloor Station 018 accumulates hydrogen generated by the hydrogen gas generator in the buoyancy tank 003 via the valve V0 and the pump P0. via V6 and V 13 from liquid tank 004 section 4. Seawater of the same volume as the pure water is injected into the liquid 004 compartment 5 by P5 via V7. The seawater in the buoyancy tank 003 section 1 is drained into the sea by P1 via V2 and V8 in response to the hydrogen gas increase. The pressure of the buoyancy tank 003 is almost equal to the seawater pressure.

(c) Surface Mothership

No other system and piping connection, independent operation.

(2) Completion of Floating and Hydrogen Gas Purge (Operational Mode 2 FIG. 50)

(a) Deepsea Crane 001

The Deepsea Crane 001 floats and docks to the Surface mother ship 016. The hydrogen gas of one atmospheric pressure remaining in the buoyancy tank 003 is purged in the atmosphere by P0 via V0 and V 10.

(b) Seafloor Station 018

Hydrogen gas generation and accumulation are carried out in a state in which the Deepsea Crane 001 is remote. Same as (1).

(c) Surface Mothership

No other system and piping connection, independent operation.

(3) Completion of Floating and MCH Unloading (Operational Mode 3 FIG. 51)

(a) Deepsea Crane 001

The MCH generated during the floating up is sent from the liquid tank 004 Partition 2 by P2 via V3. In the Surface mother ship 016, The MCH is collected in the MCH tank 204 by Ps2 via Vs2. Seawater is fed into the liquid tank 004 Partition 5 by P5 via V7.

(b) Seafloor Station 018

Hydrogen gas generation and accumulation are carried out in the state in which the Deepsea Crane 001 is remote. Same as (1).

(c) Surface Mothership

MCH is transferred in connection with the Deepsea Crane 001.

(4) Preparation for Descending (Toluene Filling) (Operational Mode 4 FIG. 52)

(a) Deepsea Crane 001

Toluene is injected with Ps1 via Vs1 from the toluene tank 203 of the Surface mother ship 016 to the liquid tank 004 Partition 3 of the Deepsea Crane 001 by P3 via V5.

Seafloor Station 018

Hydrogen gas generation and accumulation are carried out in a state in which the Deepsea Crane 001 is remote. Same as (1).

(c) Surface Mothership

Toluene is transferred in connection with the Deepsea Crane 001.

(5) Preparation for Descending (Pure Water Filling) (Operational Mode 5 FIG. 53)

(a) Deepsea Crane 001

Pure water for electrolysis is injected into the buoyancy tank 003 of the Deepsea Crane by Ps3 via Vs3 from the pure water tank 205 of the Surface mother ship 016 by P0 via V 14 and V1.

(b) Seafloor Station 018

Hydrogen gas generation and accumulation are carried out in a state in which the Deepsea Crane 001 is separated. Same as (1).

(c) Surface Mother Ship

Being connected with the Deepsea Crane 001 pure water is transferred.

(6) Descending (Operational Mode 6 FIG. 54)

(a) Deepsea Crane 001

All part of the Deepsea Crane 001 are filled with liquid, set to the same specific gravity as seawater, and the valves to the outside are closed and the Deepsea Crane 001 descends.

(b) Seafloor Station 018

Hydrogen gas generation and accumulation are carried out in a state in which the water lifting and lowering apparatus 001 is separated. Same as (1).

(c) Surface Mother Ship

No piping connection to the other systems and, independent operation.

(7) Replacement and Transfer of the Cargo Unit (Operational Mode 7 FIG. 55)

(a) Deepsea Crane 001

All part of the Deepsea Crane 001 are filled with liquid and set to the same specific gravity as seawater to move by the thrusters.

(b) Seafloor Station 018

Hydrogen gas generation and accumulation are carried out in a state in which the water lifting and lowering apparatus 001 is separated. Same as (1).

(c) Surface Mother Ship

No piping connection to the other systems and, independent operation.

(8) Post Descending Operation (Hydrogen Gas Filling, Pure Water Transfer) (Operation Mode 8 FIG. 56, Completion State FIG. 57

(a) Deepsea Crane 001

The hydrogen gas accumulated in the buoyancy tank 003 of the Seafloor Station 018 is sent by P0 via V0 of the Seafloor Station 018 to the buoyancy tank 003 of the Deepsea Crane 001 by P0 via V0. Since the hydrogen gas accumulates upward, the pure water is sent by P1 via V2 to the liquid tank 004 Partition 3 of the Seafloor Station 018.

(b) Seafloor Station 018

Connecting to the Deepsea Crane 001 to transfer pure water.

(c) Surface Mother Ship

No piping connection to the other systems and, independent operation.

(9) Floating Preparations (Seawater Injection and Completing Adjustment of Buoyancy) (Operational Mode 9 FIG. 58)

(a) Deepsea Crane 001

The hydrogen gas capacity and the seawater capacity in the buoyancy tank 003 are controlled by P0 and P1 via V0 and V1 so as to be able to continue the hydrogenation reaction to keep the specific gravity of the Deepsea Crane 001 same as the seawater for floating up.

(b) Seafloor Station 018

A hydrogen gas is transferred connecting with the Deepsea Crane 001.

(c) Surface Mother Ship

No piping connection to the other systems and, independent operation.

V Seafloor Station

1 Control System

(1) Objectives and Functions

Objectives and Functions

In the embodiment of FIG. 6, the Seafloor Station 018 comprises of the Seafloor Station platform 027 and four sets of Crane Engine 005. Therefore the hydrogen gas generator 024, and the seafloor bulldozer 019 in the Seafloor Station platform 027 are regarded as a load in place of the Cargo unit 007 in the Deepsea Crane 001 when discussing the floating, horizontal movement and descending of the Seafloor Station platform 027. The movement principle is same as that of the Deepsea Crane 001, and it constitutes a control system as a composite system of the Deepsea Crane 001.

The Seafloor Station differs to the Deepsea Crane 001 as follows and it works like the Deepsea Crane 001 by changing parameters.

(1) Structure and Weight

Seafloor Station 018 as shown in FIG. 59

Deepsea Crane 001 as shown in FIG. 24

As shown in the above, the Seafloor Station 018 is comparable to the Deepsea Crane 001.

a. It weighs about four times.

b. The water resistance in the Z-axis direction is significant.

c. There is no rotational symmetry around the Z axis (Vertical Direction), and the XY axis (Horizontal) direction is broad.

d. It is easy to get the torque around the XY axis by the thrusters (large) 200 in the Z-axis direction installed at the end of the Seafloor Station platform 027. The center of gravity Ws 202 is at a low position over the Seafloor Station platform 027 and is not symmetrical around the z-axis.

(2) Coordinate System

Seafloor Station 018 as shown in FIG. 60

Deepsea Crane 001 as shown in FIG. 26

We can handle the Seafloor Station 018 same as the Deepsea Crane 001 making the above correspondence.

(2) Thrusters and Control Vector

In response to the differences described in (1) Structure and Weight section, using placing the thruster (large) 200 and the thruster (medium) 201 as shown in FIG. 59, the moving thrust and rotational torque can be similar to the Deepsea Crane 001 as shown in FIG. 61 (a) (b) (c), as a result, the dynamic characteristics can be collectively handled with the Deepsea Crane 001.

For both of;

Seafloor Station 018 as shown in FIG. 61

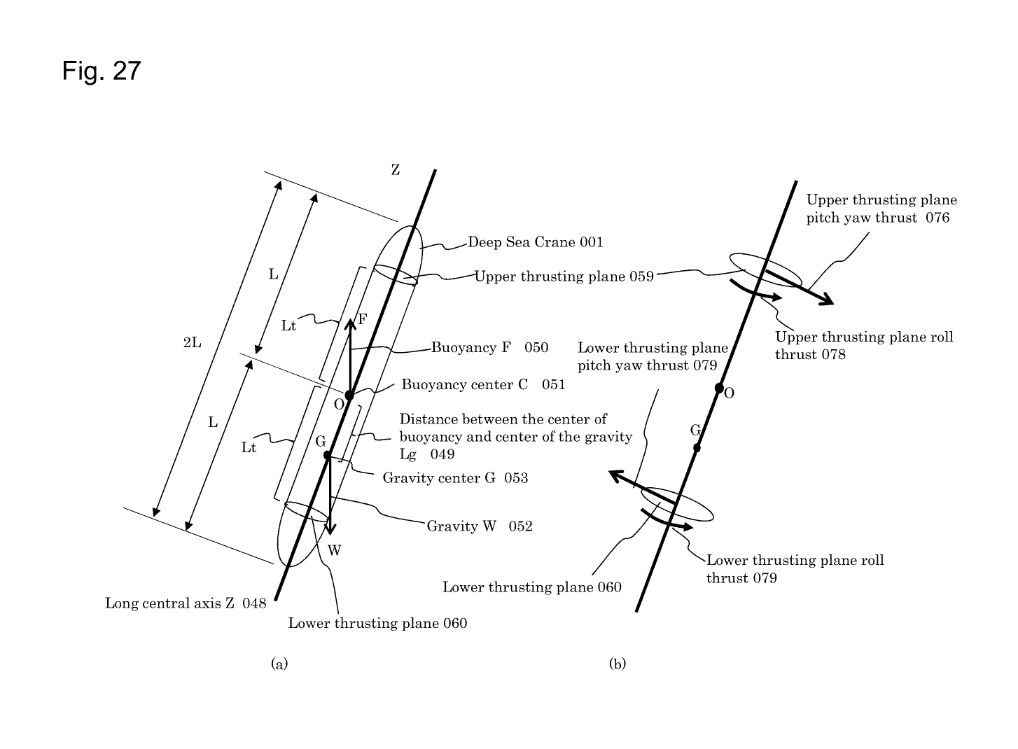

Deepsea Crane 001 as shown in FIG. 25 and FIG. 27

a. The concept of the upper thrusting plane 059 and the lower thrusting plane 060 is applicable for the Seafloor Station 018 as for the Deepsea Crane 001,

The thrusters concentrate on the two planes (Upper one, Lower one) which are perpendicular to the Z axis. The upper thrusting plane 059 exists at a position higher than the center of gravity, the lower thrusting plane 060 is set at a position lower than the center of gravity, and the z-axis locates in the same positional relation as the Deepsea Crane 001.

b. The thrusters of the lower thrusting plane 060 exist at positions below the center of gravity of the Seafloor Station platform 027, and the thrusters are the large type to meet the weight concentration at the lower portion.

c. Since the upper thrusting plane 059 and the lower thrusting plane 060 do not exist in equidistance from the center of gravity G053, the Lt changes to Lt1 and Lt2.

Replacing (Equation 001) and (Equation 003) of the Deepsea Crane 001 with (Equation 037) and (Equation 038), and then substituting the thrust vectors corresponding to the thruster in FIG. 62 (b) as follows;

T_{U0}=T₀₀+T₀₁

T_{U1}=T₁₀+T₁₁

T_{U2}=T₂₀+T₂₁

T_{U3}=T₃₀+T₃₁

It is possible to apply Equation 001 to Equation 037 for the Deepsea Crane 001 to the Seafloor Station 018 as they are.

$$T = [ \begin{matrix}{T}_{x} \\ {T}_{y } \\ {T}_{z}\end{matrix} ] = {T}_{U} + T \\ Where , {T}_{U} = [ \begin{matrix}{T}_{Ux} \\ {T}_{Uy } \\ {T}_{Uz}\end{matrix} ] = {TuI}_{b} \\ {T}_{L} = [ \begin{matrix}{T}_{Lx} \\ {T}_{Ly } \\ {T}_{Lz}\end{matrix} ] = {TlI}_{b} \\ T = {TI}_{b} \qquad [ Equation 037 ]$$

Where, I_{b} is a unit vector showing the direction of T.

$${L}_{t 1} {T}_{U} = {L}_{t 2} {T}_{L} \\ {T}_{L}^{′} = \frac{{L}_{t 1}}{{L}_{t 1} + {L}_{t 2}} T + \frac{R}{2} \\ {T}_{U}^{′} = \frac{{L}_{t 2}}{{L}_{t 1} + {L}_{t 2}} T + \frac{R}{2} \qquad [ Equation 038 ]$$

(a) Position and Speed Control

a.1 Depth Control

When floating, the Seafloor Station controls in the same way

as the Deepsea Crane 001, as it uses the Crane Engines 005 as the component for floating.

When descending, as the buoyancy tank 003 of the Crane Engine 005 keeps 1 atm of hydrogen gas, and specific gravity of the Seafloor Station 018 is same as the seawater at the start of descending from the sea surface,

Therefore, if all of the tanks of the Seafloor Station 018 fills with liquid, its specific gravity becomes larger than seawater, and a soft landing on the seafloor becomes impossible.

If the Seafloor Station 018 keeps the specific gravity same as the seawater at the sea surface filling its buoyancy tanks 003

with one atm of hydrogen,

and if the Crane Engine 005 gives the initial descending speed,

the Seafloor Station 018 descends to the seafloor at a constant rate which balances with the water resistance.

The Seafloor Station 018 descends maintaining the volume of the hydrogen gas and the buoyancy generating the hydrogen gas by the hydrogen gas generator 024,

to avoid the decrease the volume of hydrogen gas and the increase of the specific gravity and the descending speed increases, if left untreated, the seawater pressure increases as descending.

a.2 Movement Control

The Seafloor Station performs the same control as the Deepsea Crane 001.

(b) Attitude Control

The Seafloor Station controls same as the Deepsea Crane 001.

(c) Rendezvous

Termination control is not required because it is a soft bed near the designated site of the seafloor, and at the time of lift up floating is to the near point of the crane of the surface mother ship 018.

The construction procedure of the control system is same as the procedure for the Deepsea Crane 001 as follows.

(a) Position speed control

(b) Attitude control

(c) Integration of control quantities

(d) Configuration of the control system

Contrasting the following block diagrams of control systems

Seafloor Station 018 as shown in FIG. 66

Deepsea Crane 001 as shown in FIG. 29

It is necessary for the Seafloor Station 018 to carry out the control which does not exist in the Deepsea Crane 001. Therefore, The following “a” and “b” describe these points concerning FIG. 66.

a. Since the Seafloor Station 018 comprises of the four (In the case of this embodiment) Crane Engines and the Seafloor Station platform 027, and thus it is different from the Deepsea Crane 001. It is not possible to apply the operation to control the deviation between the pressure of buoyancy tank and the sea pressure to near zero controlling the depth and depth change by the thrusters.

b. During the descent, it is necessary to keep the buoyancy generating the hydrogen gas. As the correspondence to the above section “a.”. Each of the Crane Engine from 0050 to 0053 in FIG. 66 has independent hydride reactors, on the other hand since the sea depth is common, suppose seawater pressure is PW, and that of each Crane Engine is PH0, PH1, PH2, PH3, then the pressure sensors detect the differential pressure as follows;

P_{D0}=P_{H0}−P_{W}

P_{D1}=P_{H1}−P_{W}

P_{D2}=P_{H2}−P_{W}

P_{D3}=P_{H3}−P_{W}

The above data needs to be zero.

However, the Seafloor Station Platform 027 cannot keep horizontal if it is by injecting/draining water to/from the buoyancy tanks, their hydrogen gas volume becomes unbalanced and, their buoyancy becomes so among Crane Engines.

Although the Z-axis thrusters on the Seafloor Station Platform 027 can balance it, the Z-axis direction thrust is to control the pressure precisely. It is the control strategy to pay the fewer efforts to keep the balance by the Z-axis thrusters, to spend more by controlling the reaction amount changing the toluene flow Ft and the reactor temperature T by the hydride reaction control system 258.

b. As the correspondence to the section “b,” the hydrogen gas moles in each buoyancy tank 003 of the Crane Engines 005 are increased by the hydrogen gas generator controller 268 in the block diagram of FIG. 66 and by the valve/pump (V0, P0) control system for each of the Crane Engine 005 in the pipe connection of FIG. 77 using the hydrogen gas generator 024. The depth is controlled to keep the buoyancy constant against the increased hydrogen gas using the thruster (large) 200 and the thruster (medium) in FIG. 59.

This operation is that,

When floating up, as the “Principle of IV lifting 1.1 Hydride reaction” shows that the Seafloor Station 018 floats up controlling its depth to keep the buoyancy constant by decreasing the amount of hydrogen gas moles over time controlling the hydride reactor 260 by the hydride reactor controller 258.

When descending, the operation is opposite to the floating up; it is to keep the buoyancy constant against the increased hydrogen gas using the thrusters (large) 200 in FIG. 59 increasing the depth of the Seafloor Station 018. The amount of hydrogen gas moles in the buoyancy tank 003 increases over time by operating the hydrogen gas generator 024 and by the operation of the valve/pump (V0, P0) controller corresponding each Crane Engine 005.

Regarding the characteristics of buoyancy control during descent, there should be the correspondence between the following two;

The Seafloor Station 018 as shown in FIG. 67

The Deepsea Crane 001 as shown in FIG. 20

In FIG. 20 the number of moles of hydrogen gas decreases with time, and in FIG. 67 the number of moles of hydrogen gas increases so that starting from the state of the mole number equivalent to 1 atm at sea level, and the number of moles is increased corresponding to the pressure at the seafloor.

3. Navigation Control

(1) Configuration

For the entire navigation control, there should be the correspondence between the following two;
The Seafloor Station 018 as shown in FIG. 63
The Deepsea Crane 001 as shown in FIG. 30

In the Seafloor Station 018, the optical navigation and the rendezvous navigation are not adopted because precise terminal control is unnecessary.

As a special operation of the Seafloor Station 018, there is an operation to float up and move horizontally seeking seafloor resources, but it is the same as a part of the operation of replacing the Cargo unit with moving operation of the Deepsea Crane 001 at the bottom of the sea.

For the overall configuration of the control system, there should be the correspondence between the following two;
The Seafloor Station 018 as shown in FIG. 64
The Deepsea Crane 001 as shown in FIG. 32

These are same except that the contents of the navigation control system are simplified compared to the Deepsea Crane 001 (below).

For the operation of the navigation control system, there should be the correspondence between the following two;
The Seafloor Station 018 as shown in FIG. 65
The Deepsea Crane 001 as shown in FIG. 33

In comparison with the Deepsea Crane 001, it is simplified without optical navigation and docking navigation. Further, when floating up the Seafloor Station 018 moves holding the self-position as it is, the initial position setting is simplified.

(2) Inertial Navigation

For the operation of inertial navigation systems, there should be the correspondence between the following two;
The Seafloor Station 018 as shown in FIG. 69
The Deepsea Crane 001 as shown in FIG. 34

In FIG. 69 (a), pitch, yaw, and roll are assigned in the same manner as the Deepsea Crane 001 in response to the difference in external shape. Processing is common to the both.

(3) Acoustic Navigation

Regarding the principle of acoustic ranging and how to implement it, there should be the correspondence between the following two;
The Seafloor Station 018 as shown in FIG. 68
The Deepsea Crane 001 as shown in FIG. 35

In FIG. 68 (a) (b), the sound sensing elements A-D 132 to 135 and the acoustic oscillator 131 are arranged on the top of the four Crane Engines 005 and on the bottom surface of the Seafloor Station platform 027. Since the propagation of the sound waves can be handled similarly to the Deepsea Crane 001 as described in FIG. 68 (c) (d), the same acoustic navigation as the underwater lifting apparatus 001 can be applied.

(4) Optical Navigation

It does not apply to the Seafloor Station 018.

(5) Docking Navigation

It does not apply to the Seafloor Station 018.

4 Operation Mode Control

The comparison with the Deepsea Crane 001 is as follows.
The Seafloor Station 018 as shown in FIG. 70
The Deepsea Crane 001 as shown in FIG. 48
   The following operations are different from the Deepsea Crane 001 because the Seafloor Station 018 is filled with the hydrogen gas in the buoyancy tank 003 due to the low buoyancy at the time of descent.

(a) No. 6 Preparation for Descending (hydrogen gas filling)

(b) No. 7 Descending

(9) No. 9 Post Descending Operation (reduction of buoyancy)

Details are described in “5. Fluid configuration control”.

5. Fluid Configuration Control

The principle is same as the Deepsea Crane 001, since a control is made to change the liquid composition to realize the internal state corresponding to each operation mode by controlling the piping status to change the fluid composition inside the Crane Engine 005, which is a common component of the Deepsea Crane 001.

However, since the operation is different from the Deepsea Crane 001, FIG. 70 is applied instead of FIG. 48. The processing flows 1 and 2 in FIGS. 70 (a) and (c) are the same as those of FIG. 48. In the operation mode transition, control of the following (1) to (10) is performed according to the piping system of FIG. 79 (b) and FIG. 71 to FIG. 80 corresponding to each mode.

(1) Floating Up (Operational Mode 1 FIG. 71)

(a) Seafloor Station 018

The same control as the Deepsea Crane 001 is performed.

(b) Surface Mother Ship

No piping connection to other systems and, independent operation.

(2) Completion of Floating and MCH Unloading (Operational Mode 2 FIG. 72)

(a) Seafloor Station 018

The same control as the Deepsea Crane 001 is performed.

(b) Surface Mother Ship

Connecting with the Seafloor Station 018, MCH is transferred.

(3) Preparation for Descending (Toluene Filling) (Operational Mode 3 FIG. 73)

(a) Seafloor Station 018

The same control as the Deepsea Crane 001 is performed.

(b) Surface Mother Ship

Toluene is transferred connecting with the Seafloor Station 018.

(4) Preparation for Descending (Pure Water Filling) (Operational Mode 4 FIG. 74)

(a) Seafloor Station 018

The same control as the Deepsea Crane 001 is performed.

(b) Surface Mother Ship

The pure water is transferred connecting with the Seafloor Station 018

(5) Descending (Operational Mode 5 FIG. 75)

(a) Seafloor Station 018

The Seafloor Station 018 has no load to unload at the sea surface since the Seafloor Station platform 027, the hydrogen gas generator 024 and the seafloor bulldozer 019 are lifted from the seafloor as the load instead of the collected ores.

Since the Seafloor Station 018 maintains the same specific gravity as the seawater with maintaining 1 atm of hydrogen gas in the buoyancy tank 003 of the Crane Engine 005 at sea surface, if the buoyancy tank 003 is filled with liquid the specific gravity of the Seafloor station 018 becomes larger than that of seawater, and its soft landing on the seafloor becomes impossible.

The buoyancy tank 003 is filled with hydrogen gas of 1 atm at the surface of the sea so that the specific gravity of entire Seafloor Station 018 becomes same (set to be a little larger) as the seawater, and the specific gravity of the entire Seafloor Station 018 is set to 1.0. The descent is started in this state.

During the descent, hydrogen gas is generated by the hydrogen gas generator 024, and it descends while maintaining buoyancy. The valves with the outside are closed while descending, this is different from the hydrogen gas generator controller 268 in the block diagram of the control system of the Seafloor Station of FIG. 66 in the piping connection of FIG. 77.

(b) Surface Mother Ship

No piping connection to other systems, independent operation.

(6) Seafloor Movement (Operational Mode 6 FIG. 76)

(a) Seafloor Station 018

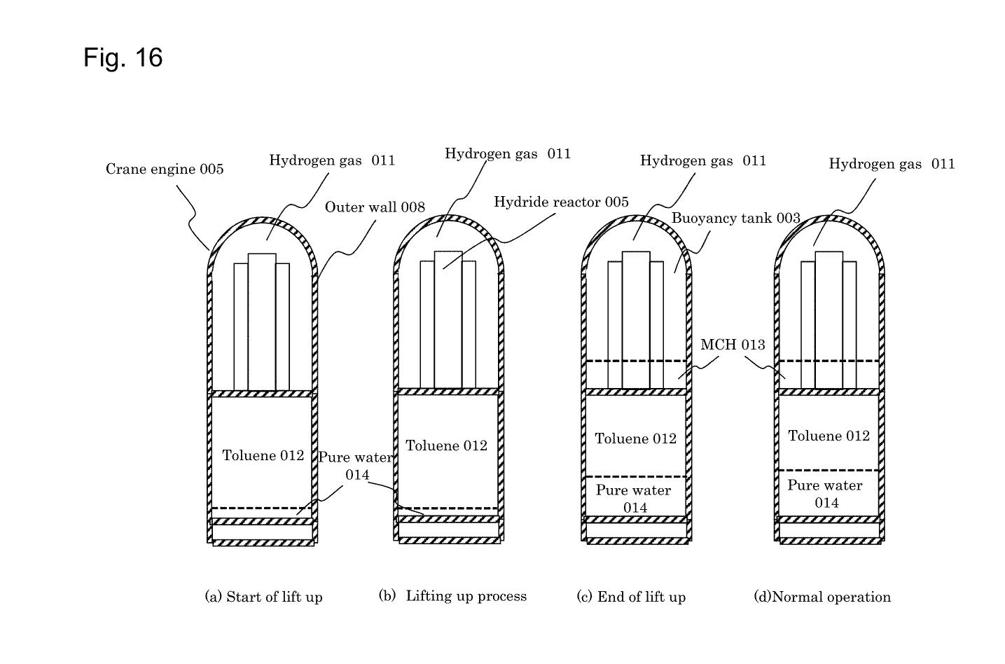

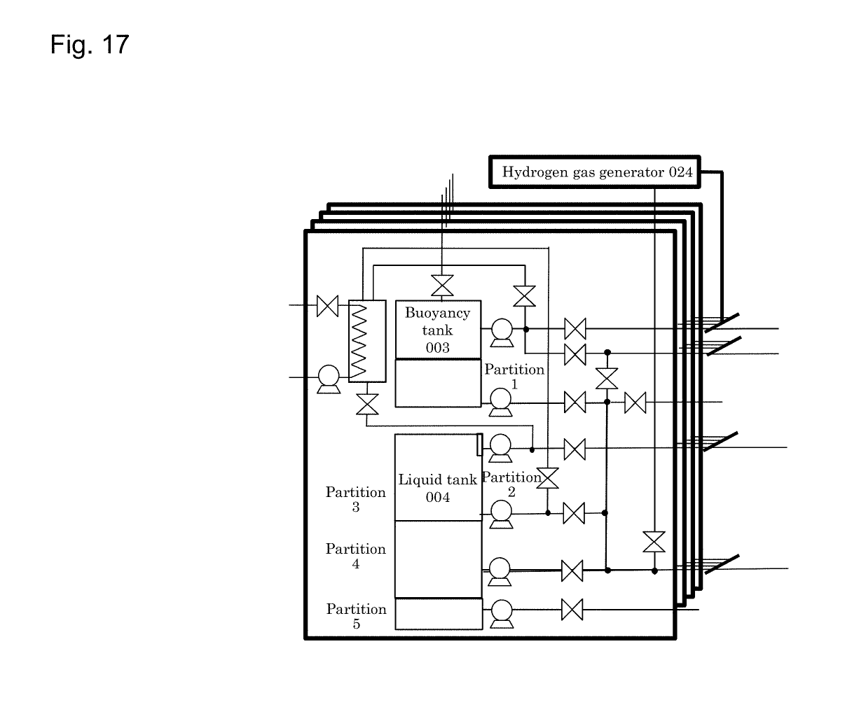

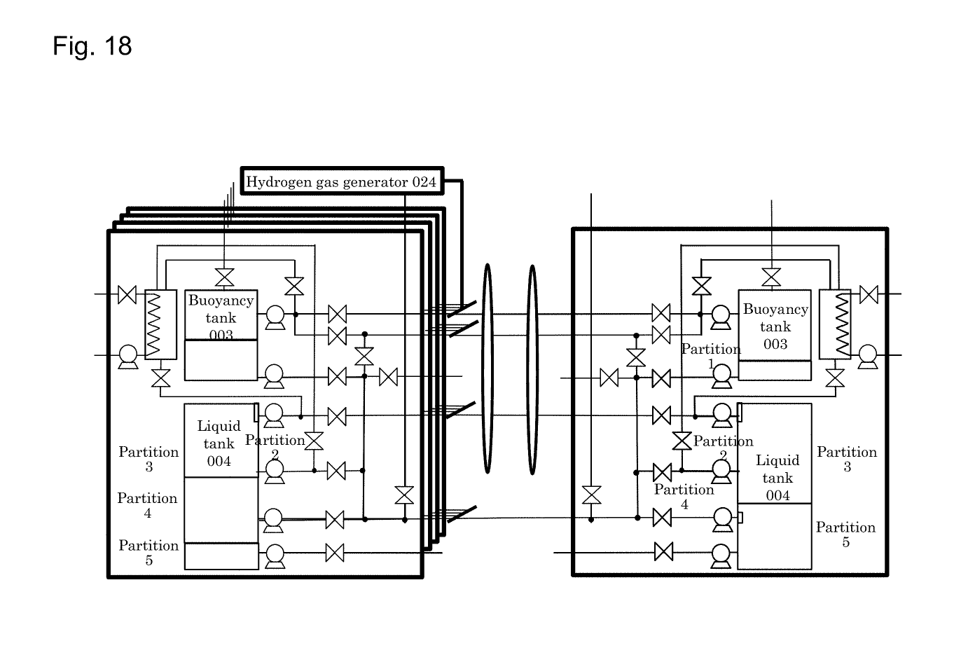

(1) The hydrogen gas in the buoyancy tank 003 is increased by the hydrogen gas generator so as to prepare for the movement, and the state of the “Start of lift up” in FIG. 16(a) is set up, excess seawater is discharged for the increased hydrogen gas.

(2) The Crane Engine 005 is set to closed to outside and lifts up by the thruster (large) 200 and the thruster (medium) 201, and then moves in parallel to the seafloor and descends over the specified position by changing the propulsion direction of thrusters (large) 200 and thrusters (medium) 201.

After the settlement on the seafloor, the volume of the hydrogen gas is decreased being adsorbed to toluene or being released, and the specific gravity is set to more than 1.0.

FIG. 15 (a) shows a state in normal operation, and the lamp way 025 for the seafloor bulldozer 019 is expanded, the volume of hydrogen gas in the Crane Engines 005 is reduced so that the specific gravity of the Seafloor Station 018 is larger than 1.0.

In FIG. 15 (b), the seafloor bulldozer 019 is mounted on the Seafloor Station 018 for preparing the movement, and the lamp way 025 is folded, and the hydrogen gas is increased by electrolysis, and the specific gravity of the Seafloor Station 018 is set to 1.0.

The Seafloor Station 018 floats up, moves, and descends by the thrusters (large) 200 and the thrusters (medium) 201.

FIG. 15 (d) is a state in which the volume of hydrogen gas is reduced and the specific gravity of the Seafloor Station 018 is larger than 1.0.

(a) Surface Mother Ship

No piping connection to other systems, independent operation.

(7) Buoyancy Reduction Process Post Settle Down (Reduction of Hydrogen Gas) (Operational mode 7 FIG. 77)

(a) Seafloor Station 018

Hydrogen gas accumulated in the buoyancy tank 003 of the Seafloor Station 018 is guided to the hydride reactor 009 and then absorbed into toluene to change to the MCH which is sent to the liquid tank 4 Partition 3 via V 12 and P2. In response to the volume reduction of hydrogen gas, seawater is injected into the buoyancy tank 003 via V2, V8 and P1.

(b) Surface Mother Ship

No piping connection to other systems, independent operation.

(8) Preparation for Floating Up, Increasing Buoyancy (Operational Mode 8 FIG. 78)

(a) Seafloor Station 018

The hydrogen gas generator 024 is activated, and the volume of hydrogen gas in the buoyancy tank 003 is increased, and the specific gravity of the entire Seafloor Station 018 is set to 1.0 to enable floating.

(b) Surface Mother Ship

No piping connection to other systems, independent operation.

VI Hydrogen Gas Generator

A hydrogen gas generator 024 is installed in the Seafloor Station 018 generate buoyancy as shown in FIG. 6. The structure of the hydrogen gas generator is as shown in FIG. 80, and by the embodiment of the present invention, four sets of hydrogen generator unit 0 to 3, 351 to 354 correspond four Crane Engines 0 to 3 in the Seafloor Station 018.

Each Crane Engine of the Seafloor Station 018 can send pure water to the hydrogen gas generator 024 by pump 4 (P4) via valves 6 and 13 (V6, V 13), as shown in FIG. 71 to 78 and pure water flows from the corresponding Crane Engine to the water electrolysis stacking unit 359 via the adjustment valve 361 from the connected Crane Engine of the Deepsea Crane 0 to 3 0050 to 0053 in FIG. 79. The power distribution board of the Seafloor Station 018 supplies electricity for electrolysis to the distribution board for hydrogen gas generator unit 480, which is the power distribution board of hydrogen generator units 0 to 3, 351 to 354, and then to the water electrolysis laminated-unit 359 via the safety shut-off switch 360. The water electrolysis laminate unit 359 operates in a rated continuous operation in the normal condition, but ON/OFF control of the safety cutoff switch 360 via the control panel for the hydrogen gas generator unit. And the control valve 360 controls the water flow for each of the individual water electrolysis laminated units 359. The control system for Seafloor Station monitoring 446 controls the control panel of the hydrogen gas generator unit 482 via the interface to the hydrogen gas generator of the Seafloor Station control system 431. The hydrogen gas generated by the water electrolysis laminated unit 359 is accumulated in the buoyancy tank 003 by the pump 0 (P0) via the valve 0 (V0) of the Crane Engines in FIG. 71 to 78.

The water electrolysis laminated unit 359 corresponding to each of the Crane Engine comprises a plurality of ones. Each of the water electrolysis laminated units 359 has a structure of FIG. 80, and is known as a solid-polymer laminate fuel cell/electrolysis apparatus.

Hydrogen gas fuel cells are fed hydrogen gas and oxygen to generate water, but also it is widely known that the same equipment operated inversely can produce oxygen gas and hydrogen gas from water and electricity. FIG. 80 shows a structure of a water electrolysis laminated unit and has been publicly in use. The hydrogen gas fuel cell has been in commercial use as a compact and durable one for automobiles. For Toyota MIRAI, there are 370 laminated sheets, 114 kw power generation capacity and 56 kg weight of 37 liters.

When the hydrogen gas generator by electrolysis is of the same level of technology, 1000 sets of the “Toyota MIRAI's” electrolysis laminate unit with 56 kg in weight and 37 m3 in the volume are needed to generate hydrogen gas of 280 m3 per day at 5000 m below the sea level at 500 atm.

One Seafloor Station 018 requires 4000 sets of the water electrolysis laminate unit, but it can mount them within its margin for the weight.

Regarding cost, the operation depth is assumed to be 5000 m, if the operation depth is one third it comes to be 1700 m, and the amount of the collected ore is one fourth, i.e., 250 tons a day, the water electrolysis laminated unit can reduce to 140 units. It is expected to correspond with the future low cost of water electrolysis laminated unit/fuel cell.

The bubbles of the decomposition gas generated in the electrode prevent the electric current, and this is a factor to degrade the performance of water electrolysis, and the efficiency reduces. The apparatus for performing electrolysis in the pressurized environment is in commercial use to prevent this factor. Therefore, the high-pressure environment of the seafloor is suitable for electrolysis, and nothing interferes its operation there. The voltage applied to one layer of the laminate is electrochemically determined and is between 1.4V and 2 V. In the case of MIRAI, 600 V for 370 layers, 1.6 V for the single one.

Since the Surface mothership 016 supplies electric power for electrolysis via the underwater power cable, it is desirable to increase the number of laminated layers to transmit electricity in high-voltage reducing its water weight and its water resistance, not to affect the dynamic characteristics of the Seafloor Station 018 and the Deepsea Crane 001.

VIII Power Generator

In the seafloor resource lifting apparatus of the present invention, the hydrogen gas generation requires electricity.

The Surface mothership 016 operates at a fixed point on the sea.

If the solar cells on the sea surface or onboard generator(s) generate electricity, the energy efficiency improves as there is no necessity of electricity transmission and no need for the land space, and also as MCH (methylcyclohexane) recovers the generated electricity in a transportable form. When the solar cells are the power source, and as the film type solar cell is rapidly advancing and has become a stage where the offshore power generation equipment is available in addition to the advance of the microinverter in the present invention.

1. Current and Wave Conditions

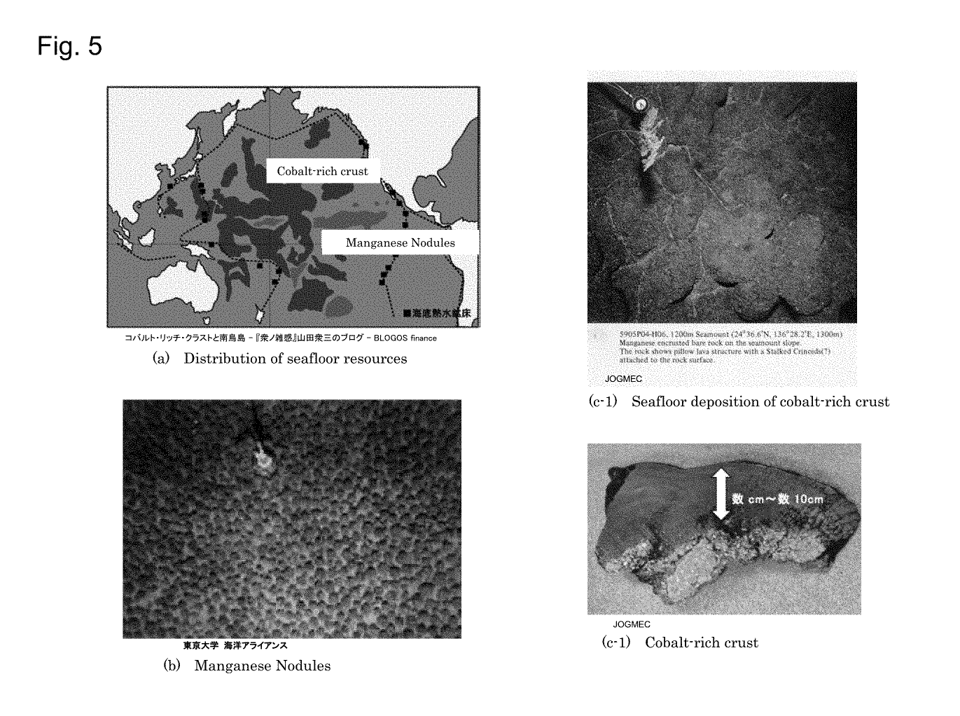

The seafloor resource lifting apparatus of the present invention is intended for the Pacific Ocean area shown in FIG. 5, and is assumed to be the sea area from the north of the equator to the vicinity of Ogasawara. FIG. 81 (a) shows that the sea conditions in this region where the Meteorological Agency forecasts the wave height, and in FIG. 81 (b) the Japan Coast Guard shows the distribution of sea current. The ocean current is between 0.5 knots and 1.5 knots, and the wave height is 3 m or less except for typhoon and cyclone area.

2. Power Supply Requirements

(1) Environmental Endurance

Waterproofing is essential for the operation at sea surface, and durability is critical because of the long-term use of the annual order. It is necessary to be in the film because the bending stress is imposed at the sea surface by the wave and at the time of expansion and withdrawal of the cells.

To withstand the wave height of up to 3 m except for typhoon, analyzing the movement of sea surface referring to FIG. 81(c) sea surface length increases by 0.05% in the case of the wave height of 3 m, compared to the case of 0 m in height, therefore it is acceptable if the cell endures this level of expansion.

(2) Area of Power Generation

The amount of solar radiation in the subject sea area is 2000 kWh/m2 per year, so it becomes 5.5 kWh/m2 in a day. As the 10% of the power generation efficiency is available (2020), it comes to be 0.55 kWh/m2.

It is necessary to generate 1000 m3 of hydrogen at 500 atm if it is collected 1000 tons daily from 5000 m of the sea bottom. Since the required power is 2500 MWh, the area of power generation is 4.5 square kilometers.

By reducing the sea depth from 5000 m to its one third, and reducing the amount of collected ore to one fourth, i.e., 250 tons/day, the area of power generation will be 0.38 square kilometers.

(3) Deployment and Withdrawal

In the event of a typhoon, the Surface mothership 016 withdraws the cells to avoid damage and deploys them after its passing. The ship has to expand the cells and remove them in two or three hours with a small number of participants.

(4) Maintainability

Because the cells become a large area, their partial failure should be detected and should be replaceable on the ship.

3. The Offshore Solar Power Generator

FIGS. 82 to 89 show the examples that match “2. Power Supply Requirements”. The onboard generator(s) mounted on the Surface mothership 018 can replace the solar power generator.

(1) Structure of Solar Cells

FIG. 82 a shows the deployed state of solar cells. A plurality of solar cells on the strip are deployable toward the downstream side of the current 410, from the Surface mothership 016. Since the Surface mothership 016 stations at a fixed point, the deployment in the current between 0.5 knots and 1.5 knots. The solar cell strip is coupled to the Surface mother ship 016 by the traction line 403.

FIG. 82 (b) shows a solar cell strip 401, which is with self-propelled solar-cell expansion equipment 404 at the tip, and the solar cell strip 401 is rolled out at the time of deployment and retracted while retracting the solar cell strip 401 during the withdrawal. The Surface mother ship 016 side is with a structure in which the traction line 403 tows the interconnected solar cell strip traction plate 390, and the cell strip termination rod 391 at the end of the solar cell strip 401 is coupled to the solar cell strip traction plate 390.

Solar cell strip 401 is a strip-linked solar cell unit 412 that seals a constant length solar cell film 400 into a foamed plastic 407 sheet with a protective film 402 to form a solar cell unit 412. The solar cell unit 412 floats on the sea surface by itself.

The protective film 402 protects the solar cell film 400 from the environment, such as seawater, and strengthens the strength of the solar cell unit 412. The micro-inverter 405 is a semiconductor circuit for converting the DC voltage generated by the solar cell film 400 into alternating current, and for converting the DC voltage to the AC cable 406, and each solar cell unit 412 has it.

The self-propelled solar cell deployment equipment 404 retracts the solar cell strip 401 in the rotary drum 415 (FIG. 84).

It accommodates a solar cell strip 401 of about 5 km by winding up until the thickness of the solar cell unit 412 reaches a radius of 2 m in the rotating drum 415 with that of 0.5 m.

Although the micro-inverter 405 has advanced in recent years, it is a semiconductor circuit, and it has no inherent obstacle to constituting the semiconductor circuit with a thickness of 4 mm and has a structure embedded in the solar cell unit 412. The solar cell unit 412 connects adjacent solar cell units 412 with zipper joints 408. This structure is for maintenance by replacing on the Surface Mothership 016 when the solar cell unit 412 fails. Further, it is also possible to absorb stress caused by waves or the like to the solar cell strip 401 by applying elasticity to the zipper joint 408.

The side edge of the solar cell strip 401 is provided with an anti-ride fin 409 so as not to ride on the adjacent solar cell strip 401, having the elasticity to be flat when winding.

The solar cell strip 401 is housed in the rotating drum 415 of the take-up wheel 414 in FIG. 86 and is housed in the Surface mother ship 016 and deployed in the target sea area. The Surface Mothership extends the solar cell strip 401 and has to withdraw it at the time of the typhoon in a small number of participants in a short time (2-3 hours).

And after the recovery of sea conditions, The Surface Mothership needs to redeploy and has a system and structure that enables withdrawal and redeployment. FIG. 84 shows the scheme of a self-propelled solar cell deployment equipment used for deployment and removal of solar cell strips 401.

The traction cradle 411 is a floating body in which the winding wheel 414 is housed in the central portion to move the solar cell strip 401. And the traction roller is provided with a propulsion motor 420 on both sides, and it is possible to move forward, backward, and variable direction using the water jet. In the center portion of the traction cradle 411, there is a hole accommodating the winding wheel 414 and fixed to the traction cradle 411 by the fixing mechanism 417 of the core portion 413 of the winding wheel 414.

The traction cradle 411 fixes the fixing mechanism 417 and the central axis 425, winding motor 416, rotation transmitter 418.

The rotating drum 415 contacts the central axis 425 via the rotary bearing 424 and the rotation of the take-up motor 416 is transmitted by the rotation transmitting device 418. The winding motor 416 rotates or reverses the solar cell strip 401 by turning or reversing the rotating drum 415.

The underwater wing called an Otter-board (used in the net deployment of trawl fisheries) in the front side of the water of the traction cradle 411 can control the course of the solar cell strip 401 without the propulsion motor 420 after the deployment by the current. And also the motor drive equipment 429 for position control can adjust the direction.

The solar cell strip self-propulsion system 428 (FIG. 87) controls the motor drive equipment 429 for position control.

FIG. 85 is a top view and side view of a self-propelled solar cell deployment device. The traction cradle 411 may be a resin cavity or a rubber boat of air expansion if it is possible to maintain self-shape and to prevent rotation of the core portion 413 of the winding wheel 414. The moving speed of the traction cradle 411 is around 1 m per second which are determined by the deploying/withdrawal speed of the solar cell strip 401.

(2) Deployment and Withdrawal of Solar Cells

FIG. 83 shows the procedure to deploy and to withdraw the solar cell strips 401. FIG. 83 (1) (2) (3) are diagrams in which the self-propelled solar cell expander equipment 404 is sequentially connected to the traction wire 403 and flows downstream of the current. FIG. 83 (4) (5) show a procedure for extending the traction wire 403 so that the self-propelled solar cell expander equipment 404 is perpendicular to the current 410. FIG. 86 illustrates the operation of the solar cell strip traction board 390 when the solar cell strip 401 is deployed. The Surface mothership tows the solar cell strip traction board 390 which is connected to each other by a solar cell strip traction board joint 392 using the traction wire 403 (FIG. 83(4)).

One traction cradle 411 is connected to each solar cell strip traction plate 390 by a traction cradle gripping arm 393.

Solar cell strip terminal bar 391, which is a distal end of solar cell strip 401, is held on solar cell strip traction plate 390 by the cell strip termination rod gripping arm 395.

The driving mechanism 394 of traction cradle grip arm and the drive mechanism 396 of the solar cell strip termination rod gripping arm, respectively (FIG. 86 (b)) can control to grip and to release the traction cradle grip arm 393 and the solar cell strip termination arm 395.

The gripping arm 395 of the solar cell strip termination bar captures the solar-cell strip termination rod 391, is supplied to the traction cradle 411, introducing a winding wheel 414 winds the solar cell strip 401 on it, In FIGS. 83(1) to 83 (3)

Solar cell strip 401 connects to solar cell strip traction plate 390 and the current collector cable 397 connects to the solar cell strip 401.

In FIG. 83 (5), the traction cradle grip arm 393 is released to drive propulsion motors 420, 421 to advance the self-propelled solar cell expander 404 (FIG. 83 (6)). The withdrawal of the solar cell strip 401 performs the reverse procedure.

(3) Solar Cell Strip Self-Propulsion System

The control system 467 of FIG. 87 for the solar cell strip deployment controls the self-propelled solar cell deployment equipment 404. The self-propelled solar cell deployment equipment 404 knows its position by GPS 419, and optical interface 453 receives the expansion/withdrawal command from the control system 450 for power supply monitoring (FIG. 90). The computing device 442 controls the winding motor 416 and the starboard propulsion motor 420 and the port propulsion motor 421 of the rotary drum 415 via the motor drive controller 423. After deployment, the motor drive equipment 429 for the position control maneuvers the direction of the Otter-board 426 for the expansion direction control by the current.

The object of the control system 467 for the solar cell strip deployment is to control the expansion/withdrawal rate of the solar cell strip 401 to a specified value (constant value). It is to control the tension applied to the solar cell film 400. And it is to make the traveling direction of the self-propelled solar cell expander equipment 404 to a specified direction.

FIGS. 88 and 89 show the operation of the solar cell strip self-propelled deployment control system. Having received the command from the power equipment supervisory control system 450 (Processing block 700) the flow of control branches based on the received command and the current state (Processing block 701,702).

At the initial state, having received the expansion direction and the expansion line of the solar cell strip 401 (Processing block 701,702), if the expansion direction and the current orientation do not match (Processing block 703), the port and the starboard propellant motor modifies the current orientation (Processing block 707). When the command from the power supply equipment supervisory control system 450 is “Deployment,” the port and starboard propellant motors to control the cradle traveling direction and the progress speed to a specified value (Processing block 711). Further, the tension of the solar cell strip 401 turns to a constant value (Processing block 712). When the position reaches the deployment completion position, the process ends (Processing block 713, 714).

Upon receiving the command from the power equipment supervisory control system 450 “Deployment,” the deployment direction of the solar cell strip 401 is set to a specified path controlling the Otter-board. The port and starboard propulsion motors comply with, as needed, managing the tension of the solar cell strip 401 to a constant value (Processing block 715,716). When the command from the power equipment supervisory control system 450 is received (Processing block 715,716), the development and the reverse direction are controlled. The control of speed and tension is a technology that has been used as the motor control since old times in papermaking and rolling.

IX Monitoring and Control System

1. System Configuration

FIG. 90 shows the supervisory monitoring and control system configuration of a seafloor resources lifting and recovery equipment. Computers implement the functions of all system, but they are unmanned except for the Surface Mothership 016, which performs all of the monitoring control.

The Deepsea Crane console 441 performs monitoring control of each of the Deepsea Crane 001 via the Deepsea Crane control system 430 installed in each of the Deepsea Crane 001.

The Seafloor Station console 442 performs monitoring and control of the Seafloor Station 018 via the Seafloor Station control system 431 installed at each Seafloor Station 018. The Seafloor Station console 442 controls the seafloor bulldozer 019 remotely via the monitoring control system of Seafloor Station 448 and the optical cable 452. The power supply console 443 controls each control system of solar cell strip deployment via a power supply control system 432.

2. Power System

FIG. 91 shows the overall configuration.

The generation of hydrogen consumes the most of energy, and the solar power generation at sea is an example of its supply sources. The Surface Mothership 016 may install a generator on it. When the rechargeable battery 483 is available, the hydrogen gas generator can reduce by charging the solar power electricity and equalizing the hydrogen gas generation in time.

X Operation Method

1. Continuous Operation Requirements

In operation of the seafloor resource harvesting apparatus, it is necessary for the Surface Mothership 016 to continuously supply toluene and pure water to the Deepsea Crane 001.

And is necessary for the Surface Mothership 016 to continuously collect the minerals and the MCH from the Deepsea crane 001, and then repetitively change the installation position including the change of the bottom depth of the Seafloor Station 018. Operational procedures are as follows.

(1) The Seafloor Station 018 descends from the Surface mother ship 016 to the seafloor of the target sea area.

(2) The specific gravity of the Seafloor Station 018 is set to be larger than seawater, and the seafloor bulldozer 019 is deployed to the seafloor.

(3) From the Surface mother ship 016, the Deepsea Crane 001 descends toward the Seafloor Station 018, and the collected and accumulated ores by the Seafloor bulldozer 019 gets on the Deepsea Crane 001, and the hydrogen gas is filled and floated toward the marine command ship 016. (The step of (3) is repeated until the seafloor bulldozer 019 finishes the collection of minerals around the Seafloor Station 018)

(4) The Seafloor Station 018 floats up from the seafloor and changes the settlement position. At this time, there are cases where the moving is only horizontal without depth change, and where to a shallower point, where to a more in-depth point.

The operation stated in (3) repeats at the moving point.

The seafloor bulldozer 019 gets to the Seafloor Station 018, and the specific gravity of the Seafloor Station 018 is set to be same as the ambient seawater by the hydrogen gas generation, to change the settlement position.

And then the Seafloor Station 018 floats up from the bottom and settles down at the target point, then repeats the same operation as stated in (2).

(5) The activities in (2) (3) (4) (4) above repeat until the Seafloor Station 018 is withdrawn to the Surface Mothership 016 and gets maintenance work.

(6) The Seafloor Station 018 floats up from the seafloor, and the Surface Mothership 016 retrieves it.

The Deepsea Crane 001 and the Seafloor Station 018 need to continuously make round trips between the seafloor and sea surface while maintaining a balance of the specific gravity and pressure to the ambient seawater containing toluene, pure water, MCH and the collected minerals. For this reason, there are the following conditions for clarifying the distribution and quantitative constraints of toluene, clean water, MCH, and collecting ores in the Deepsea Crane 001 and the Seafloor Station 018.

1. 1. Definitions of Abbreviations and Specifications

(1) The physical constants follow Table 01 (a).

(2) The device weight and dimensions of the Deepsea Crane 001 and the Seafloor Station 018 are assumed to be 0.4 times of the volume and weight described in “I Concepts and Realization 4 Realization” in the following example.

Table 01 (b) shows the specification of the Deepsea Crane 001, and the specification of the Seafloor Station 018 is as in Table 01 (c).

TABLE 01
(a)

| Constants | Unit | Symbol | |
|---|---|---|---|
| SeaWater Specific Gravity | | ρ_{W} | 1.02500 |
| Tolene Specific Gravity | | ρ_{T} | 0.86690 |
| MCH Specific Gravity | | ρ_{M} | 0.77000 |
| Tolene Molecular Gravity | | m_{T} | 92.1400 |
| MCH Molecular Gravity | | m_{M} | 98.1860 |
| Water Molecular Gravity | | m_{W} | 18.0153 |
| H2 Molecular Gravity | | m_{H} | 2.01588 |
| Molar Volume(Standard gas) | L | Mol | 22.4 |
| Toluene Vuoyancy | | | 0.15354 |
| MCH Buoyancy | | | 0.29870 |

(b)

| Deep Sea Crane Specification | Unit | Symbol | |
|---|---|---|---|
| Buoyancy Tank + Reactor | m₃ | V_{FR} | 125.0 |
| Reactor Volume | m₃ | V_{R} | 20.0 |
| Liquid Tank Volume | m₃ | Vl | 95.0 |
| Buoyancy Tank | m₃ | Vf | 105.0 |
| Reactor Auxliaries Volume | ton | Wr | 13.0 |
| Outer Wall Structure | ton | Ws | 2.0 |

(c)

| | | | | Crane |
|---|---|---|---|---|
| Seafloor Station Specification | Unit | Symbol | | Engine |
| Buoyancy Tank + Reactor | m₃ | | 500 | 125 |
| Reactor Volume | m₃ | | 80 | 20 |
| Liquid Tank Volume | m₃ | | 380 | 95 |
| Buoyancy Tank | m₃ | | 420 | 105 |
| Reactor Auxliaries Volume | ton | | 52 | 13 |
| Outer Wall Structure | ton | | 8 | 2 |
| Platform Structure | ton | | 48 | |
| H2 Generator | ton | | 56 | |

1.2 Physical Properties of Components

The physical properties of the fluid (gas, liquid) constituting the seafloor resource collection equipment are below. Only hydrogen gas is a gas phase, and others are liquid phases. Since the number of moles is constant regardless of pressure, and the flow of fluid to/from outside does not occur other than the sea surface and the seafloor, the fluids are expressed and analyzed based on the number of moles because it is constant.
(1) Hydrogen gas
   a. Moles (10 E6) M_{H}
   b. Weight (ton) W_{H}=M_{H}*m_{H}
   c. Volume (m3) V_{H}=(M_{H}/P)*Mol*1000
(2) Toluene
   a. Moles (10 E6) M_{T}
   b. Weight (ton) W_{T}=M_{T}*m_{T}
   c. Volume (m3) V_{T}=M_{T}*m_{T}/ρ_{T}
(3) MCH
   a. Moles (10 E6) M_{M}
   b. Weight (ton) W_{M}=M_{M}*m_{M}
   c. Volume (m3) V_{M}=M_{M}*m_{M}/ρ_{M}
(4) Pure water
   a. Moles (10 E6) M_{W}
   b. Weight (ton) W_{W}=M_{W}*m_{W}
   c. Volume (m3) V_{W}=M_{W}*m_{W}

1.3 Reaction in the Floating, Descending and Moving processes

The following reaction is carried out to realize the same specific gravity and the same pressure as the surrounding seawater during the floating, descending and moving process.

(a) Floating Up
Since hydrogen gas of the gas phase is necessarily included to obtain the rising buoyancy, the organic hydride reaction is carried out.

(b) Descending
When the hydrogen gas is contained hydrogen gas is generated by water electrolysis
When no hydrogen gas is contained and all fluid is liquid, no reaction occurs.

(1) Organic Hydride Reaction

The subscript 0 indicates the initial value and Δ indicates the change from the initial value.

M_{H}=M_{H0}*ΔM_{H}

M_{T}=M_{T0}*ΔM_{T}

M_{M}=M_{M0}*ΔM_{M}

From the reaction conditions

ΔM_{T}=ΔM_{H}/3

ΔM_{M}=−ΔM_{H}/3

Where, the buoyancy F (Positive upward) is as follows.

F=(V_{H}−W_{H})+(V_{T}−W_{M})+(V_{T}−W_{T})−(X_{B}+X_{L})

When expressed in moles, the following comes out.

F+(X_{B}+X_{L})=M_{H}(1000*Mol/P−m_{H})+(1/ρ_{T}−1)M_{T}*m_{T}+(1/ρ_{M}−1)M_{M}*m_{M}

If the buoyancies corresponding to pressure P₀ and P₀+ΔP at different depths are F₀, and F₁ the next equations come out.

$${F}_{0} + ( {X}_{B} + {X}_{L} ) = {M}_{H 0} ( 1000 * Mol / {P}_{0} - {m}_{H} ) + ( 1 / {ρ}_{T} - 1 ) {M}_{T 0} * {m}_{T} + ( 1 / {ρ}_{M} - 1 ) {M}_{M 0} * {m}_{M}$$

$${F}_{1} + ( {X}_{B} + {X}_{L} ) = ( {M}_{H 0} + Δ {M}_{H} ) ( 1000 * Mol / ( {P}_{0} + Δ P ) - {m}_{H} ) + ( 1 / {ρ}_{T} - 1 ) ( {M}_{T 0} + Δ {M}_{T} ) * {m}_{T} + ( 1 / {ρ}_{M} - 1 ) ( {M}_{M 0} + Δ {M}_{M} ) * {m}_{M}$$

The following equation is obtained by incorporating the organic hydride reaction condition.

$$Δ {M}_{H} = ( ( 1000 * Mol * Δ P * {M}_{H 0} ) / ( {P}_{0} * ( {P}_{0} + Δ P ) ) + ( {F}_{1} - {F}_{0} ) / ( - ( 1000 * Mol / ( {P}_{0} + Δ P ) + {m}_{H} ) + ( 1 / {ρ}_{T} - 1 ) * {m}_{T} / 3 + ( 1 / {ρ}_{M} - 1 ) * {m}_{H} / 3 \qquad ( Equation 038 )$$

P₀ and M_{H0} are given as initial values, ΔP is the pressure difference corresponding to the depth difference, F₀ and F₁ are buoyancy at the initial position and the moving destination, and both are set to 0 during the floating and descent process.

(2) Hydroelectrolysis

The subscript 0 indicates the initial value and Δ indicates the change from the initial value.

If the buoyancy corresponding to the pressure P₀ and P₀+ΔP at different depths is F₀ and F₁, the following is equivalent to the organic hydride reaction.

$${F}_{0} + ( {X}_{B} + {X}_{L} ) = {M}_{H 0} ( 1000 * Mol / {P}_{0} - {m}_{H} ) + ( 1 / {ρ}_{T} - 1 ) {M}_{T 0} * {m}_{T} + ( 1 / {ρ}_{M} - 1 ) {M}_{M 0} * {m}_{M}$$

$${F}_{1} + ( {X}_{B} + {X}_{L} ) = ( {M}_{H 0} + Δ {M}_{H} ) ( 1000 * Mol / ( {P}_{0} + Δ P ) - {m}_{H} ) + ( 1 / {ρ}_{T} - 1 ) ( {M}_{T 0} + Δ {M}_{T} ) * {m}_{T} + ( 1 / {ρ}_{M} - 1 ) ( {M}_{M 0} + Δ {M}_{M} ) * {m}_{M}$$

The reaction condition of the electrolysis of water.

ΔM_{T}=0

ΔM_{M}=0

M_{W}=M_{W0}−ΔM_{W}

M_{H}=M_{H0}+ΔM_{H}

to obtain the following formula.

ΔM_{H}=((1000*Mol*ΔP*M_{H0})/(P₀*(P₀+ΔP))+(F₀+F₁)/((1000*Mol/(P₀+ΔP)−m_{H})) (Equation 039)

As an initial value

M_{H0}=(F₀+(X_{B}+X_{L})−(1/ρ_{T}−1)M_{T0}*m_{T}−(1/ρ_{M}−1)M_{M0}*m_{M}/(1000*Mol/P₀−m_{H})) (Equation 040)

P₀ and M_{H0} are given as initial values, ΔP is the pressure difference corresponding to the depth difference, F₀ and F₁ are buoyancy at the initial position and the moving destination, and both are set to 0 during the floating and descent process.

2. Continuous Operation Configuration

Based on the constraints specified in (Equation 038) (Equation 039) (Equation 040), the operation of the Deepsea Crane and the Seafloor Station operate continuously according to the requirements (1)-(6) of the continuous operation and the operation to collect minerals from the seafloor.

FIG. 92 to 94 illustrate this example and Table 02 to Table 09 shows the corresponding operational parameters.

FIG. 92 is a case where the Seafloor Station 018 moves to a destination with the same depth (1500 m->1500 m).

FIG. 93 is a case where the destination of the Seafloor Station 018 is at the shallower depth (1500 m->1200 m).

FIG. 94 is a case where the destination of the Seafloor Station 018 is at deeper depth (1500 m->1800 m).

FIGS. 92 to 94 mean as follows. The horizontal axis shows the transition of time and the upper side of the horizontal axis shows the depth of the sea. The lower side of the horizontal axis means buoyancy at the seafloor settlement state. The negative buoyancy is same as that the water weight is positive, and it stays on the seafloor by gravity. The Seafloor Station 018 cannot remain on the seabed unless the specific gravity is larger than the surrounding seawater, so it is necessary to maintain a negative buoyancy at the time of settlement. The scale X represents a load equivalent to the rated load of the Deepsea Crane 001 at −1×.

The buoyancy of the Seafloor Station 018 varies between −0.2× and −1.5× (The water weight is 0.2× to 1.5×) because of the one of the Deepsea Crane 001 changes about 1.0× by the loading of hydrogen gas and the loading of ore. This operation is because if the water weight becomes larger the energy required to float increases, and there may be problems with the holding force of the seafloor ground occur.

The floating of the Deepsea Crane 001 and the Seafloor Station 018 require hydrogen gas generation, and pure water is essential for electrolysis. Therefore, the Seafloor Station 018 always needs to hold the necessary pure water and toluene, and the generated MCH is collected at the sea surface when the Deepsea Crane 001 floats up. Environment issue can allow dumping the pure surplus water on the seafloor, but it could not accept releasing toluene and MCH to prevent pollution.

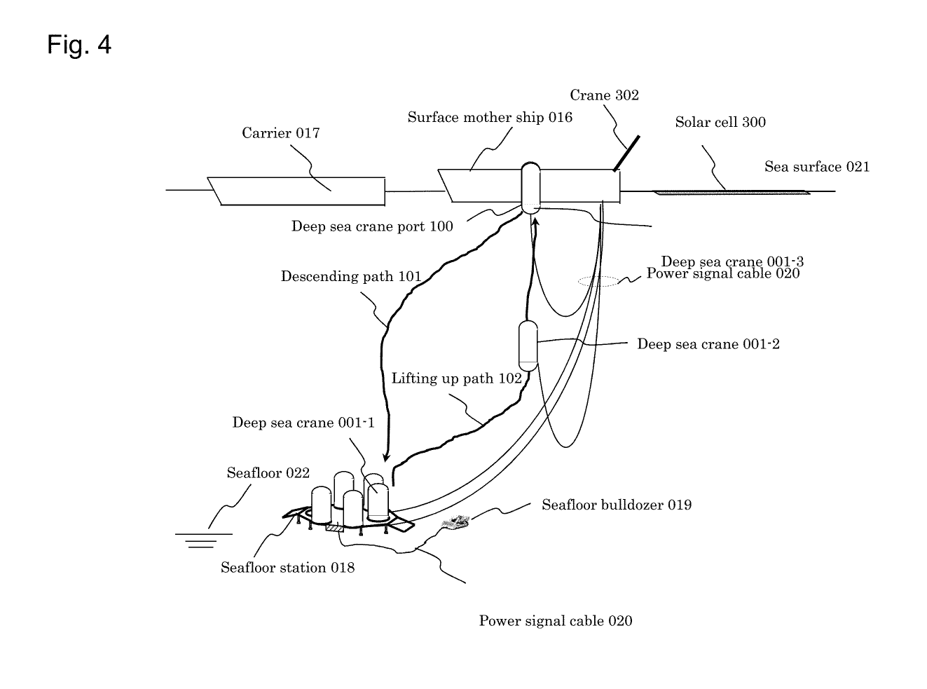

The solid lines show the units 1 to 4 of the Deepsea Cranes 001 (In FIGS. 1 to 4) as a change of the depth to the time on the upper side of the intermediate horizontal axis (time axis) in FIGS. 92 to 94, and making round trips between the Seafloor Station 018 and the Surface mothership 016 and remains in the position of the Seafloor Station 018 for the period of rendezvous & docking (In the figure, marked by “I.”).

In FIGS. 92 to 94, the Seafloor Station 018 is shown as a change of depth over time on the upper side of the horizontal axis (time axis) by bold dotted lines.

After the settlement on the seafloor in “(1) Ph0 Descending,” the Seafloor Station 018 stays there with the water weight (negative buoyancy) until “(11) Ph6 Lifting up,” except for “(6-U) Ph5-D “Move Up,” “(6) Ph5 Move,” and “(6-U) Ph5-D Move Down.”

Time transition of water weight (negative buoyancy) is as follows below the time axis.

The following is an explanation of the implementation of “1. Requirements for continuous operation operations (1)-(6)” by dividing into “(1) Ph0” to “(11) Ph6” concerning FIGS. 92-94 and Tables 02-09.

2.1 Deepsea Crane

FIGS. 92 to 94 show units 1 to 4 of the underwater lifting apparatus 001 (In FIGS. 1 to 4) with solid lines as a change of depth over time on the upper side of the middle axis (time axis). The following steps (1) through (5) are repeated to collect ore from the seafloor.

Table 02 shows the operation of the seafloor with the depth of 1500 m.

Table 03 shows the operation of the seafloor with the depth of 1200 m.

Table 04 shows the operation of the seafloor with the depth of 1800 m.

Each table shows the gas and liquid composition

at starting of the descent from the sea surface to the seafloor, at the time of the end of the descent from the sea surface to the seafloor,

at the time of the start of the floating up from the seafloor to the sea surface,

and at the time of the arrival at the sea surface.

“Pre-descending Process of the Deepsea Crane” (In the figure, marked by “J”)

Toluene is consumed in the organic hydride reaction when floating up occurs, so it is replenished at the time of descending. Pure water is replenished for the hydrogen generation used in the floating of the Deepsea Crane 001 and the Seafloor Station 018. The distribution of toluene, pure water, and MCH is determined to the total specific gravity is same as seawater, and is filled at the Surface mother ship 016 by pre-descending preparation (In the figure, “J”).

“Descending” (In the figure, marked by “C”) No reaction applied

The Deepsea Crane fills with only liquid without including gas. Therefore, because the specific gravity hardly changes due to the water pressure at the time of descent, it settles down on the seafloor with the same composition without performing an organic hydride reaction or hydrogen generation.

“Rendezvous & Docking” (In the figure, marked by “I”)

When the Deepsea Crane 001 and the Seafloor Station do the rendezvous and docking, all of the pure water and the part of toluene, descended accompanying with from the

Deepsea Crane 001, are transferred to the Seafloor Station.

Since MCH is generated and accumulated at the time of moving and adjusting the buoyancy of the Seafloor Station,

MCH fills in the Deepsea Crane as much as possible together with the collected ore as the cargo and the hydrogen gas for buoyancy to make the total specific gravity same as the seawater and to start the Deepsea Crane floating up.

The requirement for the composition of gas and liquid at the time of start of floating is to satisfy the condition that the composition satisfies its pressure and specific gravity are equal to those of the ambient seawater during the lift up process using the organic hydride reaction. Any of the following (a) to (h) is an example to satisfy this condition.

(a) Table 02 depth 1500 m load weight 100 ton normal mode “Floating start.”

(b) Table 02 depth 1500 m load weight 100 ton MCH recovery Mode “Floating start”

(c) Table 03 depth 1200 m load weight 100 ton normal mode “Floating start.”

(d) Table 03 depth 1200 m load weight 100 ton MCH recovery mode “Floating start.”

(e) Table 04 depth 1800 m load weight 100 ton normal mode “Floating start.”

(f) Table 04 depth 1800 m load weight 100 ton MCH recovery mode “Floating start.”

(g) Table 05 depth 1500 m load weight 11.62 ton toluene total recovery mode “Floating start.”

(h) Table 05 Depth 1500 m load weight 31 ton MCH total recovery mode “Floating start.”

The amount of consumption of toluene and production of MCH decide their ratio in (a) (c) (e).

The ratio in (b) (d) (f) is decided to maximize the lifting load avoiding excessive accumulation of MCH at the seafloor.
And in the usual operation. the intermediate value of (a) (c) (e) and (b) (d)(f) is to be selected for the continuous operation.

The case of (g) is the operation to lift up the maximum capacity of 200 m3 of toluene as all of the liquid compositions except for hydrogen at the expense of the load weight.

And the case of (h) is the operation to lift up the maximum capacity of 200 m3 of MCH as all of the liquid compositions except for hydrogen at the expense of the load weight.

Since no gas exists, the numerical values can be intermediate values in an example where excess toluene or MCH can be recovered from the seafloor without hydrogen generation by electrolysis or organic hydride reaction. Thus it is possible to rectify the bias of liquid type generated during continuous operation process.

(4) “Floating up” (In the figure, marked by “a.”) Organic hydride reaction is applied

The Deepsea Crane 001 reaches the sea surface from the Seafloor Station 018 while maintaining the same pressure and the same specific gravity condition as the surrounding seawater using carrying out organic hydride reaction. The gas and liquid compositions of the Deepsea Crane 001 are as follows.

Table 02 depth 1500 m load weight 100 ton normal mode “Floating start”->“sea surface arrival”

Table 02 depth 1500 m load weight 100 ton MCH recovery mode “Floating start”->“sea surface arrival”

Table 03 depth 1200 m load weight 100 ton normal mode “Floating start”->“sea surface arrival”

Table 03 depth 1200 m load weight 100 ton MCH recovery mode “Floating start”->“sea surface arrival”

Table 04 depth 1800 m load weight 100 ton normal mode “Floating start”->“sea surface arrival”

Table 04 depth 1800 m load weight 100 ton MCH recovery mode “Floating start”->“sea surface arrival”

Table 05 depth 1500 m load weight 11 62 ton toluene total recovery mode “Floating start”->“sea surface arrival”

Table 05 depth 1500 m load weight 31, MCH total recovery mode “Floating start”->“sea surface arrival”

(5) Post-floating up Process (In the figure, marked by “K”)

When the Deepsea Crane 001 arrives at the Seafloor Station 016, the unloads lifted ore and the MCH, and according to the operation depth the liquid composition of the Deepsea Crane 001 is adjusted to meet “start of descent” of table 02 to 05 and is descended to the Seafloor Station 018.

In continuous operation, the above (1)-(5) repeat.

2.2 Seafloor Station

The dotted lines show the underwater behavior of the Seafloor Station 018 in FIGS. 92 to 94, (1) Ph0 “Descending” to (11) Ph6 “Floating up.”

(1) Ph0 “Descending”

In the part of (1) Ph0 “Descending” in FIGS. 92 to 94, the Seafloor Station 018 descends from the sea surface to the seafloor while performing water electrolysis (In the figure, marked by “B”) and settles down on the seafloor. Since the specific gravity of the Seafloor Station 018 is larger than that of seawater when liquid fills all its tanks, therefore it is inevitable to fill the buoyancy tank with hydrogen gas and to decrease the total specific gravity to the same as seawater. During descending, hydrogen gas is generated by electrolysis to make the internal pressure and specific gravity of the Seafloor Station 018 equal to the ambient seawater.

In the part of (1) Ph0 “Descending” in Table 06, the gas/liquid composition in the column of “Start Descending” changes to that of “Arrival to Seafloor.”

(2) Ph1 “Deployment”

In the part of (2) Ph1 “Deployment” in FIGS. 92 to 94, the Seafloor Station 018 unloads the seafloor bulldozer 019 after the settlement on the seafloor. (In the figure, marked by “A,” D”). Having a stable settlement during the period is necessary. Since the Seafloor Station 018 has the same specific gravity as the surrounding seawater at the time of settlement, it is required to increase its water weight (negative buoyancy) to the necessary level to prevent the Seafloor Station 018 from floating even when the seafloor bulldozer 019 is unloaded. For this purpose, the organic hydride reaction absorbs hydrogen gas in the buoyancy tank (It generates MCH).

The gas/liquid composition changes from that shown in the column of (1) Ph0 “Arrival to Seafloor” in Table 06 to that shown in the column of (2) Ph1 “Decrease Buoyancy.”

In the part of (2) Ph1 “Bulldozer Deployment” (in the figure, marked by “D”) in FIGS. 92 to 94 (2), the seafloor bulldozer 019 deploys by itself to the seafloor from the Seafloor Station 018. The total weight of the Seafloor Station 018 decreases by the weight of the seafloor bulldozer 019, in the column of (2) Ph1 “Bulldozer Deployment” in Table 06,

(3) pH2 “Ore Collection, Loading (First)”

In the part of (3) Ph2 “Ore collection, Loading (First)” (in the figure, marked by “C,” “G,” “H”) in FIGS. 92 to 94, The water weight of the seafloor bulldozer 019 increases by the water weight of the collected ore, as indicated by a thick solid line, like the seafloor bulldozer 019 loads ore into the cargo unit 007 which is placed in the Seafloor Station 018.

When the status of the Seafloor Station 018 changes from the column “Ore Loading” to the column “DeepSea Crane Arrival” (3) Ph2 in Table 06, there is no change in gas and liquid composition.

In the figure, at the part where marked by “H,” the Crane Engine 005 docks to the cargo unit 007 loaded with the collected, thus the Deepsea Crane 001 loads the collected ore and the Seafloor Station 018 transfers the load weigh to the Deepsea Crane 001. The water weight variation of the part marked by “H” indicates this fact.

At the part marked by “F” in the figures, when the Deepsea Crane 001 fills with the hydrogen gas accumulated in the Seafloor Station 018, the specific gravity of the Deepsea Crane 001 becomes the same as that of the surrounding seawater and preparation for floating up is ready. On the other hand, since the Seafloor Station, 018 loses the buoyancy of hydrogen gas, its water weight increases at the portion marked by “F” “H2 Fill up”.

It is the difference at (3) Ph2 in FIGS. 92 to 94 from the case at (4) Ph3 that the Deepsea Crane 001 generates the hydrogen gas during descending at (1) Ph0, which occurs only once after the settle down to the seafloor. It is the operation from “Deepsea Crane Arrival” to “H2 Fill up/Launching” in (3) Ph2 in Table 06 that the Deepsea Crane 001 loads the ore, unloads pure water, and fills with gas and liquid such as hydrogen. The corresponding columns show the changes in gas and liquid composition during the period.

(4) PH3 “Ore Collection, Loading (Repetition)”

This operation corresponds to (4) Ph3 “Ore Collection, Loading (repetition)” in FIGS. 92 to 94 portion (in the figure marked by “B,” “G,” H”). It is the same as the portion (3) Ph2 “Ore collection, Loading (First) except for accumulation of hydrogen gas in the Seafloor Station 018 by water electrolysis (in the figure marked by “B”). It corresponds to the necessity of supplying hydrogen gas to the Deepsea Crane 001 for each its arrival. The operation (4) The Ph3 is repeated unless the position of the Seafloor Station 018 needs to change.

When a mineral collection is carried out by changing the position at the seafloor, it goes to “(5) Ph4 “preparation for movement.” If the Surface mother ship 016 withdraws the Seafloor Station 018 by floating up to the sea surface, the system goes to “(10) Ph4 “Preparation for Floating up.”

(5) Ph4 “Preparation for Move”

In response to the portion (5) Ph4 “Preparation for Move” in FIGS. 92 to 94 (5) (In the figure marked by “B,” “E,” “B”), the reverse operation of “(2) Ph1 “Deployment” is carried out.

That is, the water weight of the Seafloor Station 018, having increased to settle down to the seafloor, reduces by the hydrogen gas generation (in figure marked by “B”). And the seafloor bulldozer 019 mounts on the Seafloor Station 018 by itself (In the figure marked by “E”).

When the seafloor bulldozer 019 mounts on the Seafloor Station 018, the water weight of the Seafloor Station 018 increases, so that the specific gravity and internal pressure of the entire Seafloor Station 018 become equal to the ambient seawater by generating the hydrogen gas again.

“Increase in buoyancy” in Table 06 (5) Ph4, the water weight reduces by hydrogen gas generation, then it increases by “Bulldozer withdrawal,” and then it comes to 0 by the generation of hydrogen gas again. Thus the preparation for the move is completed.

(6-U) Ph5-U “Move Up”

It is carried out only in the case of moving to a shallower seafloor than the present depth.

Corresponding to the portion (6-U) Ph5-U “Move Up” in FIG. 93 (in the figure marked by “A.”), the Seafloor Station 018 rises to the desired depth carrying out the organic hydride reaction while maintaining the same pressure and the same specific gravity condition as the ambient seawater. The gas and liquid composition changes from “Start Moving” to “Move Up” at the column of (6-U) Ph5-U in Table 08.

(6) Ph5 “Move”

Corresponding to (6) Ph5 “Move” in FIGS. 92 to 94 (in the figure marked by “C”). the Seafloor Station 018 moves at the same depth, without organic hydride reaction and hydrogen gas generation, and moves to the destination by the thrusters of the Seafloor Station 018.

The operation (6) Ph5 “Move” in Table 07-09 does not involve changes in gas and liquid composition.

(6-D) Ph5-D “Move Down”

It is carried out only in the case of moving to a deeper seafloor position than the present depth.

(6-D) Ph5-D “Move Down” in FIG. 94 (in the figure marked by “B”), and is lowered to the desired depth while maintaining the same pressure and the same specific gravity conditions as the ambient seawater by means of the generated hydrogen gas by water electrolysis.

The transition from (6) Ph5 “Move” to (6-D) Ph5-D “Move Down” in Table 09 shows the change in gas and liquid composition.

(7) Ph1 “Deployment” Corresponds to (2) Ph1 “Deployment” in FIGS. 92 to 94 (in the figure marked by “A”, “D”).

The same operation as “(2) Ph1 “Deployment” is performed.

There is no change in gas and liquid composition at (7) Ph1 “Decrease Buoyancy”, and “Bulldozer Deployment” in Tables 07 to 09.

(8) Ph2 “Ore Collection, Loading (First)”

Corresponding to (3) Ph2 “Ore Collection, Loading (First)” in FIGS. 92 to 94 (in the figure marked by “C”,” G”). The same operation as “(3) Ph2 “Ore Collection, Loading (First)” is carried out.

Corresponding to Table 07-09 (8) Ph2 “Ore Collection, Loading” and “H2 Fill up, Launching”.

(9) Ph3 “Ore Collection, Loading (Repetition)”

Corresponding to (4) Ph3 “Ore Collection, Loading (repetition)” FIGS. 92 to 94 (in the figure marked by “B”, “G”, “H”).

The same operation as “(4) Ph3 “Ore Collection, Loading (repetition)” is carried out. Corresponding to (9) Ph3 “Ore Loading/H2 Generation” “Deepsea Crane Arrival” “H2 Fill up/Launching” in Tables 07 to 09.

(10) Ph4 “Preparation for Floating Up”

Corresponding to Ph4 “Preparation” in FIGS. 92 to 94 (in the figure marked by “B”, “E”, “B”). The same operation as “(5) Ph4 “Preparation for Floating” is carried out.

Corresponding to Tables 07-09 (10) “Increase Buoyancy” “Bulldozer Withdrawal” “Increase Buoyancy”.

(11) Ph6 “Floating Up”

Corresponding to Ph6 “Floating up” in FIG. 92 to 94 (in the figure marked by “A”) the Seafloor Station 018 floats up to the sea surface carrying out organic hydride reaction, while maintaining the same pressure and specific gravity conditions as the ambient seawater. The changes from 10) Ph4 “Increase Buoyancy” to (11) Ph6 “Lifting up” in Table 07-09 show the changes in gas and liquid composition.

2. Improving Efficiency of Continuous Operation

In the seafloor resource collecting equipment, the overall operational efficiency is improved by allocating a plurality of the Deepsea Crane 001 to the Seafloor Station 018. In the operation of the Deepsea Crane 001, due to the constraints of the reaction time of the organic hydride reaction, a considerable amount of time is needed to float from the seafloor to the sea surface. When the Deepsea Cranes 001 are used repeatedly to harvest ore, the operation of the Deepsea Cranes 001 are carried out by shifting their operation in the time division so that the Deepsea Cranes 001 can be operated in parallel without contention of the resource (pipeline control)

As shown in FIG. 95 (a), the sequential operation of the Deepsea Crane is divided into stages from (1) to (4) as shown below.
(1) Unloading Ore & Preparation for Descending (first stage) Unloading of collected ore and MCH into Surface mother ships, toluene and pure water filling
(2) Descending (second stage) Moving from sea surface to the Seafloor Station
(3) Preparation for Floating up (Docking, Ore Loading, H2 Fill up (third stage)
   The preparation for floating up includes connection to the Cargo port, hydrogen gas filling, and unloading to the Seafloor Station.
(4) Floating up (fourth stage)
   Floating Up from Seafloor to Sea Surface

FIG. 95 (b) shows an example of lifting from a depth of 5000 m, and FIG. 95 (c) is an example of lifting from a depth of 1000 m.

Since the floating up depth is deeper, it takes the longer time for descending and lifting up, each step in FIG. 95 (a) takes a longer time at a depth of 5000 m in FIG. 95 (b) compared to a depth of 1000 m in FIG. 95 (c). In either case, an example of parallel operation without contention is shown in which the resources are allocated in parallel by allocating four Deepsea Cranes 001 to one Seafloor support apparatus 018 and by shifting the time.

### INDUSTRIAL AVAILABILITY

The seafloor resource lifting apparatus of the present invention collects mineral resources distributed on the seafloor, but does not have a mechanical constraint because it does not include a high-pressure mechanism, and can operate from less than 1000 to 5000 m depth. Hydrogen filling for buoyancy at the seafloor is under the same pressure as water pressure on the seafloor, maintaining the same pressure as the sea water pressure, and there is no stress problem due to pressure. To cope with different seafloor depths in the same yield, the hydrogen buoyancy in the seafloor must be equal, so the number of moles of hydrogen filled and the amount of toluene for hydrogen absorption are increased or decreased. In order to increase or decrease the lift yield within the limit of maximum lift yield, the volume of hydrogen filled on the seafloor is increased and decreased.

Because of the flexibility in operation, it is possible to selectively move the sea area for high quality minerals selectively and to obtain a profit.

Hydrogen gas for floating up is generated by electrolysis at the seafloor, but hydrogen gas is recovered as a hydrogen fuel, and the cost of generating electricity can be drastically reduced.

A solar cell installed as a floating body on the sea surface can generate electricity, which can be used as a plant with a highly economical efficiency, with the simultaneous harvesting of submarine resources and hydrogen energy generation.

The numerical values shown in the embodiment are intended to indicate feasibility and can scale up or down.

1. A seafloor miner that collects and lifts seafloor resources using hydrogen gas as the source of buoyancy generated by decomposing water at the seafloor.
the seafloor miner comprises equipment including;
a Seafloor Station including hydrogen gas generator(s) of which electric power is sent from the sea surface,
single or plural seafloor bulldozer(s), single or plural Deepsea Crane(s) which lifts seafloor resources using hydrogen gas as the source of buoyancy,
a surface mothership,
control equipment for each said equipment;
wherein the seafloor bulldozer collects seafloor resources and accumulates them in the Seafloor Station,
then the buoyancy of fluid including hydrogen gas loaded in the Deepsea Crane, supplied from the hydrogen gas generators on the Seafloor Station makes the Deepsea crane float from the seafloor to the sea surface.
wherein in the process of floating from the seafloor to sea surface by the buoyancy of liquid including the hydrogen gas,
the seafloor miner characterized by transferring seafloor resources loaded from the Deepsea Crane to the surface mothership,
wherein in the process of floating from the seafloor to the sea surface by the buoyancy of fluid including hydrogen gas
the Deepsea Crane is controlled to be equal to the specific gravity of the ambient seawater,
and the internal pressure of the Deepsea Crane is controlled to be same as that of the ambient seawater,
by the so designed equipment including the one which absorbs the hydrogen gas and changes to MCH (Methylcyclohexane) by an organic hydride reaction
compensating the increase of buoyancy due to the growth of hydrogen gas volume caused by the decrease of ambient water pressure as lifts up,
wherein in the process of descending from the sea surface,
the constituent portion of the Deepsea Crane is all of the solid and liquid,
and the internal pressure of the Deepsea Crane can be equal to the ambient seawater pressure and the internal pressure of the Deepsea Crane is controlled to be same as the ambient seawater pressure.

2. (canceled)

3. (canceled)

4. The seafloor miner of claim 1
Wherein the structure of the deepsea Crane comprises two portions,
the lower one (hereafter called Deepsea Crane cargo-unit or “Cargo-Unit”)
and its upper-middle one (hereafter called “Deepsea Crane Engine” or “Crane Engine”),
and these two ones can separate and reconnect,
Wherein the Cargo-Unit connected to the Crane Engine descends from the sea surface without the cargo filled with the seawater,
Wherein the Cargo-Unit connected to the Crane Engine floats from the seafloor to the sea surface with cargo and filling seawater,
Wherein one set of accepting ports (hereafter called “Cargo-Unit ports”) are provided on the Seafloor Station,
the one is with the Cargo-Unit to which seafloor bulldozer which loads seafloor resources (hereafter called “working port”),
and the other one is without the Cargo-Unit (hereafter called “vacant ports”),
Wherein the Deepsea Crane with empty Cargo-Unit descends to the Seafloor Station, dock to the vacant port, and separates the empty Cargo-Unit attaching to the vacant port,
Wherein after the separation of the empty Cargo-Unit, the Crane Engine moves over the Seafloor Station to the working port and dock to the Cargo-Unit loaded with seafloor resources; then the Deepsea Crane is formed.
Wherein then hydrogen gas is loaded into the Deepsea Crane so that the specific gravity of the Deepsea Crane is equal to the ambient seawater.

5. The seafloor miner of claim 4
wherein the Cargo-Unit connected with the Crane Engine attaches to the Cargo-Unit port, then at the same time the connection between the Cargo-Unit and the Crane Engine is disconnected,
wherein the docking function implements the latter priority alternative function.

6. The seafloor miner of claim 1, wherein the Deepsea Crane comprises a shape of an axisymmetric rotating body including two half spheres, one is at the top the other is at the bottom, and a cylinder, and a partition wall perpendicular to it and its shaft. Wherein the Deepsea Crane is configured with sturdy, a lightweight structural material including carbon fiber resin,
Wherein the specific gravity of the Deepsea Crane is equal to the specific gravity of ambient seawater by filling with only liquid in the Deepsea Crane in the case of descending from the sea surface.

7. The seafloor miner of claim 1 wherein the Deepsea Crane includes;
a holding compartment capable of filling hydrogen gas, toluene, MCH, sea water, and pure water,
a piping mechanism, including pumps and valves, which connects among the holding compartments and the hydrogen gas absorbing apparatus,
propulsion devices,
control devices,
and the Cargo-Unit.
Wherein the holding compartments are partitioned into a buoyancy tank located in the upper portion of the Crane Engine, and a liquid tank located in its lower part surrounded by the outer wall and partitioned by movable flexible separators,
Wherein the distribution of volume for each partition can change according to the amount of liquid injected to each partition.
Thus it is possible to control the buoyancy of the Crane Engine distributing liquids with different specific gravity to each compartment, including injection or discharge of fluid to/from outside.
Thus the specific gravity of the entire Deepsea Crane is equal to a specified value.

8. The seafloor miner of claim 7 wherein the hydrogen gas absorbing equipment is an organic hydrides reactor, housed in the same compartment as the buoyancy tank.
The organic hydrides reactor includes
a multi-tube fixed bed type catalyst reactor,
a gas-liquid separator,
a cooler,
and a heat exchange heater.
Wherein the reaction heat is removed by the cooler inhaling sea water from the suction port and discharging to the outlet port on the outer wall.
Wherein toluene which is supplied from the toluene compartment of the liquid tank absorbs hydrogen gas in the buoyancy tank and generates MCH which is injected into the MCH compartment of the liquid tank.

9. The seafloor miner of claim 7
wherein underwater thrusters are allocated
on the upper and lower sides of the outer wall surface
in an axis-symmetrical way and parallel to the long axis on a plane which is orthogonal to the long axis;
and in an axis-symmetrical way and perpendicular to the long axis on a plane which is orthogonal to the long axis;
wherein underwater thrusters are flow velocity jet thrusters with variable speed electric motor-driven propellers having reverse rotation capability.
Thus, the Deepsea Crane provided with underwater thrusters is characterized by position control, speed control and attitude control capability.

10. The seafloor miner of claim 1,
Wherein, the buoyancy control function, is to lift the Deepsea Crane in the sea corresponding to decrease in the molar number of hydrogen gas using the organic hydride reaction,
Wherein the underwater thrusters control the depth and depth change rate of the Deepsea Crane so that the specific gravity of the Deepsea Crane is equal to the ambient seawater and so that the internal pressure of the Deepsea Crane is equivalent to the ambient seawater.

11. The seafloor miner of claim 10 wherein wherein control of the depth and depth change rate of the Deepsea Crane is performed by measuring the pressure difference between the internal pressure of the buoyancy tank and the surrounding sea pressure and its changing rate.

12. The seafloor miner of claim 10, wherein when the buoyancy control function of the control device is not able to solve the excessive buoyancy, a hydrogen gas relief valve is operated to eliminate excessive buoyancy to normalize the buoyancy.

13. The seafloor miner of claim 10, wherein the buoyancy control is not determined by the depth of the sea, but by the difference between the internal pressure and the ambient seawater pressure and is controlled within the range not to give fracture stress to the Deepsea Crane.

14. The seafloor miner according to claim 1,
wherein the control function includes
a buoyancy control function to control lifting and descending of the Deepsea Crane,
a guidance control function to control the travel path between an arrival point on the seafloor and the sea surface command ship for the Deepsea Crane,
and an attitude control function to keep the long axis of the Deepsea Crane.

15. The seafloor miner of claim 14 wherein the guidance control function is to guide and to control the moving path between a settled point on the seafloor and a position of the surface mothership.
Wherein when the Deepsea Crane descends from the surface mothership,
The positional relationship between the Deepsea Crane and the Seafloor Station, which is the descending target, switches
the inertial navigation, the acoustic one, and the optical one,
Wherein when the Deepsea Crane rises from the Seafloor Station.
The positional relationship between the Deepsea Crane and the surface mothership, which is the rising target, switches
the inertial navigation, the acoustic one, and the optical one,
Wherein in the range where the acoustic signal does not reach or its path straightness is not enough to measure the target direction or the target range, the depth data and the inertial navigation data are in use,
Wherein in the range where acoustic measurement is enough to measure the target direction or the target range the depth data and the acoustic navigation data are in use,
Wherein in the range where the target point is near and the light reaches the optical navigation is in use.
Wherein when the Deepsea Crane descends from the surface mothership, there is a characteristic that the positional relationship between the Deepsea Crane and the Seafloor Station, which is the descending target, switches the inertial navigation, the acoustic navigation, and the optical navigation.
Wherein in the range where the acoustic signal does not reach or its path straightness is not enough to measure the target direction, depth data and the inertial navigation data are in use,
Wherein in the range where acoustic measurement is enough to measure the target direction the depth data and the acoustic navigation data are in use,
Wherein in the range where the target point is near and the light reaches the optical navigation is in use.

16. The seafloor miner of claim 15, wherein acoustic transponders are installed in the Seafloor Station and the surface mothership, and acoustic echo is generated in response to the received signal from the acoustic oscillator attached in the Deepsea Crane.
Wherein at the time of lifting the distance between the Deepsea Crane and the surface mothership is measurable by the round time of the acoustic signal, and the direction of the surface mothership is detectable from the phase difference between the acoustic detectors installed at the top of the Deepsea Crane.
Wherein at the time of descending of the Deepsea Crane, the distance between the Deepsea Crane and the Seafloor Station is measurable by the round time of an acoustic signal, and the direction of the Seafloor Station is detectable from the phase difference between the acoustic detectors installed at the bottom of the Deepsea Crane.

17. The seafloor miner of claim 15 wherein the optical navigation equipment is so configured that horizontally separated plural light emitters are installed on both of the Seafloor Station and the bottom of the surface mothership, and the positional relation between the Deepsea Crane and the Seafloor Station or the positional relation between the Deepsea Crane and the bottom of the surface mothership
is calculated based on the images taken by the image sensors on the Deepsea Crane based on imaged shape and size of light emitters and based on the different emission periods of each light emitters.

18. The seafloor miner of claim 15 wherein the navigation control device is thus configured that
Wherein at the time of descending of the Deepsea Crane,
the Deepsea Crane is docked to the Seafloor Station using controlling the relative positional relation and the approaching speed to the Seafloor Station,
Wherein at the time of lifting of the Deepsea Crane, the Deepsea Crane docks to the surface mother ship using controlling the relative positional relation and the approaching speed to the surface mothership.

19. The seafloor miner of claim 1, wherein the Deepsea Crane is configured with the buoyancy control equipment which can control lifting and descend corresponding to any cargo weight within an upper limit and a lower limit and corresponding to any depth.

20. The seafloor miner of claim 1 further
comprises equipment including
plural Deepsea Crane units,
the hydrogen gas generator,
the Cargo-Unit port,
a seafloor bulldozer transportation port,
and underwater thrusters,
which are fixed and integrated into a platform structure of the Seafloor Station,
and a remotely controlled seafloor bulldozer.

21. The seafloor miner of claim 20, wherein each of the Crane Engine of the Seafloor Station has the same configuration and function as the Crane Engine of the Deepsea Crane, except for the underwater thrusters,

22. The seafloor miner according to claim 20, wherein the hydrogen gas generator comprises a solid polymer electrolyte membrane type water electrolysis system, which connects a laminated structure in series to allow for high voltage transmission, and is connected in parallel to secure volume of hydrogen gas generation.

23. The seafloor miner according to claim 20, can lift up from a seafloor settling point and move to another location and then can settle down to the new position, using controlling the buoyancy of hydrogen gas stored in each of the Crane Engine in the Seafloor Station,
and the Seafloor Station can lift up to the sea surface without settling down to the seafloor by means of controlling the buoyancy of hydrogen gas stored in each of the Crane Engines in the Seafloor Station,

24. The seafloor miner according to claim 20, wherein the buoyancy of each of the Crane Engine is controlled so that the Seafloor Station is horizontal using controlling the amount of hydrogen gas in each of the buoyancy tanks of the Crane Engine,
And wherein the hydrogen gas pressure in each of the buoyancy tank in the Crane Engine of the Seafloor Station is controlled to be equal to the ambient seawater pressure using controlling the depth and depth change rate by controlling the underwater thrusters

25. The seafloor miner according to claim 20, wherein in operation to descend to the Seafloor Station from the sea surface,
the buoyancy tanks of the Crane Engines fill wholly or partially with hydrogen gas,
and the Seafloor Station is controlled so that the specific gravity of the Seafloor Station comes to be equal to the ambient seawater pressure
and the Seafloor Station is controlled so that the hydrogen gas pressure in the buoyancy tank is equivalent to that of the ambient seawater.

26. The seafloor miner according to claim 20, wherein in operation to descend to the seafloor from the sea surface,
It is controlled that the amount of hydrogen gas injected into each buoyancy tanks of the Crane Engines in the Seafloor Station so that the Seafloor Station is horizontal.
Furthermore, it is controlled that the depth and its changing rate of the Seafloor Station by the underwater thrusters so that the hydrogen gas pressure in the buoyancy tanks of the Seafloor Station is kept same as that of the ambient sea pressure.

27. The seafloor miner according to claim 20, wherein the seafloor bulldozer collects seafloor resources powered by electricity and is controlled remotely from the surface mothership via the Seafloor Station,
and the seafloor bulldozer gathers the mineral resources on the seafloor, then puts them to the Cargo-Unit fixed to the Cargo-Unit port.

28. The seafloor miner of claim 20, wherein the seafloor bulldozer is transportable loaded on the seafloor bulldozer transportation port on the Seafloor Station.

29. The seafloor miner according to claim 20, wherein the control device of the Seafloor Station performs guidance and control of transportation between the surface mothership and target settle point on the seafloor using cooperatively controlling the buoyancy of each of the Crane Engine and underwater thrusters on the Seafloor Station,
using the same method as the Deepsea Crane of claim 15, depending on the positional relation between the Seafloor Station and the target settle point.
Wherein it is characterized that the guidance and control is switched over between the inertial navigation, and the acoustic one, and the depth data and the acoustic measurement data in the range where it is performed,
Wherein it is used depth data and inertial navigation data within the area where the acoustic signal does not reach, or its path straightness is not enough to measure the target direction due to ocean temperature distribution by depth,
Wherein it is used depth data and acoustic measurement data within the range where acoustic measurement is enough to measure the target direction depth data, and acoustic measurement data are in use.

30. The seafloor miner according to claim 20, wherein the guidance control function of the Seafloor Station can settle down the Seafloor Station to a position where an acoustic marker is disposed on the seafloor beforehand by other means.

31. The seafloor miner according to claim 1, wherein the surface mother ship supplies power to and through optical fiber communicates with the Deepsea Crane, the Seafloor Station, and the seafloor bulldozer via the Seafloor Station.
and comprises
mothership Deepsea Crane port,
power supply equipment,
integrated monitoring and controlling apparatus,
toluene tank, MCH liquid tank, pure water tank,
a seafloor resources unloader from the Deepsea Crane(s),
a toluene loader for said Deepsea Crane and the Seafloor Station,
an MCH unloader for said Deepsea Crane and the Seafloor Station,
the pure water loader for the Deepsea Crane and the Seafloor Station.

32. The seafloor miner of claim 31 wherein the integrated monitoring and controlling equipment commands and controls the surface mothership
to supply electricity to the Seafloor Station, the Deepsea Crane(s) and the seafloor bulldozer,
to unload MCH from the MCH tanks in the Deepsea Crane(s) and the Seafloor Station,
to load pure water into the pure water tanks in the Deepsea Crane(s) and the Seafloor Station,
commands and controls the Seafloor Station
to settle down to a specified point on the seafloor,
to move from a specified location to another one on the seabed,
to float to the surface command ship,
commands and controls the Deepsea Crane(s)
to descend from the surface mothership and to dock to the Seafloor Station,
to float from the Seafloor Station and to dock to the surface mothership,
to unload the collected seafloor resources from Deepsea Crane(s) to the surface mothership,
to dock to the Cargo-Unit port and then to lift up
commands and controls the seafloor bulldozer via the Seafloor Station
to depart from the seafloor bulldozer transportation port,
to collect mineral resources on the seafloor, and to load them to the Cargo-Unit,
to ride on the seafloor bulldozer transportation port to prepare for the move of the Seafloor Station

33. The seafloor miner of claim 31, wherein the power supply device includes a generator, an offshore solar cell, and a secondary battery and a power supply.

34. The seafloor miner of claim 33 wherein the offshore solar cell comprises a plurality of solar cell units having a strip structure attached to a flexible floating body.
Each solar cell unit has a segment-wise uniform structure across the entire strip region by a distributed inverter device and an AC bus for transmission and is a solar cell unit capable of maintaining and replacing each of the segments.
Wherein a solar cell is characterized in that an autonomous self-propelled deployment/withdrawal device equipped at the end of the strip structure can deploy and withdraw the strip downstream along a tidal current.

35. The seafloor miner of claim 33 wherein the solar cell comprising a plurality of solar cell units, which can be deployed and withdrawn in a cylindrical shape, in the ocean, and in a fan direction downstream of the tidal current by a traction line.

36. The seafloor miner of claim 4, wherein the single Seafloor Station allocates plural Deepsea Cranes,
Wherein each of the Deepsea Crane sequentially executes the following four steps;
as the first step, descending preparation, including unloading of lifted ore and MCH into the surface mothership, and loading of toluene and pure water to the Deepsea Crane,
as the second step, descending from the sea surface to the Seafloor Station,
as the third step, the Deepsea Crane docks to the empty Cargo-Unit port of the Seafloor Station, then Cargo-Unit is separated from the Deepsea Crane and is connected to using docking to the Cargo-Unit port of the Seafloor Station,
and subsequently, the Crane Engine is separated from the Cargo-Unit port leaving the empty Cargo-Unit to the Cargo-Unit port,
and then the Crane Engine lifts up and moves horizontally, and re-descends to another Cargo-Unit port where the Cargo-Unit loads seafloor resources,
and subsequently, the floating preparation including the buoyancy grant by hydrogen gas filling from the Seafloor Station and the unloading of the pure water from the Deepsea Crane to the Seafloor Station,
as the fourth step, floating from the seafloor to the sea surface,
For the above four steps, plural Deepsea Cranes are allocated to one Seafloor Station so that each of the four ones operates without overlapping
And furthermore, the seafloor resource collection and loading to the Seafloor Station by the seafloor bulldozer can be carried out with no conflict with each of the four steps.
Through the operation, the Cargo-Unit port with the empty Cargo-Unit and the Cargo-Unit port with the Cargo-Unit with seafloor ore change roles alternately.

37. The seafloor miner according to claim 1, wherein,
the mole amount of toluene and hydrogen gas held in the Deepsea Crane at the seafloor is adjustable by the settlement depth of the Seafloor Station,
to the specific gravity of the Deepsea Crane is equivalent to the surrounding water at the starting time of lift up,
and to during the lifting up of the Deepsea Crane there exists enough toluene volume to keep the pressure equivalent to the ambient water using absorbing hydrogen gas.

38. The seafloor miner according to claim 1,
wherein the amount of toluene and the mol amount of hydrogen gas stored in the Deepsea Crane is adjustable to be same as the specific gravity of the ambient seawater at the time of lift up from the seabed,
and wherein the amount of hydrogen gas is adjustable to be sufficient to discharge it to the sea to maintain the pressure equivalent to the ambient water.

39. The seafloor miner according to claim 37,
wherein weight meters are installed in the Cargo-Unit port, and the amount of toluene and hydrogen gas in the Deepsea Crane is adjustable by measuring the amount of toluene and hydrogen gas filled at the seafloor at the time of lifting.

40. The seafloor miner according to according to claim 20, wherein the operation comprises:
as the first step, descending of the Seafloor Station from the surface mothership and settlement at the seafloor, then the development of the seafloor bulldozer there,
as the second step, filling of toluene and pure water from the surface mothership to the Deepsea Crane;
as the third step, descending of the Deepsea Crane to the Seafloor Station which deploys on the seafloor;
as the fourth step, preparation of lifting up for the Deepsea Crane comprises;
unloading of pure water and a part of toluene from the Deepsea Crane to the Seafloor Station,
and the production of hydrogen gas at the Seafloor Station, the loading of hydrogen gas and collected ore to the Deepsea Crane, and as necessary, the loading of the MCH;
as the fifth step, lifting up of the Deepsea Crane toward the surface mothership from the Seafloor Station deployed on the seafloor,
as the sixth step, unloading of the collected ore and MCH which absorbed hydrogen gas from the Deepsea Crane to the surface mother ship;
as the seventh step, installing the seafloor bulldozer onto the Seafloor Station and the floating toward the surface mother ship;
Wherein In the above operation,
one or more of the Deepsea Cranes are repeatedly operated from the second step to the sixth step continuously without interruption to continuously.

41. The seafloor miner of claim 40,
wherein in between the second step and the seventh step,
the following three steps are prepared to move the Seafloor Station position;
as the A1 step, restoring the seafloor bulldozer on the Seafloor Station at the seafloor, and increasing buoyancy using generating hydrogen gas to equalize the specific gravity of the Seafloor Station with the surrounding seawater,
as the A2 step, lifting up of the Seafloor Station from the seafloor and subsequently changing its position,
as the A3 stage, settling down the Seafloor Station on the sea bottom and fixing its position increasing its specific gravity more than that of the ambient seawater using adsorbing hydrogen gas into toluene generating MCH.
